(19) United States
(12) Patent Application Publication
(10) Pub. No.: US 2026/0359333 A1
(43) Pub. Date: Nov. 12, 2026

(54) System and method for processing information

(71) Applicant: LiveArena Technologies, Inc., Bellevue, WA (US)

(72) Inventors: Strider AGOSTINELLI, Everett, WA (US); Anders NILSSON, Falköping (SE)

(21) Appl. No.: 19/196,784

(22) Filed: May 2, 2025

(51) Int. Cl. G06F 16/334; G06F 16/3329; G06F 40/40

(52) U.S. Cl. CPC G06F 16/334; G06F 16/3329; G06F 40/40

(57) ABSTRACT

Method for processing information in a system (100) comprising a database (200), the database (200) comprising information representing a plurality of stored items, the stored items comprising a plurality of represented entities, each entity having one or more entity types and one or more entity properties; and a plurality of represented connections, each connection being defined in terms of two or more interconnected entities and each connection having one or more connection types, wherein each of the stored items is stored in the database (200) and comprises or is associated with a respective embedding, the respective embedding being calculated based on metadata regarding the stored item.

The method comprises receiving a free-text input; calculating an input text embedding based on the free-text input; and performing a similarity search in the database (200) using the input text embedding.

### BACKGROUND

The present invention relates to systems and methods for processing information.

Recently, the development of large language models (LLMs), in particular using the so-called transformers architecture, has revolutionized the processing of textual information. This has paved the way for improvements within natural language processing but also automation in a wide range of information processing and task management systems. Such LLMs are capable of advanced language processing and even complex problem solving, as well as pattern recognition and adaptive responses. At the same time, the performance of such LLMs has proven to be inconsistent in many practical use cases. Their knowledge retention capabilities are limited, and there are scaling constraints. In addition, there are security vulnerability concerns.

The use of natural language in information processing systems dramatically increases the flexibility and reach of such systems, but on the other hand decreases reliability. To solve this problem, self-reasoning models have been suggested with varying results. One main problem is that inference requires large amounts of compute and therefore financial resources as well as calculation time. There is therefore a trade-off between reliability and speed. Attempts have also been made to tailor LLMs to particular circumstances and tasks, by for instance using narrow datasets for post-training of such models. There is a problem achieving reliable general as well as domain-specific functionality without running the risk of security breaches, such as exposing sensitive information.

In general, it would be desirable to achieve a solution for information processing configured to operate on free-text information but with high efficiency, reliability, response speeds and information security. Such a solution should also be able to use long-term contexts, be highly context-sensitive and capable of dynamically adapting to various information over time.

The present invention solves one or more of the above described problems.

The following pieces of research provide a relevant background to the presently described mechanisms: “Transformers Squared” (blog post, https://sakana.ai/transformer-squared/), “Google's Titans: Learning to Memorize at Test Time” (Ali Behrouz, Peilin Zhong, Vahab Mirrokni; https://arxiv.org/abs/2501.00663), “Leave No Context Behind: Efficient Infinite Context Transformers with Infini-attention” (Tsendsuren Munkhdalai, Manaal Faruqui, Siddharth Gopal; https://arxiv.org/abs/2404.07143), “How Memory in Optimization Algorithms Implicitly Modifies the Loss” (Matias D. Cattaneo, Boris Shigida, https://arxiv.org/abs/2502.02132), “Contextual Memory Reweaving in Large Language Models Using Layered Latent State Reconstruction” (Frederick Dillon, Gregor Halvorsen, Simon Tattershall, Magnus Rowntree, Gareth Vanderpool, https://arxiv.org/abs/2502.02046), “TReMu: Towards Neuro-Symbolic Temporal Reasoning for LLM-Agents with Memory in Multi-Session Dialogues” (Yubin Ge, Salvatore Romeo, Jason Cai, Raphael Shu, Monica Sunkara, Yassine Benajiba, Yi Zhang, https://arxiv.org/abs/2502.01630), “M+: Extending MemoryLLM with Scalable Long-Term Memory” (Yu Wang, Dmitry Krotov, Yuanzhe Hu, Yifan Gao, Wangchunshu Zhou, Julian McAuley, Dan Gutfreund, Rogerio Feris, Zexue He, https://arxiv.org/abs/2502.00592), “MINDSTORES: Memory-Informed Neural Decision Synthesis for Task-Oriented Reinforcement in Embodied Systems” (Anirudh Chari, Suraj Reddy, Aditya Tiwari, Richard Lian, Brian Zhou, https://arxiv.org/abs/2501.19318), “Zep: A Temporal Knowledge Graph Architecture for Agent Memory” (Preston Rasmussen, Pavlo Paliychuk, Travis Beauvais, Jack Ryan, Daniel Chalef, https://arxiv.org/abs/2501.13956), “Breaking Memory Limits: Gradient Wavelet Transform Enhances LLMs Training” (Ziqing Wen, Ping Luo, Jiahuan Wang, Xiaoge Deng, Jinping Zou, Kun Yuan, Tao Sun, Dongsheng Li, https://arxiv.org/abs/2501.07237), and “Are LLMs Really Not Knowledgable? Mining the Submerged Knowledge in LLMs' Memory” (Xingjian Tao, Yiwei Wang, Yujun Cai, Zhicheng Yang, Jing Tang, https://arxiv.org/abs/2412.20846).

### SUMMARY

The invention relates to a method for processing information in a system comprising a database, the database comprising information representing a plurality of stored items, the stored items comprising a plurality of represented entities, each entity having one or more entity types and one or more entity properties; and a plurality of represented connections, each connection being defined in terms of two or more interconnected entities and each connection having one or more connection types. Each of the stored items can be stored in the database and comprise or be associated with a respective embedding, the respective embedding being calculated based on metadata regarding the stored item.

In some embodiments, the method comprises receiving a free-text input; calculating an input text embedding based on at least one of the free-text input and one or more identified items automatically identified in the free-text input based on text processing; performing a similarity search in the database, comparing embeddings of the stored items to the input text embedding using a vector-based similarity measure; selecting a similar set as a subset of the stored items based on the similarity search; and expanding the similar set, thereby forming an expanded set of items.

In some embodiments, the expanding of the similar set comprises adding one or more entities stored in the database, not already forming part of similar set and being interconnected by a connection forming part of the similar set.

In some embodiments, the expanding of the similar set comprises adding one or more connections stored in the database, not already forming part of the similar set and interconnecting an entity forming part of the similar set.

In some embodiments, the method further comprises identifying a subset of the expanded set as a ranked set based on a ranking rule, the ranking rule being based on a respective vector similarity between respective embeddings of individual items in the expanded set and the input text embedding.

In some embodiments, the method further comprises providing a response to a recipient based on the ranked set.

In some embodiments, the method further comprises processing the information stored in the database based on the ranked set.

In some embodiments, the stored items comprise one or more interactions, each interaction being defined in terms of a set of two or more entities, each interaction having one or more interaction types and a timestamp.

In some embodiments, the expanding of the similar set comprises adding one or more entities stored in the database, not already forming part of the similar set and being interconnected by an interaction forming part of the similar set.

In some embodiments, the expanding of the similar set comprises adding one or more interactions stored in the database, not already forming part of the similar set and interconnecting an entity forming part of the similar set.

In some embodiments, the similarity search comprises identifying a first set of one or more of the entities having embeddings that are determined to be similar to the input text embedding according to an entity vector-based similarity measure.

In some embodiments, the similarity search comprises identifying a second set of one or more of the connections having embeddings that are determined to be similar to the input text embedding according to a connection vector-based similarity measure.

In some embodiments, the similarity search comprises identifying a third set of one or more of the interactions having embeddings that are determined to be similar to the input text embedding according to an interaction vector-based similarity measure.

In some embodiments, the similarity search comprises performing a community detection algorithm based on the similar set, resulting in a classification into distinct community groups of the items in the similar set; and wherein the ranking rule is based on the classification.

In some embodiments, the community detection algorithm is configured to assign one and the same item of the similar set into two or more of the community groups.

In some embodiments, the community detection algorithm is based on, firstly, entities and, secondly, interactions and/or connections in the similar set.

In some embodiments, the classification is a classification into the distinct community groups of the entities, interactions and/or connections in the similar first.

In some embodiments, the community detection algorithm is a Louvain community detection algorithm, nodes in the Louvain community detection algorithm correspond to entities in the similar set, edges in the Louvain community detection algorithm correspond to interactions and/or connections in the similar set, and weights in the Louvain community detection algorithm are determined based on respective similarity measurements, based on said respective vector-based similarity measure, between the input text embedding and a respective embedding of each of the entities being interconnected by the interaction and/or connection in question.

In some embodiments, the community detection algorithm is configured to assign interactions and/or connections in the similar set to communities based on community assignments of the corresponding entities interconnected by the interaction and/or connection in question.

In some embodiments, the ranking rule is based on a connection count for one or more entities in the similar set, being a respective number of stored interactions in the database for the entity, the stored interactions interconnecting the entity to other entities in the similar set.

In some embodiments, the ranking rule is based on a relevance decay or recency value for one or more entities in the similar set, being determined based on a latest timestamp of an interaction stored in the database interconnecting an entity.

In some embodiments, the ranking rule is based on a relevance decay or recency value for one or more connections in the similar set, being determined based on a latest timestamp of an interaction stored in the database interconnecting entities being interconnected by the connection.

In some embodiments, the ranking rule is based on an entity similarity score for one or more interactions in the similar set, being determined based on the respective similarity scores of entities being interconnected by the interaction.

In some embodiments, the ranking rule is based on an interaction count for one or more connections in the similar set, being determined based on a number of interactions stored in the database interconnecting the entities interconnected by the connection.

In some embodiments, the ranking rule is based on a multi-community weighting for one or more interactions in the similar set, being determined based on a number of detected community groups to which the interaction belongs.

In some embodiments, the ranking rule is based on a conversation flow value for one or more interactions in the similar set, being determined for items stored in the database.

In some embodiments, the ranking rule is based on a focus value for one or more interactions in the similar set, being determined based on a number of distinct detected community groups to which all entities being interconnected by the interaction belong.

In some embodiments, the ranking rule is determined based on a weighing of one or more of said connection count; said relevance decay or recency value for the connections or interactions; said entity similarity score; said interaction count; said multi-community weighting; said conversation flow value; and said focus value.

In some embodiments, the weighing is different for entities, connections and/or interactions in the similar set.

In some embodiments, the ranking rule is based on a similarity score of the embedding of the item and the input text embedding, according to said respective vector-based similarity measure.

In some embodiments, the ranking rule is based on a connection count for one or more entities in the similar set, being a respective number of stored connections in the database for the entity, the stored connections interconnecting the entity to other entities in the similar set.

In some embodiments, the ranking rule is based on a community count for one or more entities in the similar set, being a number of other items present in a detected community group to which the entity belongs.

In some embodiments, the ranking rule is based on a clustering coefficient for one or more entities in the similar set, being determined for the entity in relation to a detected community group to which the entity belongs.

In some embodiments, the ranking rule is based on a network centrality measure for one or more entities in the similar set, being determined for the entity in relation to other items stored in the database.

In some embodiments, the ranking rule is based on an entity similarity score for one or more connections in the similar set, being determined based on the respective similarity scores of entities being interconnected by the connection.

In some embodiments, the ranking rule is based on a structural importance for one or more connections in the similar set, being determined for entities stored in the database.

In some embodiments, the ranking rule is based on a focus value for one or more entities in the similar set, being determined based on a number of distinct detected community groups to which the entity belongs.

In some embodiments, the ranking rule is based on a focus value for one or more connections in the similar set, being determined based on a number of distinct detected community groups to which all entities being interconnected by the connection belong.

In some embodiments, the ranking rule is based on a uniqueness value for one or more items in the similar set, being determined based on a similarity score of the item as compared to a calculated distribution of similarity scores of items in the similar set.

In some embodiments, the ranking rule is based on a depth value for one or more items in the similar set, being determined based on a stored context size for the item stored in the database.

In some embodiments, the ranking rule is based on a user significance value for one or more items in the similar set, being determined based on a vector-based similarity measure between the item and an item representing a particular user according to a vector-based similarity measure.

In some embodiments, the ranking rule is determined based on a weighing of one or more of said similarity; said connection count; said community count; said clustering coefficient; said network centrality measure; said entity similarity score; said structural importance; said multi-community weighting; said conversation flow value; said focus value; said uniqueness value; said depth value; and said user significance value.

In some embodiments, the weighing is different for entities and/or connections in the similar set.

In some embodiments, the method comprises automatically producing a respective text prompt to the one or more LLMs, or to one or more different LLMs, requesting the one or more LLMs in question to, in a respective response to the text prompt, provide information as to how to determine the ranking rule, the respective text prompt comprising information regarding the free-text input; and determining the ranking rule based on the response.

In some embodiments, the input text embedding is calculated based on the entire free-text input.

In some embodiments, the input text embedding is calculated based on both the free-text input and additional context information regarding a context in which the free-text input was generated.

In some embodiments, the method comprises identifying, based on the free-text input, one or more identified items, the identified items comprising one or more identified entities and/or one or more identified connections.

In some embodiments, the method comprises identifying, based on the free-text input, one or more identified interactions.

In some embodiments, the identifying of the one or more identified items comprises automatically producing a respective text prompt to the one or more LLMs, or to one or more different LLMs, requesting the one or more LLMs in question to, in a respective response to the text prompt, identify any items referred to in the free-text input.

In some embodiments, the identifying of the one or more identified items comprises automatically causing one or more non-LLM NLPs to extract any nouns, verbs, subjects and/or objects from the free-text input.

In some embodiments, the method comprises identifying relations between items from the extracted nouns, verbs, subjects and/or objects; and formulating the identified relations as additional pieces of free-text relational information.

In some embodiments, the method comprises performing a similarity search in the database, possibly only taking into consideration the similar set or the ranked set, comparing embeddings of the stored items to an embedding of the additional pieces of free-text relational information using a vector-based similarity measure; wherein the identifying of the one or more identified items is based on the vector-based similarity measure.

In some embodiments, the method comprises identifying one or more additional pieces of free-text information, the additional pieces of free-text information preceding the free-text input, and the text prompt is produced to request the one or more LLMs to, in a respective response to the text prompt, identify any items referred to in a concatenation of one or more of the additional pieces of information with the free-text input and/or any metadata pertaining to such items.

In some embodiments, the one or more additional pieces of free-text information are identified to relate or refer to one and the same item.

In some embodiments, the method comprises identifying a respective set of one or more additional pieces of free-text information for each of the identified items.

In some embodiments, the identification of the one or more additional pieces of free-text information is performed by one or more non-LLM NLPs.

In some embodiments, the method comprises dividing the additional pieces of free-text information into two or more text chunks having mutual text overlap; and producing the text prompt to comprise the two or more text chunks.

In some embodiments, the method comprises arranging the two or more text chunks in chronological order; producing the text prompt to instruct the one or more LLMs to identify any pieces of conflicting information regarding identified items; and producing the text prompt to instruct the one or more LLMs to disregard any of the pieces of conflicting information being chronologically before another one of the pieces of conflicting information regarding the same information conflict.

In some embodiments, the method comprises determining that the two or more text chunks do not fit in an available context window of the one or more LLMs; and as a result producing two or more text prompts, each of the two or more text prompts comprising a unique subset of the text chunks; and merging a respective response from each of the one or more LLMs to the two or more text prompts into a single piece of response data.

In some embodiments, the merging comprises automatically producing a respective text prompt to the one or more LLMs, or to one or more different LLMs, requesting the one or more LLMs in question to, in a respective response to the text prompt and based on the respective response, produce the single piece of response data.

In some embodiments, the method comprises calculating the input text embedding based on one of the identified items.

In some embodiments, the method comprises producing the text prompt based on, such as to comprise or refer to, the extracted nouns, verbs, subjects and/or objects; and producing the text prompt to be instructive to the one or more LLMs to extract any information regarding the extracted nouns, verbs, subjects and/or objects that is inferred by the free-text input.

In some embodiments, the method comprises mapping each of the identified items to zero corresponding stored items or to one corresponding stored item in the database; and, for each of one or more of the identified items, if the identified item is mapped to one corresponding stored item, such as to exactly one corresponding item, updating metadata relating to the corresponding stored item in the database using metadata relating to the identified item; or if the identified item is mapped to zero corresponding stored items, adding the identified item to the database.

In some embodiments, the mapping of each of the identified items to zero corresponding stored items or to one corresponding stored item in the database comprises performing a similarity search, comparing an embedding of the identified item to embeddings of the set of similar items, using a vector-based similarity measure; and selecting a set of zero, one or more potentially matching items based on the similarity search.

In some embodiments, the embedding of the identified item is calculated based on metadata relating to the identified item.

In some embodiments, the method comprises automatically producing a respective text prompt to the one or more LLMs, or to one or more different LLMs, requesting the one or more LLMs in question to, in a respective response to the text prompt, determine a most probable matching item in the database, the text prompt comprising or referring to information regarding the set of potentially matching items.

In some embodiments, the text prompt further comprises or refers to any of the stored items having graph associations with each of the respective potentially matching items.

In some embodiments, the response to the text prompt indicates the most probable matching item in the database; and further updating the most probable matching item with metadata regarding the identified item.

In some embodiments, the updating of the most probable matching item comprises automatically producing a respective text prompt to the one or more LLMs, or to one or more different LLMs, requesting the one or more LLMs in question to, in a respective response to the text prompt, provide a merged set of metadata for the most probable matching item, the text prompt comprising or referring to metadata both for the identified item and the most probable matching item; and the updating of the most probable matching item comprises associating the most probable matching item with the merged metadata.

In some embodiments, the updating of the most probable matching item comprises adding the updated most probable matching item as a new item version in the database with an updated timestamp.

In some embodiments, the response to the text prompt indicates the absence of a most probable matching item in the database; and the method further comprises adding the identified item as a new item to the database.

The invention relates to a method for processing information in a system comprising a database, the database comprising information representing a plurality of stored items, the stored items comprising a plurality of represented entities, each entity having one or more entity types and one or more entity properties; and a plurality of represented connections, each connection being defined in terms of two or more interconnected entities and each connection having one or more connection types. Each of the stored items can be stored in the database and comprise or be associated with a respective embedding, the respective embedding being calculated based on metadata regarding the stored item.

In some embodiments, the method comprises receiving a first free-text input; invoking a response tool, the invoking of the response tool comprising automatically producing a respective text prompt to one or more LLMs requesting the one or more LLMs to, in a respective response to the text prompt, provide a first response to the first free-text input; calculating an input text embedding based on at least one of the first free-text input and one or more identified items automatically identified in the first free-text input based on text processing; performing a similarity search in the database, comparing the input text embedding to respective embeddings of the stored items, using a vector-based similarity measure; and selecting a similar set as a subset of the stored items based on the similarity search.

In some embodiments, the method comprises identifying an expanded set of items by expanding the similar set based on connections in the database interconnecting entities in the similar set.

In some embodiments, the method comprises identifying the expanded set of items by expanding the similar set based on entities in the database interconnected by connections in the similar set.

In some embodiments, the method further comprises identifying a subset of the expanded set as a ranked set based on a ranking rule; and providing the first response to a recipient and in addition providing information to the recipient based on the ranked set.

In some embodiments, the stored items comprise one or more interactions, each interaction being defined in terms of a set of two or more entities, each interaction having one or more interaction types and a timestamp.

In some embodiments, the identifying of the expanded set of items comprises expanding the similar set based on interactions in the database interconnecting entities in the similar set.

In some embodiments, the identifying of the expanded set of items comprises expanding the similar set based on entities in the database interconnected by interactions in the similar set.

In some embodiments, the providing information to the recipient based on the ranked set comprises automatically producing a respective text prompt to the one or more LLMs, or to one or more different LLMs, requesting the one or more LLMs in question to, in a respective response to the text prompt, provide a fast response to the first free-text input, and to provide the fast response to the recipient.

In some embodiments, the providing information to the recipient based on the ranked set comprises performing a search or request for external information based on the ranked set, and to provide a result from the search or request to the recipient.

In some embodiments, the result from the search or request is provided to the recipient in connection to the first response.

In some embodiments, the method comprises updating the similar set and/or the ranked set based on the result from the search or request.

In some embodiments, the providing information to the recipient based on the ranked set comprises providing one or more of the items in the ranked set to the recipient in an interactive interface, the interactive interface being configured to allow the recipient to activate selected ones of the provided items to interactively navigate the items in the database by following connections stored in the database.

In some embodiments, the one or more of the items in the ranked set is provided to the recipient in the interactive interface, in connection to the first response.

In some embodiments, the method comprises updating the similar set and/or the ranked set based on stored items activated by the recipient in said interactive navigation.

In some embodiments, the invoking of the response tool comprises producing the text prompt based on, such as to comprise or refer to, the similar set or the ranked set.

In some embodiments, the invoking of the response tool involves automatically producing a text prompt to the one or more LLMs, or to one or more different LLMs, requesting the LLM in question to, in response to the text prompt, provide information instructive of invoking one or more tools to process the first free-text input; and further invoking each of the one or more different tools to process the first free-text input.

In some embodiments, one or more of the tools are defined in terms of respective tool functionality metadata, and the invoking of the tool comprises automatically producing a respective text prompt to the one or more LLMs, or to one or more different LLMs, requesting the one or more LLMs in question to, in a respective response to the text prompt, provide a result from the selected tool, wherein the text prompt comprises information regarding the first free-text input as well as the tool functionality metadata.

In some embodiments, one or more of the tools comprises a respective algorithmic tool in the form of a piece of software encoding an algorithm, and the invoking of the tools comprises invoking the piece of software.

In some embodiments, the method comprises receiving a second free-text input after the receiving of the first free-text input.

In some embodiments, the method comprises invoking the response tool, the invoking of the response tool comprising automatically producing a respective text prompt to the one or more LLMs, or to one or more different LLMs, requesting the one or more LLMs in question to, in a respective response to the text prompt, provide a second response to the second free-text input; and providing the second response to the recipient.

In some embodiments, the method comprises recalculating the input text embedding based on at least one of the second free-text input and one or more identified items automatically identified in the second free-text input based on text processing.

In some embodiments, the recalculating of the input text embedding is performed further based on at least one of the first free-text input and one or more of the identified items automatically identified in the first free-text input based on text processing.

In some embodiments, the method comprises performing a similarity search in the database, comparing the recalculated input text embedding to respective embeddings of the stored items, using a vector-based similarity measure; selecting an updated similar set of the stored items based on the similarity search; and identifying an updated expanded set of items by expanding the similar set.

In some embodiments, the expanding of the similar set is performed based on interactions in the database interconnecting entities in the updated similar set.

In some embodiments, the expanding of the similar set is performed based on entities in the database interconnected by interactions in the updated similar set.

In some embodiments, the expanding of the similar set is performed based on connections in the database interconnecting entities in the updated similar set.

In some embodiments, the expanding of the similar set is performed based on entities in the database interconnected by connections in the updated similar set.

In some embodiments, the method further comprises identifying a subset of the expanded set as an updated ranked set based on the ranking rule; and providing updated information to the recipient based on the updated ranked set.

In some embodiments, the ranking rule is based on a connection count for one or more entities in the similar set, being a respective number of stored interactions in the database for the entity, the stored interactions interconnecting the entity to other entities in the similar set.

In some embodiments, the ranking rule is based on a relevance decay or recency value for one or more entities in the similar set, being determined based on a latest timestamp of an interaction stored in the database interconnecting an entity.

In some embodiments, the ranking rule is based on a relevance decay or recency value for one or more connections in the similar set, being determined based on a latest timestamp of an interaction stored in the database interconnecting entities being interconnected by the connection.

In some embodiments, the ranking rule is based on an entity similarity score for one or more interactions in the similar set, being determined based on the respective similarity scores of entities being interconnected by the interaction.

In some embodiments, the ranking rule is based on an interaction count for one or more connections in the similar set, being determined based on a number of interactions stored in the database interconnecting the entities interconnected by the connection.

In some embodiments, the ranking rule is based on a multi-community weighting for one or more interactions in the similar set, being determined based on a number of detected community groups to which the interaction belongs.

In some embodiments, the ranking rule is based on a conversation flow value for one or more interactions in the similar set, being determined for items stored in the database; and a focus value for one or more interactions in the similar set, being determined based on a number of distinct detected community groups to which all entities being interconnected by the interaction belong.

In some embodiments, the ranking rule is determined based on a weighing of one or more of said connection count; said relevance decay or recency value for the connections or interactions; said entity similarity score; said interaction count; said multi-community weighting; said conversation flow value; and said focus value.

In some embodiments, the weighing is different for entities, connections and/or interactions in the similar set.

In some embodiments, the ranking rule is based on a similarity score of the embedding of the item and the input text embedding, according to said respective vector-based similarity measure.

In some embodiments, the ranking rule is based on a connection count for one or more entities in the similar set, being a respective number of stored connections in the database for the entity, the stored connections interconnecting the entity to other entities in the similar set.

In some embodiments, the ranking rule is based on a community count for one or more entities in the similar set, being a number of other items present in a detected community group to which the entity belongs.

In some embodiments, the ranking rule is based on a clustering coefficient for one or more entities in the similar set, being determined for the entity in relation to a detected community group to which the entity belongs.

In some embodiments, the ranking rule is based on a network centrality measure for one or more entities in the similar set, being determined for the entity in relation to other items stored in the database.

In some embodiments, the ranking rule is based on an entity similarity score for one or more connections in the similar set, being determined based on the respective similarity scores of entities being interconnected by the connection.

In some embodiments, the ranking rule is based on a structural importance for one or more connections in the similar set, being determined for entities stored in the database.

In some embodiments, the ranking rule is based on a focus value for one or more entities in the similar set, being determined based on a number of distinct detected community groups to which the entity belongs.

In some embodiments, the ranking rule is based on a focus value for one or more connections in the similar set, being determined based on a number of distinct detected community groups to which all entities being interconnected by the connection belong.

In some embodiments, the ranking rule is based on a uniqueness value for one or more items in the similar set, being determined based on a similarity score of the item as compared to a calculated distribution of similarity scores of items in the similar set.

In some embodiments, the ranking rule is based on a depth value for one or more items in the similar set, being determined based on a stored context size for the item stored in the database.

In some embodiments, the ranking rule is based on a user significance value for one or more items in the similar set, being determined based on a vector-based similarity measure between the item and an item representing a particular user according to a vector-based similarity measure.

In some embodiments, the ranking rule is determined based on a weighing of one or more of said similarity; said connection count; said community count; said clustering coefficient; said network centrality measure; said entity similarity score; said structural importance; said multi-community weighting; said conversation flow value; said focus value; said uniqueness value; said depth value; and said user significance value.

In some embodiments, the weighing is different for entities and/or connections in the similar set.

In some embodiments, the method comprises automatically producing a respective text prompt to the one or more LLMs, or to one or more different LLMs, requesting the one or more LLMs in question to, in a respective response to the text prompt, provide information as to how to determine the ranking rule, the respective text prompt comprising information regarding the free-text input; and determining the ranking rule based on the response.

The invention relates to a method for processing information in a system comprising a database, the database comprising information representing a plurality of stored items, the stored items comprising a plurality of represented entities, each entity having one or more entity types and one or more entity properties; and a plurality of represented connections, each connection being defined in terms of two or more interconnected entities and each connection having one or more connection types, wherein each of the stored items is stored in the database and comprises or is associated with a respective embedding, the respective embedding being calculated based on metadata regarding the stored item.

In some embodiments, the method comprises receiving a first free-text input; invoking a fast-response tool, the invoking of the fast-response tool comprising automatically producing a respective text prompt to one or more LLMs requesting the one or more LLMs to, in a respective response to the text prompt, provide a first fast response to the first free-text input; invoking a slow-response tool, the invoking of the slow-response tool comprising calculating an input text embedding based on at least one of the first free-text input and one or more identified items automatically identified in the first free-text input based on text processing; performing a similarity search in the database, comparing the input text embedding to respective embeddings of the stored items, using a vector-based similarity measure; selecting a similar set as a subset of the stored items based on the similarity search; and automatically producing a respective text prompt to the one or more LLMs, or to one or more different LLMs, requesting the one or more LLMs in question to, in a respective response to the text prompt, provide a slow response to the first free-text input taking into consideration the similar set of items; wherein the method further comprises providing the fast response to a recipient at a first time and the slow response to the recipient at a second time, the second time being later than the first time.

In some embodiments, the stored items comprise one or more interactions, each interaction being defined in terms of a set of two or more entities, each interaction having one or more interaction types and a timestamp.

In some embodiments, the invoking of the fast-response tool and the slow-response tool are performed in parallel.

In some embodiments, the one or more text prompts used to produce the slow response comprises information regarding a higher number of the items stored in the database and/or a higher number of pieces of metadata regarding the items, as compared to the one or more text prompts used to produce the fast response.

In some embodiments, the invoking of the fast-response tool comprises producing the text prompt based on, such as containing or referring to, the set of selected items.

In some embodiments, the invoking of the fast-response tool involves automatically producing a text prompt to the one or more LLMs, or to one or more different LLMs, requesting the LLM in question to, in response to the text prompt, provide the fast response and also to provide information instructive of invoking one or more tools to process the first free-text input; and further invoking each of the one or more different tools to process the first free-text input to produce the slow response.

In some embodiments, one or more of the tools are defined in terms of respective tool functionality metadata, and the invoking of the tool comprises automatically producing a respective text prompt to the one or more LLMs, or to one or more different LLMs, requesting the one or more LLMs in question to, in a respective response to the text prompt, provide a result from the selected tool, wherein the text prompt comprises information regarding the first free-text input as well as the tool functionality metadata.

In some embodiments, one or more of the tools comprises a respective algorithmic tool in the form of a piece of software encoding an algorithm, and wherein the invoking of the tools comprises invoking the piece of software.

In some embodiments, the method comprises receiving a second free-text input after the first free-text input; invoking the fast-response tool to produce a second fast response to the second free-text input; and providing the second fast response to the recipient; wherein the input text embedding is calculated based on at least one of the second free-text input and one or more identified items automatically identified in the second free-text input based on text processing.

In some embodiments, the one or more text prompts provided to the one or more LLMs in the step of invoking the fast-response tool are produced to request the one or more LLMs to identify any additional information required to respond to a question or perform a task or assignment defined in the free-text input; and wherein the first fast response comprises a request for the additional information.

In some embodiments, the invoking of the slow-response tool comprises receiving one or more pieces of information from one or more external information sources, and wherein the one or more text prompts used to produce the slow response is produced based on, such as comprises or refers to, said one or more pieces of information.

In some embodiments, the one or more text prompts used to produce the second fast response comprise both the first free-text input and the second free-text input.

In some embodiments, the one or more text prompts used to produce the second fast response comprise the first fast response.

In some embodiments, the one or more text prompts used to produce the slow response comprise both the first free-text input and the second free-text input.

In some embodiments, the one or more text prompts used to produce the slow response comprise the first fast response.

The invention relates to a method for processing information in a system comprising a database, the database comprising information representing a plurality of stored items, the stored items comprising a plurality of represented entities, each entity having one or more entity types and one or more entity properties; a plurality of represented connections, each connection being defined in terms of two or more interconnected entities and each connection having one or more connection types, wherein each of the stored items is stored in the database and comprises or is associated with a respective embedding, the respective embedding being calculated based on metadata regarding the stored item, wherein two or more tool entities of the entities represents a respective available tool having metadata, the metadata specifying certain properties used when the available tool performs a task or assignment.

In some embodiments, the method comprises receiving a free-text input defining a task or assignment; calculating an input text embedding based on at least one of the free-text input and one or more identified items automatically identified in the free-text input based on text processing; performing a similarity search in the database, comparing the input text embedding to respective embeddings of the tool entities using a vector-based similarity measure; selecting a selected tool based on the similarity search; determining one or more selected previously performed tasks or assignments having been performed using the selected tool, the selected previously performed tasks or assignments being selected based on respective information signifying a success of the selected tool performing the respective selected previously task or assignment; and invoking the selected tool to perform the task or assignment and collecting a response from the selected tool, the invoking of the selected tool comprising providing information to the tool regarding the one or more selected previously performed tasks or assignments.

In some embodiments, the stored items comprise one or more interactions, each interaction being defined in terms of a set of two or more entities, each interaction having one or more interaction types and a timestamp.

In some embodiments, each of two or more task entities of the entities represents a respective previously performed task or assignment by a particular respective one of the tools, the previously performed tasks or assignments each having metadata, the metadata specifying the task or assignment, a result of the task or assignment as well as information signifying a success of the tool performing the respective task or assignment, and the method further comprises performing a similarity search in the database, comparing the input text embedding to respective embeddings of the task entities using a vector-based similarity measure; selecting a set of similar previously performed tasks or assignments based on the similarity search; and providing the selected tool as a tool being used to perform a previously performed task or assignment among the set of similar previously performed tasks or assignments.

In some embodiments, the providing of the selected tool is based on both a vector similarity between the input text embedding and the previously performed task or assignment; and the information signifying success of the performing of the previously performed task or assignment.

In some embodiments, the providing of the selected tool is performed based on a total number of previously performed tasks or assignments for the selected tool.

In some embodiments, the providing of the selected tool is performed based on a number of previously performed tasks or assignments for the selected tool among a set of similar previously performed tasks or assignments determined to be similar to the task or assignment according to a vector-based similarity measure.

In some embodiments, the providing of the selected tool comprises automatically producing a respective text prompt to one or more LLMs requesting the one or more LLMs to, in a respective response to the text prompt, provide the selected tool, wherein the text prompt comprises information regarding the information based on which the providing of the selected tool is to be performed.

In some embodiments, the text prompt comprises information about the task or assignment.

In some embodiments, the text prompt comprises information about an informational context of the task or assignment.

In some embodiments, the text prompt comprises information about a set of the tool entities having been determined to be similar to the task or assignment according to a vector-based similarity measure.

In some embodiments, the text prompt comprises information about one or more results from respective performed tasks or assignments by one or more of the tool entities.

In some embodiments, two or more of the available tools are defined in terms of tool functionality metadata; and the text prompt comprises instructions requesting the one or more LLMs to, in response to the text prompt, provide the selected tool as tool functionality metadata specifically constructed based on respective tool functionality metadata of two or more of the available tools.

In some embodiments, two or more of the available tools are defined in terms of tool functionality metadata; and the invoking of the selected tool comprises automatically producing a respective text prompt to one or more LLMs requesting the one or more LLMs to, in a respective response to the text prompt, provide a result from the selected tool, wherein
the text prompt comprises information regarding the task or assignment as well as the tool functionality metadata.

In some embodiments, the text prompt is instructive for the one or more LLMs to provide, in a respective response to the text prompt, a result of the performing by the selected tool of the task or assignment.

In some embodiments, the result from the selected tool comprises information instructive of invoking one or more different tools to each perform a respective subtask of the task or assignment, each of the different tools being defined in terms of tool functionality metadata; and the method further comprises invoking each of the one or more different tools to perform the subtask.

In some embodiments, the text prompt comprises information requesting the one or more LLMs to select, from a list of two or more of the available tools, the one or more different tools.

In some embodiments, the method comprises determining an embedding based on the information instructive of invoking one or more different tools to perform a subtask of the task or assignment; performing a similarity search in the database, comparing the embedding to respective embeddings of entities corresponding to the available tools using a vector-based similarity measure; and selecting the one or more different tools based on the similarity search.

In some embodiments, the method comprises determining a result of the performing by the selected tool of the task or assignment; assessing a success of the performing by the selected tool of the task or assignment; and storing the task or assignment as an entity in the database, together with metadata descriptive of the determined result and the assessed success.

The invention relates to a method for processing information in a system comprising a database, the database comprising information representing a plurality of stored items, the stored items comprising a plurality of represented entities, each entity having one or more entity types and one or more entity properties; a plurality of represented connections, each connection being defined in terms of two or more interconnected entities and each connection having one or more connection types, wherein each of the stored items is stored in the database and comprises or is associated with a respective embedding, the respective embedding being calculated based on metadata regarding the stored item, wherein two or more task entities of the entities each represents a respective previously performed task or assignment, each previously performed task or assignment having being performed by a respective tool of a set of available tools, the previously performed tasks or assignments each having metadata, the metadata specifying the task or assignment, a result of the task or assignment as well as information signifying a success of the performing of the respective task or assignment.

In some embodiments, the method comprises receiving a free-text input defining a task or assignment; calculating an input text embedding based on at least one of the free-text input and one or more identified items automatically identified in the free-text input based on text processing; performing a similarity search in the database, comparing the input text embedding to respective embeddings of the task entities using a vector-based similarity measure; selecting a set of similar previously performed tasks or assignments based on the similarity search; and providing a selected tool as a tool being used to perform a previously performed task or assignment among the set of similar previously performed tasks or assignments, the providing being based on both a vector similarity between the input text embedding and the previously performed task or assignment; and the information signifying success of the performing of the previously performed task or assignment.

In some embodiments, the method further comprises invoking the selected tool to perform the task or assignment and collecting a response from the selected tool.

In some embodiments, the stored items comprise one or more interactions, each interaction being defined in terms of a set of two or more entities, each interaction having one or more interaction types and a timestamp.

In some embodiments, two or more tool entities of the entities each represents a respective one of said available tools, each of the tools having respective metadata, the metadata specifying certain properties of the available tool used when the available tool performs a task or assignment.

In some embodiments, the method comprises performing a similarity search in the database, comparing the input text embedding to respective embeddings of the tool entities using a vector-based similarity measure; selecting a set of similar existing tools based on the similarity search; and providing the selected tool also based on vector similarity between the input text embedding and respective embeddings of the individual entities representing the set of similar existing tools.

In some embodiments, the method comprises determining, for the set of similar existing tools, respective success rates based on information signifying success for previously performed tasks or assignments of the tool in question; and providing the selected tool also based on the determined success rates.

In some embodiments, the method comprises determining, for the set of similar existing tools, one or both of a total number of previously performed tasks or assignments for the tool; and a number of previously performed tasks or assignments for the tool among the set of similar previously performed tasks or assignments; and providing the selected tool also based on said number and/or total number.

In some embodiments, the providing of the selected tool comprises automatically producing a respective text prompt to one or more LLMs requesting the one or more LLMs to, in a respective response to the text prompt, provide the selected tool.

In some embodiments, the text prompt comprises information regarding the information based on which the providing of the selected tool is to be performed.

In some embodiments, the text prompt comprises information about the task or assignment.

In some embodiments, the text prompt comprises information about an informational context of the task or assignment.

In some embodiments, the text prompt comprises information about the set of similar previously performed tasks or assignments.

In some embodiments, the text prompt comprises information about one or more results from the selected tool or from the set of similar previously performed tasks or assignments. In some embodiments, the text prompt comprises information about the set of similar existing tools.

In some embodiments, two or more of the available tools are defined in terms of tool functionality metadata; wherein the text prompt comprises instructions requesting the one or more LLMs to, in response to the text prompt, provide the selected tool as tool functionality metadata specifically constructed based on respective tool functionality metadata of two or more of the available tools.

In some embodiments, two or more of the available tools are defined in terms of tool functionality metadata; and the invoking of the selected tool comprises automatically producing a respective text prompt to one or more LLMs requesting the one or more LLMs to, in a respective response to the text prompt, provide a result from the selected tool, wherein the text prompt comprises information regarding the task or assignment as well as the tool functionality metadata.

In some embodiments, the text prompt is instructive for the one or more LLMs to provide, in a respective response to the text prompt, a result of the performing by the selected tool of the task or assignment.

In some embodiments, the result from the selected tool comprises information instructive of invoking one or more different tools to perform a subtask of the task or assignment, each of the different tools being defined in terms of tool functionality metadata; and wherein the method further comprises invoking each of the one or more different tools to perform the subtask.

In some embodiments, the text prompt comprises information requesting the one or more LLMs to select, from a list of two or more of the available tools, the one or more different tools.

In some embodiments, the method comprises determining an embedding based on the information instructive of invoking one or more different tools to perform a subtask of the task or assignment; performing a similarity search in the database, comparing the embedding to respective embeddings of entities corresponding to the available tools using a vector-based similarity measure; and selecting the one or more different tools based on the similarity search.

In some embodiments, the method comprises determining a result of the performing by the selected tool of the task or assignment; assessing a success of the performing by the selected tool of the task or assignment; and storing the task or assignment as an entity in the database, together with metadata descriptive of the determined result and the assessed success.

The invention relates to a method for processing information, comprising receiving a free-text input defining an assignment; performing a free-text input execution assessment, comprising automatically producing a respective text prompt to one or more LLMs requesting the one or more LLMs to select and provide, based on the free-text input and in a respective response to the text prompt, a set of one or more initial tasks and a set of one or more acceptance criteria, the set of one or more initial tasks being selected to fulfil at least part of the assignment and the set of one or more acceptance criteria being selected for evaluating the complete and successful performance of the assignment; identifying a first task of the set of one or more initial tasks and assessing the first task, the assessing of the first task comprising automatically producing a respective text prompt to the one or more LLMs, or to one or more different LLMs, requesting the one or more LLMs in question to select and reference, in a respective response to the text prompt, a set of one or more tools and optionally one or more task-specific parameters to supply to the set of one or more tools, the set of one or more tools being selected to perform the first task; invoking the set of one or more tools, optionally using said one or more task-specific parameters, and collecting a response from the set of one or more tools; and updating an assignment progress dataset.

In some embodiments, the assignment progress dataset after a first update thereof comprises information being or being derived from the free-text input; and the set of one or more acceptance criteria.

In some embodiments, the updating comprises adding, to the assignment progress dataset, information derived from the response from the one or more tools but keeping the one or more acceptance criteria unchanged in the assignment progress dataset.

In some embodiments, the method further comprises performing an assignment progress dataset finalization assessment, comprising automatically producing a respective text prompt to the one or more LLMs, or to one or more different LLMs, requesting the one or more LLMs in question to evaluate the set of one or more acceptance criteria and to provide, in a respective response to the text prompt, finalization information regarding if the set of one or more acceptance criteria have been fulfilled or not, the respective text prompt further requesting the one or more LLMs to select and provide, based on the assignment progress dataset and in a respective response to the text prompt, a set of one or more updated tasks, the set of one or more updated tasks being selected to at least partially fulfill the assignment; and determining that the finalization information indicates that the set of one or more acceptance criteria have not been fulfilled and as a result reiterating the method steps from the step of identifying but using the set of one or more updated tasks instead of the set of one or more initial tasks.

In some embodiments, the step of free-text input execution assessment comprises automatically producing the respective text prompt to the one or more LLMs requesting the set of one or more initial tasks and the set of one or more acceptance criteria without associating individual ones of the set of one or more initial tasks to individual ones of the set of one or more acceptance criteria.

In some embodiments, the step of free-text input execution assessment comprises automatically producing the respective text prompt to the one or more LLMs to comprise one or more general directives regarding how to formulate the acceptance criteria; one or more context-specific directives regarding how to formulate the acceptance criteria; and an instruction to follow the general and context-specific directives.

In some embodiments, the instruction comprises an instruction to determine a set of context-specific directives to use based on the free-text input.

In some embodiments, the method comprises amending the acceptance criteria using a process not involving invoking the set of one or more tools.

In some embodiments, the method comprises interacting with a database, the database comprising information representing a plurality of stored items, the items comprising a plurality of represented entities, each entity having one or more entity types and one or more entity properties; and a plurality of represented connections, each connection being defined in terms of two or more interconnected entities and each connection having one or more connection types.

In some embodiments, the items comprise one or more interactions, each interaction being defined in terms of a set of two or more entities, each interaction having one or more interaction types and a timestamp.

In some embodiments, each of the stored items is stored in the database comprises or is associated with a respective embedding, the embedding being calculated based on metadata regarding the stored item.

In some embodiments, the items comprise one or more interactions, each interaction being defined in terms of a set of two or more entities, each interaction having one or more interaction types and a timestamp.

In some embodiments, each of the stored items individually and selectively comprises additional metadata not being used to calculate the embedding for said each stored item.

In some embodiments, the text prompt produced in the free-text input execution assessment comprises information regarding an automatically identified set of similar items, the set of similar items being a set of one or more of the stored items being related to the free-text input.

In some embodiments, the set of similar items is determined by automatically identifying a set of referred items, the referred items comprising any entities and/or connections referred to in the free-text input; calculating respective embeddings of each of the referred items in the set of referred items; performing a similarity search in the database, comparing the embeddings or the stored items to the embeddings of the referred items using a vector-based similarity measure; and selecting the set of similar items based on the similarity search.

In some embodiments, the set of similar items is determined by automatically identifying a set of referred items, the referred items comprising any interactions referred to in the free-text input; calculating respective embeddings of each of the referred items in the set of referred items; performing a similarity search in the database, comparing the embeddings or the stored items to the embeddings of the referred items using a vector-based similarity measure; and selecting the set of similar items based on the similarity search.

In some embodiments, the automatic identification of referred items comprises producing a respective text prompt to the one or more LLMs, or to one or more different LLMs, requesting the one or more LLMs in question to, in a respective response to the text prompt, identify any entities and/or connections referred to in the free-text input, wherein the text prompt automatically produced in the free-text input execution assessment step is produced based on the set of similar items.

In some embodiments, the set of similar items is determined by calculating an embedding based on the free-text input; performing a similarity search in the database, comparing the embedding calculated based on the free-text input to the embeddings in the database, using a vector-based similarity measure; and selecting the set of similar items based on the similarity search.

In some embodiments, the method comprises performing a pre-processing of the free-text input, comprising the step of automatically producing a respective text prompt to the one or more LLMs, or to one or more different LLMs, requesting the one or more LLMs in question to, in a respective response to the text prompt, amend the free-text input to conform to a predetermined standard, wherein the text prompt automatically produced in the free-text input assessment execution step is produced based on an output from the one or more LLMs.

In some embodiments, the method comprises constructing an initial assignment assessment dataset based on the free-text input, the assignment assessment dataset having a structured format and comprising the free-text input, wherein the text prompt automatically produced in the free-text input assessment execution step is produced based on the initial assignment assessment dataset.

In some embodiments, the initial assignment assessment dataset comprises the free-text input as well as contextual metadata for the assignment, such as regarding the free-text input.

In some embodiments, the method comprises performing two or more pre-processing steps with respect to the initial assignment assessment dataset, each of the two or more pre-processing steps being configured to process an input assignment assessment dataset using a respective predefined methodology to produce an output assignment assessment dataset, an input assignment assessment dataset provided to a first one of the two or more pre-processing steps being the initial assignment assessment dataset, the output assignment assessment dataset output from any intermediate one of the two or more pre-processing steps being provided as the input assignment assessment dataset of a subsequent one of the two or more pre-processing steps, and an output assignment assessment dataset output from a last one of the two or more pre-processing steps being an updated assignment assessment dataset, wherein the automatically produced text prompt in the free-text input execution assessment step is produced based on the updated assignment assessment dataset.

In some embodiments, two or more of the pre-processing steps comprise automatically producing a respective text prompt to the one or more LLMs, or to one or more different LLMs, requesting the one or more LLMs in question to, in a respective response to the text prompt, produce the output assignment assessment dataset based on the input assignment assessment dataset being comprised in said text prompt or prompts.

In some embodiments, the set of one or more updated tasks are different from the set of one or more initial tasks, even if not counting the first task.

In some embodiments, the assignment progress dataset comprises the first task.

In some embodiments, the assignment progress dataset does not comprise any other of the set of one or more updated tasks than the first task.

In some embodiments, the assignment progress dataset comprises, after the updating of the assignment progress dataset, a history of responses from the one or more tools invoked in previous iterations, and the assignment progress dataset execution assessment comprises automatically producing the respective text prompt to the one or more LLMs requesting the one or more LLMs to select and provide the set of one or more updated tasks to fulfil at least part of the assignment given said history of responses.

In some embodiments, the step of assessing the first task comprises automatically producing the respective text prompt to comprise a description of a set of available tools.

In some embodiments, the step of assessing the first task comprises automatically producing the respective text prompt to comprise a specification of parameters accepted by each of the set of available tools.

In some embodiments, the method comprises determining the set of available tools by performing a similarity search in a database containing a plurality of tools, the similarity search being performed using a vector-based similarity measure.

In some embodiments, the similarity search compares embeddings for entities corresponding to tools to embeddings for information regarding the one or more initial tasks.

In some embodiments, the similarity search compares embeddings for entities corresponding to tools to embeddings for information regarding the one or more updated tasks.

In some embodiments, the similarity search compares embeddings for entities corresponding to tools to embeddings for the assignment progress dataset.

In some embodiments, the similarity search is a vector search of embeddings for each of the tools in the database.

In some embodiments, the set of one or more tools comprises an assignment processing tool, and the invoking of the one or more tools comprises recursively performing the method for processing information but using a task-specific parameter passed to the invoked tool as the free-text input defining the assignment.

In some embodiments, the invoking of the one or more tools comprises passing to the assignment processing tool one or more of the text prompts and/or one or more of the responses from the one or more LLMs.

In some embodiments, the set of one or more tools comprises an algorithmic tool in the form of a piece of software encoding an algorithm, and the invoking of the one or more tools comprises invoking the piece of software.

In some embodiments, the method comprises automatically producing a respective text prompt to the one or more LLMs, or to one or more different LLMs, requesting the one or more LLMs in question to provide, in a respective response to the text prompt, reasoning regarding selection of the set of one or more tools being selected to perform the first task, and adding the reasoning to the assignment progress dataset.

In some embodiments, the step of identifying the first task comprises automatically producing the respective text prompt to the one or more LLMs based on the assignment progress dataset.

In some embodiments, one or more of the text prompts are automatically produced from one or more structured datasets without using any neural network.

In some embodiments, one or more of the text prompts are automatically produced to comprise information regarding a data structure schema, said text prompt or prompts being automatically produced to request the one or more LLMs to provide the response to the text prompt using the data structure schema, and the method further comprises parsing the response using the data structure schema.

In some embodiments, the method comprises verifying that the response adheres to the data structure schema; and in case the response is found not to adhere to the data structure schema, again providing the text prompt or prompts to the one or more LLMs, but including an error message in the text prompt.

In some embodiments, the method comprises verifying that the response contains a requested piece of information; and in case the response is found not to contain the requested piece of information, again providing the text prompt or prompts to the one or more LLMs, but including an error message in the text prompt.

In some embodiments, the error message comprises a piece of text provided in the response from the one or more LLMs.

The invention relates to a method for processing information in a system comprising a database, the database comprising information representing a plurality of stored items, the stored items comprising a plurality of represented entities, each entity having one or more entity types and one or more entity properties; and a plurality of represented connections, each connection being defined in terms of two or more interconnected entities and each connection having one or more connection types, wherein each of the stored items is stored in the database and comprises or is associated with a respective embedding, the respective embedding being calculated based on metadata regarding the stored item.

In some embodiments, the method comprises receiving a free-text input; calculating an input text embedding based on at least one of the free-text input and one or more identified items automatically identified in the free-text input based on text processing; performing a similarity search in the database, comparing embeddings of the stored items to the input text embedding using a vector-based similarity measure; selecting a similar set of similar items based on the vector-based similarity measure; performing a free-text input processing, comprising automatically producing a respective text prompt to one or more LLMs requesting the one or more LLMs to provide, in a respective response to the text prompt and taking into consideration the similar set of similar items, a response to the free-text input; providing the response to a recipient; identifying, based on the free-text input, one or more identified items, the identified items comprising one or more identified entities and/or one or more identified connections; mapping each of the identified items to zero corresponding stored items or to one corresponding stored item in the database; and for each of one or more of the identified items.

In some embodiments, the method comprises verifying that the identified item is mapped to one corresponding stored item and, if the identified item is mapped to one corresponding stored item, such as to exactly one corresponding stored item, updating metadata relating to the corresponding stored item in the database using metadata relating to the identified item.

In some embodiments, the method comprises verifying that the identified item is mapped to zero corresponding stored items and, if the identified item is mapped to zero corresponding stored items, adding the identified item to the database.

In some embodiments, the stored items comprise one or more interactions, each interaction being defined in terms of a set of two or more entities, each interaction having one or more interaction types and a timestamp.

In some embodiments, the identified items comprise one or more identified interactions.

In some embodiments, the updating of the metadata comprises constructing a new item in the database having the updated metadata and also an updated timestamp.

In some embodiments, the adding of the identified item comprises constructing a new item in the database having an updated timestamp.

In some embodiments, the input text embedding is calculated based on the entire free-text input.

In some embodiments, the input text embedding is calculated based on both the free-text input and additional context information regarding a context in which the free-text input was generated.

In some embodiments, the identifying of the one or more identified items comprises automatically producing a respective text prompt to the one or more LLMs, or to one or more different LLMs, requesting the one or more LLMs in question to, in a respective response to the text prompt, identify any entities and/or connections referred to in the free-text input.

In some embodiments, the identifying of the one or more identified items comprises automatically causing one or more non-LLM NLPs to extract any nouns, verbs, subjects and/or objects from the free-text input.

In some embodiments, the method comprises identifying relations between items from the extracted nouns, verbs, subjects and/or objects; and formulating the identified relations as additional pieces of free-text relational information.

In some embodiments, the method comprises performing a similarity search in the database, possibly only taking into consideration the similar set or the ranked set, comparing embeddings of the stored items to an embedding of the additional pieces of free-text relational information using a vector-based similarity measure; wherein the identifying of the one or more identified items is based on the vector-based similarity measure.

In some embodiments, the method comprises identifying one or more additional pieces of free-text information, the additional pieces of free-text information preceding the free-text input, wherein the text prompt is produced to request the one or more LLMs to, in a respective response to the text prompt, identify any entities and/or connections referred to in a concatenation of one or more of the additional pieces of information with the free-text input.

In some embodiments, the one or more additional pieces of free-text information are identified to relate or refer to one and the same entity and/or connection.

In some embodiments, the method comprises identifying a respective set of one or more additional pieces of free-text information for each of the identified items.

In some embodiments, the identification of the one or more additional pieces of free-text information is performed by one or more non-LLM NLPs.

In some embodiments, the method comprises dividing the additional pieces of free-text information into two or more text chunks having mutual text overlap; and producing the text prompt to comprise the two or more text chunks.

In some embodiments, the method comprises arranging the two or more text chunks in chronological order; producing the text prompt to instruct the one or more LLMs to identify any pieces of conflicting information regarding identified items; and producing the text prompt to instruct the one or more LLMs to disregard any of the pieces of conflicting information being chronologically before another one of the pieces of conflicting information regarding the same information conflict.

In some embodiments, the method comprises determining that the two or more text chunks do not fit in an available context window of the one or more LLMs; and as a result producing two or more text prompts, each of the two or more text prompts comprising a unique subset of the text chunks; and merging a respective response from each of the one or more LLMs to the two or more text prompts into a single piece of response data.

In some embodiments, the merging comprises automatically producing a respective text prompt to the one or more LLMs, or to one or more different LLMs, requesting the one or more LLMs in question to, in a respective response to the text prompt and based on the respective response, produce the single piece of response data.

In some embodiments, the method comprises calculating the input text embedding based on one of the identified entities and/or connections.

In some embodiments, the method comprises producing the text prompt based on, such as to comprise or refer to, the extracted nouns, verbs, subjects and/or objects; and producing the text prompt to be instructive to the one or more LLMs to extract any information regarding the extracted nouns, verbs, subjects and/or objects that is inferred by the free-text input.

In some embodiments, the similarity search comprises identifying a first set of one or more of the entities having embeddings that are determined to be similar to the input text embedding according to an entity vector-based similarity measure.

In some embodiments, the similarity search comprises identifying a second set of one or more of the connections having embeddings that are determined to be similar to the input text embedding according to a connection vector-based similarity measure.

In some embodiments, the similarity search comprises identifying a third set of one or more of the interactions having embeddings that are determined to be similar to the input text embedding according to an interaction vector-based similarity measure.

In some embodiments, the similarity search comprises expanding the first set and/or the second set with any entity and/or connection, respectively, not already forming part of the first set and/or second set, respectively, and having an embedding that is determined to be similar to one or more of the items in the first set and/or the second set.

In some embodiments, the similarity search comprises expanding the first set with any entity not already forming part of the first set and being interconnected by a connection forming part of the third set.

In some embodiments, the similarity search comprises expanding the first set, the second set and/or the third set with any entity, connection and/or interaction, respectively, not already forming part of the first set, second set and/or third set, respectively, and having an embedding that is determined to be similar to one or more of the items in the first set, the second set and/or the third set.

In some embodiments, the similarity search comprises expanding the first set with any entity not already forming part of the first set and being interconnected by an interaction forming part of the second set.

In some embodiments, the similarity search comprises performing a community detection algorithm based on the first set and third set, resulting in a classification into distinct community groups of the entities in the first set and/or a corresponding classification into distinct community groups of the interactions in the third set.

In some embodiments, the similarity search comprises performing a ranking of the first set, the second set and/or the third set based on a connection count for one or more entities in the similar set, being a respective number of stored interactions in the database for the entity, the stored interactions interconnecting the entity to other entities in the similar set. In some embodiments, the similarity search comprises performing a ranking of the first set, the second set and/or the third set based on a relevance decay or recency value for one or more entities in the similar set, being determined based on a latest timestamp of an interaction stored in the database interconnecting an entity.

In some embodiments, the similarity search comprises performing a ranking of the first set, the second set and/or the third set based on a relevance decay or recency value for one or more connections in the similar set, being determined based on a latest timestamp of an interaction stored in the database interconnecting entities being interconnected by the connection.

In some embodiments, the similarity search comprises performing a ranking of the first set, the second set and/or the third set based on an entity similarity score for one or more interactions in the similar set, being determined based on the respective similarity scores of entities being interconnected by the interaction.

In some embodiments, the similarity search comprises performing a ranking of the first set, the second set and/or the third set based on an interaction count for one or more connections in the similar set, being determined based on a number of interactions stored in the database interconnecting the entities interconnected by the connection.

In some embodiments, the similarity search comprises performing a ranking of the first set, the second set and/or the third set based on a multi-community weighting for one or more interactions in the similar set, being determined based on a number of detected community groups to which the interaction belongs.

In some embodiments, the similarity search comprises performing a ranking of the first set, the second set and/or the third set based on a conversation flow value for one or more interactions in the similar set, being determined for items stored in the database.

In some embodiments, the similarity search comprises performing a ranking of the first set, the second set and/or the third set based on a focus value for one or more interactions in the similar set, being determined based on a number of distinct detected community groups to which all entities being interconnected by the interaction belong.

In some embodiments, the ranking is performed based on a weighing of one or more of said connection count; said relevance decay or recency value for the connections or interactions; said entity similarity score; said interaction count; said multi-community weighting; said conversation flow value; and said focus value.

In some embodiments, the weighing is different for entities, connections and/or interactions in the similar set.

In some embodiments, the similarity search comprises performing a ranking of the first set, the second set and/or the third set based on a similarity score of the embedding of the item and the input text embedding, according to said respective vector-based similarity measure.

In some embodiments, the similarity search comprises performing a ranking of the first set, the second set and/or the third set based on a connection count for one or more entities in the similar set, being a respective number of stored connections in the database for the entity, the stored connections interconnecting the entity to other entities in the similar set. In some embodiments, the similarity search comprises performing a ranking of the first set, the second set and/or the third set based on a community count for one or more entities in the similar set, being a number of other items present in a detected community group to which the entity belongs.

In some embodiments, the similarity search comprises performing a ranking of the first set, the second set and/or the third set based on a clustering coefficient for one or more entities in the similar set, being determined for the entity in relation to a detected community group to which the entity belongs.

In some embodiments, the similarity search comprises performing a ranking of the first set, the second set and/or the third set based on a network centrality measure for one or more entities in the similar set, being determined for the entity in relation to other items stored in the database.

In some embodiments, the similarity search comprises performing a ranking of the first set, the second set and/or the third set based on an entity similarity score for one or more connections in the similar set, being determined based on the respective similarity scores of entities being interconnected by the connection.

In some embodiments, the similarity search comprises performing a ranking of the first set, the second set and/or the third set based on a structural importance for one or more connections in the similar set, being determined for entities stored in the database.

In some embodiments, the similarity search comprises performing a ranking of the first set, the second set and/or the third set based on a focus value for one or more entities in the similar set, being determined based on a number of distinct detected community groups to which the entity belongs.

In some embodiments, the similarity search comprises performing a ranking of the first set, the second set and/or the third set based on a focus value for one or more connections in the similar set, being determined based on a number of distinct detected community groups to which all entities being interconnected by the connection belong.

In some embodiments, the similarity search comprises performing a ranking of the first set, the second set and/or the third set based on a uniqueness value for one or more items in the similar set, being determined based on a similarity score of the item as compared to a calculated distribution of similarity scores of items in the similar set.

In some embodiments, the similarity search comprises performing a ranking of the first set, the second set and/or the third set based on a depth value for one or more items in the similar set, being determined based on a stored context size for the item stored in the database.

In some embodiments, the similarity search comprises performing a ranking of the first set, the second set and/or the third set based on a user significance value for one or more items in the similar set, being determined based on a vector-based similarity measure between the item and an item representing a particular user according to a vector-based similarity measure.

In some embodiments, the ranking is performed based on a weighing of one or more of said similarity; said connection count; said community count; said clustering coefficient; said network centrality measure; said entity similarity score; said structural importance; said multi-community weighting; said conversation flow value; said focus value; said uniqueness value; said depth value; and said user significance value.

In some embodiments, the weighing is different for entities and/or connections in the similar set.

In some embodiments, the similarity search comprises automatically producing a respective text prompt to the one or more LLMs, or to one or more different LLMs, requesting the one or more LLMs in question to, in a respective response to the text prompt, provide information as to how to determine the ranking rule, the text prompt comprising information regarding the free-text input; and the performing of the ranking is performed based on the response.

In some embodiments, the mapping of each of the identified items to zero corresponding stored items or to one corresponding stored item in the database comprises performing a similarity search, comparing an embedding of the identified item to embeddings of the set of similar items, using a vector-based similarity measure; and selecting a set of zero, one or more potentially matching items based on the similarity search.

In some embodiments, the embedding of the identified item is calculated based on metadata relating to the identified item.

In some embodiments, the method comprises automatically producing a respective text prompt to the one or more LLMs, or to one or more different LLMs, requesting the one or more LLMs in question to, in a respective response to the text prompt, determine a most probable matching item in the database, the text prompt comprising or referring to information regarding the set of potentially matching items.

In some embodiments, the text prompt further comprises or refers to any of the stored items having graph associations with each of the respective potentially matching items.

In some embodiments, the response to the text prompt indicates the most probable matching item in the database; wherein the method further comprises updating the most probable matching item with metadata regarding the identified item.

In some embodiments, the updating of the most probable matching item comprises automatically producing a respective text prompt to the one or more LLMs, or to one or more different LLMs, requesting the one or more LLMs in question to, in a respective response to the text prompt, provide a merged set of metadata for the most probable matching item, the text prompt comprising or referring to metadata both for the identified item and the most probable matching item; and wherein the updating of the most probable matching item comprises associating the most probable matching item with the merged metadata.

In some embodiments, the updating of the most probable matching item comprises adding the updated most probable matching item as a new item version in the database with an updated timestamp.

In some embodiments, the response to the text prompt indicates the absence of a most probable matching item in the database; wherein the method further comprises adding the identified item as a new item to the database.

In some embodiments, the free-text input defines an assignment; wherein the free-text input processing comprises performing a free-text input execution assessment, comprising automatically producing a respective text prompt to the one or more LLMs, or to one or more different LLMs, requesting the one or more LLMs in question to select and provide, based on the free-text input and in a respective response to the text prompt, a set of one or more tasks selected to fulfil at least part of the assignment; and performing the one or more tasks to produce the response.

In some embodiments, the method comprises selecting a tool for performing the assignment.

In some embodiments, one or more tool entities of the entities in the database represent individual tools, and the selecting of the tool for performing the assignment comprises selecting the tool as a tool entity corresponding to an entity selected based on the ranking of the first set.

In some embodiments, the method comprises determining that no entity corresponding to a tool was found with sufficiently high ranking, according to a ranking measure, and as a consequence thereof selecting the tool for performing the assignment as a tool corresponding to an entity selected based on similarity between the input text embedding and an embedding of the entity in question, based on a vector-based similarity measure.

In some embodiments, the selecting of the tool for performing the assignment comprises automatically producing a respective text prompt to the one or more LLMs, or to one or more different LLMs, requesting the one or more LLMs in question to provide, in a respective response to the text prompt, a selection of the tool.

In some embodiments, the method comprises collecting a tool response from the tool; determining a set of used items referred to in the tool response; mapping each of the used items to zero corresponding stored items or to one corresponding stored item in the database, such as exactly one corresponding stored item in the database, for each of one or more of the used items.

In some embodiments, the method comprises verifying that the item is mapped to one corresponding stored item, and, if the used item is mapped to one corresponding stored item, such as to exactly one corresponding stored item, updating metadata relating to the corresponding stored item in the database using metadata relating to the used item.

In some embodiments, the method comprises verifying that the item is mapped to zero corresponding stored items, and, if the used item is mapped to zero corresponding stored items, adding the used item to the database.

Moreover, the invention relates to a system for processing information, the system comprising a central server and a database, the database comprising information representing a plurality of stored items as mentioned above, the stored items comprising entities and connections, each item comprising or being associated with a respective embedding calculated based on metadata regarding the stored item. The central server is configured to perform one or more of the above-mentioned methods.

Moreover, the invention relates to a computer program product for processing information in a system of the mentioned type. The computer program product is configured to, when executed on or from the central server of the system, perform one or more of the above-mentioned methods.

The computer program product can be implemented by a non-transitory computer-readable medium encoding instructions that cause one or more hardware processors located in, or accessed from, the central server of the system to perform the above-described method steps.

### BRIEF DESCRIPTION OF THE DRAWINGS

In the following, the invention will be described in detail, with reference to exemplifying embodiments of the invention and to the enclosed drawings, wherein:

FIG. 1 illustrates a database with a defined data structure;

FIG. 2 illustrates a system;

FIG. 3 illustrates a central server;

FIG. 4 is a flowchart illustrating a first method;

FIG. 5 is a flowchart illustrating a second method;

FIG. 6 is a flowchart illustrating a third method;

FIG. 7 is a flowchart illustrating a fourth method;

FIG. 8 is a flowchart illustrating a fifth method;

FIG. 9 is a flowchart illustrating a sixth method;

FIG. 10 is a flowchart illustrating a seventh method;

FIG. 11 illustrates a graphical user interface; and

FIG. 12 is a flowchart illustrating an eight method.

In all flowchart Figures in the present application, arrows represent possible execution paths, and boxes represent method steps and sometimes results; sets of information; decision points; and similar. The figures illustrate non-limiting examples, which can include one or more optional features.

### DETAILED DESCRIPTION

Embodiments of the present invention provide for an approach to achieve long-term AI (Artificial Intelligence), that can have the capability to remember, understand and evolve over time in an automatic, autonomous manner. Embodiments described herein can be used to create deeper, more meaningful interactions with human and machine users, capable of being trained to help in various contexts, such as within education, healthcare, entertainment, security and personal AI assistants. The training can be achieved automatically to increase these capabilities over time and usage.

Embodiments of the present invention can be run on local hardware and can be designed to be agnostic with respect to an underlying language-processing solution-normally one or more LLMs (Large Language Model), also called in some contexts “foundational models”. This means that the presently described solutions can be made more and more compact as development of such LLMs continue in the direction of smaller storage size, and faster and computationally more efficient as more competent hardware computing resources arise, for instance in the form of improved NPUs (Neural Processing Unit), Quantum Processing Units, or the like.

In other embodiments, these advantages can be achieved in more or less distributed computing environments, as will be described herein.

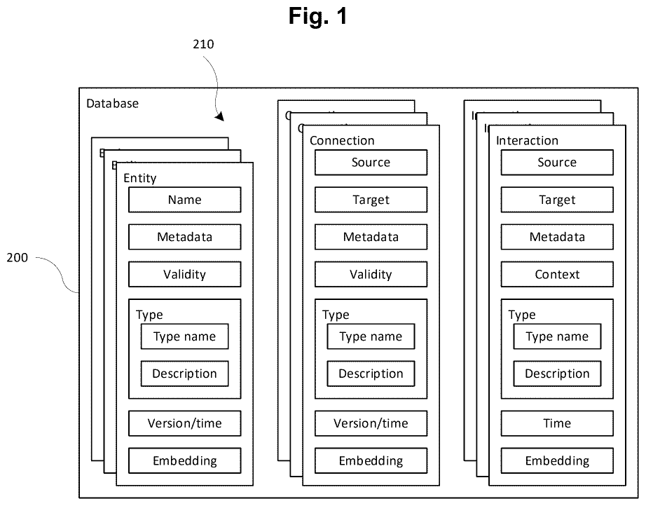

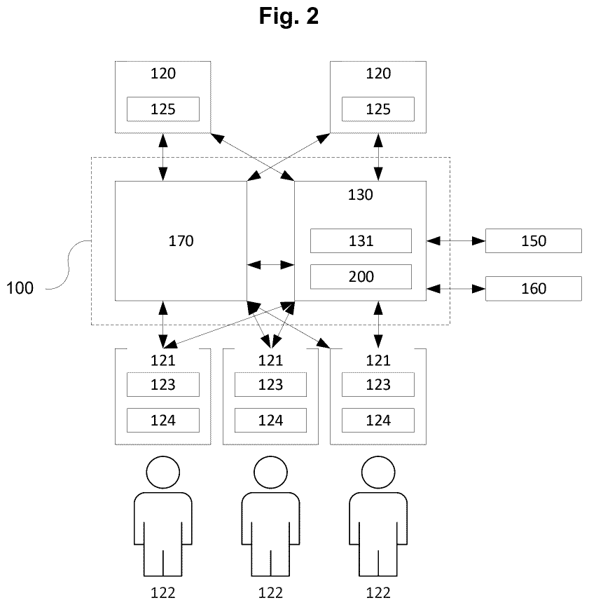

FIGS. 1 and 2 illustrate a system 100, configured to perform a method in accordance with any of the embodiments described herein, for processing information 210 in a database 200. The information 210 can be structured in the sense that it is stored in a predetermined, structured data format, for instance as a serialization of a predetermined standard data format, such as JSON, YAML, XML, or the like. The data format can be plaintext or encoded, but preferably uses a predetermined schema, or predetermined structure, allowing open-ended format definitions where the structure of the information is set but information types and similar can vary. As will be described herein, the information will typically be converted to, or represented as, free-text for processing by one or more LLMs. Therefore, data formats that allow straightforward conversion of the data into a legible text representation are particularly useful. This is, for instance, true for JSON. Formats not allowing such straightforward conversion, such as purely binary data storage formats, may need an intermediate conversion step into such a legible text representation. The examples herein primarily use JSON, but it is realized that other text-compatible data formats can be used in the corresponding manner.

Hence, some of the information 210 can be or comprise textual information, in other words any type of information being electronically and digitally stored in a text format. Such a text format can be plaintext, but it can also be compressed, encrypted, encoded and so forth, as long as the system 100 is configured to transform the stored textual information into corresponding characters, such as alphanumeric characters, non-alphanumeric characters, Unicode characters and/or symbols, or the like. Any part of the information 210 can comprise one or more sub-pieces, such as individual pieces of information that each can be a statement, a sentence, a piece of text, and so forth. A respective textual information of each such piece of textual information can individually be sequential, in other words it can have a well-defined order sequence, for instance in the form of a series of words forming a sentence or a multi-sentence text. Normally, the system 100 and the methods described herein are arranged to process textual information according to such defined sequence orders.

The database 200 can be a combined vector and graph database. The database 200 can store items of various types, each item together with, comprising or being associated with respective information specific to that item. Each item can be stored together with, comprise or be associated with a respective embedding, the embedding being calculated based on part of the information of the item, or the entirety of this information.

In practical examples, the database 200 can be a relational database or any other type of database. It can be configured to support queries on graph data, for instance using a Datalog engine. The present inventors have successfully used CozoDB for this purpose. The database 200 can be configured to support graph embeddings, vector similarity searches and possibly also time-travel functionality (slicing the data at a certain historic point in time).

As used herein, the term “memory” refers to raw information storage, and “recollection” refers to contextualized information retrieval. More particularly, a memory refers to the comprehensive, structured storage of one or more data points in the form of items in the database 200 (for instance, and in particular, entities, connections and/interactions; see below). Memories, as viewed in isolation, play the role of raw information but without paying attention to any inherent meaning of the information. Recollection, on the other hand, is the ability to retrieve and combine relevant pieces of information (memories) based on a specific context or query. Recollection considers the semantic relationships between data points to surface insights.

The database 200, with the data structures described herein, enables advanced recollection by representing data in a richly interconnected knowledge graph, where the meaning of any piece of information can be enhanced based upon the relationships between concepts and based upon the context of the task, query, or even conversation at hand.

In general, the term “item” is used herein to denote either an “entity”, a “connection” or an “interaction”. Entities, connections and interactions work together to create a multi-modal knowledge representation of the information 210 stored in the database 200. Each item can be stored in any suitable manner, such as in the form of an individual database object or entry, or a set of otherwise well-defined information unambiguously forming the entity in question. In practice, the item type (entity, connection or interaction) of each individual item can be discriminated using suitable item properties, labels, flags or similar. “Connection” items can be stored as “connection-type entities”, and so forth. In general, the information 210 can be logically divided into distinct entities where each such entity can have a type selected among different categories, the possible categories comprising “entity”, “connection” and/or “interaction”.

In some embodiments, the type “interactions” may not be used. This may remove timeline information to some extent, but could still provide some of the benefits described herein.

“Entities” can serve as the representation of fundamental objects (“nouns”) within the knowledge graph, representing distinct concepts, objects, actors, and so forth. They can form the nodes of a semantic network stored in the database 200 as graph information.

Each entity can have, comprise or be associated with an entity name, an entity type and/or an entity description. Furthermore, each entity can have, comprise or be associated with one or more pieces of metadata. As will be exemplified below, such metadata could be anything of relevance to the entity in question, and different entities can have, comprise or be associated with identical or different types of metadata. The corresponding is true regarding any metadata had by, comprised in or being associated with items of type “connection” and/or “interaction”.

In general, each entity can be defined in terms of, have, comprise or be associated with one or more entity types and/or one or more entity properties.

Each entity can also have, comprise or be associated with an embedding, in other words a multidimensional floating-point vector value being calculated using part or all of the information logically forming the entity. Specifically, an entity embedding can be generated by combining one or more of the data fields, potentially including any metadata, into a text string. Normally, the information selected for inclusion into the text string used to calculate the embedding is selected to capture the entity's semantic essence. Therefore, what fields to include could be different for different entities, and can for instance be set using configuration parameters based on different types of entities or similar.

Each entity can also have, comprise or be associated with one or more pieces of information that is configured to be explicitly excluded from the calculation of the embedding, such as system-external references or system-specific identifies. Such non-embedded fields typically contain supplementary information that shouldn't influence similarity searches.

The following is a simple example of what an entity template can look like, using JSON:

{“$schema”:“http://json-schema.org/draft-
07/schema#”,“type”:“object”,“title”:“Entity Schema”,“description”:“Schema
representing an Entity object within the
database”,“required”:[“id”,“type”,“name”,“updated_at”,“embedding”],“properties”:{
“id”:{“type”:“string”,“format”:“uuid”,“description”:“Unique identifier for the Entity in
UUID format”},“type”:{“type”:“string”,“description”:“Classification type of the
Entity”},“name”:{“type”:“string”,“description”:“Name of the
Entity”},“description”:{“type”:“string”,“description”:“Detailed description of the
Entity”},“updated_at”:{“type”:“string”,“format”:“date-
time”,“description”:“Timestamp when the Entity was last updated (Validity type in the
database)”},“metadata”:{“type”:“object”,“description”:“Additional structured
metadata for the Entity stored as
JSON”},“non_embedded”:{“type”:“object”,“description”:“Non-embedded data for
the Entity stored as JSON”},“embedding”:{“type”:“array”,“description”:“Vector
embedding representation of the Entity with 768 dimensions of 32-bit floating point
numbers”,“items”:{“type”:“number”},“minItems”:768,“maxItems”:768}},“additionalP
roperties”:false}
Using Jinja Templating:
{{item.name}} [{{item.type}}]: {{item.description}}
{{item.metadata} }

The following is an example of a CozoDB Structure used for entities:

id: Uuid, type: String, name: String, description: String, updated_at:
Validity, => metadata: Json, non_embedded: Json, embedding: <F32;
768>,

Items of type “connections” can be used to define the relationships between entities, forming edges of said knowledge graph. In some embodiments, a typical connection, or even each connection in the information 210, is directional and/or interconnects exactly two entities, such as two different entities. The connection can carry semantic meaning to this interconnection between the entities.

In general, each connection can be defined in terms of, have, comprise or be associated with two or more entities being interconnected by the connection and/or one or more connection types for the connection. For instance, a connection type can be “IS A” or “USES”. In a way corresponding to the case for entities, each connection can have, comprise or be associated with metadata of various types that is relevant to the connection in question. Some of the information of the connection can be specifically configured not to be used for calculating an embedding of the connection.

Herein, two entities interconnected by a connection or an interaction are often referred to as the “source” entity and the “target” entity, respectively. In many contexts herein, a connection/interaction is described in terms in exactly two interconnected entities, but it is understood that connections/interactions in other contexts can correspondingly have more than two interconnected entities depending on the concrete implementation.

As is the case for entities, each connection can have, comprise or be associated with a corresponding embedding derived from a composite of the information of the connection.

For instance, the embedding can be calculated based on the connection's endpoints (the entities being interconnected by the connection), attributes of the endpoints, the connection type and so forth, enabling semantic similarity searches across relationship patterns. Here is an example of what a connection Jinja template can look like:

{{item.source.name}} −> {{item.type}} −> {{item.target.name}}
{{item.metadata} }

### JSON Schema:

{“$schema”:“http://json-schema.org/draft-
07/schema#”,“title”:“Connection”,“description”:“Represents a relationship between
two or more entities, where each connection can be defined by connection types and
associated metadata. Connections enable semantic similarity searches across
relationship
patterns.”,“type”:“object”,“required”:[“type”,“source_id”,“target_id”,“updated_at”],“
properties”:{“type”:{“type”:“string”,“description”:“Defines the nature of the
relationship between entities (e.g., ‘IS A’, ‘USES’,
etc.)”},“source_id”:{“type”:“string”,“format”:“uuid”,“description”:“Unique identifier
for the source entity in the connection
relationship”},“target_id”:{“type”:“string”,“format”:“uuid”,“description”:“Unique
identifier for the target entity in the connection
relationship”},“updated_at”:{“type”:“string”,“format”:“date-
time”,“description”:“Timestamp indicating when the connection was last
modified”},“metadata”:{“type”:“object”,“description”:“Additional information
relevant to the connection that contributes to the embedding
calculation”},“non_embedded”:{“type”:“object”,“description”:“Information about
the connection that is specifically configured not to be used for calculating the
embedding”},“embedding”:{“type”:“array”,“description”:“Vector representation
derived from a composite of connection information (endpoints, attributes,
connection type, etc.) for semantic similarity searches, consisting of 768 floating-
point numbers”,“items”:{“type”:“number”},“minItems”:768,“maxItems”:768}}}

The following is an example of a CozoDB Structure used for connections:

type: String, source_id: Uuid, target_id: Uuid, updated_at:
Validity, => metadata: Json, non_embedded: Json,
embedding: <F32; 768>,

Interactions can be configured to capture temporal events and communications, such as within the system 100, providing a historical record of how entities relate and communicate over time.

Each interaction can be defined in terms of, have, comprise or be associated with a set of two or more entities interconnected by the interaction, one or more interaction types; and/or a timestamp for the interaction. As is the case with entities and connections, each interaction can have, comprise or be associated with various metadata. Some fields can be specifically marked to not be used for calculating a corresponding interaction embedding. Namely, interaction embeddings can be derived from a composite of their endpoints, such as attributes of these endpoints; one or more types for the interaction; and/or an interaction content. For instance, the interaction can be a message being transmitted from a first entity (the source entity) to a second entity (the target entity), and the interaction content can then be the contents of that message.

The following is an example of what a Jinja template for an interaction can look like:

{{item.source.name}} −> {{item.type}} −> {{item.target.name}}:
{{item.content}} {{item.metadata} }

### JSON Schema:

{“$schema”:“http://json-schema.org/draft-
07/schema#”,“title”:“Interaction”,“type”:“object”,“required”:[“type”,“source_id”,“tar
get_id”,“updated_at”],“properties”:{“type”:{“type”:“string”,“description”:“The type
of interaction between
entities”},“source_id”:{“type”:“string”,“format”:“uuid”,“description”:“UUID of the
source entity”},“target_id”:{“type”:“string”,“format”:“uuid”,“description”:“UUID of
the target entity”},“content”:{“type”:“string”,“description”:“Content of the
interaction (e.g., message text)”},“updated_at”:{“type”:“string”,“format”:“date-
time”,“description”:“Timestamp when the interaction was last
updated”},“metadata”:{“type”:“object”,“description”:“Additional metadata about the
interaction”},“non_embedded”:{“type”:“object”,“description”:“Fields that should not
be used for calculating the interaction
embedding”},“embedding”:{“type”:“array”,“items”:{“type”:“number”,“format”:“float
”},“minItems”:768,“maxItems”:768,“description”:“768-dimensional vector
representation of the interaction”}}}

A CozoDB Structure used for interactions can look like this:

type: String, source_id: Uuid, target_id: Uuid, content: String,
updated_at: Validity, => metadata: Json, non_embedded: Json,
embedding: <F32; 768>,

In the above CozoDB examples, the label “non_embedded” marks data that is not to be used when calculating the embedding of the item in question. In practical examples, the embedding can be calculated based on a simple concatenation of some or all of the information (not marked for non-embedding) forming part of the item in question and expressed in plaintext; or of a plaintext data structure, such as a JSON data structure, containing this information in a structured format. In general, the embedding can be calculated based on an input text that can be expressed in plaintext format and being at least partly directly legible by a human being without any required data formatting or processing. This can mean that the input text at least partly, such as completely, is comprised by plaintext words, possibly together with data structure characters (such as ‘{’ and similar), numerical information and similar, that is typically legible to a human being.

In general, items in the database 200 can be versioned, for instance by any entity and/or connection existing in two or more versions, such as each having a respective unique timestamp and/or a respective unique identifier. Between two such entities or between two such connections, properties and/or metadata can change whereas a defining set of one or more properties of the item in question remain the same or whereas an association between two versions of the same item can be kept together using corresponding associations. This way, different version of one and the same item can still be regarded to be “the same” item, but in different versions with different timestamps. In examples, a later version of an entity can inherit unaffected properties, such as connections, from its predecessor; and correspondingly for connections. Using versioning, a historical state of the information 210 can be extracted by filtering on timestamps, or timestamps can be used as search filters in more complex ways; a chronological development of the information 210 can be established; and/or timestamps can be used as parts of embeddings. In some embodiments, interactions are not versioned but instead represent atomic events, such as events that have a certain time of the event described using a respective time stamp.

In the database 200, there can be certain system 100 entities representing various components of the system 100. This helps with system 100 self-awareness and instruction, as connections between system 100 components and concepts or other entities can be established. For instance, a connection such as “Professional→DIRECTIVE→EmailTool” can be established, providing specific information to the system 100 regarding how a “Professional” use of the “EmailTool” should look. This also allows for tracking of interactions, such as: “Communication Agent→USED→EmailTool” making it possible to investigate what the most used tools or other similar metrics are.

It is noted that the information 210 structure described herein is an alternative method to a conventional SQL Table structure. Instead of having separate tables (or “relations” as they are called in CozoDB) for each data structure (agents, tools, LM connectors, users, etc., as described below), the present system 100 can use entities and put all of the content for serialization for such data structures in the “metadata” field of the entity in question. One particular type of entity can represent a “tool” (also sometimes referred to as an “agent”). As used herein, a tool represents defined autonomous services configured to perform complex and goal-oriented behaviors by and within the system 100. Each such tool can be configured to specialize in a particular skill or functional area and can be invoked to handle specific tasks or assignments.

The metadata field(s) of a tool entity can be configured to contain the entire content of the AgentData entry, which means that the content of the “metadata” field can be serialized directly into JSON or another predetermined textual data format, and then deserialize that JSON object into a full AgentData object in, or example, python. In other words, system entity types, such as Agent, Tool (see below), Assignment (see below), etc., can have their serialized data forms stored as the entirety of metadata. This makes it easy to serialize/deserialize with for instance JSON. For instance:
Entity: {“id”: . . . , “type”: “agent”, “metadata”: {AgentData},}

The following is an example of an entity defining a tool (an agent) for communications:

{ “id”: “agent-001”, “type”: “_agent”, “name”: “Communications Agent”,
“description”: “Handles communication tasks like email and chat”, “updated_at”:
1705881600, “metadata”: { “connector_name”: “claude”, “connector_config”: {
“model”: “claude-3-sonnet”, “temperature”: 0.7 }, “system_message”: “You are a
specialized Communications Manager...”, “role”: “Communications Manager”,
“responsibility”: “Handle all communication tasks including emails and chat
messages”, “tools”: [“email_tool”, “chat_tool”], “additional_rules”: [“Always
maintain professional tone”, “Confirm before sending external communications”],
“additional_content_blocks”: [ {“name”: “Email Templates”, “content”: “Standard
email templates and formats...” } ] }, “non_embedded”: { }, “embedding”: [0.1, 0.2, ...]
}

Throughout the present description, the term “agent tool” is used for a particular type of “tool” which is configured to perform a less specific task as compared to non-agent tools. For instance, and as will be described in detail below, such agent tools may be defined in terms of metadata, such as textual metadata fields, used to instruct an LLM to respond to a certain automatically constructed (e.g. produced) text prompt, the response from the LLM being used to then perform a particular task or assignment of the agent tool. Generally, each agent tool can be defined in terms of a set of structured data, such as a JSON structure. The JSON structure can be used by the system 100 to automatically produce the text prompt without any LLM involvement, based on a text prompt template accessible to the system 100. The text prompt will generally request the LLM to respond according to a specified data format, such as defined via a specified schema, for instance a specified JSON schema. Hence, “invoking” such an agent tool involves populating a text prompt template based on the structured definition of the agent tool together with task- or assignment specific data; allow the LLM to process the text prompt; collecting a response from the LLM; parsing/deserializing the response; and taking any actions implied by the response.

In contrast to “agent” tools, other tools (often referred to herein simply as “tools” or “non-agent tools”) can be defined to perform more specific tasks. Much like computer programming language functions or methods, such non-agent tools can be defined in terms of zero, one, two or more inputs; zero, one, two or more outputs; and certain functionality to be performed when invoking the non-agent tool, the functionality possibly operating on the input(s) and possibly producing the output(s) as a result of the invoking. The functionality can be defined in terms of concrete compiled or source code software code, for instance script code, such as in the form of a Phyton script which is executed as a result of the tool being invoked.

Hence, the word “tool” is used to cover both “agent tools” and “non-agent tools”.

For all such tools, the tool can be configured to invoke one or more sub-tools of any type, forming call trees or call chains much like a high-level programming language.

As discussed, non-agent tool entities can be defined in terms of discrete units of executable functionality available to the system 100. Examples include a non-agent tool for data transformation, 3rd party API integrations and system-internal microservices.

Like agent tool entities, non-agent tool entities can have respective metadata containing the entire content of the non-agent tool (the code defining the functionality of the non-agent tool), which has the same effect as AgentData above. In other words, the entity representing the non-agent tool can have high-level information describing the non-agent tool and identifying its function, as well as the actual software code in fact defining that functionality. This way, the system 100 can be aware of the functionality of the non-agent tool in a way making it possible for an LLM to identify the need to invoke the non-agent tool and also the code to execute to actually invoke the non-agent tool in practice.

The following is an example of a non-agent tool entity for sending an email:

{ ″id″: ″tool-001″, “type″: ″_tool″, ″name″: ″Email Tool″, ″description″: ″Sends
emails″, ″updated_at″: 1705881600, ″metadata″: { ″config″: { ″validation_rules″: {
″recipient″: ″required|email″, ″subject″: ″required|max:200″, ″body″: ″required″ },
″constraints″: { ″max_recipients″: 10, ″max_attachment_size″: 10485760,
″allowed_attachment_types″: [″pdf″, ″doc″, ″docx″, ″txt″] } } }, ″embedding″: [0.1, 0.2,
...], ″non_embedded″: { } }

The code used to invoke the tool can be stored as a part of the same data structure, or separately, in the database 200. For instance, the following exemplifying python code can be used to send emails when the non-agent email sending tool is invoked:

```
from typing import List
from pydantic import BaseModel
from src.enums import ProcessStatus
from src.results import ToolResult
from src.tools import Tool, ToolConfig
class SendEmailConfig(BaseModel):
  to_emails: List[str]
  subject: str
  email_body: str
class SendEmailTool(Tool):
  name = “send_email”
  description = “Sends an email to the list of emails provided in
to_emails with the given subject and email_body.”
  config = SendEmailConfig
  async def execute(
    self, to_emails: List[str], subject: str, email_body: str,
    **kwargs ) −> ToolResult:
    # Actual send email logic goes here.
    return self._build_tool_result(
      ProcessStatus.SUCCESS.value,
      f“Successfully send the email to {‘,’.join(to_emails)} with subject:
      {subject}”,)
```

Each non-agent tool can be an isolated, executable unit of functionality that performs a specific task on behalf of another (calling) tool, such as an agent tool. In some embodiments, non-agent tools are not decision-makers; instead, they are configured to receive structured input and return structured output. Technically, any callable code can be implemented as a non-agent tool, including execution of another tool, such as an agent tool. In general, each non-agent tool can, as a part of its definition in the database 200, comprise a free-text description of what the non-agent tool is designed to do. Correspondingly, the definition in the database 200 can contain an API definition of the non-agent tool.

In some embodiments, non-agent tools are asynchronous and can be configured to always return a result. They can be configured to support flexible execution times and to operate with the assumption that they may be invoked across different system 100 contexts. Non-agent tools can be executed primarily as part of processing of an assignment (discussed below).

In concrete embodiments, a non-agent tool can be configured to receive parameters via a ToolSelect request, to execute a defined task, and to return a ToolResult. The output can be configured to contain one, more or all of a status (such as SUCCESS, FAILED, or RETRY); a human-readable message (such as a summary of what was done, for users and logs); and raw output (such as structured data for debugging or chaining into downstream tools.

In the system 100, each non-agent tool can be an entity (or other data structure in the database 200) defined in terms of one, more or all of a unique name, a description (used in search/discovery and prompt construction); a config schema (Pydantic model) that defines its expected input; and an entry point (such as an async execute( ) method that performs the operation).

Non-agent tools can be configured to be invoked during assignment processing based on agent tool-determined ToolSelects. A ToolLibrary of the system 100 can be configured to resolve a provided tool_name and to validate the parameters against the non-agent tool's config model. If validation passes, the non-agent tool can then be executed.

Non-agent tools can be configured to access shared working memory to retrieve task-specific context and also to fallback to full memory if necessary (working memory and full memory defined below). This way, a calling agent tool does not need to explicitly pass memory results, instead non-agent tools can be configured to be responsible for contextual data access using graph information in the database 200.

The following is an example of an output ToolResult JSON data structure from an email sending non-agent tool:

{ “status”: “SUCCESS”, “tool_name”: “send_email”, “tool_output”: { “message”:
“Email successfully sent to jack@example.com and dave@example.com.”, “details”:
{ “subject”: “Meeting Follow-up”, “recipients”: [“jack@example.com”,
“dave@example.com”] } } }

The “message” field above is intended for human readability. The “details” object is for structured automatic downstream follow-up use by the system 100.

Some non-agent tools can be configured to require authentication to external systems (such as Microsoft Graph, Jira or SharePoint). Such non-agent tools can be configured not to expect calling agent tools to supply credentials directly. Instead, non-agent tools can be configured to be responsible for resolving and applying credential packages, being potentially encrypted memory entities stored in full memory in the database 200. Such a credential package can be a structured data object, such as a JSON object, that contains connection credentials for a specific service. It can include metadata that is indexable by non-agent tools but that does not expose sensitive values to LLMs or agent tools.

For instance, a credential package can be stored in the database 200 as a full entity record with a specific entity_type of “credential_package”, for instance according to the following example:

{ “entity_id”: “cred-987”, “name”: “beth-msgraph-creds”, “description”: “Microsoft
Graph access for Beth”, “entity_type”: “credential_package”, “metadata”: { “service”:
“Microsoft Graph”, “scopes”: [“Calendars.ReadWrite”, “User.Read”], “linked_user”:
“beth@example.com” }, “tags”: [“auth”, “msgraph”, “beth”], “encrypted_contents”: {
“client_id”: “...”, “client_secret”: “...”, “access_token”: “...”, “refresh_token”: “...”,
“tenant_id”: “...”}, “source”: “user-onboarding”, “created”: “2024-03-01T10:00:00Z” }

This full entity object hence lives in full memory and can be recalled by similarity searches as described hereinbelow, scoped memory lookup, or through linked relationships (e.g., linked to an agent tool or to an assignment).

Non-agent tools can be configured to perform searches across credential package metadata in the database 200, including using memory recall methods as described herein. If linked entities or assignments exist (e.g., Beth's agent or the Jabberwocky project, see below), these can be used to bias the search results. Non-agent tools can be configured to decrypt and apply credentials internally during their execution.

In some embodiments, credential packages can be grouped by service, and each non-agent tool can be configured to request and apply only credentials that match its domain. Furthermore, non-agent tools can be configured to in their return data indicate any errors, such as if no credentials were found, if multiple credentials were ambiguous, or if a selected package was invalid. Non-agent tools may cache or reuse credentials across executions, but verifying freshness if tokens expire.

A credential package can be a structured JSON (or other data format) object that contains connection credentials for a specific service. It can include metadata that is indexable by non-agent tools but that does not expose sensitive values to LLMs or agent tools. Each credential package can selectively include one, more or all of the following metadata fields, that are used for tool discovery during assignment processing and similar: name (a unique name such as “beth-msgraph-creds”); description (a human-readable label); service (a service it grants access to, such as, Microsoft Graph, Jira Cloud); scopes or capabilities (an optional list of supported operations). For example, a credential package can be structured according to the following:

{ “client_id”: “...”, “client_secret”: “...”, “access_token”: “...”,
“refresh_token”: “...”, “tenant_id”: “...” }

The system 100 can be configured to employ multi-step processes denoted “workflows” herein, by chaining non-agent tool executions together under a shared execution context to process a task. Each step in such a workflow may then consume the output of a previous non-agent tool as its input. Then, the structure of the ToolResult can be configured to be compatible with the expected parameters of the next non-agent tool. If the ToolResult does not provide the required parameters directly, a workflow engine of the system 100 can be configured to invoke a non-agent tool to generate a ToolSelect object for the next step. This non-agent tool can then be configured to use the current workflow context, including memory, prior non-agent tool outputs and/or any linked entities, to automatically derive the correct input parameters. This mechanism allows workflows to automatically chain together non-agent tools without requiring LLM reasoning at every step. Correspondingly, an agent tool can be used to derive the correct input parameters, then actually using an LLM as generally described herein.

Tool compatibility can be configured to be based on parameter alignment, such that the output is passed directly to the next non-agent tool in the workflow when the parameters are compatible, and such that the non-agent tool is instead triggered to produce a valid input when the parameters are not compatible. This design balances automation and flexibility, enabling intelligent fallback without compromising determinism. Unlike non-agent tools—which can be configured to be atomic and stateless—workflows can be configured to be stateful, tracking progression, handling partial completion, and supporting conditional logic across steps. Hence, workflows can be configured to maintain a record of completed steps and their outputs. Each step of a workflow can individually result in the execution of a non-agent tool using the prior result or context. Execution can be configured to be halted between steps and/or to be resumed asynchronously. Logic within the workflow can be configured to route execution paths based on ToolResult content or non-agent tool metadata. Some steps of the workflow can be configured to delegate decision-making to an agent tool, which can then be configured to emit the next ToolSelect based on prior outcomes. As an example of this, consider multiple non-agent tools that are configured to mutate string text. Each of these non-agent tools is String in and String out, meaning that they can be chained in sequence in any order and as many of them as needed. For instance, text input→summary tool→translate to French tool→final output. In this workflow, only dealing with string texts, no LLM is required. However, if the summary tool is configured to return a string and in addition a series of integers (for instance, prior length, new length, etc.), the integers are disregarded and only the string output is used by the downstream tool (translate to French tool). If there is ambiguous output and input, such as if the summary tool is configured to return two strings (such as the summary and the reasoning), the system 100 does not know which one of the two strings to pass into the next tool. In such situations, the system 100 can be configured to use an LLM 150, 160 (construct a text prompt requesting the LLM 150, 160 to look at the outputs of the tool and to provide, in response to the text prompt, structured information as to how to map the outputs to the inputs of the next tool in the workflow). This sequence can be mapped out like this: START (raw instructions)→assess if raw instructions can unambiguously and automatically be mapped, and if not, ask an LLM to map them for us→first non-agent tool→assess if outputs can automatically be mapped, and if not, ask an LLM to map them for us→second non-agent tool→etc. Alternatively, such mapping can be performed manually as configuration information, primarily for any statically defined workflow functionality of the system 100. If an LLM 150, 160 is used to perform the mapping, the system 100 can be configured to save the devised mapping in the same manner that would be used for a manual mapping, and for future runs of this workflow the need for the LLM 150, 160 mapping can be bypassed since it is at this point deterministic (the definitions of the non-agent tools used remain the same).

Each workflow can be configured to include one, more or all of a unique workflow name; an ordered list of step definitions; optional branching or conditional rules; access to shared working memory and/or any linked entities or assignments; and an ability to write results back to memory or emit new entities into the database 200.

A typical execution flow of a workflow includes the following steps: 1) Workflow invoking (usually by an assignment processor); 2) Working memory initialization/construction with task-relevant data; 3) First non-agent tool invoking and resulting execution using inputs from memory or previous non-agent tool; 4) Storing of the results from the non-agent tool execution in the workflow context; 5) Selection of a next non-agent tool (either deterministically or via an agent tool); and 6) Repeating of the process until all steps have completed or the workflow is halted for some reason. Some concrete examples include multi-system scheduling (e.g., memory→lookup→search→calendar); entity onboarding (e.g., enrich, validate, confirm, persist); and report generation (e.g., collect data→analyze→summarize→distribute).

Workflow definitions can include metadata, such as one, more or all of the following: Tool dependency graph (step order or dynamic decision map); Data propagation rules (what gets passed to each non-agent tool); Memory scope (which memory segments are active); and Credential continuity (which credentials can be reused across steps).

Each workflow execution instance can selectively include one, more or all of the following: Execution ID; Step-by-step logs (name of non-agent tool, input, ToolResult summary); Errors and retries; and Final output and state.

It is realized that non-agent tools do not manage their position in a workflow, but are instead executed in sequence by the workflow controller, which handles state transitions and output interpretation for a particular processing flow. As will be exemplified hereinbelow, agent tools can be used to invoke non-agent tools, by responding to responses from an LLM 150, 160, the responses carrying instructions for the invoking, the responses being to automatically produced text prompts to the LLM 150, 160.

In order to explain the concept of non-agent tools as used herein, in the following a practical exemplary scenario for non-agent tool usage by the system 100 will be provided, namely one in which the user Beth asks the system 100 to schedule a meeting with users Jack and Dave. Jack and Dave may or may not be registered users 122 of the system 100. The system 100 uses assignment processing (described below) to automatically identify a number of steps that need to be performed, namely: 1) identify Jack and Dave from memory; 2) enrich their profiles using Microsoft Graph; 3) locate contextual content for the meeting; 4) extract relevant Jira tasks; 5) generate a meeting agenda; 6) find a mutually available time for the meeting; and 7) schedule the meeting via Outlook. Each of the following non-agent tools represents one of these discrete steps:

Example non-agent tool: memory_search_entity; Purpose: Looks up people, projects, or other entities by query.

Input: { “query”: “Jack”, “filters”: { “type”: “person” }, “limit”: 5,
“include_working_memory”: true }
Output: { “results”: [ { “entity_id”: “entity-001”, “name”: “Jack Dylan”, “metadata”: {
“team”: “Infrastructure”, “email”: “jack@example.com” }, “similarity_score”: 0.91 } ],
“message”: “1 entity found in Working Memory” }

Tool: microsoft_graph_lookup_person; Purpose: Enriches a person entity using Microsoft Graph. When this exemplifying non-agent tool is executed, it needs a valid Microsoft Graph credential package to query the Microsoft Graph API. The resolution process follows a strict sequence to avoid ambiguity while still allowing for flexible fallback and override logic: 1) Search working memory for credential packages (the non-agent tool searches working memory for credential_package entities where metadata.service=Microsoft Graph; 2) If exactly one credential package is found, the non-agent tool uses this credential directly. No ambiguity, no need for scoring or agent tool intervention; 3) If multiple credential packages are found, the non-agent tool performs a relevance calculation including similarity scoring against linked users or assignments (e.g., is it tied to Beth?), name and tag relevance (e.g., does it match the requested email or entity?), recent usage or success rates, if tracked; 4) if results are ambiguous or low confidence, the non-agent tool invokes an agent tool (LLM-driven, as described more in-depth below) to resolve the ambiguity. The agent tool is supplied with metadata about each credential candidate and the task context. The agent tool then selects the most appropriate credential, or returns an error if no safe choice can be made; 5) If no credential packages are found in working memory, the procedure according to steps 1-4 is repeated but using the full memory instead of the current working memory. If no credential can be selected after all attempts, the non-agent tool will fail with status FAILED, returning a text message like: “No usable Microsoft Graph credential found for this task.”

Input: { “search”: { “entity_id”: “entity-001”, “name”: “Jack Dylan”, “metadata”: {
“team”: “Infrastructure”, “email”: “jack@example.com” }, “credential_package”: {
“client_id”: “...”, “client_secret”: “...”, “access_token”: “...”, “refresh_token”: “...”,
“tenant_id”: “...” } }
Output: { “person”: { “id”: “c3f1e7c1-9a63-4a84-b7d0-193e4b273b93”, “displayName”:
“Jack Dylan”, “mail”: “jack@example.com”, “jobTitle”: “Senior Engineer”,
“officeLocation”: “12B”, “mobilePhone”: “+1 555-0101” }, “message”: “Microsoft
Graph profile retrieved for Jack Dylan.” }

Example non-agent tool: sharepoint_context_search; Purpose: Searches SharePoint for documents related to a project.

Input: { “context”: “Project Jabberwocky”, “max_results”: 10 }
Output: { “files”: [ { “name”: “Design_Spec_Jabberwocky.pdf”, “webUrl”:
“https://company.sharepoint.com/sites/eng/Shared%20Documents/Design_Spec_Ja
bberwocky.pdf”, “lastModifiedDateTime”: “2024-03-01T17:12:00Z”, “modifiedBy”:
“beth@example.com” }, { “name”: “Sprint_Notes.docx”, “webUrl”:
“https://company.sharepoint.com/sites/eng/Shared%20Documents/Sprint_Notes.do
cx”, “lastModifiedDateTime”: “2024-03-05T09:00:00Z”, “modifiedBy”:
“dave@example.com” } ], “message”: “2 documents found for Project Jabberwocky.”
}

Example non-agent tool: jira_task_summary; Purpose: Summarizes Jira tasks for people on a given project.

Input: { “project”: “Jabberwocky”, “assignees”: [“Beth”, “Jack”, “Dave”] }
Output: { “tasks”: [ { “id”: “JAB-104”, “summary”: “Finalize API design”, “status”: “In
Progress”, “assignee”: “Jack” }, { “id”: “JAB-108”, “summary”: “Prepare QA
checklist”, “status”: “To Do”, “assignee”: “Beth” }, { “id”: “JAB-112”, “summary”:
“Bugfix: login timeout”, “status”: “In Review”, “assignee”: “Dave” } ], “message”: “3
tasks retrieved across 3 users.” }

Example non-agent tool: generate_meeting_agenda; Purpose: Builds an agenda from project context and active tasks.

Input: { “tasks”: [...], “documents”: [...] }
Output: { “agenda”: [ “Review finalized API design (Jack)”, “Discuss QA checklist
(Beth)”, “Review bugfix status (Dave)” ], “estimated_duration_minutes”: 45,
“message”: “Agenda generated for 3 discussion points.” }

Example non-agent tool: calendar_get_availability; Purpose: Finds overlapping availability across participants.

Input: { “participants”: [“beth@example.com”, “jack@example.com”,
“dave@example.com”], “duration_minutes”: 45 }
Output: { “available_slots”: [ { “start”: “2024-04-04T13:00:00Z”, “end”: “2024-04-
04T13:45:00Z”, “confidence”: 100 }, { “start”: “2024-04-04T15:00:00Z”, “end”: “2024-
04-04T15:45:00Z”, “confidence”: 95 } ], “message”: “2 time slots found with full
availability.” }

Example non-agent tool: outlook_schedule_meeting; Purpose: Schedules a meeting via Microsoft Outlook.

Input: { “from”: “beth@example.com”, “to”: [“jack@example.com”,
“dave@example.com”], “subject”: “Follow-up on Jabberwocky”, “body”: “Agenda
attached”, “start_time”: “2024-04-04T13:00:00Z”, “duration_minutes”: 45 }
Output: { “event”: {“id”:
“AAMKAGVmM2IxN2Y3LTA1MDctNDE3NS1iYzViLTA2NzQ4NzcxNDU1ZgBGAAAAAA
BY”, “subject”: “Follow-up on Jabberwocky”, “start”: “2024-04-04T13:00:00Z”, “end”:
“2024-04-04T13:45:00Z”, “attendees”: [“beth@example.com”, “jack@example.com”,
“dave@example.com”] }, “message”: “Meeting created and invites sent to attendees.”
}

The information 210 in the database 200 can comprise a number of specific entities, such as one or more semantic entity types, for instance:
A “ME” entity representing the system 100 itself. This entity can be the root of the knowledge graph and constitute a core entity of the information 210. As the system 100 is used more and more over time, the notion of “ME”, including the ME entity iteself and various interconnections to other entities in the information 210 created by such use, will expand based upon the content provided via interactions. In prompting, the system 100 can be configured to switch between “me” and “you” when referring to the ME entity, depending on the current perspective:
{“id”: “In-root”, “type”: “ME”, “name”: “LiveArena Networks”, “metadata”: { }}
A “My Computer” entity can be configured to capture key information about the hardware and software environment in which the system 100 operates. It can include details about compute resources, configurations, and software dependencies:

{ “id”: “In-env”, “type”: “My Computer”, “name”: “LiveArena Kubernetes Cluster”,
“metadata”: { “kubernetes_version”: “1.27”, “node_count”: 50, “cpu_cores”: 1200,
“memory_gb”: 8192, “region”: “us-west-2” } }

The information 210 can comprise entities representing concepts, such as ideas, categories or topics used by the system 100 to build understanding around key ideas and to group similar entities together via “IS_A” type connections. Such entities can form the basis of ontological organization within the knowledge graph. Concepts can be connected to each other to create hierarchical taxonomies.

The following is an example of such a concept entity, in this particular case representing the concept of a “user”:

{ “id”: “concept-user”, “type”: “Concept”, “name”: “User”, “description”: “A human
interacting with the system”, “metadata”: { “properties”: [ “has an identity”, “can send
and receive messages”, “has associated preferences” ] } }

Moreover, connections can have special semantic types, such as the following:
An “IS_A” connection can represent a subsumptive or inheritance relationship between two entities. It can then indicate that a source entity is a specific instance or subtype of the corresponding target entity. IS_A connections can be used extensively to build ontological hierarchies of concepts.

### Example—Person IS_A User:

{ ″source_id″: ″person-123″, ″target_id″: ″concept-user″, ″type″: ″IS_A″, ″metadata″:
{ “handle”: “JimBoBob” } }

A “HAS_A” connection can represent a compositional or ownership relationship—it can then indicate that the source entity contains or comprises the target entity. HAS_A Connections are used to model part-whole hierarchies:

{ ″source_id″: ″person-123″, ″target_id″: ″concept-birthday″, ″type″: ″HAS_A″,
″metadata″: { ″birthday″: ″Feb 2, 1986″, “location”: “Los Angeles, CA” } }

In addition to modeling descriptive relationships, connections in the information 210 can also represent prescriptive or instructional relationships in the form of directives. Such directive-type connections allow abstract concepts to provide behavioral guidance to concrete tools. For instance, by following DIRECTS connections from a concept entity to its associated tools, the system 100 can dynamically tailor its processing based on situational context. The following is an example of Users→DIRECTS→Agents:

{ “source_id”: “concept-user”, “target_id”: “concept-agents”, “type”: “DIRECTS”,
“metadata”: { “guidance”: [“Always address users by name”, “Prioritize response
speed”, “Escalate issues to human operator” ] } }

As illustrated by the above examples, the metadata can vary and be of different types and size for different items, even items of the same type, in a highly context-dependent way.

FIG. 1 illustrates the database 200, having the data 210 stored therein with the following exemplifying logical data structure:
One, two or more, such as a plurality of at least 10, at least 100 or even at least 1000, entities, each comprising one, more or all of a name; metadata; validity information, indicating if the data is current or not; a type, in turn comprising one or more of a type name and a description; a piece of version information and/or timestamp; and an embedding of part or all of the other information for the entity.
One, two or more, such as a plurality of at least 10, at least 100 or even at least 1000, connections, each comprising one, more or all of a source entity; a target entity; metadata; validity information, indicating if the data is current or not; a type, in turn comprising one or more of a type name and a description; a piece of version information and/or timestamp; and an embedding of part or all of the other information for the connection.
One, two or more, such as a plurality of at least 10, at least 100 or even at least 1000, interactions, each comprising one, more or all of a source entity; a target entity; metadata; validity information, indicating if the data is current or not; a type, in turn comprising one or more of a type name and a description; a piece of version information and/or timestamp; and an embedding of part or all of the other information for the connection.

As used herein, the term “generate” is used to denote the producing by a generative AI component, such as an LLM or an agent tool, of an output. The generated result may not be strictly deterministic and may vary both due to the fact that an LLM may be used, and also based on context and input variations.

As used herein, the term “build” denotes the production of an output which is deterministically derived from existing data and known structures. The case herein is often that an LLM generates an output, and the system 100 thereafter builds a structured object based on that output. The generated output can be on a predetermined format as explicitly instructed to the LLM in the text prompt provided to the LLM, such as instructing the LLM to provide its output in JSON format using a specific JSON schema, and then the building can comprise parsing, consuming and/or otherwise processing that JSON data structure to produce a built output.

As the term is used herein, “similarity” refers to vector embedded semantic similarity, a measure of how semantically similar two sets of data are. This similarity is, for instance, computed using cosine similarity on embedded vector representations.

The term “relevance”, as opposed to “similarity”, refers to how contextually related one piece of data (item; memory) is to another piece of data or (more typically) a group of data, such as a group of memories, such as to a part of or the entire working memory. Similarity and relevance are distinct concepts—two items can be similar but not necessarily relevant. For example, “Marketing Strategies for Q2” and “Sales Projections for Q2” may have a high similarity score but may not be relevant in the context of scheduling engineering sprints. Herein, a “memory” refers to a single item (entity, connection or interaction), or possibly to a group of single items, such as a group graphically interconnected items in the database 200. To the contrary, a “full memory” refers to the entire graph vector database 200 containing all items.

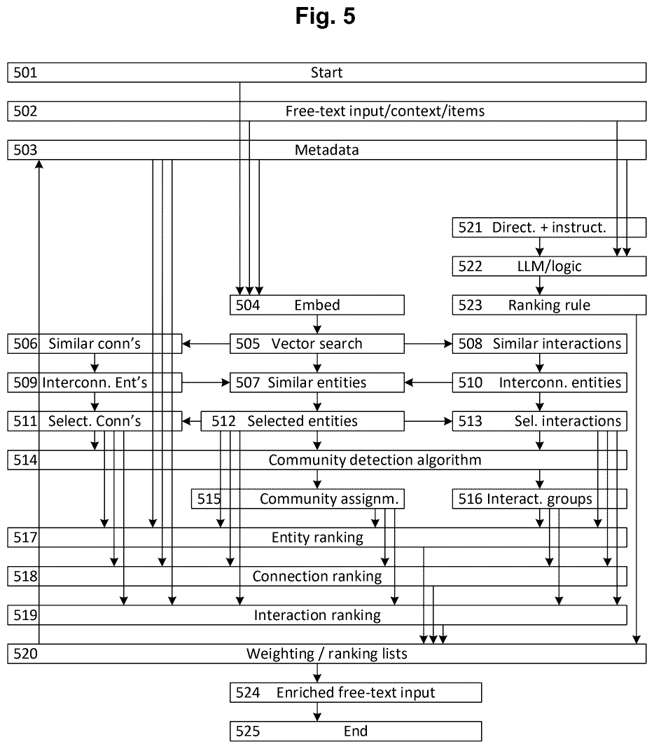

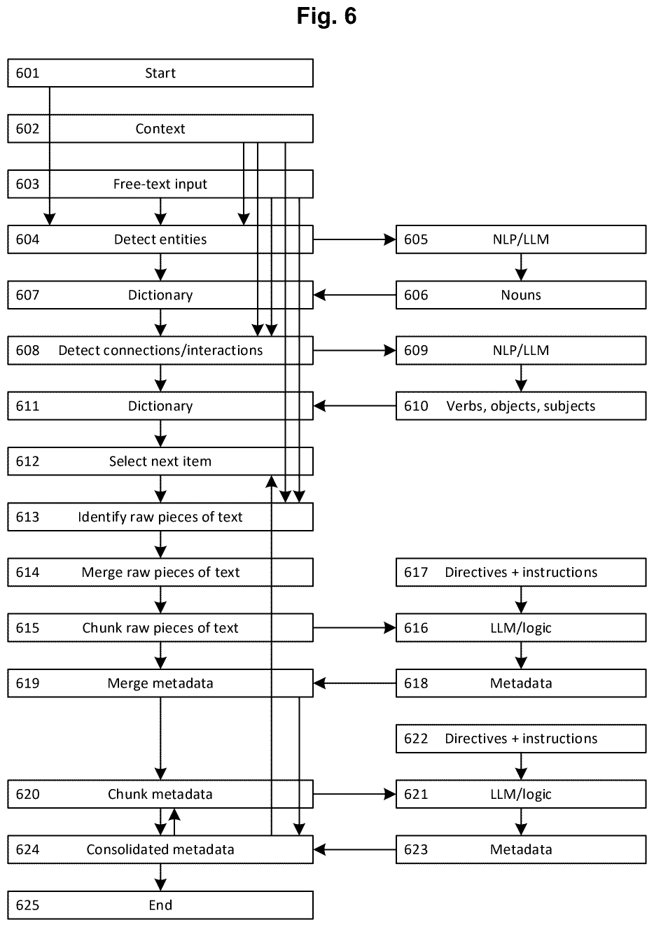

A “working memory” is constructed in the way generally described below from the “full memory” (the entire information 210 in the database 200) using a series of processing steps to create a targeted scope based on a freeform text input object (also referred to as the “initial input” or “free-text input”). The construction of a working memory can comprise one or more of the following steps (also illustrated in FIGS. 5-7, in particular FIG. 6):
1) Identify or provide the freeform text input;
2) Perform a broad similarity search between the freeform text input and the full memory (the full database 200) to come up with a set of similar memories (the “similar set”).
3) Expand the similar set by using graph information in the database 200, resulting in an “unprocessed working memory”. The expansion can use graph data in the database 200 and can include for instance adding connections/interactions having as source or target entities in the similar set; and adding entities being source or target for connections/interactions in the similar set.
4) Extract nouns, subjects and/or labels from the freeform text input using non-LLM natural language text processing tools (NLP), such as Named Entity Recognition (NER) and Named Relationship Extraction (NRE), or a combination of NER and NRE, resulting in a set of identified entities (people, organizations, dates, concepts, etc.) and/or corresponding connections (relations between the entities).
5) Compute similarity metrics for the items in the working memory, the metrics being calculated against the identified nouns/subjects/labels (the embedding of each item in the unprocessed working memory is comparted to the embedding of each identified noun, subject and/or label), resulting in similarity information for each item in working memory (respective similarities to each of the extracted nouns, subjects and/or labels) and as a result regarding how closely it generally matches the freeform text input.
6) Compute various other types of metrics for the memories in the unprocessed working memory, such as graph-based measures, for instance the various “dichotomies” described below.
7) Compute respective relevance scores for the items in the working memory based on one or more of the various similarities and/or other metrics calculated in steps 5 and 6, for instance using a set of weights. The set of weights can be predetermined and/or fixed, but it can also be context-dependent. For instance, one or more LLMs can be used to determine the set of weights directly or indirectly by being tasked, via an automatically produced prompt, to in response to the text prompt provide information relevant to a categorization of the context, style or type of the freeform text input to be able to determine a suitable set of weights in an accurately context-dependent manner.
8) Optionally, rank and/or filter the items in the unprocessed working memory.
9) Use the resulting set of items, possibly with the metrics and/or the relevance scores, as the final working memory. The working memory can be stored as a structured dataset, such as in JSON format, including all the relevant information discussed above.

Unlike working memory, the term “domain knowledge” is used herein to denote a specifically selected set of information in relation to a particular entity, called the “core entity” of the domain knowledge. The domain knowledge reflects contextual information about the core entity based on the information 210. Producing a domain knowledge in relation to a particular core entity can comprise one or more of the following steps (also illustrated in FIG. 5):
1) Identify or provide the core entity.
2) Identify any connections and/or interactions for which the core entity is source or target, and/or the corresponding entities being interconnected to the core entity.
3) Identify any connections and/or interactions interconnecting any pair of entities identified in step 2.
4) Calculate one or more importance metrics for each of the identified entities, for instance one or more of a) a number of connections of each entity; b) a number of interactions of each entity; and c) a number of connections for an entity shared with other ones among the identified entities.
5) Use the identified entities, together with their connections, interactions and importance metrics, as the domain knowledge. The domain knowledge can be stored as a structured dataset, such as in JSON format, including all the relevant information discussed above.

FIG. 2 illustrates the system 100, which may be or comprise a central server 130. As used herein, the term “central server” is a computer-implemented functionality that is configured to be accessed in a logically centralized manner, such as via a well-defined API (Application Programming Interface). The functionality of such a central server may be implemented purely in computer software, or in a combination of software with virtual and/or physical hardware. It may be implemented on a standalone physical or virtual server computer or be distributed across several interconnected physical and/or virtual server computers.

The physical or virtual hardware that the central server 130 runs on, in other words the physical or virtual hardware that computer software defining the functionality of the central server 130 executes on, may comprise a per se conventional CPU, possibly a per se conventional GPU or NPU, a per se conventional RAM/ROM memory, a per se conventional computer bus, and a per se conventional external communication functionality such as an internet connection.

In FIG. 2, the database 200 is shown as a part of the central server 130, but it is realized that the database 200 can be stored anywhere, in a monolithic or distributed manner, geographically in connection to or at a distance from the central server 130, and so forth. In fact, all that has been said about the central server in terms of general physical and logical configuration is equally applicable also to the database 200.

The central server 130 also comprises various tools 131, such as NLPs (Natural Language Tools). Such tools 131 can be internal or external (invoked via external API) to the central server 130 and to the system 100. An NLP can be a non-LLM functionality configured to process natural language by, for instance, automatically identifying nouns, verbs, objects, subjects and so forth from natural-language text data.

FIG. 2 also shows a querying device 120, such as a client. The querying device 120 can also be a central server in the above sense with the corresponding interpretation, and physical or virtual hardware that the querying device 120 runs on, in other words that computer software defining the functionality of the querying device 120 executes on, may also comprise a per se conventional CPU/GPU/NPU/xPU, a per se conventional RAM/ROM memory, a per se conventional computer bus, and a per se conventional external communication functionality such as an internet connection.

The system 100 can comprise the querying device 120, or even several such querying devices 120, and/or one or more querying devices 120 can be external to the system 100. Alternatively, the querying device 120 is external to the system 100.

The system 100, such as the central server 130 or a different central server 170 of the system 100, can be configured to provide a video and/or text and/or voice communication service involving two or more participating clients 121 that in turn also can be central servers in the above sense and with the corresponding interpretation. Such communication service can be configured to allow human users 122 of the participating clients 121 to communicate with each other, and with the system 100, digitally and automatically, using video and/or audio and/or text, via their respective participating clients 121.

However, the system 100 can also or alternatively be arranged to provide other communication services to human users 122 and/or to machine users 122 via clients 121. For instance, the system 100 can be arranged to maintain, update and keep track of the set of information 210, for instance in a logically centralized manner in the database 200, for the benefit of various human or machine users 122 of the system 100. In such embodiments, various such human and/or machine users 122 can contribute or add various pieces of information to the central server 130, in turn being tasked to process such information in relation to, and in turn affecting, the set of information 210 as a result of such contributions or additions. The contributions or additions can, for instance, be in the form of facts, queries, questions, reflections and so forth, and can be highly unstructured in itself.

For instance, the central server 130 can be provided with a transcript of a video or audio showing one or more persons talking, such as in a video conference, and to process that information continuously, intermittently or at a later point in time by consuming/processing (in the general way described below) one piece of textual information from the transcript at a time, resulting in various possible outcomes along the way, such as updating of the information 210 using new information from the transcript; responding to any queries automatically identified in the transcript, possibly using automatically harvested system-external information; automatically identifying the need for, and posing, follow-up questions or remarks, the responses to which are then processed in the corresponding manner as the transcript; and so forth.

Furthermore by way of example, the central server 130 can be provided with call transcripts from customer support interactions, and then process this information to detect frequently asked questions, customer sentiment, and recurring issues. Based on this, it can automatically update internal documentation, suggest updates to support playbooks, and even notify product teams of pain points users are facing.

In other examples, the central server 130 can ingest transcripts from recorded sales calls to evaluate adherence to a sales script, detect key objections raised by clients, and identify missed opportunities. It can provide real-time or post-call coaching suggestions to improve sales effectiveness, or dynamically update CRM records based on what's mentioned during the call.

In a healthcare setting, the central server 130 can receive audio transcripts of doctor-patient consultations. It can extract structured information like symptoms, diagnosis, prescribed medication, and next steps. This information can be automatically fed into electronic health records (EHR) and used to schedule follow-ups or generate summary reports.

The central server 130 can process lecture transcripts to break them down into summa-rized notes, extract key concepts, generate quiz questions, and highlight areas requiring deeper study. It can also track the evolution of concepts discussed across multiple lectures and link them contextually.

The central server 130 can monitor live news broadcasts or podcasts, transcribe the content, and automatically extract and cross-reference factual claims, generate breaking-news summaries, or update knowledge graphs for ongoing events in real time.

After a strategic planning meeting, the system 100 can process the transcript to identify all decisions made, unresolved questions, assigned tasks, and strategic themes. Based on this, it can auto-draft a summary, assign action items, and update the relevant project plans or internal documentation.

In all these examples, the system 100 is configured to automatically process incoming unstructured information and to provide a response based on the information and also based on the information 210 in the database 200. In some cases, the information 210 will also be updated based on this processing. Using the present invention, such processing and updating can be performed with higher reliability due to automatic information amelioration over time; and with higher computational efficiency as compared to conventional solutions.

As is understood from the above, the information 210 can be a highly changing set of information, being automatically affected, using the methods described herein, by any information exchanged to and from the central server 130 and evolving over time while potentially retaining all previously stored information. In other words, the system 100 can be configured so that any provision of information to or from the central server 130 in relation to clients 121 is reflected as an update of the information 210, and any such update of the information 210 can potentially affect any later function of the central server 130 in its interaction with clients 121.

In a further, similar, example the central server 130 is a chat bot, accepting textual input from one or more clients 121 and providing responses in the corresponding manner.

In another example, the central server 130 is configured to continuously or intermittently scan a computing environment, such the servers of a company or a particular Internet domain, and to digest any updated information in the corresponding manner as mentioned for the transcription case; and to provide suitable reactions, such as email alerts or notifications, to users of the computing environment in the corresponding manner.

In one example explained in detail below, user 122 Beth is active in a chat with the system 100, and tells the system 100 in the chat, “I need a brainstorming session for the Jabberwocky project this week.” The system 100 captures her exact words as input and processes Beth's request by breaking it down into key concepts. It identifies “Jabberwocky project” as the main topic and “this week” as a time reference, structuring this information for efficient recall. The system 100 then searches for past interactions related to “Jabberwocky project” and retrieves other relevant memories from the information 210. The retrieved information is analyzed, determining relevant context. The system 100 identifies that past meetings included discussions about security concerns and suggests adding related topics to the new session. Then, based on this the system 100 can automatically schedule the meeting, draft a proper agenda, and send email invitations based on the recalled details and Beth's request. The system 100 processes its action results, extracting new action items and key decisions. If Beth provides feedback, such as adjusting meeting structure or prioritizing different topics, the system 100 will be able to automatically refine its processes to better align with her preferences in future interactions. Later, instances of the system 100 used by Beth's team members (other users 122) can exchange feedback and insights. These instances can collaborate to refine meeting structures, highlight recurring topics, and improve responses, ensuring a more efficient and personalized experience across the team while maintaining privacy controls.

Hence, the system 100 is configured to automatically process information provided to the system 100 and residing in the database 200 in at least one or more of the following ways:
Interpreting and parsing incoming information;
Identifying tasks or assignments inferable from, or contained in, the incoming information;
Acting on the tasks or assignments by invoking a suitable selected set of one, two or more tools;
Providing a result of the actions to the user 122 providing the incoming information, or to a different user 122 or to external parties;
Affecting the internal state of the information 210 as a result, including expanding the information 210 and adding pieces of information 210 causing the system 100 to be able to process subsequent information more efficiently and/or properly;
Automatically summarizing/contextualizing the incoming information by extracting relevant decisions, tasks, and contextual references, and updating the information 210 accordingly;
Receiving an instruction in natural language, such as a request to notify a client or send a reminder, and automatically invoking a corresponding tool to perform a proper action in relation to the information 210 in the database 200 or in relation to external information or actors, while storing all relevant entities and interactions;
Detecting and processing reports of malfunction or workflow issues by inferring the affected process, responsible parties, and historical context, and taking suitable action to resolve or escalate the matter;
Analyzing incoming alerts or structured data streams, such as those relating to security incidents or operational anomalies, and autonomously triggering predefined procedures or analysis routines to respond to any malfunctioning or workflow any issue(s);
Receiving loosely defined goals or milestones (e.g., project deadlines or production targets), and transforming these into structured and concrete plans, tasks and dependencies, informed by prior similar cases stored in the information 210;
Identifying contradictions or inconsistencies in newly received information compared to prior data stored in the information 210, and initiating clarification procedures or marking conflicts for later resolution;
Recognizing shared themes, projects or entities across inputs from multiple users 122 and automatically associating corresponding items in the information 210 to construct a unified or collaborative knowledge context;
Monitoring progress or activity levels related to previously identified assignments, and autonomously generating follow-up reminders or escalation actions when task stalling or delay is detected;
Parsing audio or video transcripts and/or activity logs to identify implicit requests or action items—such as informal prompts or directives in conversation- and converting them into structured interactions and entities; and
Validating the coherence or plausibility of new input by comparing it against historically stored interactions and connections, optionally triggering further processing or verification steps when deviations are detected.

Each of the one or more querying devices 120 and each of the one or more participant clients 121 can individually comprise or be in communication with a respective computer screen, configured to display video content, for instance as a part of an ongoing video communication of said type; one or more respective loudspeakers, such as configured to emit sound content provided as a part of a communication; one or more respective video cameras; and one or more respective microphones, for instance configured to record sound locally to a user 122 to said communication, the user 122 using the participant client 121 in question to participate in said communication.

In other words, a respective human-machine interface of each participant client 121 can be configured to allow a respective user 122 to interact with the participant client 121 in question, in a communication, with other users and/or text/audio/video streams provided by various sources.

In general, each of the querying devices 120 and each of the participating clients 121 can individually comprise a respective input means 123, that may comprise said video camera(s); said microphone(s); a keyboard; a computer mouse or trackpad; and/or an API to receive a digital video stream, a digital audio stream and/or other digital data. The input means 123 can be specifically configured to receive a video stream and/or an audio stream from a central server, such as from the central server 170, such a video stream and/or audio stream being provided as a part of a video communication and possibly being produced based on corresponding digital data input streams provided to the central server 170 from at least two sources of such digital data input streams, for instance one or more of the participant clients 121 and/or from one or more external information sources. The corresponding can be true regarding a text stream.

It is understood that the system 100 as described herein is largely text-based, and that any context being in the form of image and/or audio can be transformed into text format before being fed to the central server 130. For instance, audio can be automatically transcribed into text; and imagery/video can be automatically categorized and described in words using a suitable generative AI tool, as is generally well-known as such. Correspondingly, any output from the central server 130 in text format can be converted into audio using a text-to-speech conversion tool, or even images or video. Alternatively, the users 122 can engage with the central server 130 directly using text.

Generally, each of the querying devices 120 and each of the participating clients 121 can individually comprise a respective output means 124, that may comprise said computer screen; said loudspeaker(s); and an API to emit a digital video and/or audio stream, such audio stream being representative of a captured video and/or audio locally to the participant 122 using the participant client 121 in question. Correspondingly, a text interface such as a screen display or a file system can accept and show or provide textual information to the user 122, depending on use case and, for instance, if the user 122 is a human or a machine user.

In practice, each querying device 120 and each participant client 121 can individually be a mobile device, such as a mobile phone, arranged with a screen, a loudspeaker, a microphone and an internet connection, the mobile device executing computer software locally or accessing remotely executed computer software to perform the functionality of the querying device 120 or the participant client 121 in question. Correspondingly, the querying device 120 and the participant client 121 may alternatively individually be a thick or thin laptop or stationary computer, executing a locally installed application, using a remotely accessed functionality via a web browser, and so forth, as the case may be. Each querying device 120 and each participant client 121 can also individually comprise or be connected to any peripherally connected equipment, such as any external cameras, microphones and/or loudspeakers.

There may be more than one, such as at least two, at least three or even at least four, participant clients 121 used in one and the same communication.

Each querying device 120 can individually be one and the same logical or physical unit as one of the participant clients 121. Then, a result of processing by the central server 130 as described herein, such as a query posed by the client 121 to the central server 130 or provided by the central server 130 to the client 121 based on a different trigger than a specific query, can be used by the participant client 121 when providing the communication service experience to the corresponding user 122 or when determining information to be sent to the central server 170 providing the communication service experience. In other embodiments, the central server 130 can provide results of processing of the set of unstructured information to a querying device 120 that is external to the system 100 and not directly involved in such communication service.

In some cases, the querying device 120 can be an internal part of the system 100, acting autonomously as a part of a larger information processing activity. For instance, an autonomous party 125 in the form of an automatic “bot” type functionality can be configured to continuously, intermittently or discretely analyze a course of events within the communication service. As a part of such analysis, the party 125 can process textual information, for instance to take decisions regarding what information to provide to a requesting party; making automatic video production decisions in the form of text-format production commands for automatic execution by the server 170 and/or based on text-format descriptions of events and/or states in and/or of the video communication service; providing a summary of the course of events; and so forth. The textual information can be automatically extracted from the communication service, e.g. from the server 170, such as in the form of an automatically provided transcript of speech detected in the context of the video communication service; or in the form of an automatically produced textual description of a certain course of events in the context of the video communication service. The latter can, for instance, be produced based on automatic image analysis, such as using a trained neural network, of one or more video streams occurring within the video communication service, in combination with a textual processing, such as using an LLM, of metadata describing the video stream and deducted using the automatic image analysis.

An autonomous party 125 in the form of such an automatic “bot” functionality can further be configured to provide meeting summaries for participants after a video communication service has ended. As a part of this task, the party 125 can process textual information such as transcripts and generate a (possibly concise) summary of a discussion held between the participants during the communication service meeting, such as by identifying and mentioning/describing key topics and action items. It can also use metadata from video, audio, text or other types of streams occurring in or in connection to the communication service to track speaker participation and to provide insights on who contributed to different discussion points. The textual information can be extracted from both speech-to-text outputs and metadata associated with the interaction dynamics, allowing for detailed post-meeting reports.

An autonomous party 125 in the form of such an automatic “bot” functionality can further be configured to monitor the communication service for compliance with pre-defined content standards. As a part of this task, the autonomous party 125 can analyze textual information from speech-to-text transcripts, identifying and flagging inappropriate language or content. In addition, it can generate real-time alerts to moderators or apply automatic filters to remove or mute certain parts of the communication service. The textual information used by the autonomous party 125 could include speech-to-text data, contextual metadata, or keyword triggers provided by the central server 170.

Moreover, an autonomous party 125 in the form of such an automatic “bot” functionality can be configured to monitor ongoing communications in real-time and to send notifications based on certain trigger events. As a part of such monitoring, the autonomous party 125 can analyze available or deduced textual information to detect and notify users of key moments, such as speaker changes or specific keywords being mentioned. The bot could also provide real-time control recommendations, such as switching camera feeds based on who is speaking in a video communication, or generate a real-time summary of discussion points during the process of the communication service. Textual information for these tasks can be derived from live transcripts and/or metadata related to the participants' interactions, extracted automatically from the communication service by the central server 170.

It is realized that these various examples regarding the possible capabilities and tasks of the autonomous party 125 are not meant to be exhaustive, and that the examples can be combined in any manner.

At any rate, the autonomous party 125 can be configured to provide information, such as continuously updated information gathered in any of the ways discussed above, to the central server 130 processing the set of information 210, possibly as a result providing the autonomous party 125, or any other corresponding autonomous party 125, with return information, or offering the autonomous party 125 to use the information 210 as a resource, for instance by querying the central server 130, for deciding what to do next in terms of automatic video production decisions, resource allocation or task planning.

For instance, the set of information 210 can be or comprise a description of the course of events that has taken place during the course of activities within a communication service, such as in a video communication meeting, possibly including a set of subjective assessments or interpretations made by one or more participants 122 regarding one or more subjects, for instance regarding the course of events itself. The autonomous party 125 can then query the central server 130 for information regarding the course of events for use by the autonomous party 125 to produce an automatic summary of the course of events for a newly entering participant 122.

In a different example, the set of information 210 can be, or be comprised in, a defining set of information based on which an avatar is defined in terms of background knowledge, behavior, etc., of the avatar. Additional information regarding the avatar can be fed or otherwise provided from various sources, and an autonomous party 125 can draw from the information 210, by engaging in a dialogue with the central server 130, when calculating possible responses to queries the avatar may be posed. For instance, parts of the information 210 can form part of, or be used when determining, a textual prompt to an LLM impersonating a person in the form of the avatar or otherwise providing functionality representing the avatar based on responses to such textual prompts.

In general, the examples provided above regarding possible functionalities of, and uses for, the devices 120, 121 is not exhaustive, and may be combined in any way suitable.

FIG. 2 also shows a first neural network or LLM 150 and a second neural network or LLM 160. It is understood that an LLM comprises one or more neural networks, such as several layers and/or parallel neural network “heads”. In the following, 150 and 160 will be referred to as “LLMs” for brevity, knowing that each of 150 and 160 can refer to a complete LLM or merely one or more trained neural networks that in turn can form part of an LLM or of some other neural network-based functionality for processing language using such one or more trained neural networks.

The first and second LLMs 150, 160 can each be configured to communicate with the central server 130 by the central server 130 posing queries or requests, in the form of prompts, to any of the LLMs 150, 160, the LLM 150, 160 in question then being configured to automatically respond to such prompts back to the central server 130. It is realized that the LLMs are shown in FIG. 2 to be external to the system 100, but that they individually can alternatively be internal to the system 100. In some embodiments, the central server 130 comprises one or more such LLMs 150, 160.

The LLMs 150, 160 can be of the same or different types (“foundational models”, see above). Each LLM 150, 160 can in turn be configured to call upon or invoke a sub-LLM in call trees or call sequences. In general an LLM (Large Language Model), as the term is used herein, is a type of machine learning model designed for natural language processing tasks, typically having a very large set of parameters and possibly being trained with self-supervised learning on a vast amount of available text. For instance the LLM can follow the so-called “transformers” architecture, an in particular be a generative pretrained transformer (GPT). Such an LLM can be fine-tuned, for instance by various post-training. Well-known examples of such LLMs comprise the ChatGPT, Claude and Groq suite of models.

In many cases as described herein, the system 100 uses LLMs 150, 160 by providing text prompts to one or more of the LLMs 150, 160. It is understood that this can be construed to mean that one single text prompt is sent to one or more LLMs 150, 160 (if more than one LLM 150, 160: in parallel or in sequence); and/or that several different text prompts can be sent to one or more LLMs 150, 160 (again if several LLMs 150, 160; in parallel or in sequence). Said several different text prompts can be defined as different sub parts of a larger text prompt; to achieve a set of sub goals; and similar. The output from one LLM 150, 160 can be used in a text prompt fed into another LLM 150, 160, and so forth.

In general, when herein it is talked about one or more text prompts, such as s respective text prompt, being automatically produced to one or more LLMs 150, 160, requesting the one or more LLMs 150, 160 to provide, in a respective response to the one or more text prompts, a response, this can imply any of the above-described options. In particular, this can imply that a single text prompt is automatically produced and provided to a single LLM 150, 160, and that a single response is then provided from the single LLM 150, 160.

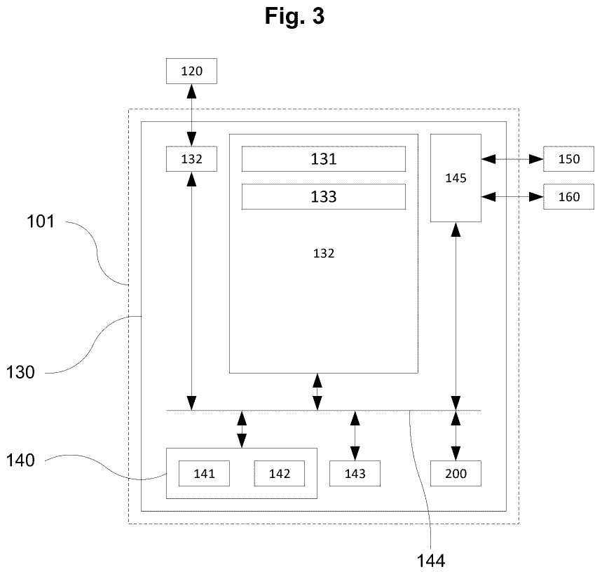

FIG. 3 illustrates in closer detail a possible embodiment of the central server 130. The central server 130 comprises an external digital communication interface 132, such as an internet interface. The interface 132 can be a HTTP interface, that can be configured to allow communication between the central server 130 and an external entity, such as the querying device 120 or 121.

The central server 130 further comprises a digital memory 140, such as a RAM memory. The memory 140 can be arranged to store the set of information 210 (if not the database 200 is separately arranged as indicated in FIG. 3) and/or a computer software program being configured to perform a method, in whole or part, of the type described herein when executed on a computing unit 143 of the central server 130.

Namely, the central server 130 can further comprise the computing unit 143 in question, such as in the form of a per se conventional CPU, GPU, NPU, QPU, or similar.

The central server 130 further comprises a piece of logic 132, being implemented in software and/or hardware as is per se conventional. The logic 132 can comprise a main algorithm or logic 133 implementing at least part of each of the methods described herein. The algorithm will normally be embodied as software, but can instead or additionally comprise hardware-implemented logic. The logic 132 can also comprise tools 131.

The central server 130 further comprises an LLM interface 145, configured to allow the central server 130 to communicate with the LLMs 150, 160. As discussed above, the LLMs 150, 160 can also be comprised as respective parts of the central server 130. The interface 145 can utilize any suitable digital communication protocol, in particular as described above in relation to interface 132. The communication between the LLM interface 145 and the LLMs 150, 160 typically comprises a text-form prompt to the LLMs 150, 160 and a text-form response from the LLMs 150, 160. In some embodiments, the interfaces 132, 145 are one and the same hardware and/or software interface.

The central server 130 also comprises a communication bus 144, allowing the various parts 131, 132, 140, 143, 145 to communicate one with the other.

In some embodiments, the central server 130 is a discrete physical hardware component, whereby one or more of the parts 131, 132, 133, 140, 143, 145 (any combination of one or more of these parts) are enclosed within one and the same physical enclosure. The database 200 may then also be comprised as a part of such discrete physical hardware component, or be an external database 200 in communication with the discrete physical hardware component. The device 120, 121 can also be part of the same physical entity, such as within the same physical enclosure. For instance, the system 100 can be installed on a single computer, such as a laptop computer, allowing a user 122 of the computer to use the system 100, including the central server 130 and the database 200, locally on the single computer.

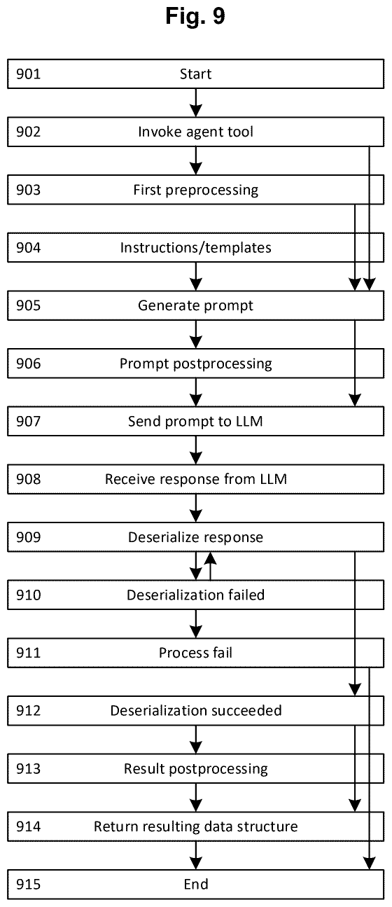

FIG. 9 illustrates method steps for performing agent tool processing by the system 100. The system 100 can be configured to perform agent tool processing (that is, for assignment or tasks that are not directly processable using a non-LLM tool) according to a set of principles that can be the same for several, or even all, agent tools in the system 100, even for the below-described assignment assessment agent tool. In some embodiments, the mechanisms used for several, or even all, agent tools in the system 100 are the same, so that the system 100 can invoke and interact with any such agent tool in the same principle way but using different data.

From a general point of view, the invoking of an agent tool comprises automatically producing a text-form prompt based on context-dependent data available to the system 100; to provide the produced prompt to an LLM 150, 160; to receive a response from the LLM 150, 160; to automatically parse or deserialize the response into a data structure of predetermined format; and to process the resulting data structure.

The data structure can contain different types of information. One important example is when the data structure comprises a text-form response to a query, question or statement provided as part of the text prompt. Then, the system 100 can be configured to provide the text-form response to whoever made the query, question or statement. For instance, a user 122 participant in a chat can pose a question the answer to which is provided by the LLM 150, 160 and provided back to the user 122 participant. Another example is when the data structure comprises information specifying a non-agent tool to invoke, together with input parameters. In this case, the system 100 can be configured to invoke the non-agent tool using the input parameters and to potentially pass any results from the invoked non-agent tool back to a suitable receiver, such as a different agent, depending on context.

In general, agent tools of the present type are used to define a conversion of unstructured (text-form) input into structured output (such as JSON) through LLM 150, 160 interaction. This process is inherently not completely deterministic due to the nature of LLM 150, 160 responses, but using the mechanisms described herein, following a structured approach, consistency and reliability is ensured in terms of output formatting and contents.

In a first step 901, the method starts.

In a subsequent step 902, the agent tool is invoked by the system 100, either on the initiative of the system 100 itself (such as is the case for the assignment assessment tool described below) or by a different invoking agent tool. The invoking is made using some kind of input information, normally a text-form input. This input can comprise, for instance, a chat message received and that is to be processed. The input can comprise metadata, such as a data structure of predetermined format, comprising any amount of information relevant to the input.

In practical embodiments, the invoking can comprise or be in the form of a so-called agent request data structure being created by the system 100 and sent to the agent tool for processing. The agent request data structure can be fixed according to a predetermined schema, which can be the same for several different tools. The agent request data structure can be created to include various information passed to the tool in the invoking, such as one or more of instructions (the raw instructions for the agent, such as a task or chat message that is the primary focus of the agent tool); additional rules (any additional rules that need to be followed by the agent tool when processing the instructions, in addition to rules generally applied by the agent tool or by all agent tools); additional blocks (any additional content blocks that provide context to the agent tool, such as a reference to a memory or an additional set of instructions or guidance); and a response object type (a schema that the response from the agent tool should adhere to). In the general case, the system 100 may not be in a position to interpret any significance of some, any or all of the information passed to the agent tool via the prompt; instead, the system 100 can be configured to populate the used text tool prompt with any available information and let the LLM 150, 160 interpret the information based on the additional information provided as a part of the text prompt template. This will be exemplified below.

The following is an example of an agent request schema:

{ “instructions”: { “type”: “string”, “description”: “The primary objective or task
description for the agent.” },
“additional_rules”: { “type”: “array”, “items”: { “type”: “string” }, “description”: “An
array of supplementary rules or constraints for the agent tool to follow during task
execution.”, “default”: [ ] },
“additional_blocks”: { “type”: “array”, “items”: { “type”: “string” }, “description”: “An
array of content blocks providing contextual information or supporting data for the
agent tool.”, “default”: [ ] },
“response_object_type”: { “type”: “string”, “description”: “The expected type or
schema of the object the agent tool should generate as a response.” },
“run_agent_preprocessing”: { “type”: “boolean”, “description”: “A boolean flag
indicating whether the agent tool should run its preprocessing pipeline on this
object.”, “default”: true },
“run_prompt_processing”: { “type”: “boolean”, “description”: “A boolean flag
indicating whether the agent tool should run its prompt preprocessing pipeline on the
generated prompt.”, “default”: true },
“run_tool_preprocessing”: { “type”: “boolean”, “description”: “A boolean flag
indicating whether the agent tool should run its tool preprocessing pipeline on the
selected tool and its input parameters.”, “default”: true },
“run_agent_postprocessing”: { “type”: “boolean”, “description”: “A boolean flag
indicating whether the agent tool should run its postprocessing pipeline on the
generated object.”, “default”: true }, }

In a subsequent step 903, an agent request object preprocessing step can be employed to enhance and sanitize the raw agent request object before it is passed to the invoked agent tool for execution. The system 100 can be configured to apply one or more agent request preprocessing steps, each being configured to impart a specific processing to the agent request data structure, such as in a sequential processing flow. In other words, the agent request object can be passed through each of a set of zero, one, two or more agent preprocessors, whereby the output of each preprocessor becomes the input for the next one, forming a chain of preprocessing steps.

One example of such an agent request preprocessing step is an instruction sanitizer, configured to scan the instructions field of the agent request and to remove any potentially sensitive, harmful or irrelevant content and/or safeguard the instructions field against prompt injection attacks by modifying the field.

Another example is a metadata enricher, configured to enhance the metadata field of the agent request by adding additional context or information that can be useful for the agent tool that is to process the agent request data structure, normally by retrieving relevant memories from system 100 memory (such as from the current working knowledge) or from external data sources. For example, such a metadata enricher can be configured to query the database 200, the current working memory, external APIs, and so forth, potentially applying rule-based and/or machine learning models to process the metadata information according to specific predetermined requirements.

In a subsequent step 905, once the preprocessing (if any) has been finalized of the agent request, an LLM prompt can be automatically generated by the system 100. This can be performed by filling in a corresponding prompt template which may be specific for the agent tool or for a class of agent tools to which the agent tool belongs. This is an example of such a text prompt Jinja template:

You are a specialized {{ agent.role }} Your sole task is to {{ agent.responsibility }} {% if rules
%} You must strictly adhere to the following rules: {% for rule in rules %} {{ loop.index }}.{{
rule }} {% endfor %} {% endif %} {% for block in content_blocks %} {% if block.content %}
-- START {{ block.name.upper( ) }} -- {{ block.content }} -- END {{ block.name.upper( ) }} -- {%
endif %}{% endfor %} {% if instructions %}
-- YOUR INSTRUCTIONS -- {{ instructions }} -- END INSTRUCTIONS --{% endif %} **Your
response must strictly follow this JSON format: **
-- START JSON RESPONSE -- {{ json_reply_schema }} -- END JSON RESPONSE -

See below for practical examples of produced prompts. The text prompt can in general be produced based on general or agent-specific instructions and/or directives 904, that can be incorporated as a part of the text prompt template or as a separate template. It is noted that both the text prompt template, the directives and/or instructions can be completely text-form, and that the text prompt generation can be fully automated and predetermined by the system 100 simply filling in the template(s) using the specified available information. Prompt templates can be preconfigured in the system 100.

As seen in the example, the data formatting instructions (in this case a specific JSON structure that needs to be adhered to) can be placed at the end of the text prompt, increasing the chances of the LLM 150, 160 providing an immediately useful result.

The text prompt can also be constructed to include information from a working memory constructed from a free-text input and/or one or more pieces of domain knowledge constructed from a respective item relevant to the task or assignment. In this case, any working memory and/or domain knowledge is added to the text prompt as structured data fields, using labels or similar automatically determined based on the memory extraction process that resulted in the extraction of the data from the database 200. In many cases, an entire working memory will not fit in a single prompt, so a ranking/filtering may be performed of an available working memory, resulting in that only a top-ranked/filtered fraction of the items in the working memory is added to the text prompt.

In a similar fashion to the agent request preprocessing, the system 100 can also use, in a subsequent step 906, a text prompt postprocessing function, configured to process the text prompt generated from the text prompt template before it is passed to an LLM 150, 160.

The text prompts automatically produced by the system 100 as a part of agent tool processing can generally be text strings that contain all the instructions for an LLM to generate a text reply, such as a single text reply. Each prompt can be specifically produced to encapsulate any necessary context, instructions, and any additional information required for the LLM to perform a requested task or assignment, and/or to produce a relevant and coherent response. Normally, the system 100 is configured to produce each prompt in a deterministic manner based on available information and context. However, for certain use cases the automatically produced prompt may require post processing before being handed to the LLM 150, 160. Examples of such prompt preprocessors include language translation preprocessors, that in turn can be implemented using language translation APIs, libraries, or pre-trained translation models and that can be configured to ensure that the text prompt string is converted into the preferred language of the LLM 150, 160 used. Another example is token replacers, such as implemented using regular expressions, predefined token mappings, or machine learning techniques and configured to identify and handle tokens that are not essential for the understanding and generation of the response by the LLM 150, 160 in certain cases. Examples include summarization compressors and semantic compressors, that may be of per se known types.

After the text prompt has been finalized, the system 100 can be configured to, in a step 907, send it to a preconfigured LLM interface 145 for processing and subsequently, in a step 908, receive a response from the LLM 150, 160. The agent tool then, in a step 909, takes the output from the LLM interface 145 and tries to deserialize it into a data object having a data structure (schema) specified to the LLM 150, 160, such as in the text prompt provided thereto. If deserialization fails, in a step 910, the agent can try, again in step 909, to provide the same prompt to the LLM 150, 160 (via the LLM interface 145) again until a predetermined number of attempts have been made. If deserialization still fails, the agent tool may then be configured to fail the whole agent processing, in a step 911, and the process ends with an error message.

If, however, deserialization is possible, in a step 912, the result is a data structure of predetermined format. This generated object can then undergo agent result postprocessing, in a step 913, which can be similar to the agent request preprocessing described above and that can combine zero, one, two or more postprocessing functions that can be run in series.

One example of such postprocessing functions is a memory extractor, configured to automatically extract relevant information from the generated object to be stored in a memory of the agent (in the agent entity object in the database 200), and possibly to create or update other memories in the database 200, for future reference. The specific memory extraction logic can be implemented using natural language processing techniques, such as entity recognition or custom heuristics. The goal is to identify and extract information from the generated object that can be stored as memories for future reference. At this point in the process, the system 100 can be configured not to assess relevance of each piece of data in the generated object and instead try to capture as much information as possible. Then, the captured pieces of information could be stored as part of the metadata for related memories. The system 100 can be configured to keep a list of associated labels that pointed to any particular entity.

For instance, if the database 200 contains an entity “Beth Rogers” representing a user 122 commonly referred to in text as “Beth”, “Beth Rogers”, “beth” or “Mrs. Rogers”, the NLP extraction will provide those labels. The labels should be associated to the Beth entity. Therefore, the labels can be stored, for example, as an array on the Beth entity that is added to and used by the semantic similarity processing. This means the next time the system 100 encounters “beth” in a text and its working memory contains “Beth Rogers” who has the label associated with her as “beth” and there are no other close matches, the system 100 can infer that “beth” is likely referring to “Beth Rogers” without needing an LLM. Hence, this way the system 100 will be able to search directly on the same labels again, in the future, with a higher accuracy. For instance: {“id”: “entity-pants”, “labels”: [“pant”, “pants”, “shorts”]}. This way, the system 100 will be able to capture the exact language that users 122 use so that when a particular phrasing is encountered again, the system 100 can better understand personal semantics beyond just general similarity.

In a concrete example, the LLM 150, 160 generated the following return object:

{ “task_summary”: “Beth booked an evening yoga session at Sunflower Yoga
Studio.”, “details”: “The session is scheduled for Tuesday at 6:30 PM, instructed by
Emma Turner. Beth mentioned wanting a relaxing session to wind down after work.”
}

From this object, the system 100 can be configured to automatically identify/extract an interaction that might look like this:

{ “id”: “interaction-5678”, “source_id”: “entity-me”, “destination_id”: “conversation-
1234”, “labels”: [“Beth”, “evening yoga session”, “Sunflower Yoga Studio”, “Emma
Turner”, “relaxing session”, “wind down”, “after work”], “message”: “The session is
scheduled for Tuesday at 6:30 PM, instructed by Emma Turner. Beth mentioned
wanting a relaxing session to wind down after work.” }

From that interaction, the system 100 would iterate through the labels and create new entities for each of them. This is what some of them might look like:

{ “id”: “entity-emma-turner”, “name”: “Emma Turner”, “type”: “PERSON”, “labels”:
[“Emma Turner”] }{ “id”: “entity-sunflower-yoga-studio”, “name”: “Sunflower Yoga
Studio”, “type”: “ORG”, “labels”: [“Sunflower Yoga Studio”] }{ “id”: “entity-evening-
yoga-session”, “name”: “evening yoga session”, “type”: “EVENT”, “labels”:
[“evening yoga session”] }

Doing memory extraction this way, memories in the database 200 gets better organized for more precise memory recall later. Focusing on the Sunflower Yoga Studio, it is now (for the purposes of this example) assumed that there is an existing entity in the database 200 representing this:

{ “id”: “entity-sunflower-yoga-studio”, “name”: “Sunflower Yoga Studio”, “type”:
“ORG”, “labels”: [“Sunflower Yoga Studio”, “Sunflower Studios”], “metadata”: {
“location”: “Downtown District”, “known_activities”: [“yoga”, “meditation”] }}

In this case, there is no new information on a strict entity basis. However, it is now assumed that there was a prior connection in the database 200 to a different instructor that looked like this:

{ “source_id”: “entity-alex-jones”, “target_id”: “entity-sunflower-yoga-studio”,
“type”: “WORKS_AT”, “metadata”: { “class_types”: [“vinyasa flow”, “power yoga”],
“schedule”: [“Monday 7:00 AM”, “Wednesday 6:00 PM”], “specialties”: [“breathwork
integration”, “strength-focused routines”] } }

All of the newly generated memories, the prior memories, and the original text are all added to an LLM 150, 160 prompt, and the system 100, using the LLM 150, 160, constructs new memories from this data as it pertains to entity-sunflower-yoga-studio. This results in no change to the entity itself, but does create the following connection:

{ “source_id”: “entity-emma-turner”, “target_id”: “entity-sunflower-yoga-studio”, “type”:
“WORKS_AT”, “metadata”: { “class_types”: [“evening yoga”], “schedule”: [“Tuesday
6:30 PM”], “specialties”: [“relaxation-focused sessions”, “winding down routines”] } }

This can be done for all of the extracted labels. For instance, an entity will be created in the database 200 also for Emma Turner:

{ “id”: “entity-emma-turner”, “name”: “Emma Turner”,
“type”: “PERSON”, “labels”: [“Emma Turner”],
“metadata”: { “roles”: [“yoga instructor”], } }

Another example is a summarization function, configured to produce a concise summary of the generated object useful to provide a high-level overview of its content. The specific summarization logic can be implemented using extractive or abstractive summarization techniques, such as TextRank, LexRank, or seq2seq models. The goal is to generate a concise summary that captures the key points of the generated object.

After any postprocessing of the data structure, the agent tool can be configured to, in a step 914, return the final object to whomever requested it.

In a subsequent step 915, the method ends.

For reasons of clarity, many of the aspects of the present invention will be explained using one and the same (and sometimes similar) line of events, involving a user Beth. Beth just received her new computer 121, having the system 100 installed locally thereon. As Beth powers the computer 121 on for the first time, the system 100 launches with an introductory chat window, displaying the following message:

“Welcome to the AI Companion—your intelligent assistant designed to help you stay organized, streamline tasks, and enhance productivity. Powered by LiveArena Networks, I don't just respond to queries—I remember, learn, and adapt based on your interactions. The more you use me, the better I get. Whether you need help summarizing meetings, tracking action items, managing schedules, or optimizing workflows, I seamlessly integrate with your tools and processes. I can recall relevant information from past conversations, make smart suggestions, and even anticipate what you might need next. To get started, tell me a little about yourself. What kind of work do you do, and how do you see AI assisting you in your daily tasks?”

In this example, the system 100 is configured to begin with this structured introduction to establish clarity in its role. By setting user expectations, it ensures Beth understands its capabilities. Additionally, prompting Beth to describe her role and workflow preferences allows the system 100 to immediately begin shaping the memory model (the information 210) around her specific needs. This approach not only personalizes the experience but also accelerates the system's 100 ability to provide relevant and meaningful assistance.

Beth responds, using the keyboard 123 of the computer 121 or a voice-to-text conversion utility: “Hello, my name is Beth and I'm a project manager at The Best Company, Inc. My primary responsibilities include organizing meetings, keeping track of project deliverables, and ensuring clear communication between departments. I often juggle multiple projects, so I need help managing schedules, tracking action items, and quickly retrieving relevant past discussions. It would also be helpful if you could assist in summarizing meetings and ensuring follow-ups aren't missed.”

When Beth provides her input, the system 100 automatically processes it, as will be described in the following, by storing identified key details in the database 200, and in particular using the above-discussed item types entities, connections and interactions, together representing a graph view of the continuously constructed information 210. It is understood that that initial welcome message may also be the result of an assignment to the system 100 to greet Beth, this assignment being processed as is generally described hereinbelow.

For the purposes of the present example, simple string identifiers are used for entities, but in concrete embodiments each item could be assigned a UUID to ensure uniqueness and scalability. Such UUIDs can be configured to allow efficient querying and retrieval while maintaining structured relationships between items. On the flip side, the system 100 can be configured to autonomize data such as this being fed into the LLMs 150, 160, so that the LLMs 150, 160 end up seeing things such as “person-123” in the text prompt instead of something like: “4f43sd-34far-4rfadfa-43rqgy”. This can be achieved by a simple dictionary between a database 200 internal identity and an identifier that makes more sense to a human reading the text. This also helps the LLMs 150, 160 to interpret the information.

To extract and classify entities, the system 100 can be configured to use Named Entity Recognition (NER) techniques, identifying types such as PERSON, ORG, and WORK_OF_ART from the input text. Whereas the system 100 initially can be configured to identify common entity types defined by NLP models 131, the system 100 can also be configured to support custom entity definitions tailored to the user's data. Over time, as more interactions occur, the system 100 will be able to refine its classification model to recognize new entity types specific to Beth's workflow, ensuring a highly personalized and adaptive experience. This refinement then takes place automatically by dynamically developing the classification model, as will be exemplified below.

Additionally, any metadata not used for similarity searches, such as potentially any timestamps and any references, can be stored separately in each item, in this example under label “non_embedded_metadata”. This allows efficient querying without unnecessary computational overhead.

As discussed above, entities can form the foundational building blocks of the information 210, representing individual data points, in the present case automatically extracted from Beth's input. The system 100 can be configured to use NER to classify these data points into predefined types, ensuring structured and efficient storage. By way of illustrative example, standard entity types can comprise one or more of PERSON (refers to individuals, including fictional characters); NORP (nationalities, religious, and political groups); FAC (buildings, airports, highways, bridges, etc.); ORG (companies, agencies, institutions, etc.); GPE (countries, cities, states); LOC (non-GPE locations, mountain ranges, bodies of water); PRODUCT (objects, vehicles, foods, etc., but not services); EVENT (named hurricanes, battles, wars, sports events, etc.); WORK_OF_ART (titles of books, songs, etc.); LAW (named documents made into laws); LANGUAGE (any named language); DATE (absolute or relative dates or periods); TIME (times smaller than a day); PERCENT (percentage, including “%”); MONEY (monetary values, including currency units); QUANTITY (measurements, such as weight or distance); ORDINAL (ordered numerals like “first” or “second.”); and CARDINAL (numerals that do not fall under another type). Of course, other similar standard entity types can be used as well.

If an identified entity does not fit into one of the existing categories, the system 100 can then be configured to temporarily classify it under CONCEPT, ensuring all relevant information is stored while allowing for future refinement, potentially leading to the creation of a new and additional standard entity type that can thenceforth be used by the system 100 when processing information.

As an alternative to storing entity properties as metadata on the entity in the database 200, it is also possible to store entity properties as connections to corresponding property entities. This way, property metadata can be shifted from being stored with, comprised in or being associated with the entity, to instead be encoded using the corresponding connection. For instance, there can be a “HAS_A” type connection interconnecting the “Beth” entity with a “Birthday” entity: Beth→HAS_A→Birthday. Metadata such as the birthday date, “Beth prefers smaller birthday parties” or “Beth enjoys Carrot Cake on her birthday” can be stored on the connection.

The conversation with Beth itself is stored as an entity with the type CONVERSATION. This entity acts as a container that groups all chat messages exchanged between Beth and the system 100. Unlike individual chat messages, that focus on specific interactions, the conversation entity helps maintain continuity across multiple exchanges, allowing the system 100 to track discussions as a whole. The entity can be stored as follows:

{ “id”: “conversation-001”, “type”: “CONVERSATION”, “name”: “Beth's Initial
Interaction”, “description”: “The initial conversation where Beth introduces herself
and outlines her needs.”, “metadata”: { “start_timestamp”: “2025-03-02T10:00:00Z”,
“participants”: [“entity-beth”, “ai-companion”] }, “non_embedded_metadata”: { “source”:
“System chat” } }

The chat message itself is stored as an entity with the type CHAT_MESSAGE. Unlike other entities, that can be extracted using NLP 131, this entity is automatically and directly created based on structured input data. It serves as a keystone for other connections and interactions, ensuring that conversations are properly linked to relevant entities, actions, and decisions:

{ “id”: “chat-001”, “type”: “CHAT_MESSAGE”, “name”: “Beth's Introduction Message”, “description”:
“Hello, my name is Beth and I'm a project manager at The Best Company, Inc. My primary
responsibilities include organizing meetings, keeping track of project deliverables, and ensuring
clear communication between departments. I often juggle multiple projects, so I need help managing
schedules, tracking action items, and quickly retrieving relevant past discussions. It would also
be helpful if you could assist in summarizing meetings and ensuring follow-ups aren't
missed.”, “metadata”: { “timestamp”: “2025-03-02T10:00:00Z”, “author_id”: “entity-beth” },
“non_embedded_metadata”: { “source”: “System Chat”. “conversaion_id”: “conversation-001”} }

In ways that will be described in detail below, the system 100 automatically extracts information from Beths introduction message using NLP 131 and possibly LLM 150, 160 tools, including the following:

Beth is automatically recognized by the system 100 as a PERSON entity, storing her information in a structured format. The system 100 captures essential details about her interactions as they appear, while her relationships to roles and organizations are handled as connections: {“id”: “entity-beth”, “type”: “PERSON”, “name”: “Beth”, “non_embedded_metadata”: {“last_interaction”: “2025-03-02T10:00:00Z”}}

The system 100 automatically recognizes “Project Manager” as an entity categorized under WORK_OF_ART, representing a defined role rather than an individual person. The specifics of Beth's role within this category are stored in the connection between Beth and this entity:

{ “id”: “entity-project-manager”, “type”: “WORK_OF_ART”,
“name”: “Project Manager”, “metadata”: {} }

Beth's workplace The Best Company, Inc. is stored as an ORG entity, providing a structured reference to her employer. Employee relationships are maintained through connections rather than embedded lists: {“id”: “entity-the-best-company”, “type”: “ORG”, “name”: “The Best Company, Inc.”, “metadata”: {“industry”: “Technology”}}

There are also a handful of other entities mentioned in Beth's introduction that the system 100 automatically captures, for instance using the LLMs 150, 160 and/or standard non-LLM language processing tools such as NLP 131:

{ “id”: “entity-projects”, “type”: “CONCEPT”, “name”: “projects”},
{ “id”: “entity-schedules”, “type”: “CONCEPT”, “name”: “schedules” },
{ “id”: “entity-action-items”, “type”: “CONCEPT”, “name”: “action items” },
{ “id”: “entity-meetings”, “type”: “CONCEPT”, “name”: “meetings” },
{ “id”: “entity-deliverables”, “type”: “CONCEPT”, “name”: “deliverables” },
{ “id”: “entity-communication”, “type”: “CONCEPT”, “name”: “communication” },
{ “id”: “entity-follow-ups”, “type”: “CONCEPT”, “name”: “follow-ups” },
{ “id”: “entity-discussions”, “type”: “CONCEPT”, “name”: “discussions” },
{ “id”: “entity-meeting-summaries”, “type”: “CONCEPT”, “name”: “meeting summaries” }

A number of connections are automatically identified and stored, defining the structured relationships between entities. When first created, each connection is labelled with property CREATED, helping the system 100 to later understand where something came from:

{ “source_id”: “chat-001”, “target_id”: “entity-beth”, “type”: “CREATED” },
{ “source_id”: “chat-001”, “target_id”: “entity-project-manager”, “type”: “CREATED” },
{ “source_id”: “chat-001”, “target_id”: “entity-the-best-company”, “type”: “CREATED” },
{ “source_id”: “chat-001”, “target_id”: “entity-projects”, “type”: “CREATED” },
{ “source_id”: “chat-001”, “target_id”: “entity-schedules”, “type”: “CREATED” },
{ “source_id”: “chat-001”, “target_id”: “entity-action-items”, “type”: “CREATED” },
{ “source_id”: “chat-001”, “target_id”: “entity-meetings”, “type”: “CREATED” },
{ “source_id”: “chat-001”, “target_id”: “entity-deliverables”, “type”: “CREATED” },
{ “source_id”: “chat-001”, “target_id”: “entity-communication”, “type”: “CREATED” },
{ “source_id”: “chat-001”, “target_id”: “entity-follow-ups”, “type”: “CREATED” },
{ “source_id”: “chat-001”, “target_id”: “entity-discussions”, “type”: “CREATED” },
{ “source_id”: “chat-001”, “target_id”: “entity-meeting-summaries”, “type”:
“CREATED” }

The system 100 also automatically creates a connection between the conversation and the chat itself: {“source_id”: “chat-001”, “target_id”: “conversation-001”, “type”: “CHILD_OF”}

From Beth's message, the system 100 automatically extracts the following connections. Connections between concepts and other entities are created dynamically based on Beth's input. By standardizing connection types, the system 100 makes structured queries easier, while still possibly capturing the exact words Beth uses as synonyms stored in item metadata. This helps similarity searches lean toward her specific terminology. The goal of the system 100 here is to store as much useful data as possible so the system 100 later can understand Beth's workflow and preferences. Over time, this structured data in the database 200 will automatically develop towards a personalized information model with respect to Beth as a user (and in parallel with respect to any other users 122), making the system 100 more intuitive to use and reflective of Beth's unique style of communication, her bias, opinions, and work habits. The following are examples of pieces of information that may have been captured by the system 100 in the current or previous interactions with and/or concerning Beth:

{ “source_id”: “entity-beth”, “target_id”: “entity-the-best-company”, “type”:
“WORKS_AT”, “metadata”: { “position”: “Project Manager″, “employment_start”: “2022-05-01” } }
{ “source_id”: “entity-beth”, “target_id”: “entity-project-manager”, “type”: “IS_A” }
{ “source_id”: “entity-beth”, “target_id”: “entity-schedules”, “type”: “MANAGES”,
“metadata”: { “used_synonyms”: [“juggles”], “description”: “Beth manages
schedules to ensure project timelines are met.” } },
{ “source_id”: “entity-beth”, “target_id”: “entity-projects”, “type”: “MANAGES”,
“metadata”: { “used_synonyms”: [“juggles”], “description”: “Beth handles multiple
projects at once, balancing competing priorities.” } },
{ “source_id”: “entity-beth”, “target_id”: “entity-action-items”, “type”: “MANAGES”,
“metadata”: { “used_synonyms″: [“tracks″], “description”: “Beth ensures action
items are completed and followed up on.” } },
{ “source_id”: “entity-beth”, “target_id”: “entity-meetings”, “type”: “MANAGES”,
“metadata”: { “used_synonyms”: [“organizes”], “description”: “Beth organizes
meetings to keep stakeholders aligned.” } },
{ “source_id”: “entity-beth”, “target_id”: “entity-deliverables”, “type”: “MANAGES”,
“metadata”: { “used_synonyms”: [“keeps track of”], “description”: “Beth has to keep
track of project deliverables, usually for multiple projects.” } },
{ “source_id”: “entity-project-manager”, “target_id”: “entity-schedules”, “type”:
“MANAGES”, “metadata”: { “used_synonyms”: [], “description”: “Project Managers
are responsible for maintaining schedules to ensure deadlines are met.” } },
{ “source_id”: “entity-project-manager”, “target_id”: “entity-projects”, “type”:
“MANAGES”, “metadata”: { “used_synonyms”: [“oversees”], “description″: “Project
Managers oversee projects, ensuring they progress efficiently.” } },
{ “source_id”: “entity-project-manager”, “target_id”: “entity-action-items”, “type”:
“MANAGES”, “metadata”: { “used_synonyms”: [“tracks”], “description”: “Project
Managers track action items to maintain accountability and progress.” } },
{ “source_id”: “entity-project-manager”, “target_id”: “entity-meetings”, “type”:
“MANAGES”, “metadata”: { “used_synonyms”: [“organizes″], “description”: “Project
Managers organize meetings to align teams and stakeholders.” } },
{ “source_id”: “entity-project-manager”, “target_id”: “entity-deliverables″, “type”:
“MANAGES”, “metadata”: { “used_synonyms”: [“keeps track of”], “description”:
“Project Managers often have to keep track of various deliverables.” } }

Interactions represent any action recorded in the system 100, either from a user 122, an AI process (such as an agent tool), or an internal operation. Unlike connections, that evolve over time, interactions can be configured to be immutable records of (possibly atomic) activity. High-traffic areas of memory are captured through multiple interactions rather than modifying a single historical entry. These interactions are rarely LLM-generated and are normally built directly from structured system data.

The first interaction with respect to Beth's chat comes from the ME entity (representing the system 100 itself) to the entity representing the conversation between the system 100 and Beth. This interaction stores the raw system prompt used to generate the system's 100 welcome message:

{ “source_id”: “entity-me”, “target_id”: “conversation-001”, “type”:
“GENERATED_PROMPT”, “timestamp”: “2025-03-02T10:00:00Z”,
“content”: “You are HP Al Companion,
your role is to give the user a nice welcome message”, “metadata”:
{ “model”: “GPT-40”, “temperature”: 0.7 } }

Beth's message is captured as both a CHAT_MESSAGE entity and an INTERACTION from Beth to the conversation. This interaction contains the raw input Beth provided, ensuring her original message is preserved alongside its parsed elements:

{ “source_id”: “entity-beth”, “target_id”: “conversation-001”, “type”: “USER_INPUT”,
“timestamp”: “2025-03-02T10:00:02Z”, “content”: “Hello, my name is Beth and I'm a
project manager at The Best Company, Inc. My primary responsibilities include
organizing meetings, keeping track of project deliverables ... [as above]”, “metadata”:
{ “input_method”: “chat api”, “language”: “en-US” } }

In a way that will also be described in detail below, the memories now created can be found and used by the system 100 in various contexts. However, since Beth's message now exists in both the CHAT_MESSAGE entity and as an INTERACTION, the system 100 must be able to intelligently determine which of these memories to surface during memory recall. If the goal is to retrieve user 122 input, the interaction might be the best reference. If the goal is to reconstruct a conversation, the chat message entity may be preferable. The system 100 can hence be configured to prioritize relevance when surfacing recalled memories. For the sake of the example here, it is assumed that no prior data on Beth exists in the database 200, meaning that such a memory recall process performed in reaction to Beth's chat message would return nothing directly relevant.

However, to illustrate what is happening, it is now assumed that there is already some data in the database 200 that is relevant for recall. However, at this stage, none of the structured data from Beth's introduction—including entities, connections, and interactions—has been added to the database 200. This ensures that memory recall operates solely on preexisting knowledge and does not introduce a déjà vu hallucination.

A déjà vu Hallucination occurs when the system 100 prematurely recalls newly processed data as if it were historical memory. This results in false reinforcement, where recent information is mistakenly treated as long-standing knowledge, creating self-reinforcing loops and misleading responses. Possible causes of déja vu hallucinations include premature memory ingestion (committing newly extracted entities, connections, and interactions to the database 200 before similarity searches and recall are completed, causing the system 100 to accidentally retrieve fresh input as past knowledge, in turn potentially causing the system 100 to reinforce certain facts such as Beth being the Project Manager at The Best Company several times); Race conditions in parallel processing (asynchronous processing of parallel processes resulting in data inconsistencies, causing the system 100 to retrieve incomplete data before full ingestion); recursive reinforcement (system 100 generated responses getting stored as facts, leading to self-referential loops); duplicate memory artifacts (asynchronous processes storing the same information in different ways, causing inconsistencies); and delayed recognition (the system 100 failing to acknowledge new data immediately, only recognizing it in later interactions).

Such déja vu can lead to false memory recall (the system 100 believing it has encountered the same conversation before, even when it has not); responses from the system 100 sounding overly familiar, as if the system 100 is “remembering” information that was just introduced; self-referencing responses (the system 100 mistakenly recalling its own generated output instead of legitimate past interactions, such as the system 100 saying things like “As you mentioned earlier,” when no prior mention exists); inconsistent or conflicting recall (users seeing duplicated or contradictory responses or connections being stored with two different metadata structures, leading to confusion in ranking and recall); recognition lag or delayed acknowledgment (the system 100 failing to recognize new information immediately, only acknowledging it in a later response, making human users 122 feel like they have to repeat themselves or causing confusion in machine users 122).

Déja fu hallucinations can be mitigated in a few different ways, including one or more of controlled memory ingestion timing (ensure all similarity searches and memory recall complete before ingesting of any new data into the database 200, for instance marking new data as pending until retrieval is confirmed); process synchronization and locking, using sequential processing pipelines (memory recall must finish first before ingestion begins) and/or commit flags and checkpoints (ensure memory updates are only marked as valid after completion of all recall steps); preventing recursive memory storage (system 100 generated responses are prevented from being stored as structured memory unless first explicitly validated and/or tagging system 100 generated responses with a “non-persistent” flag); timestamped data validation (newly ingested data must have a minimum time window before it can be surfaced in memory recall and/or if memory recall retrieves brand-new data, the system 100 can be configured to apply a dampening factor to reduce ranking weight).

In various method steps described herein, an “input text embedding” is calculated based on at least one of a free-text input; one or more identified items automatically identified in the free-text input, the items being automatically identified based on text processing, such as rule-based processing, NLP 131, and/or LLM-based text processing 150, 160; and any identified relevant context metadata pertaining to the free-text input. Hence, such an input text embedding can be calculated based on part of, or the entire, free-text input, for instance on the text of the free-text input itself, or on a structured data object comprising part of, or the entire, input text (such as a plaintext JSON object representing the chat input entity in the database 200). Such structured data object can also comprise metadata about the free-text input, such as relating to context (for instance, the chat itself, the parties of the chat, previous chat messages in the chat and/or results from the system 100 processing such previous chat messages in the chat). In some embodiments, the input text embedding can furthermore be calculated based on any automatically extracted contextual information about the free-text input, such as any items in the database 200 connecting the free-text input or a chat in which the free-text input occurs according to the graph structure of the information 210 (for instance, connected entities, etc.). In particular, one or more pieces of domain knowledge can be constructed using respective extracted parts (such as individual words or relations between words) of the free-text input 403, and such domain knowledge can be used to calculate the input text embedding. In general, the input embedding can be calculated based on both the free-text input and any additional context information regarding a context in which the free-text input was generated, introduced or arisen.

The free-text input can be any text-form input to the system 100, as described above, that the system 100 is to process. In many of the examples provided herein, the text-form input is a chat message from a user 122 to the system 100, but it is realized that everything that is said about this particular case is equally applicable also to other origins of the free-text input.

In the following, the calculation of the input text embedding, and its subsequent use, will be described in more detail with reference to FIGS. 5, 6 and 7.

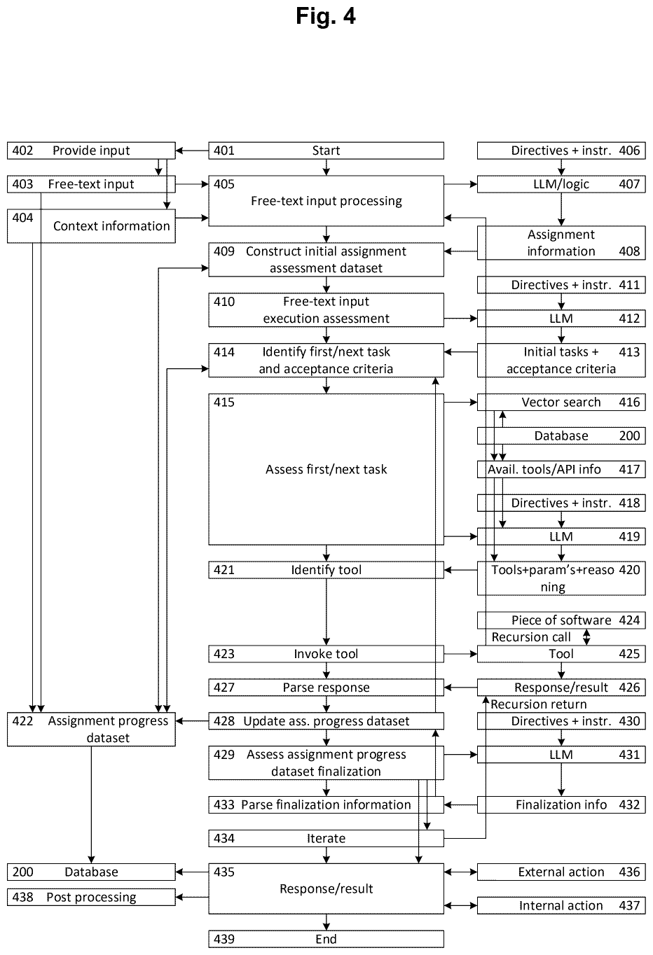

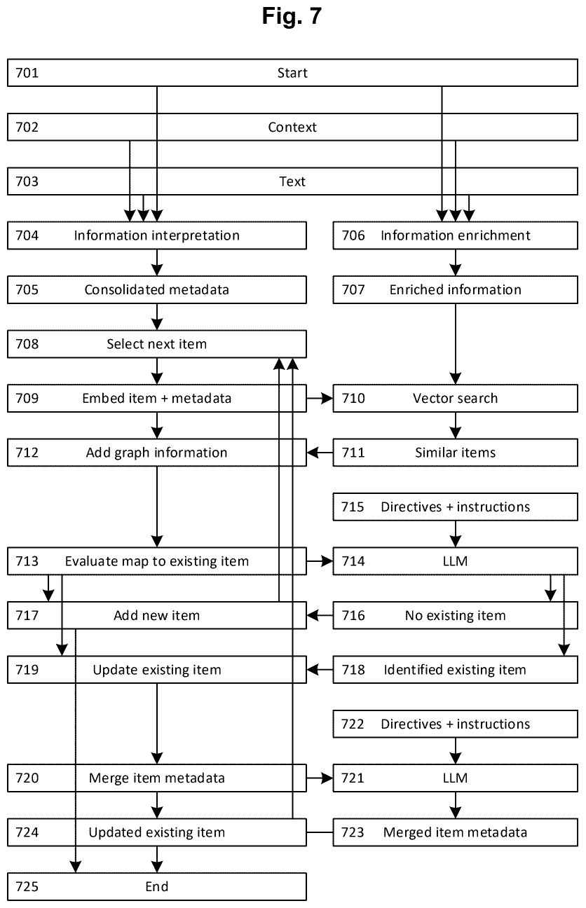

Hence, FIG. 5 illustrates method steps useful for automatically extracting items from the information 210 in the database 200 based on the free-text input text and any automatically identified items occurring therein. The flow illustrated in FIG. 5 is useful as a subpart of the flow illustrated in FIG. 4 and described further below, but can also be used in any situation to informationally enrich and contextualize a free-text input before processing the enriched/contextualized free-text input in any type of subsequent step, in particular by creating domain knowledge regarding one or more parts of the free-text input 502. Also, the flow illustrated in FIG. 5 can be used to automatically identify relevant items in the database 200 as a part of an information interpretation and possible ingestion process of the general type illustrated in FIGS. 6 and 7.

In a step 501, the flow of FIG. 5 starts.

In a subsequent step 504, the input text embedding is calculated based on at least one of the free-text input 502 or one or more identified items automatically identified in the free-text input 502 based on text processing. The input text embedding can also be calculated based on available metadata 503 regarding the free-text input 502, such as a context in which the free-text input arises, as mentioned above.

Thereafter, in a subsequent step 505, the system 100 can be configured to perform a similarity search (“vector search”) in the database 200, comparing respective embeddings of the stored items to the input text embedding using a vector-based similarity measure. Herein, reference is often made to such a “vector-based similarity measure”, and it is realized that this can be any suitable and per se conventional similarity measure. The type of similarity measure can be specifically selected for each type of task, and can be the same or different when used in various situations as described herein.

Using this similarity search, a similar set of items is identified among the items stored in the database 200 based on the similarity search, for instance as a set of such items being found to be more similar to the input text embedding than other items. In concrete examples, a similarity threshold value can be used, or a certain number of most similar items can be selected. The selection can be individualized across similar connections 506, similar entities 507 and similar interactions 508. The resulting similar set is hence made up from sets of identified entities 507, connections 506 and/or interactions 508.

In general, in the case illustrated in FIG. 5 and in other cases, similarity searches used as parts of the present invention can be performed in various ways to accommodate different use cases and performance requirements. In the following, three main such options will be described, namely Hierarchical Navigable Small World (HNSW), Exact K-Nearest Neighbors (KNN) and Approximate Nearest Neighbors (ANN). Each of these approaches offers different trade-offs between search speed, accuracy, and resource utilization.

Since the database 200 is typically designed to be large and high-dimensional, HNSW is often a reasonable option. The other two methods may also be useful in various situations. HNSW is a graph-based indexing method that is optimized for efficient approximate nearest neighbor searches. It builds a multi-layer hierarchy of navigable small world graphs, where each higher layer is a sparser representation of the layer below it. HNSW can build indexes quite quickly, even for large datasets. The hierarchical structure allows for very fast approximate nearest neighbor queries. HNSW can handle large, high-dimensional datasets efficiently. On the other hand, HNSW provides approximate results, which may not be suitable if exact neighbors are critical. The index can also consume significant memory, especially for large datasets. Given these pros and cons, HNSW is particularly well-suited for similarity-based retrieval in large datasets and in particular for embedding-based searches. Exact KNN search finds the exact k nearest neighbors to a query vector. It guarantees that the returned results are the true closest points in the vector space. Exact KNN provides the true nearest neighbors, with no approximation. It can work with any distance metric, not just cosine similarity. On the other hand, exact KNN can be slow for large datasets, as it may need to compare the query to every vector. Query times also increase with dataset size. Therefore, KNN can be used when the true nearest neighbors are required, and when searching through a relatively small dataset such as an identified working memory or a domain knowledge. Some use cases include small-scale similarity search where accuracy is critical; to validate the results of approximate methods; and scenarios where non-cosine distance metrics are needed.

ANN methods provide approximate nearest neighbor results, trading some accuracy for significant speedups. They use techniques like locality-sensitive hashing or vector quantization to reduce the search space. ANN can be orders of magnitude faster than exact KNN, especially on large datasets, and can handle very large datasets efficiently. On the other hand, the returned neighbors are approximate, not guaranteed to be the exact closest points and ANN methods often require careful parameter tuning to balance speed and accuracy. ANN is useful for very large datasets; when speed is important; and when some approximation is tolerated. Scenarios include real-time similarity search in large-scale systems; approximate nearest neighbor search in high-dimensional spaces; and in situations where some inaccuracy is acceptable for a significant speed boost.

A concrete example of a call to create an HNSW index in CozoDB is the following:

::hnsw create entities:entity_embedding_index { dim: 384, m: 16, dtype: :
F32, fields [embedding], distance: Cosine, ef_construction: 200 }

The present inventors have determined that at least the following parameter values are useful for the present purposes of performing the similarity search:
Dimension parameter (dim; specifies the size of feature vectors in the index): 128-384
Connections per node (m, defines the maximum number of edges, i.e. connections/interactions, that each node in the graph can maintain to other nodes): 16-32.
Data type (dtype; specifies the numerical format used to store each individual value within the feature vectors): F32.
Distance metric (distance, defines how similarity between vectors is calculated): cosine has been used in concrete cases, but Euclidian, dot product and Manhattan can also be useful.
Construction quality factor (ef_construction; controls the thoroughness of the graph construction process by determining how many candidates are evaluated when building each node's connections): 500-1000.

The following is an example of how to perform a search with a created HNSW index in CozoDB:

?[dist, id] := ~ entities:entity_embedding_index { id | query:
$search_vector, k: 10, ef: 100, bind_distance: dist }

? [dist, id]:=is the projection clause. It specifies which values from the search results returned and what to name them. Here, the requested return is the id of each result item and the dist (distance score). ~entities:entity_embedding_index tells CozoDB which HNSW index to search. entities is the namespace e of the index and entity_embedding_index is the specific index name. {id| . . . } is the search body, consisting of the two parts id (the result projection) and query: $search_vector, k: 10, . . . (defining the search conditions).

So, in plain English this query is saying: “Search the entity_embedding_index for the 10 items most similar to $search_vector, and return their ids and similarity scores (dist).”

The following modified CozoDB code also returns the type fields from the metadata:

?[dist, id, type] := ~entities:entity_embedding_index { id, metadata->>‘type’ as type |
query: $search_vector, k: 10, bind_distance: dist }

This will return results like the following:
[{“id”: “item-123”, “type”: “document”, “dist”: 0.05}, . . . ]

In addition to the core search parameters like query, k, and ef, CozoDB also supports adding filter conditions to HNSW searches, allowing narrowing down the search results based on specific criteria. The following is an example query that includes a filter condition telling CozoDB to only search among items of type “document”:

?[dist, id, type] := ~entities:entity_embedding_index { id, metadata->>‘type’ as type |
query: $search_vector, k: 10, filter: metadata->>‘type’ = ‘document’ }

It is noted that the terms “vector search” and “similarity search” are used as synonyms, the “similarity” in “similarity search” referring to “vector similarity”. To “embed” is to apply a transform from a piece of (text) information to a multi-dimensional vector (the “embedding”).

To retrieve the most relevant items from the database 200, the system 100 can hence run similarity searches across one, two, three or more of the three key data types and potentially other data types stored in the database 200:
Entities: Searching for people, organizations, concepts, or previously mentioned projects relevant to Beth's input. For entities, an entity vector-based similarity measure can be used, which may be the same or different from a connection vector-based similarity measure and/or an interaction vector-based similarity measure.
Connections: Identifying structured relationships that provide insights into Beth's prior interactions with the system 100. For connections, a connection vector-based similarity measure can be used, which may the same or different from an entity vector-based similarity measure and/or an interaction vector-based similarity measure.
Interactions: Retrieving past actions recorded between Beth and the system 100, including past messages, requests, or responses. For interactions, an interaction vector-based similarity measure can be used, which may the same or different from an entity vector-based similarity measure and/or a connection vector-based similarity measure.

Hence, using for instance an HNSW-based vector similarity search, the system 100 can process Beth's raw input by first transforming it into an embedding vector. This allows it to query the database 200 efficiently, retrieving structured records ranked by similarity score.

The following is an exemplifying search definition:

{ “query”: “Hello, my name is Beth and I'm a project manager at The Best Company,
Inc. My primary responsibilities include organizing meetings, keeping track of project
deliverables ... [as above]“,”, “vectorized_input”: [0.34, −0.12, 0.88, ...],
“search_parameters”: { “entity_search”: {“top_k”: 100, “similarity_threshold”: 0.75},
“connection_search”: {“top_k”: 50, “similarity_threshold”: 0.65},
“interaction_search”: {“top_k”: 50, “similarity_threshold”: 0.60} } }

Using NLP 131 processing techniques, for instance SpaCy, it is possible to automatically extract items from the free-text input to use when calculating the input text embedding from input 502 in a manner which is consistent, deterministic, efficient, parallelizable and without having to pay respect to token limits (as is the case when using LLMs for identifying items in a piece of text). However, it is also possible to chunk the free-text input as described further below in case it is very long, even if it results in a single chunk. In other words, the system 100 can scale effectively and process massive datasets of millions of words, such as a full Wikipedia dump or similarly, by distributing workload efficiently while maintaining structured memory extraction.

To extract entities effectively, SpaCy's Named Entity Recognition (NER) function can be combined with noun chunk analysis. In this and other cases, the extracted entities can be structured in a dictionary where each entry contains the name of the entity, its type, and its occurrences in the text, allowing the system 100 to reference it later. By using a dictionary-based structure, it can be ensured that multiple occurrences of the same entity are tracked in a coherent manner. This is especially useful when processing large-scale text, like books or long transcripts, where entities might be referenced multiple times across different contexts.

In general, the identifying of the one or more identified items can comprise automatically causing one or more non-LLM NLPs 131 to extract any nouns, verbs, subjects and/or objects from the free-text input.

So far, item extraction from the free-text input 502 has been described using non-LLM NLP 131 processing methods. Although NLP methods can parse text with speed and consistency, LLMs offer more nuanced interpretations. By applying LLMs to the structured output from NLP 131 processing, roles, statuses, or implicit attributes can be documented, in a way not requiring the original text to explicitly state them or requiring that assumptions are clearly labeled as inferences, while still maintaining clarity and accuracy. When providing the information extracted using the non-LLM NLP tool 131 in the text prompt to an LLM 150, 160, the system 100 can be configured to also include the most relevant items from working memory as part of the text prompt (as described above). For instance, if the raw extracted piece of information is “Beth is a project manager” and working memory adds the piece of existing information “Beth works on the Jabberwocky Project”, the LLM 150, 160 can infer that “Beth is a project manager for the Jabberwocky Project” and as a result the system 100 can generate additional connections that had not been made without this additional working memory context.

LLMs can also be used to extract domain-specific concepts, such as project milestones or specialized terminology, and generate explanatory or contextual metadata (e.g., short summaries of an entity's significance to a project). Hence, in a separate method step a text prompt can be provided to an LLM, prompting the LLM to analyze the free-text input and/or any items already extracted using NLP 131, and potentially together with contextual information (such information forming part of the text prompt), to extract more entities, connections and/or interactions. For example, if the direct textual evidence from the free-text input is that “Beth” describes herself as “Project Manager” for the “Jabberwocky Project,” a connection like Beth→Works On→Jabberwocky Project can be created, adding metadata such as {“role”: “Project Manager”}. If another statement indicates that Beth uses she/her pronouns, {“pronouns”: “she/her”} can be added to Beth's metadata. By ensuring each detail is supported (such as explicitly) by the source content, a justified, coherent knowledge graph can be ensured. A text prompt can be automatically constructed and provided to the LLM 150, 160, the text prompt specifically requesting the LLM 150, 160 to identify any nouns, verbs, labels, subjects and/or objects occurring in the free-text input, and possibly also for any other information such as the already extracted items, any metadata and context available, and so forth, and to return the information according to a specified format, such as a on a JSON format, for further processing.

Once entities have been identified, meaningful relationships between them can be extracted. This process structures knowledge for retrieval and decision-making.

To this end, the similarity search 505 is performed based on the input text embedding, in turn calculated based on some, any or all of the information extracted in the above-described ways, such as using non-LLM and LLM methods. For instance, any additional information can be added as metadata to the structured data of the entity representing the free-text input (the chat message in the present example). The similarity search will then result in a set of similar items from the information 210, possibly together with corresponding similarity scores according to the used vector similarity measure. For instance, the following data can accrue:

| Data | | Similarity |
|---|---|---|
| Type | ID | Score |
| Entity | entity-projects | 0.92 |
| Entity | entity-action-items | 0.88 |
| Connection | Beth → MANAGES → Schedules | 0.85 |
| Interaction | chat-045 (past request about | 0.81 |
| | meeting summaries) | |

It is noted that the similarity search can be a broad search in the database 200, retrieving as many relevant data points as possible, potentially hundreds or even thousands of items. These initial results serve as a rough approximation of relevance rather than a definitive answer.

In an optional part of step 505, additional vector searching can be performed specifically based on the NLP-identified nouns, subjects and/or labels retrieved as described above from the free-text input. Such additional searches can then result in additional entities, connections and/or interactions that are added to the similar set of items. Each identified noun, subject and/or label can be embedded individually, possibly together with any metadata resulting from the NLP 131 processing related to the noun, subject or label, respectively, including all generated connections between nouns, but possibly without metadata from connected nouns in order to prevent bias. In the present example, since Beth is referenced in all of these connections, she will frequently appear in the similarity results.

In other words, an additional similarity search can be made for each of one or more nouns, subjects or labels automatically identified using the non-LLM NLP tools 131 to find any additional items not already forming part of the set of similar items initially identified as described above.

The following text can be automatically generated using non-LLM NLP tools 131 based on the free-text input. Firstly, for the identified noun “Beth” the following can be gleaned using NLP 131 (again, it is assumed that the database 200 already contains information based on previous interactions with and/or about Beth):

Beth: { } Connections:
Beth WORKS_AT The Best Company: {“position”: “Project Manager”,
“employment_start”: “2022-05-01”}
Beth IS_A Project Manager: { }
Beth MANAGES Projects: {“used_synonyms”: [“juggles”], “description”: “Beth
handles multiple projects at once, balancing competing priorities.”}
Beth MANAGES Schedules: {“used_synonyms”: [“juggles”], “description”: “Beth
manages schedules to ensure project timelines are met.”}
Beth MANAGES Action Items: {“used_synonyms”: [“tracks”], “description”: “Beth
ensures action items are completed and followed up on.”}
Beth MANAGES Meetings: {“used_synonyms”: [“organizes”], “description”: “Beth
organizes meetings to keep stakeholders aligned.”}
Beth MANAGES Deliverables: {“used_synonyms”: [“keeps track of”], “description”:
“Beth has to keep track of project deliverables, usually for multiple projects.”}

Embeddings can be calculated for each of the above data structures individually, and used to perform similarity searches in the database 200. Alternatively, the entire text (the concatenation of the data structures regarding Beth immediately above) can be used to calculate one single embedding, used for a similarity search. For instance, such similarity searches can result in the following similar items:

| Search | | Similarity |
|---|---|---|
| Target | Retrieved Entity/Connection | Score |
| Beth | entity-beth | 0.92 |
| Beth | entity-action-items | 0.88 |
| Beth | connection-Beth → MANAGES → Schedules | 0.85 |
| Beth | interaction-chat-045 (past request about | 0.81 |
| | meeting summaries) | |
| Beth | entity-john-doe (another project manager) | 0.76 |

For the identified “project manager” the following data structures can be gleaned and correspondingly used to calculate an embedding for similarity searches:

Projects: { } Connections:
Beth IS_A Project Manager: { }
Project Manager MANAGES Projects: {“used_synonyms”: [“oversees”],
“description”: “Project Managers oversee projects, ensuring they progress
efficiently.”}
Project Manager MANAGES Schedules: {“description”: “Project Managers are
responsible for maintaining schedules to ensure deadlines are met.”}
Project Manager MANAGES Action Items: {“used_synonyms”: [“tracks”],
“description”: “Project Managers track action items to maintain accountability and
progress.”}
Project Manager MANAGES Meetings: {“used_synonyms”: [“organizes”],
“description”: “Project Managers organize meetings to align teams and
stakeholders.”}
Project Manager MANAGES Deliverables: {“used_synonyms”: [“keeps track of”],
“description”: “Project Managers often have to keep track of various deliverables.”}

The similarity search can result in:

| | | Similarity |
|---|---|---|
| Search Target | Retrieved Entity/Connection | Score |
| Project Manager | entity-projects | 0.90 |
| Project Manager | connection-Project Manager → | 0.89 |
| | MANAGES → Meetings | |
| Project Manager | entity-beth | 0.88 |
| Project Manager | connection-Project Manager → | 0.85 |
| | MANAGES → Deliverables | |
| Project Manager | entity-team-lead (similar role) | 0.77 |

Similarly for identified noun “projects”:

Projects: { } Connections:
Beth MANAGES Projects: {“used_synonyms”: [“juggles”], “description”: “Beth
handles multiple projects at once, balancing competing priorities.”}
Project Manager MANAGES Projects: {“used_synonyms”: [“oversees”],
“description”: “Project Managers oversee projects, ensuring they progress
efficiently.”}

The similarity search can results in:

| Search | | Similarity |
|---|---|---|
| Target | Retrieved Entity/Connection | Score |
| Projects | entity-beth | 0.92 |
| Projects | entity-project-manager | 0.90 |
| Projects | connection-Beth → MANAGES → Projects | 0.88 |
| Projects | entity-agile-methodology (related concept) | 0.78 |
| Projects | connection-uses (Projects → Kanban system) | 0.82 |

Similarly for identified noun “schedules”:

Schedules: { } Connections:
Beth MANAGES Schedules: {“used_synonyms”: [“juggles”], “description”: “Beth
manages schedules to ensure project timelines are met.”}
Project Manager MANAGES Schedules: {“description”: “Project Managers are
responsible for maintaining schedules to ensure deadlines are met.”}

| Search | | Similarity |
|---|---|---|
| Target | Retrieved Entity/Connection | Score |
| Schedules | entity-beth | 0.89 |
| Schedules | entity-project-manager | 0.87 |
| Schedules | connection-Beth → MANAGES → Schedules | 0.85 |
| Schedules | entity-team-calendar (Beth's shared schedule) | 0.71 |
| Schedules | connection-coordinates (Schedules → Meetings) | 0.88 |

In general, the similarity search step 505, comprising one or more individual searches in the database 200, can comprise one or more of:
identifying a first set of one or more of the entities having embeddings that are determined to be similar to the input text embedding according to an entity vector-based similarity measure;
identifying a second set of one or more of the connections having embeddings that are determined to be similar to the input text embedding according to a connection vector-based similarity measure; and
identifying a third set of one or more of the interactions having embeddings that are determined to be similar to the input text embedding according to an interaction vector-based similarity measure.

At this point, the similarity searches based on the free-text input itself: any relevant metadata; and/or NLP-identified items (including entities, connections and/or interactions) have resulted in the set of similar items. This similar set can be sorted by retrieved entity or connection, aggregating their corresponding similarity scores from different searches in any suitable manner. This allows an automatic analysis of relevance across multiple information dimensions. Furthermore at this point, it is likely that the similar set comprises connections and interactions that reference entities not yet included in the similar set. In these cases, those associated entities can also be added to the similar set, and additional similarity searches can be performed on the data 210, using respective embeddings of said associated entities, to further add items to the similar set. While these entities may not initially surface due to a lack of NLP 131 similarity, they can become valuable when organizing dichotomies (see below), helping to identify patterns such as novelty and consensus in later stages of processing.

Hence, the similar set can be expanded to form an expanded or selected set of connections 511, entities 512 and/or interactions 513 (in FIG. 5 denoted “selected” items).

The expanding can take place by adding (as mentioned above) one or more of the entities 509, 510 stored in the database 200, not already forming part of the similar set and being interconnected (referenced) by a connection and/or an interaction forming part of the similar set.

Alternatively or in addition, the expanding can take place by adding one or more connections and/or interactions stored in the database 200, not already forming part of the similar set and interconnecting (referencing) an entity forming part of the similar set.

After these steps, the produced working memory can look as follows:

| | | Similarity | |
|---|---|---|---|
| ID | Name | Score | NLP Results |
| entity-beth | Beth | 0.92 | {“Beth”: 0.92, “Schedules”: 0.89, |
| | | | “Meetings”: 0.88} |
| entity-projects | Projects | 0.90 | {“Projects”: 0.92, “Project |
| | | | Manager”: 0.90, “Schedules”: |
| | | | 0.87} |
| entity-action- | Action Items | 0.88 | {“Beth”: 0.88, “Project |
| items | | | Manager”: 0.85, “Meetings”: |
| | | | 0.83} |
| connection-1 | Beth MANAGES | 0.85 | {“Schedules”: 0.85, “Beth”: 0.85, |
| | Schedules | | “Meetings”: 0.82} |
| connection-2 | Project Manager | 0.89 | {“Meetings”: 0.89, “Schedules”: |
| | MANAGES Meetings | | 0.88, “Beth”: 0.87} |
| entity-the-best- | The Best Company, | 0.80 | {“Beth”: 0.80, “Project |
| company | Inc. | | Manager”: 0.79} |
| connection-3 | Beth WORKS_AT | 0.80 | {“Beth”: 0.80, “The Best |
| | Best Company pany” | | Com The: 0.80} |
| entity-meetings | Meetings | 0.88 | {“Beth”: 0.88, “Schedules”: 0.87, |
| | | | “Project Manager”: 0.85} |

Thereafter, a subset of the expanded set can be identified as a ranked set based on a ranking rule. Such ranking rule can be of different types, depending on the detailed embodiment and context, but will generally be defined in terms of the results of the similarity searches described above, in other words defined in terms of and calculated based on a respective vector similarity between respective embeddings of individual items in the expanded set and the input text embedding. The ranking can be performed in different ways, and can be based on different additional information as will be exemplified in the following. The ranking rule can be predetermined, such as defined in terms of respective values of one or more predetermined parameters, or it can be dynamically determined based on for instance a context of the free-text input.

In some embodiments, the similarity search comprises performing a community detection algorithm 514 based on the similar set, resulting in a classification into distinct community groups of the items in the similar set. Then, the ranking rule can be based on the results of this classification.

The community detection algorithm 514 can be configured to assign one and the same item of the similar set into two or more of the community groups. It can be based on entities in the similar set. Alternatively or in addition, it can be based on interactions and/or connections in the similar set. The classification can be a classification into the distinct community groups of the entities, interactions and/or connections in the similar set.

In particular, the community detection algorithm 514 can be a Louvain community detection algorithm, wherein individual nodes in the Louvain community detection algorithm correspond to individual entities in the similar set; wherein individual edges in the Louvain community detection algorithm correspond to individual interactions and/or connections in the similar set; and wherein weights in the Louvain community detection algorithm are determined based on respective similarity measurements, based on the respective vector-based similarity measure, between the input text embedding and a respective embedding of each of the entities being interconnected by the interaction and/or connection in question.

In specific examples, using the refined set of entities, connections and interactions represented by the similar set, the system 100 can be configured to group related connections and/or interactions into communities using a Louvain community detection. This ensures that contextually related connections and/or interactions are surfaced together, even if they are not directly similar in vector space.

Similarity searches are useful for retrieving interactions based on direct semantic relevance but have inherent limitations. They rely solely on vector distance, which can fail to recognize contextually related discussions that do not share direct lexical similarities, over-prioritize keyword-heavy results while ignoring broader thematic relationships and miss recurring conversational structures that develop over time.

Louvain community detection improves upon this by identifying clusters of interactions based on historical discussion structures, allowing the system 100 to detect and group thematically linked exchanges even if they are not direct vector matches.

A Louvain community is a group of entities, in the present case being interrelated by connections/interactions as edges. This way, the entities naturally form clusters based on past conversations and relationships. Instead of looking at each connection/interaction in isolation, this method finds patterns where connections/interactions tend to be closely related.

For example, if Beth frequently discusses “projects” and “schedules”, those interactions will cluster into the same community. If discussions about “action items” and “meetings” often overlap, they will belong to another community. It is noted that this graph data, again, is found in the database 200.

The system 100 can hence be configured to build these communities by treating entities (like Beth, projects and meetings) as nodes in a graph network; by treating connections/interactions (such as Beth managing schedules or tracking action items) as edges connecting these nodes; and by assigning higher weights to connections/interactions that are more similar or frequently occur together. In particular, edge weights can be calculated as combined similarity scores (calculated as described above) of connected entities. This clustering allows the system 100 to surface entire discussion themes rather than just isolated interactions. Depending on the configuration, the system 100 can generate graphs using only connections, only interactions, or a combined set of both edge types.

Louvain community detection assigns numerical groups, herein denoted “Community IDs”, to clusters of interactions that share common themes. These numerical identifiers allow the system 100 to recognize recurring discussion patterns and prioritize contextually relevant interactions.

By running Louvain community detection, entities are clustered naturally based on historical discussion structures rather than just semantic similarity. Historical discussion structures are identified by analyzing recurring topics, the frequency of connections/interactions between entities, and the persistence of certain themes over time. The system 100 can be configured to assign weights to these entities based on how often they co-occur, ensuring that even indirectly related entities are grouped if they share contextual relevance. While a single run of Louvain yields a single partitioning of the graph, different graph constructions (based on edge type) can produce alternative groups that emphasize distinct aspects of the graph. This can result in nodes (entities) belonging to multiple Louvain groups.

In the present example, the following computed communities can result:

| Community ID | Entity ID | Hierarchy |
|---|---|---|
| 1 | entity-beth | [1, 5] |
| 1 | entity-projects | [1, 4] |
| 2 | entity-action-items | [2, 5] |
| 2 | entity-meetings | [2, 5] |
| 3 | entity-schedules | [3, 4] |

These communities ensure that related discussions are grouped, even if individual interactions were not directly retrieved via the similarity search.

Since the Louvain grouping approach assigns communities to entities, the system 100 can be configured to assign interactions to the correct community. When an interaction belongs to multiple communities, its priority can be determined by its edge weight, which can then be a combined similarity score of the connected entities. If an interaction is strongly associated with one community over another, it will be retrieved with higher priority in that context. This ensures that when interactions span multiple topics, they are ranked appropriately within each discussion group rather than appearing equally relevant everywhere.

In general, the community detection algorithm can be configured to assign interactions and/or connections in the similar set to communities based on community assignments of the corresponding entities interconnected by the interaction and/or connection in question.

For instance, Beth is responsible for both “projects” and “schedules”. If she frequently discusses project timelines, those interactions will likely belong to the “projects” community. However, if a conversation involves both meeting deadlines and scheduling conflicts, it may be assigned to both “projects” and “schedules”. In this case, if an interaction is highly relevant to both communities, it will be surfaced equally in both. If the discussion leans more towards “projects”, it will have a higher weight in the “projects” community. If another topic surfaces where Beth discusses only “scheduling” without project-specific context, that interaction would primarily belong to the “schedules” community. This approach prevents interactions from being misplaced while allowing them to surface in the most relevant discussions.

Interactions in the present type of example primarily occur between chat-type entities and other entities. These interactions include exchanges between the “ME” entity (representing the system 100 itself) and various conversation-type entities, as well as interactions between Beth and multiple such conversation-type entities. Since these conversations often reference “schedules” and “projects”, the content field of each interaction will include those references, making them key factors in vector embeddings. For instance:

| | | | Similarity | Community |
|---|---|---|---|---|
| Interaction ID | Source ID | Target ID | Score | ID(s) |
| interaction-101 | entity-me | conversation-001 | 0.92 | 1, 4 |
| interaction-102 | entity-beth | conversation-002 | 0.89 | 1, 5 |
| interaction-103 | entity-beth | conversation-003 | 0.85 | 2, 4 |
| interaction-104 | entity-me | conversation-003 | 0.82 | 2, 4 |
| interaction-105 | entity-me | conversation-004 | 0.80 | 3, 5 |

By structuring interactions this way, the system 100 can ensure that discussions remain properly grouped while still being accessible in multiple relevant contexts where necessary. Now that both entities and interactions have been assigned to their respective Louvain communities, a final reference table can be compiled. This table, defining community assignments 515 of entities and interaction groups 516 of interactions, serves as the structured output for community detection, allowing the system 100 to retrieve and utilize these groupings efficiently during memory recall and reasoning processes:

| Entity ID | Name | Community ID(s) |
|---|---|---|
| entity-beth | Beth | 1, 4 |
| entity-projects | Projects | 1, 5 |
| entity-schedules | Schedules | 1, 4 |
| entity-meetings | Meetings | 2, 4 |
| entity-action-items | Action Items | 2, 4 |
| entity-deliverables | Deliverables | 3, 5 |

| | | | Similarity | Community |
|---|---|---|---|---|
| Interaction ID | Source ID | Target ID | Score | ID(s) |
| interaction-101 | entity-me | conversation-001 | 0.92 | 1, 5 |
| interaction-102 | entity-beth | conversation-002 | 0.89 | 1, 4 |
| interaction-103 | entity-beth | conversation-003 | 0.85 | 2, 5 |
| interaction-104 | entity-me | conversation-003 | 0.82 | 2, 4 |
| interaction-105 | entity-me | conversation-004 | 0.80 | 1, 4 |

After assigning entities and interactions to Louvain communities, the next step is to compute additional ranking metrics. These metrics are configured to go beyond similarity scores and to incorporate network structure, contextual relevance, and interaction flow to improve ranking precision.

Namely, similarity search is a powerful tool. It allows the system 100 to retrieve relevant data based on semantic meaning rather than simple keyword matching. This allows for identifying relevant past interactions, recognizing patterns, and improving recall efficiency. However, similarity alone has drawbacks for determining what information should be prioritized. By also calculating one or more additional metrics to be used for the ranking of the similar or expanded set, a number of additional benefits can be achieved:
Taking context into consideration more fully, including how entities interact over time or within different conversation structures.
More structural awareness, capturing how central an entity or interaction is in a broader network and playing down the importance of rarely referenced but semantically similar entities.
Placing the emphasis on more recent interactions.
Taking into consideration network connectivity, such as how often an entity is referenced across different conversations.

Hence, the system 100 can be configured to calculate one or more additional ranking metrics that refine memory recall by considering aspects as network structure, recency, and conversational flow in conjunction with similarity scores. Such additional ranking metrics can then be used to perform said ranking.

In some embodiments, entities can be ranked based on their importance within the community, their relevance to the free-text input, and their role in the identified interactions in the similar set.

In a first example, the ranking rule can be based on a connection or interaction count for one or more entities in the similar set and/or within the community (such as the identified Louvain community) to which the entity belongs. The connection or interaction count can be a respective number of stored connections and/or interactions in the database 200 for the entity, where the stored connections and/or interactions interconnect the entity to other entities in the similar set. Such a connection count measures the number of entities in the same Louvain community, and can be normalized, such as to a number between 0 and 1.

In a second example, the ranking rule can be based on a network centrality measure for one or more entities in the similar set, the network centrality measure being determined for the entity in relation to other items stored in the database 200. Such a network centrality measure measures how structurally important an entity is in the overall graph. Suitable centrality measures may include, for instance, Degree Centrality, PageRank, ClosenessCentrality and Betweenness (for instance provided by CozoDB), and of course any corresponding network centrality measure algorithms. In general, centrality measures look for how important a single node (entity) is within the overall network (the graph information 210).

In a third example, the ranking rule can be based on a relevance decay or recency value for one or more entities in the similar set, the relevance decay or recency value being determined based on a latest timestamp of an interaction stored in the database 200 interconnecting an entity; and/or a relevance decay or recency value for one or more connections in the similar set, being determined based on a latest timestamp of an interaction stored in the database 200 interconnecting entities being interconnected by the connection. Such a relevance decay or recency measure measures entity or connection recency based on the most recent interaction it appears in.

In a fourth example, the ranking rule can be based on a clustering coefficient for one or more entities in the similar set, the clustering coefficient being determined for the entity in relation to a detected community group to which the entity belongs. Such a clustering coefficient measures how interconnected an entity is within its local community. A higher value indicates that an entity's neighbors are also well connected to each other. Useful examples include, for instance, ClusteringCoefficient (for instance provided by CozoDB), or corresponding clustering coefficient algorithms. In general, clustering coefficient algorithms look at a node's (entity's) neighbors (connections/interactions) to see how interconnected they are.

In a fifth example, the ranking rule can be based on an entity similarity score for one or more interactions in the similar set, the entity similarity score being determined based on the respective similarity score of individual entities being interconnected by the interaction; and/or based on a respective entity similarity score for one or more connections in the similar set, in turn being determined based on the respective similarity score of individual entities being interconnected by the connection. Such an entity similarity score measures an average similarity score of the two connected entities. The ranking rule can also be based on a similarity score of the embedding of an item and the input text embedding, according to a suitable vector-based similarity measure.

In a sixth example, the ranking rule can be based on a calculated structural importance for one or more connections in the similar set, the calculated structural importance being determined for entities stored in the database 200. Such a structural importance of a connection measures how crucial a connection is in the overall entity network in the information 210. Structural Importance can be calculated directly by using one or more centrality calculations, such as DefgreeCentrality or ClosenessCentrality provided by CozoDB. It may also be calculated by using multiple weighted centrality calculations.

In a seventh example, the ranking rule can be based on a multi-community weighting for one or more interactions in the similar set, the multi-community weighting being determined based on a number of detected community groups to which the interaction belongs. Such a multi-community weighting measures whether the interaction in question spans multiple identified communities (such as Louvain communities) or not.

In an eighth example, the ranking rule can be based on a conversation flow value for one or more interactions in the similar set, the conversation flow value being determined for items stored in the database 200. Such a conversation flow detection measures whether the interaction is part of an ongoing discussion or a standalone exchange. In practice, this can be a rough measure of how well an interaction fits into an ongoing discussion, based on its proximity and relationship to nearby interactions in the same conversation. For example, if Beth sends a message and there is another message from her two minutes earlier and a reply from the system 100 one minute later, the system 100 can be configured to check for these adjacent interactions and give each one a pre-configured weight—such as 0.5 for a previous interaction and 0.5 for a next interaction. The system 100 can also be configured to check whether the same users 122 were involved and give, by way of example, an extra 0.25 weight if the source matches and another 0.25 weight if the target matches for the interactions. In this case, the total raw weight score then becomes 0.5+0.5+0.25+0.25=1.5. This number can then be normalized by dividing by the maximum possible value (in this example hardcoded as 1.5), resulting in a final flow value of 1.0. These values can be predetermined configuration values. It is also possible to apply a decay to the time between replies, meaning that previous messages are only counted if they are within the last 24 hours, as an example. Alternatively, the system 100 can be configured to only count the previous message if it was also included as part of working memory.

One particular class of additional metrics are herein denoted “dichotomies”, configured to measure various metrics in relation to items in the similar set along respective axes between opposite values for various informational dimensions. Dichotomy metrics, as is the case for the above-described additional metrics, can be normalized, such as to values between −1 and 1 to reflect a position of the item in question along the axis in question.

In a first example of such a dichotomy, the ranking rule can be based on a focus value for one or more interactions in the similar set, the focus value in turn being determined based on a number of distinct detected community groups to which all entities being interconnected by the interaction belong; a focus value for one or more entities in the similar set, being determined based on a number of distinct detected community groups to which the entity belongs; and/or a focus value for one or more connections in the similar set, being determined based on a number of distinct detected community groups to which all entities being interconnected by the connection belong.

Such a focus value measures whether the item in question is “focused” or “broad”, in other words how varied or concentrated the item is within the larger dataset of the information 210. Hence, a value of −1 (“focused”) means that the data belongs to fewer communities and has limited reach. A value of +1 (“broad”) means that the data spans multiple communities or connects disparate topics. A broad entity or interaction likely serves as a bridge between multiple topics, while a focused one is highly relevant within a specific theme. For entities, the focus value can be calculated as the number of unique communities an entity belongs to, and can be normalized. For connections, the focus value can be calculated as the number of communities shared by both connected entities, and can be normalized. For interactions, the focus value can be calculated as the number of communities the interaction source and target belong to, and can be normalized.

In a second example of said dichotomies, the ranking rule can be based on a timeliness measure, for one or more items in the similar set. The timeliness measure can be configured to measure timeliness along an axis comparing “historical” (−1) to “timely” (1). It can measure whether an item is older or more recent in relation to other items in the similar set and/or in the community group (such as the Louvain community group), so that −1 means that the item is the oldest item and 1 means that the item is the most recent item according to the relevant timestamp.

For entities, the most recent connected interaction can be used for the timestamp, since an entity itself may not change often but its relevance being maintained if it continues to be actively discussed. For connections, the most recent shared interaction between both entities can be used for the timestamp, regardless of direction, ensuring that even static relationships remain relevant if they form part of ongoing discourse.

In practice, for entities the timeliness value can be calculated as the time for the most recent timestamp of any connected interaction, and can be normalized. For connections, the timeliness value can be calculated as the time for the most recent interaction between the two connected entities, and can be normalized. For interactions, the timeliness value can be calculated as the time for the timestamp of the interaction, and can be normalized.

In a third example of said dichotomies, the ranking rule can be based on a uniqueness value for one or more items in the similar set, the uniqueness value being determined based on a similarity score of the item as compared to a calculated distribution of similarity scores of items in the similar set. Such uniqueness value measures how aligned or unique an item is within the dataset in the information 210, along the axis “consensus” (−1; the item shares strong alignment with many similar items) or “novelty” (1; the item has little similarity to most other items). The uniqueness measure is not about the number of connections or interactions, but about variance in similarity scores. If many items share the same similarity score, it is considered a well-agreed-upon topic. If an item differs significantly, it is novel. The uniqueness measure can be calculated by computing the variance of similarity scores between an item and other items, to determine how aligned or distinct the item is within the dataset in the information 210. Unlike the other ranking factors described herein, the uniqueness measures focuses on the distribution of similarity scores rather than absolute similarity.

In some embodiments, the system 100 is configured to precompile various similarity scores between items whenever a new connection or interaction is created, or whenever it is updated in the database 200 or added to the database 200. This allows the system 100 to assess novelty efficiently without having to compute all pairwise similarities at runtime. When an item has few interactions, it may still be novel if its similarity varies significantly from those of others in its category. Conversely, even frequently discussed topics can be novel if they introduce new variations or perspectives that differ from established consensus.

At an overview level, the purpose of the uniqueness measure is to measure how much “consensus” exists around each piece of information in a temporary working memory set. However, instead of comparing every item to every other item (which would be very slow), the system 100 is instead configured to investigate how similar each item is to a central reference point, like the user's 122 query or an initiating input.

Each item already has a similarity score to that input, and the system 100 can be configured to use those scores to estimate said consensus. The assumption is: if many items are similarly close to the input, they likely reflect a shared theme. If an item has a similarity score that is very different from the others, it probably represents something novel or unusual.

It is realized that two different items might have the exact same similarity score to the input but still be far apart from each other in embedding space-meaning they are equally relevant to the input, but not actually similar to each other. Therefore, this approach does lose some detail about how items relate to each other, which a full pairwise similarity matrix would capture. But this is traded off for scalability and speed, and because everything in working memory was already selected based on its relation to the input, this shortcut has been found to still give meaningful results.

To figure out which similarity scores are common, or frequently occurring, and which are rare, the system 100 can be configured to model the distribution of all similarity scores using one of two exemplary approaches: kernel density estimation or histogram bucketing. With kernel density estimation (KDE) each similarity score is treated like a bump on a graph (typically a Gaussian curve) and are added together. This achieves a smooth curve showing where similarity scores tend to cluster. If the similarity score of an item falls in a high-density area, it is assumed that this reflects consensus. If it falls in a sparse part of the curve, it is treated as novel. Histogram bucketing is simpler. The score range is simply divided into buckets, such as 10 bins, and the system 100 then counts how many items fall into each bin. An item in a full bin is considered to be common; an item in a nearly empty bin is considered to be rare. This approach is cruder than KDE but faster and good enough in many cases. In both methods, the system 100 can be configured to normalize the achieved rarity estimates, such as to a range between −1 and 1. Items in dense areas then get a consensus score close to 1 (meaning “widely aligned”), and items in sparse areas get a score closer to −1 (meaning “novel” or “fringe”). Even though this is not an exact measure, it provides a fast, scalable way to capture how typical or surprising a piece of information is, relative to the current context.

If the system 100 finds that the raw consensus estimation method (relying on similarity-to-input alone) starts to break down in certain situations, especially in the lower similarity ranges where items may be similarly distant from the input but semantically unrelated to each other, it can be configured to selectively fall back to a more accurate approach. Specifically, for the items with the lowest consensus scores that also cluster tightly around a narrow similarity band, the system 100 can be configured to extract just those items and build a smaller pairwise similarity matrix for that subset. This allows a direct measure how those items relate to each other, rather than assuming that they are related simply because they share a similar distance from the input. By doing this selectively and only for fringe or ambiguous regions, overall performance can be kept high while recovering precision in the areas where the shortcut method is most likely to introduce noise. This has been found to work well for histogram bucketing, since similarity needs to be computed only for each item within its bucket rather than for all items. The system 100 can also be configured to include overlap, for instance so that the edge items are included in multiple buckets, with their scores being averaged across the 2 buckets.

The system 100 can be configured to detect raw consensus estimation method breakdown by directly computing the similarity of two items. The results of such calculation can be stored in the database 200 for use as a cache for future queries. Over time, several such results can be used to perform triangulation to see how far two items are from a shared set of connections. Concretely, as the database 200 gets more data into it, a set of selected similarities can be calculated. Now when that information arises as part of a certain working memory, the system 100 does not have to build a full matrix, but instead only needs to build a partial matrix to a smaller number of items.

In a fourth example of said dichotomies, the ranking rule can be based on a depth value for one or more items in the similar set, the depth value being determined based on a stored context size for the item stored in the database 200. Such depth value is determined along an axis between “shallow” (−1, the item is short) and “deep” (1, the data contains significant substance and content). In practical examples, the depth value can be a simple string length, such as a length of the free-text input including or not including any metadata, for instance a string-format representation of the structured data representing the free-text input entity as exemplified above.

The system 100 can be configured to break (segment) data into smaller parts, meaning length alone may not be a reliable measure. Instead, the system 100 can be configured to track the combined content length before segmentation as a new field calculated at data ingestion. This means that the original content length can be computed and stored before segmentation to ensure consistency across different data types. This field can then be universally managed so that rankings and dichotomy calculations remain accurate and standardized across entities, connections, and interactions.

The depth value can be calculated by measuring the original content length before segmentation; computing the ratio of content length to average content length; and possibly normalizing the value to between −1 and 1.

In a fifth example of said dichotomies, the ranking rule can be based on a user significance value for one or more items in the similar set, the user significance value being determined based on a vector-based similarity measure between the item and an item representing a particular user according to a vector-based similarity measure. Such a user significance value can measure how relevant an item is to a specific user 122, or to the system 100 entity “ME”. It is realized that this is not technically a dichotomy, as it does not exist on a spectrum of opposing values: 0 means “not relevant”, 1 means “highly relevant”. The user significance value can be based on domain knowledge built around the user 122 (Beth in the present example) and/or the working memory built as described above for a currently performed task or assignment (see below). For instance, the calculation of the user significance value can comprise the steps of 1) build a domain knowledge around the user entity or entities; 2) for each piece of data in the working memory: a) if it forms part of the user domain knowledge, give it a score of 1, meaning that it is very relevant to the user; b) otherwise, calculate the similarity to each piece of data in domain knowledge, providing a max similarity, a mean similarity, and an average similarity; 3) set the user relevance score to w1*max_similarity+w2*mean_similarity, where w1 and w2 are preconfigured weights.

Any combination of the various metrics described above can be calculated and used to determine the ranking of the similar set. In particular, the various one or more metrics determined can be integrated to compute a final relevance score for each item type.

In some embodiments, the ranking rule is determined based on a weighing of one or more of said additional metrics and/or dichotomies. For instance, the ranking rule can be calculated as a weighted sum of the various additional metrics and/or dichotomies. The weighing can be different for entities, connections and/or interactions in the similar set, whereby a separate entity ranking 517, a separate connection ranking 518 and/or a separate interaction ranking 519 can be achieved. These rankings 517, 518, 519 can then be combined to achieve a final set of one or more weighting/ranking lists 520.

To effectively rank data across entities, connections and interactions, a hybrid normalized score can be implemented, for instance with dynamic scaling. Such a method can be configured to preserve basic vector similarity as the dominant factor for items, while additional metrics and dichotomies can provide structural and contextual relevance without overpowering the ranking system.

Not all metrics are equally important for each data type. Therefore, different item types and/or different contexts can be configured to result in different weights. Some metrics can also be completely left out in case their weights are determined to be below a predetermined threshold, improving computational efficiency and logical consistency in ranking.

In various embodiments, a different predetermined or parameter-driven set of weights can be used for each of the individual item types: entities, connections and/or interactions.

For instance, for entities the weights can be selected so that the ranking is primarily or entirely based on entity similarity (the primary ranking factor, ensuring alignment with the free-text input), centrality (determines network importance, surfacing well-connected entities) and recency (ensures that recently discussed entities are prioritized over stale data). An exemplifying configuration would be the following:
config_entities={“w_similarity”: 0.7, “w_centrality”: 0.2, “w_relevance_decay”: 0.1}

For connections, the weights can be selected so that the ranking is primarily or entirely based on entity similarity (ensures that strongly linked entities are prioritized) and frequency of interaction (interaction/connection count, as described above; highlights connections that are frequently referenced). An exemplifying configuration would be the following:
config_connections={“w_connection_similarity”: 0.7, “w_interaction_count”: 0.3}

For interactions, the weights can be selected so that the ranking is primarily or entirely based on interaction similarity (ensures relevant discussions are surfaced) and conversational flow (ensures that ongoing, structured discussions rank higher). An exemplifying configuration would be the following:
config_interactions={“w_interaction_similarity”: 0.8, “w_conversation_flow”: 0.2}

In some embodiments, the ranking rule can additionally or alternatively be determined using one or more LLMs 522. In particular, the system 100 can be configured to automatically produce a respective text prompt to the one or more LLMs, requesting the one or more LLMs in question to, in a respective response to the text prompt, provide information as to how to determine the ranking rule, the respective text prompt comprising information regarding the free-text input 502, such as the free-text input 502 itself and/or the metadata 503. Then, the ranking rule 523 can be determined based on the response. For instance, the LLM(s) 522 can be instructed, via said text prompt, to provide a set of weights for each of one or more of the additional metrics, these weights being used when calculating a ranking score for each item in the ranked set. The text prompt may be automatically produced by the system 100, such as based on a predetermined set of directives and/or instructions 521 (see below for a general discussion about directives).

In general, once the additional metrics have been calculated, the system 100 can be configured to determine how to order the results for memory recall using said ranking rule. There are multiple possible approaches, each with different advantages based on the detailed, situation dependent and potentially context dependent retrieval needs of the system 100.

Using predetermined weighting rules, a simple and computationally efficient method is achieved that still surfaces relevant information. However, by tailoring the weights dynamically to the current context increases precision.

Instead of only using non-dichotomy additional metrics, the system 100 can be configured to apply targeted weights to dichotomies to select results that match a desired pattern of data. For example, a search for “emerging trends” in the information 210 might favor dichotomy measures timeliness (+1) and novelty (+1). A search for “foundational knowledge” might instead favor dichotomies historical (−1) and consensus (−1). Finally, a search for “deep discussions” might favor dichotomies deep (+1) and high conversation flow (+1).

As mentioned above, an LLM 522 can be used by the system 100 to analyze the raw text input and to assign appropriate targeted weight configurations for each dichotomy. This approach allows for automated reasoning about what types of results best serve the query; on-the-fly adjustments based on user 122 intent; and more tailored recall strategies without requiring manual weight tuning. For instance, the prompt to the LLM 522 can comprise information about the various metrics and dichotomies, what they typically measure and for what situations various individual ones are useful and relevant. The LLM 522 may not be prompted to provide exact weights, but rather information (such as a list of important metrics/dichotomies) about what metrics and dichotomies to focus on, or similar. Then, step 520 can take that information into account based on predetermined rules to formulate the ranking rule.

Once the ranking rule has been finally determined, it can be used to generate the ranked set as one or more ordered lists or sets 520, each ranking results according to a different retrieval strategy. For example, one such ordered list may be ranked to prioritize timely and novel results; another such ordered list may be ranked to prioritize historical and consensus results; and a third such ordered list may be ranked to prioritize high similarity alone.

One single such ordered list 520 can be formed by interleaving results from several individual ordered lists, for instance in a round-robin fashion whereby one item at a time is selected, in ranking order, from each of the ordered lists and placed in the common ranked list. This ensures a broad but balanced selection of retrieved data.

It is noted that the various mechanisms for calculating various metrics, including dichotomies and other additional metrics, is configured to bring forth any relevant content from the information 210, including directive entities, agent entities, connections, interactions and so forth. In general, the retrieved information is not discarded even if it is not explicitly used for the memory recall in the end; instead, the system 100 can be configured to keep this information for possible later use during the process in which the flow illustrated in FIG. 5 forms a part.

The resulting ranked list(s) can be used to produce an enriched version of the free-text input 524, for instance in the form of a data structure (such as a JSON data structure) including as metadata the items identified in the ranked list(s), for further use.

In a step 525, the method ends.

As mentioned above, non-LLM NLP 131 methods can be used to automatically identify prospective items, such as entities, connections and interactions, in the free-text prompt. Similarly, one or more LLMs can be used for such automatic identification. This type of automatic identification can be used for being able to calculate a more accurate input text embedding, for instance by automatically producing a data structure (such as a JSON structure) comprising textual information representing the various identified items, so that the input text embedding can be used to identify items in the database 200 that not only are similar to the free-text input but also to other relevant information being related to the cognitive contents of the free-text input according to the information already available in the database 200. However, this type of identification can also be used for information ingestion into the database 200 based on a piece of text (such as the free-text input or any output from an agent as described in more detail further below). More particularly, the automatic identification of the items in the database 200 can be used to investigate whether the database 200 already comprises an item corresponding to an item that the piece of text relates to; to update such a corresponding item using the new information in the piece of text if the corresponding item exists; or adding a new item to the database 200 reflecting the new information in the piece of text in case the corresponding item does not exist.

Generally, the flow illustrated in FIG. 5 can be used to identify a subset of the information 210 that is related or relevant to a particular piece of information (such as the free-text input with or without any relevant contextual metadata). As mentioned above, this subset is denoted the “working memory”, and can comprise one or many pieces of domain knowledge as defined above. The working memory can then be used by the system 100 when performing tasks or assignments, for instance by inserting information regarding identified items of the subset into a text prompt to an LLM 150, 160 being used to perform the task or assignment. This will be described in detail further below. The working memory can also be used for memory ingestion, in other words the addition to the information 210 of newly accrued information in the system 100.

In particular, in the following the use of one or more LLMs will be described in more detail in the context of memory ingestion and with reference to FIGS. 6 and 7. Generally, FIG. 6 shows a flow for information interpretation, with the aim of forming a consolidated metadata structure describing relevant structured information based on a given piece of provided textual information; whereas FIG. 7 describes a way for identifying already existing information 210 in the database 200 to figure out how to efficiently inject any new information contained in the piece of provided textual information into the database 200. It is understood that the corresponding methodology can be used also for automatic identification of items and corresponding metadata as a part of, for instance, forming working memory or individual pieces of domain knowledge. Any information reaching or surfacing in the system 100 can be the subject of memory ingestion, such as any free-text input reaching the system 100 as a part of a chat or otherwise; intermediate results during internal processing by the system 100 of such a free-text input, a task or an assignment; and any result of the processing of a task or an assignment. Whereas the building of working memory is about collecting a relevant subset of the information 210, memory ingestion is about identifying entities, connections and/or interactions present or occurring in, or being inferred by, a certain available piece of information, such as the free-text input.

Although NLP 131 methods can parse text with speed and consistency, LLMs offer more nuanced interpretations. By applying LLMs to the free-text input with or without metadata—and/or to the structured output from NLP 131 processing—roles, statuses or implicit attributes can be selectively documented only in case the original text explicitly states them or if any assumptions are clearly labeled as inferences, to maintain clarity and accuracy. Domain-specific concepts, such as project milestones or specialized terminology, can be extracted. Explanatory or contextual metadata (e.g., short summaries of an entity's significance to a project) can be generated. If, for example, there is direct textual evidence that “Beth” describes herself as “Project Manager” for the “Jabberwocky Project,” the system 100 can create a connection like Beth→Works On→Jabberwocky Project, adding metadata such as {“role”: “Project Manager”}. If another statement indicates that Beth uses she/her pronouns, the system 100 can add {“pronouns”: “she/her”} to Beth's metadata. By ensuring each detail is explicitly supported by the source content, a justified, coherent knowledge graph can be preserved.

This can be achieved by programmatically chunking any raw source content (of the type generally discussed above) around one or more identified entities and/or connections. Once an entity or a connection has been identified, such as using the steps illustrated in FIG. 5 or using an LLM-based or non-LLM NLP tool 131 from the piece of information to be analyzed for ingestion, any references of such an entity or connection can be gathered and split into smaller, token-sized groups. Each group can then be processed, using an LLM 150, 160, by extracting metadata entries and providing a concise explanation linking the metadata entries back to the original text material. Because the process can be made chronological, if the attributes of an item changes within the same text, the final mention can be configured to override earlier ones. One way to decide the contents of each chunk is to take the known starts and ends of the identified entity (for instance), and then add padding around them. For instance, include the prior X number of tokens and get the X number of tokens afterwards. Since the identified item is likely part of a sentence or paragraph, it is also possible to first look for common breaks, such as a period, explanation point, question mark, and so for the, and then include the contents of the identified sentence or paragraph before adding the padding.

Turning now specifically to FIG. 6, in a first step 601 the method starts.

In a subsequent step 604, entities are detected as described above, in the free-text input 603 and/or another available piece of textual information (or text-containing data structure such as a JSON structure) 603 and/or any context information 602 that can form part of the free-text input 603 or be provided separately. The detection can be performed by a non-LLM NLP tool 131, 605 configured to automatically extract nouns 606, such as labels, from the information 602, 603 and to form dictionary entries 607 comprising the extracted nouns. In a step 608, that can be performed in parallel or in series with step 604, any connections and/or interactions in the information 602, 603 is or are correspondingly automatically extracted using a non-LLM NLP tool 609, configured to extract, for instance, verbs, objects and/or subjects 610 from the information and to form dictionary entries 611 with the extracted information. In general, any relations between items from the extracted nouns, verbs, subjects and/or objects can be identified, and the identified relations can be formulated as additional pieces of free-text relational information and/or stored as dictionary entries 611.

Alternatively or additionally, the identifying of the one or more identified items, connections and/or interactions in step 605 and/or 609 can comprise automatically producing a respective text prompt to an LLM 150, 160, requesting the LLM 150, 160 to, in a response to the text prompt, identify any items referred to in the free-text input 603, including any entities, connections between entities and/or interactions between entities. It is realized that the LLM usage in steps 605 and 609 can be combined, so that one and the same prompt requests the LLM 150, 160 to provide, as a structured data response, both entities and connections/interactions. The text prompt can, for instance, mention any entities, connections and/or interactions already identified using the non-LLM NLP tools 131 as described above.

In general, any identified (by non-LLM NLP 131 and/or LLM 150, 160 tools) relations between entities can be formulated by the system 100 as additional pieces of free-text relational information for use later in the method, for instance “Beth IS_A Project Manager”.

Then, once a set of one, two or more items have been identified in the analyzed set of text information, for each identified items in the dictionary 607, 611 steps 612-624 can be performed. Hence, steps 612-624 can be performed iteratively, once for each of the detected items.

In a step 612, a next identified item is selected, and one or more pieces of raw text associated with, such as contains or references, the selected item is identified, in a step 613. For instance, every text line or paragraph in the starting material 602, 603 that references the selected entity can be identified, and these lines/paragraphs can be compiled into a list of raw lines. In the present example, the entity representing Beth is selected as the first item. In case “Beth” appears in multiple chat logs or document sections, those references can be merged in chronological order in a subsequent step 614.

In general, the raw text can be identified as one or more additional pieces of free-text information, the additional pieces of free-text information possibly preceding the free-text input, such as in a coherent flow of information, for instance a chat. The one or more additional pieces of free-text information can then be identified to relate or refer to one and the same item, such as “Beth”. Since steps 612-624 are performed iteratively, such a set of one or more additional pieces of free-text information can be identified, using non-LLM NLP tools 131, for each of the identified items.

In some situations, the total amount of text mentioning Beth can exceed a preconfigured token limit for an LLM 616 to be used for producing metadata 618. To keep each prompt under this limit, the content can be split into chunks, that in turn can be overlapping ensuring enough context is preserved on both ends of each segment (chunk).

By way of example, it is assumed that the following lines have been identified referencing Beth: 1) Beth: “Hello, my name is Beth, and I am the Project Manager for the Jabberwocky Project. I prefer she/her pronouns.”; 2) Beth: “I was in finance before I moved to product last month.”; and 3) Beth: “By the way, I'm also a vegetarian.” It is particularly noted that the non-LLM NLP tool 131 here, together with logic knowing that the chat message comes from user Beth (based on the fact that the computer belongs to Beth), identified that “I” referred to “Beth”, something that is an example of what can be within the capacity of standard non-LLM NLP tools 131.

In practice, text segments can be much longer, and any of the identified segments may exceed a current token budget. The token budget may have to be determined dynamically, for instance taking into consideration instructions or formatting to be inserted into the text prompt of the LLM 616 and so forth. For example, if the LLM 616 model has a limit of 8096 tokens and a text prompt without the text segment takes 1000 tokens, there are roughly 7096 tokens available for source content. By dynamically measuring the text prompt length, a chunk size can be adapted accordingly to maximize the amount of content that can be processed in each LLM 616 request while ensuring the token limit of the used LLM 616 is never exceeded. The following is an example pseudocode for overlapping splits, producing chunked raw pieces of text in step 615:

raw_lines = [ “Beth: Hello, my name is Beth, and I am the Project Manager...”, “Beth:
I was in finance before...”, # Potentially many more lines referencing Beth ];
MAX_TOKENS = 1000; OVERLAP = 100; chunks = [ ]; current_chunk = [ ];
current_count = 0;
for line in raw_lines: { line_token_count = approximate_token_count(line); if
current_count + line_token_count > MAX_TOKENS: { # finalize this chunk;
chunks.append(current_chunk); current_chunk = [line] ; current_count =
line_token_count; } else: { current_chunk.append(line); current_count +=
line_token_count; }
# wrap up last chunk if needed; if current_chunk: { chunks.append(current_chunk); }
# next, transform each chunk into tokens and overlap if needed; final_chunks = [ ]; for
i, chunk_lines in enumerate(chunks): { # convert chunk_lines to tokens;
chunk_tokens = lines_to_token_array(chunk_lines); if i > 0: { # overlap logic here by
merging tokens from the previous chunk; chunk_tokens =
overlap_tokens(final_chunks[-1], chunk_tokens, OVERLAP); }
final_chunks.append(chunk_tokens); }
# result is a set of final_chunks, each safe to feed the LM

The overlap_tokens function might take the last OVERLAP tokens from the end of final_chunks[−1] and prepend them to the current chunk. This helps preserve continuity near boundaries.

After chunking, the final structured content for Beth might look like this: Chunk 1: “Beth: Hello, my name is Beth, and I am the Project Manager for the Jabberwocky Project. I prefer she/her pronouns. I was in finance before I moved to product last month.”. Chunk 2: “I was in finance before I moved to product last month. Beth: By the way, I'm also a vegetarian. Recently, I started a new initiative within my department to improve AI automation workflows.” Chunk 3: “Recently, I started a new initiative within my department to improve AI automation workflows. Beth has been working closely with the data science team to integrate real-time analytics into project planning.”

This illustrates how overlapping text ensures continuity. The phrase “I was in finance before I moved to product last month” appears at the end of chunk 1 and is repeated at the beginning of chunk 2. Similarly, “Recently, I started a new initiative within my department to improve AI automation workflows” is repeated between chunks 2 and 3. This guarantees that when these chunks are processed separately, key contextual elements are not lost, allowing the LLM 150, 160 to maintain a clear, uninterrupted understanding of Beth's activities and attributes.

In general, the method can comprise dividing the additional pieces of free-text information into two or more text chunks having mutual text overlap, and producing a text prompt to the LLM 150, 160 so as to comprise the two or more text chunks, such as in chronological order.

Hence, the chunks generated as described above can now be fed to a first pass using one or more LLMs 616. Each chunk can then be added chronologically to a text prompt in turn intended for provision to the LLM 616 until a current token limit is reached. If a chunk is particularly large, it will need to be processed on its own, while smaller chunks (especially those originating from different parts of the text source) can potentially be processed together in the same LLM 616 prompt.

The text prompt can be produced to specifically instruct the LLM 616 to identify any pieces of conflicting information regarding identified items, and to disregard any of the pieces of conflicting information being chronologically before another one of the pieces of conflicting information regarding the same information conflict.

The system 100 can be configured to determine that the two or more text chunks do not fit in the available context window of the used LLM(s) 616, and as a result produce two or more text prompts, wherein each of the two or more text prompts comprises a unique subset of the text chunks. Then, the system 100 can be configured to merge each of a set of respective responses from the LLM(s) 616, into a single piece of consolidated metadata (see below).

Using the chunked content from the previous step 615, an LLM 616 prompt can now be automatically constructed according to the following example:

Entity: Beth. Below are content chunks containing references to Beth: Chunk 1: “Beth: Hello, my name is Beth, and I am the Project Manager for the Jabberwocky Project. I prefer she/her pronouns. I was in finance before I moved to product last month.” Chunk 2: “I was in finance before I moved to product last month. Beth: By the way, I'm also a vegetarian. Recently, I started a new initiative within my department to improve AI automation workflows.” Chunk 3: “Recently, I started a new initiative within my department to improve AI automation workflows. Beth has been working closely with the data science team to integrate real-time analytics into project planning.” Please extract any metadata about Beth from these statements. For each piece of metadata, specify which snippet you used as evidence. Output JSON with fields “metadata” and “summary.” The “metadata” field should be a JSON object of key-value pairs. The “summary” field should be a brief textual note. If a metadata entry spans multiple chunks, reference all relevant chunks in the explanation.

The LLM 616 is provided with this prompt. The automatic construction of the text prompt can also be based on directives and/or instructions (such as the prompt template) 617 provided by the system 100 as will be explained in detail below. The LLM 616 processes the text prompt and then processes these chunks and returns the following exemplary structured response:

{ “metadata”: { “role”: “Project Manager”, “pronouns”: “she/her”,
“previous_department”: “finance”, “diet”: “vegetarian” }, “summary”: “Beth states
she is the Project Manager for Jabberwocky and uses she/her pronouns. She
mentions transitioning from finance last month and later states that she is a
vegetarian.” }

In general, the system 100 can be configured to produce the text prompt to request the LLM 616 to, in response to the text prompt, identify any items, and/or any metadata regarding such items, referred to in a concatenation of one or more of the additional pieces of information, the additional pieces of information also possibly (or at least in one of the text prompts) being concatenated with (part or all of) the free-text input. Moreover, the system 100 can be configured to produce the text prompt based on, such as comprising or referring to, one or more of the extracted nouns, verbs, subjects and/or objects, in this example “Beth”, and to be instructive to the LLM 616 to extract any information regarding the extracted nouns, verbs, subjects and/or objects that is inferred by the free-text input and/or in the identified additional pieces of information.

If multiple small chunks are included in a single prompt, the LLM 616 will process them together (the system 100 is configured to place them in one and the same text prompt), maintaining continuity across references. However, if a chunk is too large to fit within the remaining token budget, it will be sent as a standalone request. Each response is stored separately and later merged in the next step to create a consolidated entity profile.

Once the first pass of metadata extraction is complete, there will possibly be multiple sets of metadata and summaries. To achieve a single consolidated metadata object, these outputs can be merged iteratively, in step 619. This process can mirror the approach described above, of handling large amounts of text, but instead of chunking source content, extracted metadata and summaries can now instead be chunked. The goal is to iteratively refine and merge metadata through multiple LLM processing steps until a final, as complete as possible, metadata representation of Beth is achieved. Generally, the merging can comprise automatically producing a respective text prompt to an LLM 621, requesting the LLM 621 to, in a respective response to the text prompt and based on the one or more responses from the LLM 616, produce a single piece of response data in the form of merged metadata.

If the combined metadata and summaries exceed applicable token limits, another pass can be performed, consolidating smaller sets into progressively more complete ones. This process can then continue (e.g., second pass on first pass results, third pass on second pass results, and so forth) until a single unified set of metadata is reached for Beth. At this point, the metadata is a full representation of the item in question (the identified entity Beth) provided whatever text-form information 602, 603 the process started to analyze.

Hence, in a possible step 620 corresponding to step 615, the metadata is chunked and processed using one or more LLMs 621 that can be the same or different LLMs 150, 160 as the LLMs 616 possibly using directives/instructions 622 to automatically produce the relevant prompts. The output from the LLM or LLMs 621 is metadata 623 forming or used to produce the consolidated metadata 624.

As an example of such a second LLM processing pass (merging first-pass outputs), after processing the source chunks in the first pass, the system 100 has constructed partial metadata objects based on the available information like this:

Result 1: { “metadata”: { “role”: “Project Manager”, “pronouns”: “she/her”,
“previous_department”: “finance” }, “summary”: “Beth is a Project Manager who
previously worked in finance. She identifies with she/her pronouns and has
transitioned into a leadership role within the Jabberwocky Project.” }
Result 2: { “metadata”: { “diet”: “vegetarian” }, “summary”: “Beth is a vegetarian,
maintaining a diet that aligns with her personal lifestyle choices.” }
Result 3: { “metadata”: { “previous_role”: “intern” }, “summary”: “Beth has progressed
from an intern role in finance to a full-time position, demonstrating career growth
within her organization.” }

Now, the system 100 needs to merge these pieces of metadata into a single, more complete metadata object. The LLM 621 prompt for this second pass would look something like the following (it is understood that the instructions in practice, in particular regarding the output format, would likely be more specific):

Entity: Beth. We have extracted multiple sets of metadata about Beth. Below are the partial
metadata objects: 1) {“metadata”: {“role”: “Project Manager”, “pronouns”: “she/her”,
“previous_department”: “finance”}} 2) {“metadata”: {“diet”: “vegetarian”}} 3) {“metadata”:
{“previous_role”: “intern”}}. Please merge these into a single JSON object with all relevant
metadata combined. If fields conflict, prefer the most recent statement. Output the final
metadata object and a concise summary (maximum two paragraphs).

The output from the LLM may look like this:

{ “metadata”: { “role”: “Project Manager”, “pronouns”: “she/her”,
“previous_department”: “finance”, “diet”: “vegetarian”, “previous_role”: “intern” },
“summary”: “Beth is a Project Manager with a background in finance. She identifies
with she/her pronouns and follows a vegetarian diet. Her career progression includes
transitioning from an intern role to a full-time position before taking on leadership
responsibilities.” }

If the combined metadata and summaries still exceed current token limits, the process can be repeated in a third pass of the corresponding type, consolidating sets further until all information fits within a single LLM prompt. Each pass reduces redundancy while ensuring no important details are lost.

By the final iteration, a fully unified metadata object is achieved for the entity representing Beth. This information can then be inserted into the knowledge graph formed by the information 210 in the database 200 (information ingestion). Historical data can be configured to remain accessible, such as via CozoDB's validity records, ensuring all previous states of the entity representing Beth and related metadata can be retrieved if needed. Some of the nuance of changed data within a single conversation can be lost; for instance it can be seen that Beth's diet is vegetarian whereas the fact that it used to be Keto is lost, at least as it pertains to Beth's metadata record. The raw content is still stored in the information 210, however, so the system 100 can dive in deeper in the information 210 to find this if need be later.

In a subsequent step 625, the method shown in FIG. 6 ends.

FIG. 7 illustrates method steps for injecting information into the database 200 so as to form part of the information 210. Again, these method steps can be used to inject any type of information into the database 200, including information received by the system 100 as well as intermediate and finalized information internally produced by the system 100, such as in response to an identified task or assignment. Generally, any information accruing in or in relation to the system 100 will be stored in the database 200 to form part of the information 210 for potential later use.

In a first step 701, the method starts.

In a subsequent step 704, an information interpretation of the text 703 (the free-text input) and/or context 702 (metadata) can take place according to the flow illustrated in FIG. 6 and described above.

Alternatively or additionally, an information enrichment/memory recall 706 can take place of the text 703 and/or context 702 according to the flow illustrated in FIG. 5 and described above.

In the case of the information interpretation step 704, the result is the consolidated metadata 705, corresponding to box 624 in FIG. 6. This final metadata representation of Beth, based on the new content 702/703, can now be consolidated with any prior information we already have in the information 210 of the database 200.

In case a similarity search and relevance ranking was performed as described above, according to the flow shown in FIG. 5, the similar set or the ranked set is available to the system 100 at this point. However, if the process illustrated in FIG. 6 has been performed, new metadata has been extracted regarding a set of one or more items. Then, the goal is to determine whether each of the final metadata objects (such as the metadata regarding the entity representing Beth described above) corresponds to an already known entity in the information 210, or if it should be considered a new entry. Correspondingly, in case only an information enrichment process has taken place, according to the flow of FIG. 5 and resulting in a domain knowledge about a certain item, the goal can be to update the information 210 with respect to the certain item.

Performing a similarity search directly on metadata alone can be less reliable in some situations. Unlike raw textual similarity, metadata similarity searches are more prone to false positives because structured metadata may share common fields without actually referring to the same entity. For example, many employees may share the role “Project Manager” or the department “Finance.” If the system 100 relies only on metadata based similarity measures, the metadata of Beth may incorrectly match with the entity representing a different project manager who simply happens to have overlapping attributes.

To mitigate this issue, a hybrid approach can be employed that prioritizes previously retrieved data while incorporating targeted similarity searches and LLM-based verification. Hence, in a subsequent step 708, the next entity in the consolidated metadata 705 is selected. Then, steps 709-724 can be performed iteratively, for each item that may be found in the consolidated metadata 705 (if the flow according to FIG. 6 was used).

In case the flow of FIG. 5 was also used, similarity search and relevance ranking has already been performed during memory recall, and it is highly likely that if a prior item exists in the database 200 it was surfaced during that step. Instead of searching the entire database 200 again, the system 100 can then be configured to limit any queries and similarity searches to the subset of items represented by the similar set or the ranked set (above), significantly reducing the likelihood of false positives while ensuring that relevant information remains accessible. In general, a free-text part of the next item is embedded 709, possibly together with the metadata found in the flow of FIG. 6. For instance, a data structure (such as JSON) of the metadata for the next item can be embedded as it is. In particular, the above-discussed additional pieces of information and/or the additional pieces of free-text relational information, can be used to calculate the embedding. In practice, the embedding can be calculated by forming a single string or text-based data structure comprising the relevant information and embedding that string or data structure. In case the flow of FIG. 6 was not used, but only the flow of FIG. 5, the embedding in step 709 can be based on the domain knowledge, such as a data structure comprising the item for which the domain knowledge was constructed together with one or more of the items identified as part of the domain knowledge, and possibly also any relevant metadata extracted for such items from the database 200.

Then, a similarity search 710 can be performed of the information 210, either searching the entire database 200 or only the similar/ranked set. The similarity search compares embeddings of the information 210 to the embedding from step 709, using a vector-based similarity measure. This results in a set of zero, one or more identified similar items 711 (a set of potentially matching items 711), identified based on the vector-based similarity measure.

Further generally, the similarity search 710 can be performed on all entities, connections and interactions in the relevant dataset. In case the flow of FIG. 6 was used, the embedding of the next item can be configured to reflect the current full understanding by the system 100, given the ingoing information 701, 702, in the example used above of what “Beth” is. It is noted that the embedding does not provide any justification for why certain information was added to the consolidated metadata or not. The corresponding is true in case only the flow of FIG. 5 was used.

To enhance accuracy, the system 100 can be configured to, in this similarity search 710, only add items being more similar than a certain threshold value, or only a top number of items from each category (entities, connections and interactions) to the identified similar items 711. To the similar items 711 can also be added linked entities retrieved by the system 100 from identified similar connections and/or interactions connecting to such items. The metadata alone may not always provide enough information, why the latter may be useful depending on the detailed use case. A direct entity match based purely on metadata might not account for structural relationships between identified similar entities. By incorporating connections and interactions, the LLM 713 (see below) is provided with more context when evaluating whether Beth aligns with an existing entity or should be considered a new addition. Hence, in a step 712 graph information available via the identified similar items 711 can be added, such as adding items interconnected via identified similar connections/interactions (as described above); adding connections and/or interactions interconnecting identified similar entities; and so forth.

In a subsequent step 713, a map between the next item of the consolidated metadata 705 and the identified similar items 711 is evaluated. This step can be performed using LLM 714 as will be described in the following.

Concretely, at this point the system 100 has gathered the identified similar items 711 as a set of top candidates for a match to the next item selected in step 708. These top candidates can then be provided, as part of a text prompt also containing the metadata constructed in relation to the next item (such as the metadata structure of the item representing Beth) to the LLM 714, the text prompt requesting the LLM 714 to decide whether the metadata should be merged with an existing one of the identified similar items 711 or if an additional entity item should be created in the database 200. Alternatively, the text prompt may request the LLM 714 to provide information regarding if the metadata corresponds to an existing item in the database 200 or not, or similar. This allows the LLM 714 to use a reasoning-based approach beyond just numerical similarity scores.

In general, each of the identified items (for which the process of FIG. 5 and/or FIG. 6 produced the domain knowledge or the consolidated metadata) can be mapped, by the LLM 714 using a suitable automatically produced prompt, to one or zero corresponding stored items in the database 200.

The following is an example of such a text prompt to the LLM 714:

Entity: Beth. Newly Extracted Metadata: { “metadata”: { “role”: “Project Manager”,
“pronouns”: “she/her”, “diet”: “vegetarian”, “previous_department”: “finance”,
“previous_role”: “intern” }, “summary”: “Beth is a Project Manager with a background in
finance. She identifies with she/her pronouns and follows a vegetarian diet. Her career
progression includes transitioning from an intern role to a full-time position before taking
on leadership responsibilities.” } Potential Existing Matches: 1) { “id”: “entry-001”,
“metadata”: { “name”: “Bethany Smith”, “role”: “Team Lead”, “department”: “Finance” },
“connections”: [“Works On → AI Initiative”, “Reports To → John Doe”], “similarity_score”:
0.78 } 2) { “id”: “entry-002”, “metadata”: { “name”: “Elizabeth Brown”, “role”: “Project
Manager”, “department”: “Marketing” }, “connections”: [“Works On → Marketing
Analytics”], “similarity_score”: 0.82 } 3) { “id”: “entry-003”, “metadata”: { “name”: “Beth
Rogers”, “role”: “Project Manager”, “department”: “Finance” }, “connections”: [“Works On
→ Jabberwocky Project”, “Manages → Team 7”], “similarity_score”: 0.95 } Please determine
if Beth's metadata corresponds to an existing entity or should be considered a new entry. If
a match is found, merge the metadata. Otherwise, output a new entity record. Output JSON
Format: { “match_id”: “<existing_entity_id>” or null, “merged_metadata”: { ... },
“justification”: “<brief reasoning>” }

As noted, the text prompt can comprise or be produced based on (such as including information from) the item being processed and/or metadata regarding the item (such as the consolidated metadata 624), including information regarding the item itself and any known metadata information providing context to the LLM 714. The text prompt can also be produced to include a request to the LLM 714 to respond with the desired information regarding the item in relation to the set of identified similar items 711. For each of the identified similar items 711, any of the information stored in the database 200 in relation to that item can be used, including any relevant metadata. In concrete embodiments, a respective data structure representing each of the similar items 711 can simply be serialized and put directly into the text prompt.

In general, the text prompt can be constructed to request the LLM 714 to determine a most probable matching one of the potentially matching items, the text prompt comprising or referring to information regarding the set of potentially matching items. Further generally, and as mentioned above, the text prompt can further comprise or refer to any of the stored items having graph associations in the database 200 with each of the respective potentially matching items.

The LLM 714 might reply along the following lines:

{ “match_id”: “entry-003”, “merged_metadata”: { “role”: “Project Manager”,
“pronouns”: “she/her”, “diet”: “vegetarian”, “previous_department”: “finance”,
“previous_role”: “intern” }, “justification”: “Beth's metadata closely matches Beth
Rogers, who is also a Project Manager in Finance and works on the Jabberwocky
Project. Despite minor differences in job responsibilities, these records most likely
refer to the same person, so metadata should be merged.” }

In this case, the LLM 714 confirms, in step 718, that Beth's data aligns with the already-existing entity representing Beth Rogers, and the system 100 can therefore automatically decide to merge the two entities (update existing item, step 719). If no strong match were found (the LLM 714 confirms that no strong match was found, in step 716), “Beth” would be treated as a new entity in the knowledge graph and added to the database 200 in step 717. The text prompt to the LLM 714 can be automatically constructed as described above, using any relevant directives and/or instructions 715.

More generally, for each of one or more of the identified items in the dictionary 611, or for each of a set of one or more items for which a domain knowledge has been constructed according to the flow of FIG. 5, the item in question can be mapped, by the LLM 714, to zero or one of the items stored in the database 200. As mentioned, this mapping can be performed for instance by the LLM 714 being instructed to compare information relating to the item to a set of other items, such as the set of similar items 711, that in turn may be selected using a vector search among an available set of the similar or ranked items from FIG. 5. The response from the LLM 714 can be configured (via the text prompt) to indicate the most probable matching item among the provided items.

In case the item is mapped to (exactly) one corresponding stored item (step 718), the metadata relating to the corresponding stored item in the database 200 can be updated, in a step 719, using available metadata relating to the identified item, such as the consolidated metadata 624 for the item in question. In general, the response from the LLM 714 to the text prompt then indicates a most probable one among the potentially matching items in the database 200, and the system 100 can then be configured to update the most probable matching item with metadata regarding the identified item. This will be described more in detail below.

If, on the other hand, the item is mapped to zero corresponding stored items (step 716), the identified item can instead be added, in a step 717, to the information 210 stored in the database 200. In general, the response from the LLM 714 to the text prompt then indicates the absence of a most probable matching item among the potentially matching items in the database 200, and the system 100 can then be configured to add the item in question as a new item to the database 200.

As an example of the case no existing item is identified, in step 716, the phrase “adaptive AI” is considered, appearing in a transcript processed by the system 100. Unlike the entity “Beth”, which refers to a person who may already have an entry, “adaptive AI” represents a potentially new concept entity that needs to be added to the memory system.

Extracted consolidated metadata 624: {“metadata”: {“concept”: “adaptive AI”, “category”: “AI Methodology”, “related_terms”: [“machine learning”, “self-improving algorithms”]}, “summary”: “Adaptive AI refers to AI systems capable of modifying their behavior dynamically based on new inputs without explicit reprogramming.”} A similarity search is performed, on entities, connections and interactions in the working memory/domain knowledge produced in the flow according to FIG. 5 and/or FIG. 6. This ensures that the system 100 is not only looking for direct metadata matches but also searches for relevant relationships that might connect this concept to existing entities. The top search results might look like this:

Entities: 1) { “id”: “concept-001”, “metadata”: { “concept”: “Self-Learning Al”,
“category”: “Al Methodology”, “related_terms”: [“machine learning”, “unsupervised
learning”] }, “similarity_score”: 0.67 } 2) { id”: “concept-002”, “metadata”: { “concept”:
“Neural Architecture Search”, “category”: “Al Methodology”, “related_terms”:
[“automated model selection”, “deep learning optimization”] }, “similarity_score”:
0.45 }
Connections: 1) { “id”: “connection-034”, “type”: “Enhances”, “source”: “Self-
Learning Al”, “target”: “Al Research Lab” } 2) { “id”: “connection-078”, “type”:
“Utilized By”, “source”: “Neural Architecture Search”, “target”: “Automated Model
Optimization” }
Interactions: 1) { “id”: “interaction-112”, “type”: “Tested In”, “source”: “Al Research
Group”, “target”: “Self-Learning Al Experiment” }

This information is passed to the LLM 714 to verify whether “adaptive AI” corresponds to an existing concept or should be inserted as a new entry. The text prompt can look like this:

Concept: Adaptive AI. Extracted Metadata: { “metadata”: { “concept”: “adaptive AI”,
“category”: “AI Methodology”, “related_terms”: [“machine learning”, “self-improving
algorithms”] }, “summary”: “Adaptive AI refers to AI systems capable of modifying their
behavior dynamically based on new inputs without explicit reprogramming.” } Potential
Matches:
Entities: 1) {“id”: “concept-001”, “metadata”: {“concept”: “Self-Learning AI”}} 2) {“id”:
“concept-002”, “metadata”: {“concept”: “Neural Architecture Search”}} Connections: 1)
{“id”: “connection-034”, “type”: “Enhances”, “source”: “Self-Learning AI”} 2) {“id”:
“connection-078”, “type”: “Utilized By”, “source”: “Neural Architecture Search”}
Interactions: 1) {“id”: “interaction-112”, “type”: “Tested In”, “source”: “AI Research Group”}
Does “adaptive AI” refer to an existing entity, or should it be treated as a new concept? If it
should be merged, provide an updated metadata object. Follow the following JSON Structure
in your output: {“already_exists”:{“type”:“bool”,“description”:“Does this entity already
exists in your supplied information
above.”},“associated_id”:{“type”:“string”,“description”:“If this entity already exists, put the
existing ID in this field. Leave empty if not.”},“complete_metadata”:{“type”:
“object”,“description”:“The full metadata object that will be used for this entity. Make sure
to include prior data that does not conflict with new information.”}}”

The LLM 714 may provide the following output:

{ “match_id”: null, “new_entity”: { “metadata”: { “concept”: “adaptive Al″, “category”:
“Al Methodology”, “related_terms”: [“machine learning”, “self-improving
algorithms”] }, “summary”: “Adaptive Al refers to Al systems capable of modifying
their behavior dynamically based on new inputs without explicit reprogramming.” },
“justification”: “The closest existing match, ‘Self-Learning Al,’ describes a general Al
ability to improve, but ‘Adaptive Al’ specifically refers to real-time adjustments
without retraining. Additionally, no relevant connections or interactions suggest that
‘adaptive Al’ has been referenced before. Therefore, ‘Adaptive Al’ should be treated
as a new concept.” }

Since no strong match is found by the LLM 714, “Adaptive AI” is now created as a new concept entity in the database 200, ensuring that it can be referenced in future interactions and connected to related concepts as more information becomes available in the system 100.

In the case of step 718, where the LLM 714 identifies an already existing item in the database 200, the available information related to the processed item can be merged into the existing item so as to update the latter. In general, the updating of the identified most probable matching item can comprise automatically producing a text prompt to an LLM 721, potentially based on directives/instructions 722, requesting the LLM 721 to, in a response to the text prompt, provide a merged set of metadata for the most probable matching item, the text prompt comprising or referring to metadata both for the identified/processed item and the most probable matching item. Then, the system 100 can be configured to associate the most probable matching item with the produced merged metadata. This can, for instance, take place by storing the merged metadata as, or as part of, an updated or new version of the already existing most probable item in the database 200, such as with an updated timestamp. In other words, the text prompt can be produced to request the LLM 721 to produce an updated metadata structure as a part of the affirming that a particular item is a likely match, so that the LLM 721 only has to be called once.

For this step, the system 100 can be configured to follow a process similar to the previous examples, but start with Beth's preexisting record (the identified most probable entity). In many cases, the information 210 may already contain data about a certain item, and new information may confirm, alter, or expand that data. In the specific case of CozoDB, using validity records, each attribute update will automatically increment the version for the item, preserving a historical trail if prior information needs to be referenced. In other cases, an explicit additional version can be created, as the case may be.

Below is an illustration of how the updated data on the Beth entity can be consolidated:

Existing Beth object (before new conversation): {“metadata”: {“role”: “Project Manager”, “pronouns”: “she/her”, “diet”: “keto”, “team”: “AI Research”, “achievements”: [“Once climbed Mount Fuji.”]}, “summary”: “Beth is a Project Manager on the AI Research team, uses she/her pronouns, follows a keto diet, and previously climbed Mount Fuji.”}

In this example, the system 100 receives a new transcript or user statement indicating that Beth has changed her diet to vegetarian, and revealing other updates not captured in the old record. The system 100 is configured to then prompt, in a step 720, the LLM 721 to produce a merged, comprehensive set of metadata that reflects both the old content and newly discovered details.

The text prompt can look like this (slightly simplified for reasons of brevity):

Entity: Beth. We have the following existing metadata: { “metadata”: { “role”: “Project
Manager”, “pronouns”: “she/her”, “diet”: “keto”, “team”: “AI Research”, “achievements”:
[“Once climbed Mount Fuji.”] }, “summary”: “ ... ” } Newly Discovered Metadata: {
“metadata”: { “diet”: “vegetarian”, “previous_department”: “finance”, “previous_role”:
“intern” }, “summary”: “Beth mentions she switched from finance and changed her diet to
vegetarian.” } Please consolidate these into a single JSON object. If any information conflicts
(e.g., keto vs. vegetarian), keep only the most recent statement. Include a final summary of
all relevant details.

The finally merged item metadata 723 can be like the following response from the LLM 721:

{ “metadata”: { “role”: “Project Manager”, “pronouns”: “she/her”, “diet”: “vegetarian”,
“team”: “Al Research”, “achievements”: [“Once climbed Mount Fuji.”]
“previous_department”: “finance”, “previous_role”: “intern” }, “summary”: “Beth,
who now follows a vegetarian diet, is a Project Manager using she/her pronouns. She
was formerly part of finance, currently works in Al Research, and once climbed Mount
Fuji.” }

This metadata structure 723 can then constitute the new structure for the updating 724 of the existing item in the database 200. It is noted that the “diet” field has been updated from “keto” to “vegetarian.” Because the system 100 is configured to assume that the new statement is the most recent, it supersedes the older data while retaining anything not contradicted by the updated text. If these changes had to be tracked historically by the system 100, each attribute update would produce a new version, such as CozoDB Validity record with an incremented version, showing a respective updated timestamp.

In a subsequent step 725, the method according to FIG. 7 ends.

In another example, the system 100 has completed its initial system initialization and begins the process of getting to know its user—in this case a person 122 named Strider Agostinelli. In the example, the system 100 accomplishes this through natural conversation with the user 122, learning about the user's various life contexts, roles, and interests gradually rather than through rigid questioning or forms.

The system 100 begins by ensuring the necessary agents are in place. Among other things, two agent tools are initialized: the MemoryExtraction agent tool and the ChatProcessing agent tool. The MemoryExtraction agent tool is responsible for identifying and categorizing information learned about the user, while the ChatProcessing agent tool manages the flow of conversation and ensures natural, engaging dialogue. These agents work in tandem to gather and process user information effectively.

A foundational concept of “New user onboarding” is established and added to the information 210 in the database 200. This concept carries directives that guide how the ChatProcessing agent tool is to interact with new users, including guidelines for maintaining conversational tone and goals for gathering specific types of information. This framework ensures consistency in the onboarding process while allowing for natural, adaptive conversation flow.

The following entities (System Learning concept, Assignments concept, Chats concept and InitialAssignmentAssessor agent tool) are also created:

{ “id”: “concept-006”, “type”: “concept”, “name”: “LiveArena Networks: System
Learning”, “description”: “Guidelines and goals for system learning interactions”,
“updated_at”: 1705881600, “metadata”: { }, “embedding”: [0.1, 0.2, . . . ],
“non_embedded”: { } }
{ “id”: “concept-007”, “type”: “concept”, “name”: “Assignments”, “description”:
“Tasks that the system needs to complete”, “updated_at”: 1705881600, “metadata”:
{ }, “embedding”: [0.1, 0.2, . . . ], “non_embedded”: { } }
{ “id”: “concept-008”, “type”: “concept”, “name”: “Chats”, “description”: “All chat
interactions within the system”, “updated_at”: 1705881600, “metadata”: { },
“embedding”: [0.1, 0.2, . . . ], “non_embedded”: { } }
{ “id”: “agent-004”, “type”: “_agent”, “name”: “Initial Assignment Assessor”,
“description”: “Generates a full Assignment object based on the context of the
interaction”, “updated_at”: 1708164000, “metadata”: { “connector_name”: “claude”,
“connector_config”: { “model”: “claude-3-sonnet”, “temperature”: 0.7 },
“system_message”: “You are a specialized Initial Assignment Assessor responsible
for generating full Assignment objects based on provided context.”, “role”:
“Assignment Generator”, “responsibility”: “Analyze context and generate complete
Assignment objects”, “additional_rules”: [ “Examine all provided context carefully to
generate accurate assignments”, “Ensure all necessary fields are populated”, “Follow
provided guidelines and goals for assignment creation” ] }, “embedding”: [0.1, 0.2,
. . . ], “non_embedded”: { } }

The system 100 creates a dedicated chat space for the onboarding process. This involves setting up various data structures to track the conversation, including the chat entity itself and its connections to both the system 100 and the user 122. Initially, the user 122 is represented by an “Unknown User” entity, which will be updated as more information is learned during the conversation.

As the conversation progresses, each interaction triggers a processing pipeline for processing each free-text input. User messages are first handled by the ChatProcessing agent tool for immediate response, then analyzed by the MemoryExtraction agent tool to identify and store important information about the user 122. This dual-processing approach ensures both engaging real-time conversation and thorough information capture.

Throughout the onboarding process, the system 100 continuously updates its understanding of the user. The MemoryExtraction agent tool identifies entities and connections from the conversation, which are then integrated into the database 200 (the system's 100 knowledge graph). This creates a rich, interconnected representation of the user's 122 identity, roles, and relationships that can be leveraged in future interactions.

First, both the chat space and the guidelines for how the conversation should proceed are set up by the system 100, involving several interconnected pieces (MemoryExtraction agent tool, ChatProcessing agent tool, user onboarding concept) that work together to enable a natural, engaging onboarding experience, defined in JSON according to the following:

{ “id”: “agent-003”, “type”: “_agent”, “name”: “Memory Extraction Agent”,
“description”: “Identifies and extracts entities and connections from any given text”,
“updated_at”: 1708164000, “metadata”: { “connector_name”: “claude”,
“connector_config”: { “model”: “claude-3-sonnet”, “temperature”: 0.7 },
“system_message”: “You are a specialized Memory Extraction Agent responsible for
identifying entities and connections from provided text. Your goal is to build a
structured memory representation from unstructured data.”, “role”: “Memory
Extractor”, “responsibility”: “Analyze text input to identify and extract relevant
entities and connections”, “additional_rules”: [ “Examine all provided text carefully
to identify potential entities and connections”, “Create new entity and connection
types as needed to accurately represent the information”, “If an existing entity or
connection is provided for reference, include all its details in your extraction to avoid
data loss”, “Only exclude objectively invalid or irrelevant data from extractions”,
“Provide complete information for each extracted entity and connection”, “Use the
provided definitions and examples as a guide, but feel free to extend them as required
by the input text”, “Aim for high recall - it's better to overextract than to miss
potentially important information” ], “additional_blocks”: [ { “name”:
“ENTITY_DEFINITION”, “content”: “An entity is a person, place, thing, concept or
event that is mentioned in the text. Entities can be real or fictional, concrete or
abstract. Each entity should have a name, short description, a type, and optional
metadata.” },{ “name”: “ENTITY_TYPES”, “content”: “Some common entity types
include: Person, Organization, Location, Event, Product, Concept, Artwork, etc.
However, feel free to create new types as needed to best categorize the entities you
find.” }, { “name”: “CONNECTION_DEFINITION”, “content”: “A connection represents
a relationship or interaction between two entities. Connections are directional, with a
source entity, a target entity, and a type that specifies the nature of their relationship.”
}, { “name”: “CONNECTION_TYPES”, “content”: “Some common connection types
include: KNOWS, EMPLOYS, LOCATED_AT, PART_OF, INTERACTS_WITH,
SIMILAR_TO, CAUSES, etc. Like with entities, create new connection types when
needed to accurately capture the relationships you identify.” } ] }, “embedding”: [0.1,
0.2, . . . ], “non_embedded”: { } }
{ “id”: “agent-002”, “type”: “_agent”, “name”: “Chat Processing Agent”,
“description”: “Processes chat messages and manages conversation flow”,
“updated_at”: 1705881600, “metadata”: { “connector_name”: “claude”,
“connector_config”: { “model”: “claude-3-sonnet”, “temperature”: 0.7 },
“system_message”: “You are a specialized Chat Processing Agent responsible for
managing chat interactions and updating the system's memory based on
conversation content.”, “role”: “Chat Manager”, “responsibility”: “Process chat
messages and maintain conversation context”, “additional_rules”: [ “Always
maintain conversation context”, “Request clarification when information is
ambiguous”, “Follow Directives as best as you can” ] }, “embedding”: [0.1, 0.2, . . . ],
“non_embedded”: { } }
{ “id”: “concept-005”, “type”: “concept”, “name”: “LiveArena Networks: New User
Onboarding”, “description”: “Core guidelines and goals for building understanding
of new users to LiveArena Networks”, “updated_at”: 1705881600, “metadata”: { },
“embedding”: [0.1, 0.2, . . . ], “non_embedded”: { } }

The system 100 also creates a directive item regarding the user onboarding concept entity and the ChatProcessing agent entity. Generally, directives can be used to provide context and guidance between different entities, and can be defined as a connection between a concept entity and an agent entity to provide contextual guidance when a directive is deemed highly relevant in a set of working memory or domain knowledge. In the following example, the ChatProcessing agent tool is informed how it should behave in the context of user onboarding:

{ “source_id”: “concept-005”, “target_id”: “agent-002”, “type”: “DIRECTIVE”,
“metadata”: { “guidelines”: [ “Start with a warm, welcoming introduction that explains
what LiveArena Networks is”, “Ask questions one at a time, allowing the user to share
what they feel is important”, “When the user shares information, acknowledge it and
show understanding before exploring further”, “Reference previously shared
information to demonstrate active listening”, “Let the user guide the conversation
toward what matters to them”, “If any information is unclear, ask for clarification while
respecting privacy boundaries”, “Maintain a conversational tone that encourages
open dialogue”, “When sufficient context about user interests/work is gathered, offer
to transition to system learning”, “Respect user preference if they want to continue
sharing more about themselves” ], “goals”: [ “Learn how the user prefers to be
addressed”, “Understand the various roles and contexts in their life”, “Actively try to
understand, clarify, and validate your understanding of the user's goals that they
share, both personally and professionally”, “Build awareness of their interests and
priorities”, “Discover how they prefer to interact and communicate”, “Learn about
their typical activities and tools they use”, “Understand their preferences for how
LiveArena Networks can best assist them”, “Identify natural opportunities to
introduce system capabilities that align with user interests”, “Enable smooth
transition to system learning when appropriate” ] } }

Now, with our guidelines established, the system 100 can create the chat space entity itself:

{ “id”: “chat-123”, “type”: “system_chat”, “name”: “Onboarding Chat”, “description”:
“Initial onboarding chat for new user”, “updated_at”: 1705881600, “metadata”: {
“status”: “active”, “chat_type”: “onboarding”, “created_at”: “2025-01-21T00:00:00Z”
}, “embedding”: [0.1, 0.2, . . . ], “non_embedded”: { “core_concepts”: [“concept-005”] }
}

The onboarding chat is added to the chats concept via a connection:

{ “source_id”: “chat-123”, “target_id”: “concept-008”, “type”: “IS_A”, “updated_at”:
1705881600, “metadata”: { }, “embedding”: [0.1, 0.2, . . . ], “non_embedded”: { } }

By placing the concept references (“concept-5”) in ‘non_embedded’, the system 100 ensures that these references don't influence similarity searches. This means that when the system 100 searches for similar chats later, they will be found based on their actual content and purpose rather than their associated concepts. The concepts should pop up naturally if they are relevant, as is described herein.

The system 100 then establishes ownership of the chat space by creating a connection to itself:

{ “source_id”: “me-001”, “target_id”: “chat-123”, “type”: “CREATED”, “updated_at”:
1705881600, “metadata”: { }, “embedding”: [0.1, 0.2, . . . ], “non_embedded”: { } }

When a user 122 first interacts with the system 100, the system 100 may not yet know who the user 122 is. To handle this, the system 100 can be configured with a temporary way to represent this unknown user 122 while learning more about them. Herein, an **Unknown User** entity is used. First, the system 100 searches the database 200 for any existing user entities. Since this is the first run of the system 100, it does not find any, and instead creates a new **Unknown User** entity (it is noted that the database 200 can contain multiple such unknown users):

{ “id”: “user-001”, “type”: “user”, “name”: “Unknown User”, “description”:
“Temporary anonymous user pending identification”, “updated_at”: 1705881600,
“metadata”: { }, “embedding”: [0.1, 0.2, . . . ], “non_embedded”: { } }

A number of connections are created with respect to the new user entity:

{ “source_id”: “chat-123”, “target_id”: “user-001”, “type”: “CREATED”, “updated_at”:
1705881600, “metadata”: { }, “embedding”: [0.1, 0.2, . . . ], “non_embedded”: { } }
{ “source_id”: “user-001”, “target_id”: “concept-001”, “type”: “IS_A”, “updated_at”:
1705881600, “metadata”: { }, “embedding”: [0.1, 0.2, . . . ], “non_embedded”: { } }

Now that the environment has been setup, the system 100 can start processing the actual communication flow with the user.

The system 100 can be configured to then start the onboarding with a special interaction between the system 100 itself (ME) and the ChatProcessing agent tool. This interaction is configured to setup up the entire onboarding process by the system 100 delegating to a specialized entity to handle the communication flow. The interaction is defined as follows:

{ “id”: “interaction-001”, “source_id”: “me-001”, “target_id”: “chat-123”, “type”:
“system_chat”, “message”: “Initialize onboarding chat with unknown user”,
“updated_at”: 1705881600, “metadata”: { }, “non_embedded”: {
“previous_interaction_id”: null, “conversation_id”: “chat-123” } }

When this interaction is created and processed by the system 100, a ChatHandler function of the system 100 is configured to call upon the ChatProcessing agent tool (this can be hardcoded) and to automatically generate an LLM prompt that guides its behavior. The system 100 takes known relevant information (graph information from the database 200 and/or information gleaned based on similarity search(es)) and stores this information in an AgentRequest object (a structured data object, for instance in JSON), having clear sections for different types of content. For example, instructions go in one section, while context about the user goes in another of the AgentRequest object. Again, explicit instructions regarding output format can also be included in the text prompt. Based upon the AgentRequest object, the text prompt can for instance look like this:

You are a specialized Chat Manager. Your sole task is to Process chat messages and maintain conversation context. You must strictly adhere to the following rules:
1. You will be provided context in—<BLOCK TYPE>—dividers below. These are meant to provide additional context, but may or may not be relevant to your given instructions. You have to logicly decide what is relevant and what is not. 2. You may see—DIRECTIVE—blocks. These are critically important and should be considered as additional Guidelines and Goals you should follow. 3. Always maintain conversation context. 4. Request clarification when information is ambiguous. 5. Follow Directives as best as you can.

-- START YOU -- This information represents you, the AI System that is processing the rest of
this information in your prompt. AI System (Entity): - Name: LiveArena Networks; - Type: AI
System; - Connections: - CREATED -> Chat: Onboarding Chat (chat-123); - WORKS_WITH - >
Concept: Users; - INSTALLED_ON -> Computer: My Computer; - Purpose: Enhance user
productivity and streamline tasks through intelligent automation -- END YOU --
-- START ONBOARDING DIRECTIVE -- guidelines: “Start with a warm, welcoming introduction
that explains what LiveArena Networks is”, “Ask questions one at a time, allowing the user
to share what they feel is important”, “When the user shares information, acknowledge it
and show understanding before exploring further”, “Reference previously shared
information to demonstrate active listening”, “Let the user guide the conversation toward
what matters to them”, “If any information is unclear, ask for clarification while respecting
privacy boundaries”, “Maintain a conversational tone that encourages open dialogue”
goals: “Learn how the user prefers to be addressed”, “Understand the various roles and
contexts in their life”, “Actively try to understand, clarify, and validate your understanding
of the user's goals that they share, both personally and professionally”, “Build awareness of
their interests and priorities”, “Discover how they prefer to interact and communicate”,
“Learn about their typical activities and tools they use”, “Understand their preferences for
how LiveArena Networks can best assist them” -- END ONBOARDING DIRECTIVE --
-- START CHAT HISTORY -- -- END CHAT HISTORY --
You have been given the instructions: Initialize onboarding chat with unknown user.
Format your reply to adhere to the following JSON Schema: { “message_reply”: string,
“has_assignment”: bool, “assignment_instructions”: string }

This prompt is provided to the LLM 150, 160, and after processing the following response is generated and returned by the LLM 150, 160:

{ “message_reply”: “Hello! I'm LiveArena Networks, an AI assistant designed to help
streamline your tasks and enhance productivity. To get started, could you please tell
me your name and a bit about yourself?”, “has_assignment”: false,
“assignment_instructions”: “” }

The “message_reply” message is thereafter sent to the chat and shown as the initial message to the user 122. Since this initial message is generated by the LLM 150, 160, it is likely to vary each time it runs but still provide the same basic cognitive information.

When the user 122 in the chat responds with something like “Hi, my name is Strider Agostinelli and I'm the Head of AI Research and Development for Live Arena Technologies”, this is sent to the ChatHandler endpoint and a new interaction is created as follows:

{ “id”: “interaction-002”, “source_id”: “user-001”, “target_id”: “agent-002”, “type”:
“chat”, “message”: “Hi, my name is Strider Agostinelli and I'm the Head of AI
Research and Development for Live Arena Technologies”, “updated_at”: 1705881600,
“metadata”: { }, “non_embedded”: { “previous_interaction_id”: “interaction-001”,
“conversation_id”: “chat-123” } }

This interaction can be processed in the same manner as above, the primary difference being that the Chat History block will now have new content:

-- START CHAT HISTORY -- AI: Hello! I'm LiveArena Networks, an AI assistant designed to help
streamline your tasks and enhance productivity. To get started, could you please tell me your
name and a bit about yourself? -- END CHAT HISTORY --

The Instructions are also updated with the message from the User: “Hi, my name is Strider Agostinelli and I'm the Head of AI Research and Development for Live Arena Technologies. A new generated reply JSON object is created:

{ “message_reply”: “Thank you, Strider! It's great to meet you. As the Head of AI
Research and Development for Live Arena Technologies, your role sounds
fascinating. Could you share more about your responsibilities and what you hope to
achieve with LiveArena Networks?”, “has_assignment”: false,
“assignment_instructions”: “” }

The message_reply message is sent to the chat for the user 122 to see immediately, and then the processing is continued in the background as will now be described.

Namely, since this message came from a “user” entity, the system 100 can do a bit of memory processing after the fact. Using the MemoryExtraction agent tool defined above, the system 100 takes the user's message and the agent tool's reply and processes them together with an automatically produced prompt produced as follows:

You are a specialized Memory Extractor. Your sole task is to Analyze text input to identify and extract relevant entities and connections. You must strictly adhere to the following rules: 1. You will be provided context in—<BLOCK TYPE>—dividers below. These are meant to provide additional context, but may or may not be relevant to your given instructions. You have to logically decide what is relevant and what is not. 2. You may see—DIRECTIVE—blocks. These are critically important and should be considered as additional Guidelines and Goals you should follow. 3. Examine all provided text carefully to identify potential entities and connections. 4. Create new entity and connection types as needed to accurately represent the information. 5. If an existing entity or connection is provided for reference, include all its details in your extraction to avoid data loss. 6. Only exclude objectively invalid or irrelevant data from extractions. 7. Provide complete information for each extracted entity and connection. 8. Use the provided definitions and examples as a guide, but feel free to extend them as required by the input text. 9. Aim for high recall—it's better to overextract than to miss potentially important information. 10. It's possible that Unknown Data or information, such as an Unknown User, is actually identified in the text. IF you see an identification and the source is Unknown or incomplete, you should aim to add as much identification as is reasonable.

-- START YOU -- This information represents you, the AI System that is processing the rest of
this information in your prompt. AI System (Entity). - Name: LiveArena Networks. - Type: AI
System. - Connections: - CREATED -> Chat: Onboarding Chat (chat-123). - WORKS_WITH - >
Concept: Users. - INSTALLED_ON -> Computer: My Computer. - Purpose: Enhance user
productivity and streamline tasks through intelligent automation. -- END YOU --
-- START ENTITY_DEFINITION -- An entity is a person, place, thing, concept or event that is
mentioned in the text. Entities can be real or fictional, concrete or abstract. Each entity
should have a name, short description, a type, and optional metadata. -- END
ENTITY_DEFINITION --
-- START ENTITY_TYPES -- Some common entity types include: Person, Organization,
Location, Event, Product, Concept, Artwork, etc. However, feel free to create new types as
needed to best categorize the entities you find. -- END ENTITY_TYPES --
-- START CONNECTION_DEFINITION -- A connection represents a relationship or interaction
between two entities. Connections are directional, with a source entity, a target entity, and
a type that specifies the nature of their relationship. -- END CONNECTION_DEFINITION --
-- START CONNECTION_TYPES -- Some common connection types include: KNOWS,
EMPLOYS, LOCATED_AT, PART_OF, INTERACTS_WITH, SIMILAR_TO, CAUSES, etc. Like with
entities, create new connection types when needed to accurately capture the relationships
you identify. -- END CONNECTION_TYPES --
-- START MEMORIES -- Entity: Unknown User { “id”: “user-001”, “type”: “user”, “name”:
“Unknown User”, “description”: “Temporary anonymous user pending identification”,
“metadata”: { }, “non_embedded”: { } } Entity: Onboarding Chat { “id”: “chat-123”, “type”:
“system_chat”, “name”: “Onboarding Chat”, “description”: “Initial onboarding chat for new
user”, “metadata”: { “status”: “active”, “chat_type”: “onboarding”, }, “non_embedded”: {
“core_concepts”: [“concept-005”] } } Entity: LiveArena Networks: New User Onboarding {
“id”: “concept-005”, “type”: “concept”, “name”: “LiveArena Networks: New User
Onboarding”, “description”: “Core guidelines and goals for building understanding of new
users to LiveArena Networks”, “metadata”: { }, “non_embedded”: { } } Entity: ME { “id”: “me-
001”, “type”: “system”, “name”: “LiveArena Networks”, “description”: “The AI system
responsible for managing and processing interactions”, “metadata”: { }, “non_embedded”: { }
} Entity: Users { “id”: “concept-001”, “type”: “concept”, “name”: “Users”, “description”:
“Users are entities that interface with the AI System.”, “metadata”: { }, “non_embedded”: { }
} Connection: Onboarding -> DIRECTIVE -> Chat Processing Agent { “source_id”: “concept-
005”, “target_id”: “agent-002”, “type”: “DIRECTIVE”, “metadata”: { “guidelines”: [ ″Start
with a warm, welcoming introduction that explains what LiveArena Networks is”, “Ask
questions one at a time, allowing the user to share what they feel is important”, “When the
user shares information, acknowledge it and show understanding before exploring further”,
“Reference previously shared information to demonstrate active listening”, “Let the user
guide the conversation toward what matters to them”, “If any information is unclear, ask
for clarification while respecting privacy boundaries”, “Maintain a conversational tone that
encourages open dialogue”], “goals”: [ “Learn how the user prefers to be addressed”,
“Understand the various roles and contexts in their life”, “Actively try to understand, clarify,
and validate your understanding of the user's goals that they share, both personally and
professionally”, “Build awareness of their interests and priorities”, “Discover how they prefer
to interact and communicate”, “Learn about their typical activities and tools they use”,
“Understand their preferences for how LiveArena Networks can best assist them”] } }
Connection: ME -> CREATED -> Chat { “source_id”: “me-001”, “target_id”: “chat-123”,
“type”: “CREATED” } Connection: Chat -> CREATED -> user {“source_id”: “chat-123”,
“target_id”: “user-001”, “type”: “CREATED” } Connection: User -> IS_A -> users { “source_id”:
“user-001”, “target_id”: “concept-001”, “type”: “IS_A” } -- END MEMORIES --
-- START CONTENT TO EXTRACT FROM -- Unknown User[user-001]: Hi, my name is Strider
Agostinelli and I'm the Head of AI Research and Development for Live Arena Technologies
AI[me-001]: Thank you, Strider! It's great to meet you. As the Head of AI Research and
Development for Live Arena Technologies, your role sounds fascinating. Could you share
more about your responsibilities and what you hope to achieve with LiveArena Networks? -
- END CONTENT TO EXTRACT FROM --
You have been given the instructions: Process the information within CONTENT TO EXTRACT
FROM and generate full and complete entries for Entities and Connections, as defined below.
Format your reply to adhere to the following JSON Schema: { “entities”: [ { “id”: “string”,
“type”: “string”, “name”: “string”, “description”: “string”, “metadata”: { }, “non_embedded”:
{ } } ], “connections”: [ { “source_id”: “string”, “target_id”: “string”, “type”: “string”,
“metadata”: { }, “non_embedded”: { } } ] }

This prompt is provided to the LLM 150, 160, which after processing can respond to a JSON structure like the following:

{ “entities”: [ { “id”: “user-001”, “type”: “person”, “name”: “Strider Agostinelli”,
“description”: “Head of AI Research and Development for Live Arena Technologies”,
“metadata”: { }, “non_embedded”: { } },
{ “id”: “org-002”, “type”: “organization”, “name”: “Live Arena Technologies”,
“description”: “A technology company focused on AI and research”, “metadata”: { },
“non_embedded”: { } } ],
“connections”: [ { “source_id”: “user-001”, “target_id”: “org-002”, “type”:
“EMPLOYED_BY”, “metadata”: { “role”: “Head of AI Research and Development” },
“non_embedded”: { } } ] }

After the initial identification of the user 122 and establishment of basic entities and connections, the system 100 enters a phase of continuous information exchange. Each subsequent interaction follows the pattern established, creating a cycle of gathering, processing, and integrating information about the user 122.

Every user message triggers the following sequence: 1. The ChatProcessing agent tool receives the message and formulates an appropriate response based on current context and directives. 2. The MemoryExtraction agent tool processes both the user's message and the system's response by the system 100 automatically producing a text prompt passed to the LLM 150, 160 in turn responding with a JSON data structure containing extracted items. 3. New entities and connections are created or updated in the database 200. 4. The updated context informs the next interaction.

For example, if after initial identification the user mentions: “I primarily work with Python and TensorFlow for our AI research projects, and I love finding ways to optimize neural network performance.” the system 100 processes this through the same steps as above:

{ “id”: “interaction-003”, “source_id”: “user-001”, “target_id”: “agent-002”, “type”:
“chat”, “message”: “I primarily work with Python and TensorFlow for our AI research
projects, and I love finding ways to optimize neural network performance.”,
“updated_at”: 1705881900, “metadata”: { }, “non_embedded”: {
“previous_interaction_id”: “interaction-002”, “conversation_id”: “chat-123” } }

This triggers the MemoryExtraction agent tool to identify new entities and connections:

{ “entities”: [ { “id”: “concept-006”, “type”: “concept”, “name”: “Python”,
“description”: “Programming language commonly used in AI development and data
science”, “metadata”: { “category”: “Programming Language”, “identified_in”:
“interaction-003” } },
{ “id”: “concept-007”, “type”: “concept”, “name”: “TensorFlow”, “description”: “Open
source machine learning framework developed by Google”, “metadata”: { “category”:
“AI Framework”, “identified_in”: “interaction-003” } } ],
“connections”: [ { “source_id”: “user-001”, “target_id”: “concept-006”, “type”:
“USES”, “metadata”: { “context”: “AI Research”, “identified_in”: “interaction-003” } },
{ “source_id”: “user-001”, “target_id”: “concept-007”, “type”: “USES”, “metadata”: {
“context”: “AI Research”, “identified_in”: “interaction-003” } } ] }

Each round of conversation helps build a richer understanding of the user 122 through direct information such as facts explicitly stated by the user 122; implied context, i.e. information derived from how the user communicates; relationship mapping, namely connections between different aspects of the user's world; and preference learning, i.e. understanding how the user 122 likes to work and communicate.

The system 100 can be configured to maintain this ongoing learning process throughout the entire conversation, continuously updating and refining its understanding of the user. When processing user responses during onboarding, the ChatProcessing agent tool continuously evaluates the conversation against its directives to identify opportunities for introducing system 100 capabilities. This will now be illustrated through a practical example.

Consider this interaction within our onboarding chat: User 122: “I primarily work with Python and TensorFlow for our AI research projects, and I love finding ways to optimize neural network performance.” The system 100 may identify this as a transition opportunity because several directive goals have been met (refer above):

[ “Identify natural opportunities to introduce system capabilities that align with user
interests”, “Enable smooth transition to system learning when appropriate” ]

Namely, the following information is now available, and will in particular be inferred by an automatically produced prompt to the ChatProcessing agent tool containing said directive text: The user's 122 role (AI Research and Development); the user's 122 key tools (Python, TensorFlow); the user's 122 interests (neural network optimization); and identified clear areas where the system 100 can provide value.

As a result, the ChatProcessing agent tool might reply to the text prompt with something like: “That's amazing Strider! I want to learn more about you, but this looks like a good opportunity for me to explain how LiveArena Networks can start to work with you and help you with your every day life. Would you like to dive into that with me, or would you rather we continue this chat so that I can get more context that can help me better understand you and your needs?”

The user 122 may respond positively: User: “Yes, let's do that”. Then, the system 100 may begin the transition process by creating a new assignment. This assignment generation is triggered through the creation of a specific Interaction and the LLM's 150, 160 reply. Because the text prompt for the LLM 150, 160 includes the chat history, it is able to contextually understand that Strider is ready to start the new chat. It is the history that allows this kind of “Yes, let's do that” to have the context required to make it work:

{ “id”: “interaction-004”, “source_id”: “user-001”, “target_id”: “chat-123”, “type”:
“chat”, “message”: “Yes, let's do that”, “metadata”: { }, “non_embedded”: {
“previous_interaction_id”: “interaction-003”, “conversation_id”: “chat-123” } }

When the user 122 agrees to transition to system 100 learning, the system 100 generates a new assignment to create and configure a dedicated chat for this purpose. This involves setting “has_assignment” to true and providing specific instructions for the new chat setup. The reply from the LLM 150, 160 would look like this:

{ “message_reply”: “Great! Let's get started with how LiveArena Networks can assist
you. I'll set up a new chat focused on system learning. You can continue to chat with
me here as well to let me know more about you.”, “has_assignment”: true,
“assignment_instructions”: “Create and configure new chat for system learning” }

To generate the metadata for “assignment-001”, the system 100 can use several concepts and items that have been introduced during the onboarding process, such as one or more of the user's 122 context, interests, and the type of transition. This metadata ensures that the new chat is tailored to the user's 122 needs and preferences.

The system 100 sends the ‘assignment_instructions’ to the InitialAssignment Assessor agent tool, similar to how it sends information to the MemoryExtractor agent tool. The end result is a fully generated assignment object.

The raw instructions are sent to the AssignmentHandler function. Here is an example JSON request to the AssignmentHandler:

{ “id”: “interaction-005”, “source_id”: “me-001”, “target_id”: “agent-004”, “type”:
“assignment_creation”, “message”: “Create and configure new chat for system
learning”, “updated_at”: 1705881600, “metadata”: { “context”: { “source_chat”: “chat-
123”, “user_context”: { “name”: “Strider Agostinelli”, “role”: “Head of AI Research
and Development”, “interests”: [“python”, “tensorflow”, “neural_networks”],
“focus_areas”: [“optimization”, “performance”] }, “learning_objectives”: [
“multi_chat_functionality”, “assignment_creation”, “system_capabilities” ] } },
“non_embedded”: { “previous_interaction_id”: “interaction-004”, “conversation_id”:
“chat-123” } }

The AssignmentHandler takes the instruction, along with the working memory, to get relevant information to generate an agent tool text prompt for the InitialAssignmentAssessment agent tool. The expected output is the full AssignmentData object as the JSON Response Schema. Here is the full prompt:

You are a specialized Initial Assignment Assessor. Your sole task is to analyze context and generate complete Assignment objects. You must strictly adhere to the following rules: 1. You will be provided context in—<BLOCK TYPE>—dividers below. These are meant to provide additional context, but may or may not be relevant to your given instructions. You have to logically decide what is relevant and what is not. 2. You may see—DIRECTIVE—blocks. These are critically important and should be considered as additional Guidelines and Goals you should follow. 3. Examine all provided context carefully to generate accurate assignments. 4. Ensure all necessary fields are populated. 5. Follow provided guidelines and goals for assignment creation.

-- START YOU -- This information represents you, the AI System that is processing the rest of
this information in your prompt. AI System (Entity). - Name: LiveArena Networks. - Type: AI
System. - Connections: - CREATED -> Chat: Onboarding Chat (chat-123). - WORKS_WITH ->
Concept: Users. - INSTALLED_ON -> Computer: My Computer. - Purpose: Enhance user
productivity and streamline tasks through intelligent automation. -- END YOU --
-- START CONTEXT -- { “source_chat”: “chat-123”, “user_context”: { “name”: “Strider
Agostinelli”, “role”: “Head of AI Research and Development”, “interests”: [“python”,
“tensorflow”, “neural_networks”], “focus_areas”: [“optimization”, “performance”] },
“learning_objectives”: [ “multi_chat_functionality”, “assignment_creation”,
“system_capabilities” ] } -- END CONTEXT --
-- START INSTRUCTIONS -- Create and configure new chat for system learning -- END
INSTRUCTIONS --
Format your reply to adhere to the following JSON Schema: { “name”: “string”, “description”:
“string”, “status”: “string”, “priority”: “string”, “instructions”: “string”,
“acceptance_criteria”: [“string”], “history”: “string”, “current_progress”: “string”,
“completed_at”: “integer”, “updated_at”: “integer”, “metadata”: { “source_chat”: “string”,
“user_context”: { “name”: “string”, “role”: “string”, “interests”: [“string”], “focus_areas”:
[“string”] }, “learning_objectives”: [“string”] }, “non_embedded”: { “source_interaction”:
“string” } }

The response after passing this prompt to the LLM 150, 160 may look like this (FTUE is “First Time User Experience”):

{ “name”: “Initialize Dynamic FTUE Chat”, “description”: “Create and configure new
chat for system learning”, “status”: “created”, “priority”: “high”, “instructions”:
“Create and configure new chat for system learning”, “acceptance_criteria”: [ “Chat
environment is created”, “User context is integrated”, “Learning objectives are set” ],
“history”: “”, “current_progress”: “Assignment Created”, “completed_at”: null,
“updated_at”: 1705881600, “metadata”: { }, “non_embedded”: { “source_interaction”:
“interaction-004”, “user_context”: { “name”: “Strider Agostinelli”, “role”: “Head of AI
Research and Development”, “interests”: [“python”, “tensorflow”,
“neural_networks”], “focus_areas”: [“optimization”, “performance”] }, } }

This assignment carries forward all relevant context from the onboarding process while establishing the framework for a new learning-focused conversation. The “metadata” field contains structured information about the user's 122 interests and role, ensuring the new chat can immediately provide relevant examples and demonstrations.

After the onboarding chat session has concluded, the process of learning about the user 122 continues, the system 100 constantly structuring and storing items, in the database 200, coding for new information based on later interactions, including updates of existing information related to the user 122. Generally, all information accruing as a part of the system 100 interacting with or in relation to the user 122 is stored in the database 200, including the interactions themselves.

In particular, in the current example it is assumed that the free-text input comprises, implies or refers to a task or an assignment for the system 100 to perform. As the term is used herein, a “task” defines something that the system 100 is to perform or achieve. If a task is specified sufficiently for the system 100 to know how to perform the task unambiguously, the system 100 will do so, otherwise the system 100 can be configured to pose a follow-up request or query for additional or clarifying information, such as from a user 122 of from an external information source; or to fail the task, such as using the error-handling methodology described below. Normally, a task is defined to be performed by one single agent or non-agent tool.

An “assignment” needs interpretation by the system 100 for performing the assignment, and the performing involves the system 100 automatically identifying one or more tasks for performing of the assignment. The finalization of the assignment can be defined in terms of one or more acceptance criteria as described below. The performing of an assignment can be iterative in the sense that the identification and performance of a first task can result in an updated assignment, and each such updated assignment can require additional or clarifying information, that the system 100 can be configured to request or collect, such as from a user 122 or from an external information source. Assignments are processed by agent tools.

In some embodiments, one, two or more automatically identified acceptance criteria are used to define explicit conditions that must be met for an assignment to be considered complete. These criteria ensure that an output from the system 100 aligns with the requestor's expectations and provides a clear, measurable standard for evaluating the success of each assignment including its resulting tasks.

In some embodiments, the acceptance criteria remain immutable once identified during the processing of each assignment. Such immutability prevents the system 100 from altering the acceptance criteria during subsequent processing stages. Since the processing is performed partly using LLMs 150, 160, if the acceptance criteria are allowed to change this leads to a risk of LLM 150, 160 responses simplifying the acceptance criteria as the processing of the assignment moves along, in turn potentially leading to incomplete or subpar results that do not fulfill an initial set requirements of the assignments.

In many cases, as in the present example, the free-text input defines some sort of task or assignment. It is noted that such task or assignment needs to be parsed and interpreted, since it is generally expressed in free-text form, probably referencing items in the database 200 and perhaps adding additional information still not in the database 200. At the time of receiving the free-text input and before parsing/interpreting, the system 100 is unaware of this.

Reference is now made to the flow shown in FIG. 4, where a general flow for the system 100 to process an incoming piece of information is illustrated in terms of producing a response to a piece of free-text input 403. The free-text input 403 can generally be as described above. The general flow can comprise the flows shown in FIGS. 5, 6 and/or 7, that have already been described above. The free-text input 403 can be any input received in any manner, for instance in any of the ways exemplified above. However, if the free-text input 403 is not in text format it is first converted into text format, such using an ASCII representation, before being processed by the system 100.

In a first step 401 the method starts.

In a subsequent step 402, the free-text input 403 is received by the central server 130.

As mentioned above, assignments can be processed by an AssignmentHandler functionality of the system 100. The AssignmentHandler functionality can be configured to perform/trigger/invoke some or all of the steps in FIG. 4, and specifically to accept a structured assigment request automatically prepared by the system 100 based on available information, such as a JSON request data structure with the following schema:

Assignment Request Schema {
“instructions”: { “type”: “string”, “description”: “The core instructions or objective
provided by the requestor. This field is required and should contain a clear, concise
description of the task or goal to be accomplished.” },
“acceptance_criteria”: { “type”: “array”, “items”: { “type”: “string” }, “description”:
“An optional array of explicit criteria that must be met for the assignment to be
considered complete and acceptable. Each criterion is represented as a string,
specifying a particular requirement or condition.”, “default”: [ ] },
“priority”: { “type”: “string”, “enum”: [“low”, “normal”, “high”, “critical”],
“description”: “An optional field indicating the priority level of the assignment. It can
be one of the following values: ‘low’, ‘normal’, ‘high’, or ‘critical’. If not provided, the
default priority is set to ‘normal’.” , “default”: “normal” },
“metadata”: { “type”: “object”, “description”: “An optional object containing metadata
associated with the assignment. This metadata is intended to be vector searchable,
allowing for efficient retrieval and comparison of assignments based on specific
attributes.”, “properties”: { }, “additionalProperties”: true, “default”: { } },
“non_embeds”: { “type”: “object”, “description”: “An optional object containing non-
vector searchable data related to the assignment. This can include concept links,
source references, or any other relevant information that does not fit into the vector-
based metadata.”, “properties”: { }, “additionalProperties”: true, “default”: { } } }

Continuing the above example of the new chat for system 100 learning, the following assignment request can be constructed by the system 100 and provided to the AssignmentHandler for processing. This assignment request can be automatically and deterministically created based on information to the system 100, depending on the concrete situation:

{ “instructions”: “Create and configure new chat for system learning”,
“acceptance_criteria”: [ ], “priority”: “normal”, “metadata”: { }, “non_embeds”: {
“source_interaction”: “interaction-004”, “user_context”: { “name”: “Strider
Agostinelli”, “role”: “Head of AI Research and Development”, “interests”: [“python”,
“tensorflow”, “neural_networks”], “focus_areas”: [“optimization”, “performance”] } }
}

The AssignmentHandler can also be configured to create an assignment object based on this request information. Initially, the assignment object can be configured to only contain data directly derivable from the request, and the system 100 can be configured not to use any LLM and/or memory processing to construct the initial assignment object exemplified as follows:

{ “name”: “”, “description”: “”, “status”: “created”, “priority”: “normal”,
“instructions”: “Create and configure new chat for system learning”,
“acceptance_criteria”: [ ], “history”: “”, “current_progress”: “Assignment Created”,
“completed_at”: null, “updated_at”: 1705881600, “metadata”: { }, “non_embedded”: {
“source_interaction”: “interaction-004”, “user_context”: { “name”: “Strider
Agostinelli”, “role”: “Head of AI Research and Development”, “interests”: [“python”,
“tensorflow”, “neural_networks”], “focus_areas”: [“optimization”, “performance”] } }
}

As is evident from the above, only information directly known to the system 100 is added to the initial assignment object. This data structure is denoted “initial assignment assessment dataset” in FIG. 4, and is created using processing 405 of the free-text input in a step 409. In particular, logic 407 can be used to automatically construct this data structure based on available information and said schema (or a suitable predetermined template) 406.

The reason that the system 100 can construct the initial assignment assessment dataset in a completely deterministic and automatic manner in the present example is that the system 100 already knows what the assignment is—to “Create and configure new chat for system learning”. This information was extracted using the LLM 150, 160 as described above. In other cases, the actual assignment may be extracted as a part of the free-text input processing 406 using an LLM 150, 160, 407 suitably prompted, based on available information and possibly on directives and/or specific/general instructions 406 as generally described above. This 407 call can be as a part of an agent tool invoking based on the free-text input.

The LLM 150, 160 or logic 407 emits assignment information 408 that can be or be used to create the initial assignment assessment database in step 409.

Irrespectively of if rule-based logic and/or an LLM 150, 160 is used at 407, the initial assignment assessment dataset can be constructed, using the free-text input processing, to contain structure data relating to any memories, working memory and/or domain knowledge(s) extracted using similarity searching and expansion as described in connection to FIG. 5 (and at this point possibly forming part of the context information 404). The structured information provides context to the initial assignment assessment dataset. The initial assignment assessment dataset can be constructed to have a structured format, such as in JSON, and comprise the whole or part of the free-text input.

Similarly, the initial assignment assessment dataset can be constructed to comprise any automatically identified context information 404 (contextual metadata) identifiable by the system 100 without using an LLM 150, 160 and instead using graph information in the database 200, such as previous chat messages in the same chat as the message comprising the assignment. Generally, the initial assignment assessment dataset can be automatically produced to comprise information regarding the above-discussed similar or ranked sets of items discussed in connection to FIG. 5, such set of similar or ranked items being a set of one or more of the stored items being related to the free-text input from the perspective of the information 210 in the database 200. The presence in the initial assignment assessment dataset of such similar or ranked items then also implies the presence of the similar or ranked items in a text prompt provided to the LLM 150, 160 in the below-described free-text input execution assessment 410. All such information can be added in the “metadata” field of the initial assignment assessment dataset.

As described above, the set of similar or ranked items can be determined by automatically identifying a set of referred items, the referred items comprising any entities, connections and/or interactions referred to in the free-text input 403, such as using non-LLM NLP tools 131; calculating respective embeddings of each of the referred items in the set of referred items, of the free-text input 403; and/or any combination of the free-text input 403 and one or more of the referred items; performing a respective similarity search in the database 200, comparing the embeddings or the stored items to the calculated embedding in question, using a vector-based similarity measure; and selecting the set of similar items based on the similarity search.

Further generally and as described above, the automatic identification of the referred items can comprise producing a respective text prompt to the LLM 150, 160, requesting the LLM 150, 160 in question to, in a respective response to the text prompt, identify any entities, connections and/or interactions referred to in the free-text input 403.

As is the case for any text prompt, agent or data structure comprised in the database 200 or produced by the system 100, the initial assignment assessment dataset can be subjected to preprocessing before being further processed by the system 100 (the further processing being described below). Such preprocessing can comprise one, two or more pre-processing steps, each being configured to process an input assignment assessment dataset using a respective predefined methodology to produce an output assignment assessment dataset, an input assignment assessment dataset provided to a first one of the two or more pre-processing steps being the initial assignment assessment dataset; the output assignment assessment dataset output from any intermediate one of the two or more pre-processing steps being provided as the input assignment assessment dataset of a subsequent one of the two or more pre-processing steps; and an output assignment assessment dataset output from a last one of the two or more preprocessing steps being an updated assignment assessment dataset. Here, the terms “input” and “output” are used in relation to the pre-processing steps. In other words, two or more preprocessing steps can be performed serially, each updating the initial assignment assessment dataset before the next step performs the next updating.

Any of the pre-processing steps can selectively be performed using LLM 150, 160 processing, in particular comprise automatically producing a respective text prompt to the LLM 150, 160, requesting the LLM 150, 160 to, in a respective response to the text prompt, produce the output assignment assessment dataset based on the input assignment assessment dataset being comprised in said text prompt or prompts.

Next, the AssignmentHandler can be configured to determine an agent tool to process the initial assessment of the assignment defined by the assignment request with the purpose of selecting such an agent for performing the assignment-specific assessment. In some embodiments, this selected agent tool is fixed, but the system 100 can alternatively be configured to be dynamically select this agent tool from an available agent tool library based on the assignment request in a way corresponding to how various agent tools are dynamically selected to perform assignments as described hereinbelow.

Once the assignment assessment tool has been selected, first an AgentRequest object can be created. This can be done directly from the assignment object, not requiring any LLM Processing at this stage since all information is known. In the example below, it is noted that the assignment information is placed in a context block and is not a part of the instruction. The instructions, the “additional_rules” and processing flags (such as “run_agent_preprocessing”) are part of the configuration and can be predetermined and static at runtime. Moreover, the “additional_rules” is not a complete list of rules, others are populated by the selected agent tool itself, others can be a part of an agent type of the agent definition, such as being part of a base class of the agent.

It is understood that, from a general point of view, as used herein the notion of “selecting an agent tool” can mean “selecting a particular schema for constructing a text prompt to the LLM 150, 160 to perform a particular analysis of a set of information insertable into the schema. In practical examples, each agent tool can be represented in the database 200 as an entity, having connections and/or interactions interconnecting it to other entities and comprising or being associated with any previous uses of the agent tool in question, including any results therefrom. Such contextual information for each agent tool can both be used by the system 100 to find a particular agent tool and by the agent tool itself for providing relevant contextual information in said text prompt.

The following exemplified AgentRequest object would be automatically and mechanically constructed from the information available to the system 100, including any agent preprocessing as described above. Note that the “additional_rules” can be automatic gleaned from a directive entity configured to apply to agent tools by a corresponding connection:

{ “instructions”: “Assess the ASSIGNMENT below and create a JSON report that
adheres to the Schema defined below.”,
“agent”: { “role”: “Initial Assignment Assessor”, “responsibility”: “fully and
accurately assess Assignments” },
“additional_rules”: [ “Always analyze the full context of the Assignment before
making any assessments”, “Break down complex tasks into clear, actionable steps”,
],
“additional_blocks”: [
{ “name”: “YOU”, “content”: “This information represents you, the AI System that is
processing the rest of this information in your prompt.\nAI System (Entity)\n- Name:
LiveArena Networks\n- Type: AI System\n- Purpose: Enhance user productivity
through intelligent task automation\n- Core Capabilities:\n - Chat system
configuration\n - Learning system management\n - User interaction processing\n -
Security protocol implementation” },
{ “name”: “INTERACTION-004”, “content”: “Timestamp: 2025-01-
21T12:34:56Z\nContent: \“Strider (User): Yes, please teach me about LiveArena
Networks!\“” },
{ “name”: “ASSIGNMENT”, “content”: “Instructions: Create and configure new chat
for system learning\n Metadata: { }\n Additional Metadata: {\n \“source_interaction\”:
\“interaction-004\”,\n \“user_context\”:
{\n \“name”: \“Strider Agostinelli\”, \n \“role\”: \“Head of AI Research and
Development\”,\n \“interests\”: [\“python\”, \“tensorflow\”, \“neural_networks\”],\n
\“focus_areas\”: [\“optimization\”, \“performance\”]\n }\n}” } ],
“response_object_type”: “Initial Assignment Assessment”,
“run_agent_preprocessing”: true, “run_prompt_processing”: true,
“run_tool_preprocessing”: true, “run_agent_postprocessing”: true }
JSON Schema: {“assignment_name”: { “type”: “string”, “title”: “Name”,
“description”: “Short human-readable title for the Assignment.” },
“acceptance_criteria”: { “type”: “array”, “items”: { “type”: “string” }, “title”:
“Acceptance Criteria”, “description”: “A list of strings that contain the rules for
validating that the assignment has been completed.” }, “status_update”: { “type”:
“string”, “description”: “The human-readable progress report for the assignment.
This will be shown to the end-user, it's important to fill out.” }, “next_step_reasoning”:
{ “type”: “string”, “description”: “The reasoning behind the next step that needs to
be performed. Use this for your notes.”, “nullable”: true }, “action_name”: { “type”:
“string”, “description”: “A short human-readable header for the next action to be
performed.”, “nullable”: true }, “agent_name”: { “type”: “string”, “description”: “The
string name of the agent expected to perform the next action.”, “nullable”: true },
“instructions”: { “type”: “string”, “description”: “The explicit and detailed
instructions to be supplied to the agent.”, “nullable”: true } }

The AgentRequest is used to automatically produce the following prompt:

You are a specialized Initial Assignment Assessor. Your sole task is to fully and accurately assess Assignments. You must strictly adhere to the following rules: 1. Always analyze the full context of the Assignment before making any assessments. 2. Break down complex tasks into clear, actionable steps. 3. Identify all required tools, agents, or resources needed. 4. Establish clear acceptance criteria that can be validated. 5. Consider the user's context and expertise level when setting requirements. 6. Flag any potential risks or dependencies. 7. Provide realistic complexity and time estimations. 8. Ensure all assessment criteria are measurable and specific. 9. Maintain alignment with system capabilities. 10. Include necessary security and permission requirements.

-- START YOU -- This information represents you, the AI System that is processing the rest of
this information in your prompt. AI System (Entity). - Name: LiveArena Networks. - Type: AI
System. - Purpose: Enhance user productivity through intelligent task automation. - Core
Capabilities: - Chat system configuration. - Learning system management. - User interaction
processing. - Security protocol implementation. -- END YOU --
-- START INTERACTION-004 -- Timestamp: 2025-01-21T12:34:56Z Content: “Strider (User):
Yes, please teach me about LiveArena Networks!” -- END INTERACTION-004 --
-- START ASSIGNMENT -- Instructions: Create and configure new chat for system learning
Metadata: { } Additional Metadata: { “source_interaction”: “interaction-004”,
“user_context”: { “name”: “Strider Agostinelli”, “role”: “Head of AI Research and
Development”, “interests”: [“python”, “tensorflow”, “neural_networks”], “focus_areas”:
[“optimization”, “performance”] } } -- END ASSIGNMENT --
-- YOUR INSTRUCTIONS -- Assess the ASSIGNMENT above and create a JSON report that
adheres to the Schema defined below. -- END INSTRUCTIONS --
**Your response must strictly follow this JSON format: **
-- START JSON RESPONSE -- {{ [INITIAL ASSIGNMENT ASSESSMENT SCHEMA from above.] }}
-- END JSON RESPONSE --

This prompt is passed to the LLM 150, 160 for processing, and the response (which is completely generated by the LLM 150, 160) may look something like this:

{ “assignment_name”: “Configure Learning Chat System”, “acceptance_criteria”: [
“Implement secure chat environment”, “Configure learning parameters”, “Establish
monitoring system” ], “status_update”: “Initial assessment complete, action
created”, “next_step_reasoning”: “The next step involves configuring the chat
system with learning capabilities to meet the specified acceptance criteria.”,
“action_name”: “Configure Chat System”, “agent_name”: “Chat Agent”,
“instructions”: “Configure new chat system with learning capabilities, ensuring
security and monitoring are enabled.” }

In other words, the selected initial assignment assessor agent tool (also denoted “InitialAssignmentAssessor” herein) is invoked to, based on the initial assignment assessment dataset and any applicable directives or instructions automatically used by the system 100 depending on configurations in the database 200, for instance as encoded by corresponding entities and connections, provide a set of one, two or more acceptance criteria of the above-discussed type, as well as at least a first and/or next step (in this case, “Configure Chat System” using the “Chat Agent”) to take in order to eventually fulfill these acceptance criteria. The InitialAssignmentAssessor also provides free-text form reasoning. Any agent tool in the system 100 can be configured to provide such free-text reasoning regarding why the agent tool provided the output it did, and can generally be stored in the database 200 as a part of the entity representing the invoking of the agent tool and/or of the agent tool entity itself. This way, such reasoning can be used by subsequent invokings of the same or different agent tools by being provided as a part of a text prompt to that subsequently invoked agent tool. Again, such a subsequent prompt can be constructed entirely mechanically and automatically, without any LLM involvement.

From a general point of view, the method can comprise the performing, in a step 410, of a free-text input execution assessment, comprising automatically producing a respective text prompt to the LLM 150, 160, 412 requesting the LLM 412 to select and provide, based on (such as contained in the text prompt) the free-text input and to provide, in a respective response to the text prompt, a set of one or more initial tasks and a set of one or more acceptance criteria 413. The text prompt can be constructed to request the LLM 412 to provide/select the set of one or more initial tasks so as to fulfil at least part of the assignment and the set of one or more acceptance criteria being selected for evaluating the complete and successful performance of the assignment. The text prompt can be automatically produced based on the initial assignment assessment dataset. In case the initial assignment assessment dataset underwent preprocessing, the automatically produced text prompt in the free-text input execution assessment step can be produced based on the updated assignment assessment dataset instead of the original assignment assessment dataset.

The text prompt can be automatically produced by the system 100 based on at least the agent tool definition; any directives/instructions 411 pertaining to the agent tool; and the assignment defined by the free-text input 403. In particular, the text prompt can be produced to comprise one or more general directives regarding how to formulate the acceptance criteria, one or more context-specific directives regarding how to formulate the acceptance criteria as well as an instruction to follow the general and context-specific directives. This instruction can comprise an instruction to determine a set of context-specific directives to use based on the free-text input 403, for instance by the text prompt comprising several such context-specific directives and information 411 requesting the LLM 412 to choose applicable ones from said directives based on information provided in the text prompt being, being derived from or being related to/associated with the free-text input 403.

Further generally, the text prompt can be produced to request the LLM 412 to produce the set of one or more initial/first/next tasks and the set of one or more acceptance criteria without requesting the LLM 412 to associate individual ones of the set of one or more initial/first/ext tasks to individual ones of the set of one or more acceptance criteria, or even to explicitly request the LLM 412 not to make such association. As mentioned above, the acceptance criteria can be configured to not be subject change during the processing of a particular assignment, whereas a first/next task to perform in order to eventually fulfil the fixed assignment criteria can be re-evaluated from scratch in each iteration of the processing. Therefore, the system 100 can be configured not to map the first/next task to any one or more individual acceptance criteria but instead to the set of acceptance criteria as a whole given how far the processing of the assignment has come at the time when the initial/updated/first/next task(s) is/are to be evaluated.

After receiving the processed object from the agent, the system 100 can update the initial assignment assessment dataset with the new information to thereby form an assignment progress dataset 422 that will from this point on be used by the AssignmentHandler to track progress of the assignment:

{ “id”: “assignment-123”, “name”: “Configure Learning Chat System”, “status”:
“in_progress”, “priority”: “normal”, “instructions”: “Create and configure new chat
for system learning”, “acceptance_criteria”: [ “Implement secure chat environment”,
“Configure learning parameters”, “Establish monitoring system” ], “history”: “”,
“current_progress”: “Initial assessment complete, action created”, “completed_at”:
null }

In step 414, the acceptance criteria can hence be identified based on the output from the LLM 412. In addition, the one or more initial tasks can be identified based on the output from the LLM 412, and a first task of the set of one or more initial tasks can be identified. In a next iteration (see below), step 414 can involve the identification of the next task (which is then the first task in the first iteration). The assignment progress dataset 422 can also be updated to reflect the identified acceptance criteria and the first/next task. The assignment progress dataset 422 can be its own entity in the database 200, which is updated therein, such as using versioning as described above.

Mapping the fields from the initial assignment assessment dataset above, potentially after preprocessing thereof, the system 100 can automatically and mechanically build the following object, herein called an “action” object:

{ “agent_status”: “Created”, “tool_status”: “Created”, “assignment_id”:
“assignment-123”, “action_reasoning”: “The next step involves configuring the chat
system with learning capabilities to meet the specified acceptance criteria.”, “name”:
“Configure Chat System”, “agent_name”: “Chat Agent”, “instructions”: “Configure
new chat system with learning capabilities”, “agent_reasoning”: null, “tool_name”:
null, “tool_params”: null, “tool_output”: null }

This action object is then processed by the system 100 by passing it to an tool selection agent tool for generation of parameters for invoking a suitably selected tool, such as an agent tool, to perform the first task given the acceptance criteria defined in the assignment assessment dataset. The process for invoking this tool selection agent tool follows the same basic flow as described herein for invoking agent tools in general.

In general, the system 100 can be configured to, in a step 415, assess the first/next task and to select a tool suitable for performing the first/next task. This can involve assessing the first/next task, comprising automatically producing a text prompt to the LLM 150, 160, 419, requesting the LLM 419 to select and reference, in a respective response to the text prompt, a set of one or more tools 420 and optionally one or more task-specific parameters to supply to the set of one or more tools, the set of one or more tools being selected to perform the first/next task. As before, the text prompt can be automatically produced based on any relevant directives/instructions 418, as will be exemplified in the following.

First, the system 100 can be configured to create an AgentRequest object, in a way corresponding to the creation of the AgentRequest tool for assessing the assignment described above. This AgentRequest object can be created directly from the action above along with some pre-configured values, parsed together from information available to the system 100 including any preprocessing as described above but potentially without using any LLM 150, 160 involvement. The finished AgentRequest object may look like the following:

{ “instructions”: “Analyze the ACTION provided and select the most appropriate tool
along with required parameters. Generate a JSON report that follows the schema
defined below.”,
“agent”: { “role”: “Tool Selection Specialist”, “responsibility”: “select and configure
appropriate tools for actions” },
“additional_rules”: [ “Always validate tool availability before selection”, “Ensure all
required parameters are specified”, “Consider security implications of tool usage”,
“Verify parameter types match tool requirements”, “Include comprehensive
reasoning for tool selection” ],
“additional_blocks”: [
{ “name”: “YOU”, “content”: “This information represents you, the AI System that is
processing the rest of this information in your prompt.\nAI System (Entity)\n- Name:
LiveArena Networks\n- Type: AI System\n- Purpose: Enhance user productivity
through intelligent task automation\n- Core Capabilities:\n - Chat system
configuration\n - Learning system management\n - User interaction processing\n -
Security protocol implementation” },
{ “name”: “AVAI LABLE_TOOLS”, “content”: “chat_config: Configure chat system
parameters\n security_manager: Manage security settings\n learning_system:
Configure learning capabilities\n monitoring_system: Set up system monitoring” },
{ “name”: “ACTION”, “content”: “Name: Configure Chat System\nInstructions:
Configure new chat system with learning capabilities\n Status: Created\n Metadata:
{\n \“assignment_id\”: \“assignment-123\”,\n \“priority\”: \“normal\”,\n
\“acceptance_criteria\”: [\n \“Implement secure chat environment\”,\n \“Configure
learning parameters\”,\n \“Establish monitoring system\“\n ]\n}” } ],
“response_object_type”: “AgentToolSelect”, “run_agent_preprocessing”: true,
“run_prompt_processing”: true, “run_tool_preprocessing”: true,
“run_agent_postprocessing”: true }

A schema for agent tool selection may look like this:

{ “reasoning”: { “type”: “string”, “description”: “The rationale or justification for
selecting the specific tool and its parameters. This should provide a clear explanation
of how the chosen tool and parameters align with the agent's objectives and
contribute to the successful completion of the task.” },
“tool_name”: { “type”: “string”, “description”: “The unique identifier or name of the
tool that the agent has selected to use for the current task. This should match one of
the available tools in the system's tool registry.” },
“parameters”: { “type”: “object”, “description”: “A structured object containing the
input parameters required by the selected tool. The schema of this object will vary
depending on the specific tool and its expected inputs. The agent should populate
this object with the appropriate values based on its reasoning and the task
requirements.”, “additionalProperties”: true } }

Going through the corresponding steps as above but for the tool selection agent tool, a text prompt similar to the following may be achieved via automatic, mechanistical processing of the AgentRequest object above and/or based on the assignment progress dataset 422, again potentially using any applicable directives and/or instructions, but not involving any LLM 150, 160 use:

You are a specialized Chat Management Agent. Your sole task is to manage chat related actions. You must strictly adhere to the following rules: 1. Always validate tool availability before selection. 2. Ensure all required parameters are specified. 3. Consider security implications of tool usage. 4. Verify parameter types match tool requirements. 5. Include comprehensive reasoning for tool selection. 6. Document all configuration decisions. 7. Validate parameter constraints. 8. Consider system resource requirements. 9. Ensure monitoring capabilities. 10. Maintain audit trail of tool usage.

-- START YOU -- This information represents you, the AI System that is processing the rest of
this information in your prompt. AI System (Entity) - Name: LiveArena Networks. - Type: AI
System. - Purpose: Enhance user productivity through intelligent task automation. - Core
Capabilities: - Chat system configuration. - Learning system management - User interaction
processing. - Security protocol implementation -- END YOU --
-- START AVAILABLE_TOOLS -- chat_config: Description: Configure chat system parameters
Parameters: - chat_name (string): Name of the chat system. - secure (boolean): Enable
security features. - monitoring (boolean): Enable system monitoring. security_manager:
Description: Manage security settings. Parameters: - encryption (boolean): Enable end-to-
end encryption. - auth_type (string): [“basic”, “oauth”, “saml”]. - role_based (boolean):
Enable role-based access. - audit_logs (boolean): Enable security audit logging.
learning_system: Description: Configure learning capabilities Parameters: - learning_rate
(float): System learning rate (0.01-1.0). -feedback_enabled (boolean): Enable user feedback
collection. - auto_adjust (boolean): Enable automatic parameter adjustment. - save_history
(boolean): Save learning history. monitoring_system: Description: Set up system monitoring
Parameters. - metrics (array): List of metrics to track [“cpu”, “memory”, “network”, “errors”].
- interval (integer): Monitoring interval in seconds. - alerts (boolean): Enable alert
notifications. - retention_days (integer): Number of days to retain data -- END
AVAILABLE_TOOLS --
-- START ACTION -- Name: Configure Chat System Instructions: Configure new chat system
with learning capabilities Status: Created Metadata: { “assignment_id”: “assignment-123”,
“priority”: “normal”, “acceptance_criteria”: [ “Implement secure chat environment”,
“Configure learning parameters”, “Establish monitoring system” ] } -- END ACTION --
-- YOUR INSTRUCTIONS -- Analyze the ACTION provided and select the most appropriate tool
along with required parameters. Generate a JSON report that follows the schema defined
below. -- END INSTRUCTIONS --
**Your response must strictly follow this JSON format: ** -- START JSON RESPONSE -- {
“reasoning”: string, “tool_name”: string, “parameters”: { additionalProperties: true } } -- END
JSON RESPONSE -

As can be seen from the above, the text prompt can be produced to comprise a description of a set of available tools, and possibly also a specification of parameters accepted by each of the set of available tools (or other tool API information).

This prompt is then passed to the LLM 150, 160, 419, and after processing by the LLM 419 the response 420 may look like the following (“AgentToolSelect” data structure):

{ “reasoning”: “The chat_config tool is most appropriate for this initial action as it
provides the core configuration capabilities needed for the learning chat system. The
parameters enable security and monitoring as required by the acceptance criteria.”,
“tool_name”: “chat_config”, “parameters”: { “chat_name”: “LearningChat”, “secure”:
true, “monitoring”: true } }

As is illustrated by this, the text prompt can be produced to request the LLM 419 to provide, in response to the text prompt, text-form reasoning regarding selection of the set of one or more tools being selected to perform the first task. This reasoning text can then be added to the assignment progress dataset 422.

As an alternative, or supplementary, way of selecting a suitable tool for performing the first/next task, a similarity search 416 can be performed in the database 200, such as across all available tool entities in the database 200 or in a current working memory, to identify the most relevant one or ones for the given first/next task. This leverages the information 210 and available contextual data to dynamically discover tools that best match the requirements of the first/next task. By using the entire database 200, this also allows every agent tool to be able to use any other tool. This may then be in contrast to when using the LLM 419 to select a suitable tool, since the LLM 419 may be prompted (due to limited prompt size) to select a suitable tool among a limited (not database 200 wide) set of potential tools selected from, for instance, a constructed working memory.

In general, one or more tool entities of the entities in the database 200 can each represent a respective individual tool, and the selecting of the tool 425 for performing the assignment or sub assignment can then comprise selecting the tool 425 as a tool entity corresponding to an entity selected based on an extracted working memory or domain knowledge, in turn being extracted as described in FIG. 5 based on the free-text input 403. For instance, the tool 425 can be selected as a tool entity corresponding to an entity selected based on a ranking of the first set, the similar set or the ranked set (described above). The tool(s) found using the similarity search 416 can be provided in the text prompt to the LLM 419.

The vector/similarity search 416 can be performed by creating an embedding based on the AgentRequest data structure, either by embedding the data structure (such as the JSON) itself in its entirety or by extracting parameters from that data structure and embedding a text string constructed from the extracted parameter values. Then, the similarity search 416 can be performed across all tool entities in the database 200, or across a prefiltered set of the tool entities (using any suitable filter the parameters of which are specifically selected based on context, for instance based on available information regarding that no system 100 external functionality is to be invoked; or that the task is about string processing). The similarity score achieved can be used to rank the tool entities, being a proxy to their relevance to the first/next task, and the top-ranked tools can be selected for further assessment. The found/ranked/selected tools can be a set of one or more available tools and/or corresponding tool API information (such as for non-agent tools) 417. These tools 417 can then, for instance, be or be comprised in a set of available tools provided in the text prompt to the LLM 419 described above.

In general, the similarity search 416 can be configured to compare respective embeddings for entities in the database 200, such as for each of the tool-type entities in the database 200, to an embedding calculated based on one or more of information regarding the one or more initial tasks; information regarding the one or more updated tasks (see below); and a current version of the assignment progress dataset 422.

One primary advantage of using a similarity search to find a tool to use to perform a certain task is to allow the system 100 to adapt dynamically over time. For instance, since each tool entity may comprise information about previous executions of the tool and the particulars around each such execution (all such information can in turn be used to calculate the embedding of the tool entity), the system 100 will over time become better at identifying a suitable tool for a particular assignment or task with improved precision. It is noted that this does not require any manual input or other manual operations, but will follow naturally from usage of the system 100. Another advantage is that the system 100 can be configured to be capable of selecting the most appropriate tool for a certain task with increased probability. The use of similarity search to find a tool also allows scalability by supporting a growing library of tools for automatic selection and invoking.

In some embodiments, when arriving at step 421 potentially relevant information is already available to the system 100 regarding tools useful for performing the assignment, either for processing the assignment from scratch (by assessing the assignment and producing the initial tasks and acceptance criteria) or for performing the first/next task. Such potentially relevant information may comprise, for instance, the above-mentioned first set; the similar set; and/or the ranked set. In some embodiments therefore, the system 100 can be configured to investigate whether any of the entities in an available working memory or domain knowledge extracted as a part of the processing of the free-text input 403 are sufficiently similar to the task at hand. This can be done, for instance, by comparing a ranking value of each agent-type entity to a threshold; by prompting an LLM 150, 160 to determine if any one of a select number of high-ranking agent entities are useful for performing the task at hand, and so forth. The system 100 can be configured to determine that no entity corresponding to a tool was found with sufficiently high ranking, according to a used ranking measure, and as a consequence thereof to instead select the tool 425 for performing the first/next task as a tool corresponding to an entity selected based instead on similarity between the input text embedding and an embedding of the entity in question, based on a vector-based similarity measure, such as against the entire information 210 in the database 200, and further querying the LLM 150, 160 for which one of a set of several such selected tools is the most appropriate for the task at hand.

Irrespectively of how the most suitable tool 425 for performing the first/next task was found, the system 100 has now received an identifier of the selected tool 425, such as the “tool_name” of the AgentToolSelect object. This identifier can then be used, in a step 421, to select the tool entity from the database 200. It is noted that the selected tool 425 can be an agent tool or a non-agent tool.

It may be the case that no suitable tool was identified by the LLM 419. In this case, the tool select agent tool can be invoked again, with the same prompt, along with a free-text error message provided from the first attempt explaining that the tool selected doesn't exist. After a predetermined number of retries, the entire assignment processing process can instead fail for error handling by the system 100.

In this case, the ChatConfigTool was identified:

class ChatConfigTool(Tool): “““ Tool for configuring and initializing chat system
environments. Handles core chat system setup including security, monitoring, and
basic parameters. ”””
name = “chat_config”; description = “Configure chat system parameters and security
settings”; config = ToolConfig(validation_rules={ “required_params”: [“chat_name”,
“secure”, “monitoring”], “optional_params”: [“max_users”, “encryption_enabled”,
“audit_logging”] }, constraints={ “chat_name”: { “type”: “string”, “pattern”: “\hat{ }[a-zA-
Z0-9 _-]{3,50}$” }, “max_users”: { “type”: “integer”, “minimum”: 1, “maximum”: 1000 }
def execute(self, chat_name: str, secure: bool, monitoring: bool, max_users:
Optional[int] = 100, encryption_enabled: Optional[bool] = True, audit_logging:
Optional[bool] = True, **kwargs ) -> ToolResult: # Actual Logic would go here # return
self ._build_tool_result(ProcessStatus.SUCCESS.value, $”{chat_name} successfully
Created!”)

In a subsequent step 423, the selected tool 425 is invoked, optionally using (passing to the selected tool) the one or more task-specific parameters provided previously by the response from the LLM 419. The invoking of the tool 425 can generally take place in the corresponding manner as tool invoking described herein for other cases, and can involve either the invoking of an LLM 150, 160 (if the selected tool is an agent tool) or a rule-based functionality (if the selected tool is a non-agent tool). As indicated above, a set of two or more tools 425 can also be selected, for instance a series of tools 425 identified to perform a sequence of individual subtasks of a larger task. Irrespectively, the method can comprise collecting and parsing 427 a response 426 from the set of one or more tools 425.

The system 100 can be configured to perform a rule-based (based on predetermined as well as tool and case dependent configuration parameters) sanitizing and cleanup processing of the AgentToolSelect object, making sure that the parameters provided are correct and possibly also adding any additional information that the LLM 419 would not have generated, such as API keys or user email addresses.

Then, in case the identified tool (ChatConfigTool in this case) is a non-agent tool, the identified tool 425 is passed the parameters generated in the AgentToolSelect object into an execute method. The tool 425 logic can be configured to include functionality for reformatting and checking parameter values and validity and so forth. The non-agent tool 425 can be configured to, when invoked 423, either fail out with an error message, or to succeed with a tool output, such as an output string. Such an output can be anything from the results of a query, to the success message from sending an email message. In this example of the ChatConfigTool, the tool output is stored as a JSON representation of the string returned from the execution of the tool logic:

{ “status”: “SUCCESS”, “tool_name”: “chat_config”, “tool_output”: “Learning Chat
successfully Created!”,}

Hence, in general, the set of one or more selected tools 425 can comprise or be an algorithmic (non-agent) tool in the form of a piece of software encoding an algorithm, and the invoking 423 of the one or more tools 425 can then comprise invoking the corresponding piece of software as described. However, the set of one or more tools 425 can alternatively comprise or be constituted by one or more agent tools, the invoking 423 of which involves automatically producing a corresponding text prompt, feeding the text prompt to an LLM 150, 160, receiving in a response from the LLM 150, 160 a formatted data structure and then acting on the data structure. This is then performed as generally described above and herein. In case no suitable non-agent tool is identified to perform a certain task, the system 100 can comprise a general-purpose agent tool configured to handle requested functions in a certain way, such as by querying online for a solution or directing the user 122 in a particular direction for further information. In other cases, the first/next task identified is a complex task, such as setting up a meeting including several people, a task that needs analyzing in multiple substeps. In such and other cases, the text prompt provided to the LLM 150, 160 (invoking the tool 425) can be produced to comprise information from the assignment progress dataset 422 and/or the reasoning from the AgentToolSelect object. Furthermore, the text prompt can be configured to include metadata information extracted from and descriptive of the assignment processing so far, so that the LLM 150, 160 used in the invoking of the selected agent tool 425 is provided with relevant contextual background. It is realized that such an agent tool 425 in turn can be configured to invoke agent and/or non-agent tools in a recursive manner. This is illustrated in FIG. 4, by the arrow going from box 425 (the invoked tool) to box 405, wherein the free-text input processed in box 405 is, or is contained in, the structured output from the LLM 150, 160 of the invoked agent tool 425. After processing, the arrow going from “iterate” box 434 to box 426 wraps up the recursive call, where a final response/result of the recursively called agent tool is used in the production of the response/result 426 of the recursively calling agent.

Hence, the processing of the assignment can comprise invoking various non-agent and/or agent tools in call trees, whereby the invoking of one agent tool results in the invoking of another agent or non-agent tool in one, two or more layers. This processing by the system 100 can be completely automatic following the principles described above, finally resulting in a final result 435.

In general, the set of one or more tools identified to perform an identified task or assignment can comprise an agent-type assignment processing tool, in other words an agent tool that can generally be of the same general type as other agent tools described herein. The invoking of the one or more tools can comprise passing to this assignment processing tool one or more of the text prompts to and/or one or more of the responses from the LLM 150, 160. One or more of the text prompts used in the invoking of the one or more identified agent tools can be automatically produced from one or more structured datasets without using any neural network (such as LLM 150, 160) support.

The invoking of the one or more identified tools can comprise recursively invoking such tools for processing information. In such recursion, a task-specific parameter can be passed to the invoked tool as the free-text input defining the assignment, the task-specific parameter potentially being identified by the calling tool. Each tool that recursively calls another tool can be an agent tool, even if it is possible for non-agent tools to invoke other tools as a part of their logic algorithm. Each tool that is recursively called can individually be either a non-agent or an agent tool. Each of said tools can be represented by a respective entity in the database 200 defining the behavior of the tool in question and storing any or all information regarding previous executions (by invoking) the tool in questions, including specific instructions provided to the tool and/or any results from the execution.

Further generally, and as exemplified above, one or more of the text prompts used to invoke the one or more selected agent tools can be automatically produced to comprise information regarding a selected data structure schema. Then, each of the text prompts can selectively be automatically produced to request the LLM 150, 160 to provide the response to the text prompt using the data structure schema. Then, the system 100 can be configured to automatically parse 427 the response 426 using the data structure schema. The parsing 427 can comprise verifying that the response 426 adheres to the selected/specified data structure schema. In case the response 426 is found not to adhere to the data structure schema, the system 100 can be configured to again provide the text prompt to the LLM 150, 160, but including an error message in the text prompt. The error message may be automatically extracted from the response 426. Correspondingly, the system 100 can be configured to verify that the response 426 contains a requested piece of information, such as a success flag or a requested piece of information, and, in case the response is found not to contain the requested piece of information, again providing the text prompt to the LLM but also including an error message in the text prompt. For instance, a new prompt can be constructed comprising part of, or the entire, previous prompt as well as the error message, such as on the following format:

You were given the following prompt: [previous prompt]. You failed to process the text prompt, providing the following error message: [error message]. Please reprocess the text prompt, taking the error message into consideration.

In general, the error message provided in the updated prompt can comprise a piece of text provided in the response from the previous LLM 150, 160 call.

After step 427, the system 100 can be configured to, in a step 428, update the assignment progress dataset 422 with the new information that accrued as a result of the processing by tool 425. In particular, the assignment progress dataset 422 can be updated so that it after the first iteration (of one or more iterations, as mentioned) comprises one or more of pieces of information being or being derived from the free-text input 403; and the set of one or more identified acceptance criteria. In general, the updating of the assignment progress dataset 422 can comprise adding to the assignment progress dataset 422 the response from the one or more selected and invoked tools 425, and/or information derived therefrom, but keeping the one or more acceptance criteria unchanged in the assignment progress dataset 422 throughout the processing of the assignment. When agent tools are invoked recursively, the acceptance criteria can be global, in the sense that they are the same and immutable for each invoked agent tool during the entire processing of the assignment, including recursive calls. Alternatively, each invoked agent tool can be associated with its own acceptance criteria for performing the assignment allotted to that agent tool.

In general, the system 100 can be configured so that no agent tool or non-agent tool being involved in the processing of actions or tasks (such as one of the initial tasks or the first/next tasks) identified for moving the process in a direction of fulfillment of the acceptance criteria is configured or allowed to modify the acceptance criteria. However, the acceptance criteria can be allowed to change during the processing of the assignment in some embodiments. In a first example of this, each selected agent tool 425 performing one of the initial tasks or the first/next task (in each iteration of the assignment processing) can be requested to report any identified problems with respect to the acceptance criteria, such as logical contradictions. Upon such reporting, a different agent tool, not being used to perform any of the initial or first tasks in the assignment processing but being defined as a specialized acceptance criteria reviewing agent tool, can be called, by automatically producing a text prompt in which it is requested to review and, if necessary, amend the acceptance criteria based on the information provided by the reporting agent tool 425. In a second example, a specialized assignment processing monitoring agent tool can be employed, again not taking part in the performance of any of the initial or first tasks, to monitor the development of the assignment processing, such as by being provided the information in the assignment progress dataset 422, and to be requested, in a text prompt containing that information, to evaluate and propose any amendments to the acceptance criteria based on the progress so far of the assignment processing. Again, such monitoring agent tool can be requested to identify any problems with the acceptance criteria such as logical contradictions.

In concrete embodiments, after the tool 425 execution of the task is complete, the system 100 is configured to also update (such as in step 428) the action object (of the task) with the results of the invoking of the tool 425. This can include updating the status of the action object, recording any output data from the tool 425, and marking the task as completed. The action object can then be returned to the requestor, providing a comprehensive summary of the execution and its outcomes. The following is an example of the updated action object after the task (configuration of the new chat system according to the above):

{ “agent_status”: “SUCCESS”, “tool_status”: “SUCCESS”, “assignment_id”:
“assignment-123”, “action_reasoning”: “Configure new chat system with learning
capabilities”, “name”: “Configure Chat System”, “agent_name”:
“ChatSystemConfigAgent”, “instructions”: “Configure new chat system with learning
capabilities”, “agent_reasoning”: “The chat_config tool is most appropriate for this
initial action as it provides the core configuration capabilities needed for the learning
chat system. The parameters enable security and monitoring as required by the
acceptance criteria.”, “tool_name”: “chat_config”, “tool_params”: { “chat_name”:
“LearningChat”, “secure”: true, “monitoring”: true, “max_users”: 100,
“encryption_enabled”: true, “audit_logging”: true }, “tool_output”: “LearningChat
successfully Created!” }

Once the action object has been returned to the AssignmentHandler, the system 100 can be configured to perform an updated assignment assessment 429 to evaluate the results and determine the next step(s). This assessment ensures that the action object has been executed correctly and indeed works towards the fulfilling of the predefined acceptance criteria. In practice, there will be individual actions and tool usages that do not actually achieve any of the defined acceptance criteria, but in context anyway work towards fulfilling them. For example, Beth may be asking the system 100 to send an email to John. Because the system 100 does not know John's email address immediately, it might have to run a tool to find that email. Finding that email is not part of any acceptance criteria per se, but finding the email address is a step working towards fulfilling the acceptance criteria of having sent the email out.

Following the same steps as described above in relation to the initial assignment assessment, the system 100 can be configured to also perform the updated assignment assessment 428, resulting in the updated assignment progress dataset 422.

First, an AgentRequest object is created for the updated assessment. As is described above, this AgentRequest can be created directly from the assignment and action objects and without undergoing any LLM 150, 160 processing at this stage. This is an example of the final AgentRequest data structure:

{ “instructions”: “Assess the ASSIGNMENT and ACTION_RESULTS below to
determine completion status and next steps. Create a JSON report that adheres to the
Schema defined below.”,
“agent”: { “role”: “Updated Assignment Assessor”, “responsibility”: “evaluate action
results and determine assignment status” },
“additional_rules”: [ “Evaluate action results against acceptance criteria”, “Determine
if assignment objectives are met”, “Identify any remaining required actions”, “Ensure
all criteria are properly validated” ],
“additional_blocks”: [ { “name”: “YOU”, “content”: “This information represents you,
the AI System that is processing the rest of this information in your prompt.\n AI
System (Entity)\n - Name: LiveArena Networks\n - Type: AI System\n - Purpose:
Enhance user productivity through intelligent task automation\n - Core Capabilities:\n
- Chat system configuration\n - Learning system management\n - User interaction
processing\n - Security protocol implementation” }, { “name”: “ASSIGNMENT”,
“content”: “Name: Configure Learning Chat System\n Status: in_progress\n
Acceptance Criteria:\n - Implement secure chat environment\n - Configure learning
parametersIn - Establish monitoring system\n Current Progress: Chat system
configuration complete” }, { “name”: “ACTION_RESULT”, “content”: “Action:
Configure Chat System\n Status: Completed\n Tool Used: chat_config\n Parameters
Applied:\n chat_name: LearningChat\n secure: true\n max_users: 100\n monitoring:
true\n Output: Chat system successfully configured with security and monitoring
enabled” } ], “response_object_type”: “Updated Assignment Assessment”,
“run_agent_preprocessing”: true, “run_prompt_processing”: true,
“run_tool_preprocessing”: true, “run_agent_postprocessing”: true }

Based on this data structure, and any directives/instructions 430, the following prompt can be automatically constructed and provided to the LLM 150, 160, 431:

You are a specialized Updated Assignment Assessor. Your sole task is to evaluate action results and determine assignment status. You must strictly adhere to the following rules: 1. Evaluate action results against acceptance criteria. 2. Determine if assignment objectives are met. 3. Identify any remaining required actions. 4. Ensure all criteria are properly validated. 5. Consider dependencies between actions. 6. Verify security requirements are met
7. Validate learning system configuration. 8. Check monitoring system status. 9. Assess overall system readiness. 10. Maintain clear progress tracking.

-- START YOU -- This information represents you, the AI System that is processing the rest of
this information in your prompt. AI System (Entity). - Name: LiveArena Networks. - Type: AI
System. - Purpose: Enhance user productivity through intelligent task automation. - Core
Capabilities: - Chat system configuration. - Learning system management. - User interaction
processing. - Security protocol implementation. -- END YOU --
-- START ASSIGNMENT -- Name: Configure Learning Chat System. Status: in_progress.
Acceptance Criteria: - Implement secure chat environment - Configure learning parameters
- Establish monitoring system. Current Progress: Chat system configuration complete -- END
ASSIGNMENT --
-- START ACTION_RESULT -- Action: Configure Chat System. Status: Completed Tool Used:
chat_config. Parameters Applied: chat_name: LearningChat. secure: true max_users: 100
monitoring: true. Output: Chat system successfully configured with security and monitoring
enabled -- END ACTION_RESULT --
-- YOUR INSTRUCTIONS -- Assess the ASSIGNMENT and ACTION results above to determine
completion status and next steps. Create a JSON report that adheres to the Schema defined
below. -- END INSTRUCTIONS --
** Your response must strictly follow this JSON format: ** -- START JSON RESPONSE -- {
“is_completed”: boolean, “status_update”: string, “next_step_reasoning”: string?,
“action_name”: string?, “agent_name”: string?, “instructions”: string? } -- END JSON
RESPONSE

The response (assignment finalization information 432) from the LLM 431 can be according to the following example:

{ “is_completed”: false, “status_update”: “Chat system base configuration complete.
Learning parameters still need to be configured and monitoring system requires
additional setup.”, “next_step_reasoning”: “While the chat system is secure and
monitoring is enabled, we need to configure specific learning parameters to meet the
acceptance criteria.”, “action_name”: “Configure Learning Parameters”,
“agent_name”: “Learning System Agent”, “instructions”: “Configure learning system
parameters for the chat system, including feedback collection and automatic
adjustments.” }

The updated assignment progress dataset 422 is stored into the database 200, such as a new version of the assignment progress dataset 422.

As can be seen from the response above, the assignment is still not done. The chat system configuration is complete, and the next task is to configure the specific learning parameters. In general, the assignment progress dataset finalization assessment can comprise automatically producing the text prompt to the LLM 431, requesting the LLM 431 to evaluate the set of one or more acceptance criteria and to provide, in a response to the text prompt, the assignment finalization information 432 regarding if the set of one or more acceptance criteria have been fulfilled or not. As seen above, the text prompt can also be produced to request the LLM 431 to select and provide, based on the assignment progress dataset 422 and in a response to the text prompt, a set of one or more updated tasks, the set of one or more updated tasks being selected to at least partially fulfill the assignment. It is realized that this part of the finalization information 432 can be provided in a separate step from the determining of if the acceptance criteria have been met or not even if the number of LLM 150, 160 calls are fewer if requesting both of these things in the same prompt.

In case the acceptance criteria are indeed determined to have been met, the assignment or sub-assignment is finished, and the method jumps to step 434. At this step, the method iterates back to box 426 in case the processing of the assignment progress dataset 422 was in a called sub-agent tool. Otherwise, the method jumps to box 435 providing a final response or result from the now finalized top-most assignment processing (the entire assignment has been completed). The final result 435 can give rise to, or define, one or more calls to external functionality or otherwise result in an external action 436 such as storing information relevant to the assignment on an external memory area or invoking an external tool or function, such as sending an email. The final result 435 can alternatively or additionally give rise to, or define, one or more system 100 internal actions 437, such as responding to the user 122 in a chat environment. Irrespectively, the updated response 435 is stored into the database 200, possibly as metadata to a new version of the assignment entity.

Once the assignment has hence been evaluated as complete, it can be marked as “completed” and be provided with an updated “completed_at” timestamp. Any other fixed cleanup can also take place. The following is an example of the finalized assignment entity as stored in the database 200. As can be seen, all relevant information pertaining to the assignment, its processing and the results thereof can be stored in the entity:

{ “id”: “assignment-123”, “name”: “Configure Learning Chat System”, “description”:
“Implementation of a secure learning-enabled chat system with monitoring
capabilities”, “status”: “completed”, “priority”: “normal”, “instructions”: “Create and
configure new chat for system learning”, “acceptance_criteria”: [ “Implement secure
chat environment”, “Configure learning parameters”, “Establish monitoring system”
],
“history”: [ { “timestamp”: “2025-01-21T12:34:56Z”, “status”: “created”, “message”:
“Assignment created from user request” }, { “timestamp”: “2025-01-21T12:35:00Z”,
“status”: “in_progress”, “message”: “Initial assessment complete, starting chat
system configuration” }, { “timestamp”: “2025-01-21T12:36:00Z”, “status”:
“in_progress”, “message”: “Chat system base configuration complete, proceeding
with learning parameters” }, { “timestamp”: “2025-01-21T12:37:00Z”, “status”:
“in_progress”, “message”: “Learning parameters configured, setting up monitoring”
}, { “timestamp”: “2025-01-21T12:38:00Z”, “status”: “completed”, “message”: “All
acceptance criteria met, assignment completed successfully” } ], “current_progress”:
“Assignment completed successfully. Chat system configured with security, learning
capabilities, and monitoring enabled”, “completed_at”: “2025-01-21T12:38:00Z”,
“updated_at”: “2025-01-21T12:38:00Z”, “metadata”: { “system_config”: {
“chat_name”: “LearningChat”, “security_enabled”: true, “learning_enabled”: true,
“monitoring_enabled”: true }, “completion_metrics”: { “total_actions”: 3,
“execution_time”: 240, “success_rate”: 100 } },
“non_embedded”: { “source_interaction”: “interaction-004”, “user_context”: {
“name”: “Strider Agostinelli”, “role”: “Head of AI Research and Development”,
“interests”: [“python”, “tensorflow”, “neural_networks”], “focus_areas”:
[“optimization”, “performance”] }, “system_details”: { “chat_config”: { “secure”: true,
“max_users”: 100, “monitoring”: true }, “learning_config”: { “learning_rate”: 0.01,
“feedback_enabled”: true, “auto_adjust”: true, “save_history”: true },
“monitoring_config”: { “metrics”: [“cpu”, “memory”, “network”, “errors”], “interval”:
60, “alerts”: true, “retention_days”: 30 } } } }

After the final assignment entity has been created, various post processing 438 can take place based on the assignment entity. For instance, a memory extraction post processing step can be configured to take the completed assignment entity and its tasks to extract new memories related to the assignment. This might include discovering, in the database 200, new entities or updating connections between existing entities, and can take place as is generally shown in and described in connection to FIGS. 5-7. The extracted memories can themselves be stored into the database 200, such as in the form of generated or updated entities, connections and/or interactions (FIG. 7). In general, the tool response 426 can be collected from the selected tool 425 and a set of used items referred to in the tool response 426 can be determined, for instance using non-LLM NLP tools 131 or by prompting the LLM 150, 160, as described above in connection to FIG. 7. Each of the used items can then be mapped to zero corresponding stored items or to (exactly) one corresponding stored item in the database 200. If the used item is mapped to (exactly) one corresponding stored item, metadata relating to the corresponding stored item can be updated in the database 200 using metadata relating to the used item. If the used item is mapped to zero corresponding stored items, the used item can be added to the database 200.

If, instead, the assessment in steps 429-433 shows that the finalization information indicates that the set of one or more acceptance criteria have not been fulfilled, the method can reiterate back to step 414 (via step 428) using the set of one or more updated tasks instead of the set of one or more initial tasks to select a next task (the first task in that next iteration) to perform in order to eventually fulfil the acceptance criteria.

It is noted that, for each assignment or sub-assignment, the acceptance criteria are determined at the initial assignment assessment 409 and thereafter do not change during the processing of the assignment or sub-assignment (apart possibly from in the above-described exceptions). In case the processing of a particular assignment results in the generation of a sub-assignment via the invoking of an agent tool in step 423, that sub-assignment can be provided with its own set of one or more acceptance criteria at step 409, and those acceptance criteria will then also not change during the processing of the sub-assignment. When the sub-assignment is finalized and control is reverted back to the parent assignment, the acceptance criteria of the parent assignment are still remembered and are continued to be applied. Hence, this can work in a way similar to a function call stack in a high-level programming language with one main difference in that the execution is dynamically adapted by repeated assessments using the LLM 150, 160 for execution of each assignment.

To the contrary, the set of one or more tasks identified to fulfill the acceptance criteria can be generally subject to change, and in particular the first task in each iteration. In fact, the set of one or more updated tasks can be different from the set of one or more initial tasks, even if not counting the first task. The system 100 can be configured to, in every iteration during the processing of each assignment or sub-assignment, identify the set of one or more tasks from scratch, including a next first task to be performed. The assignment progress dataset can be configured to comprise the first task, but, since the set of tasks will generally change every iteration, the assignment progress dataset can be configured not to comprise any other of the set of one or more updated tasks than the first/next task (with the possible exception of a complex first task comprising two or more sub tasks to be performed in series). The system 100 can be configured to identify the set of one or more tasks, and in particular the first/next task, to not completely fulfill the acceptance criteria but to merely perform an initial set of one or more steps towards such fulfillment. After this task, or these tasks, have been performed, reevaluation can yield a different set of tasks, iteratively adjusting the course of action towards the eventual fulfillment of the acceptance criteria iteratively. In various embodiments, hence, the assignment handler does not know after the construction of the initial assignment assessment dataset, the full course of actions required to completely fulfil the acceptance criteria.

In some embodiments, the system 100 can be configured to, such as in each performance of step 428 in each iteration of the processing, update the assignment progress dataset 422 to comprise, after the updating of the assignment progress dataset 422, a history of responses from the one or more tools 425 invoked in previous iterations. The text prompt to the LLM 431 can then be configured to comprise the whole, or a part, of this history of responses.

In a subsequent step 439, the method ends.

It is understood that the response/result 435 can be used to produce a response to an input from a machine or human user 122, the response to the input being or being derived from the response 435. For instance, the response 435 can be in the form of a data structure following a specific schema, where a response to the input can be part of this data structure in a way allowing the system 100 to automatically and deterministically extract the response to the input from the data structure. It is further realized that, in methods according to FIG. 4 and other methods described herein producing such a response to an input, the response to the input can be determined based on the above-discussed similar set and/or ranked set as a result of the response to the input being determined based on a working memory or a domain knowledge created using the methodology illustrated in FIG. 5 as a part of the producing of the assignment by the system 100.

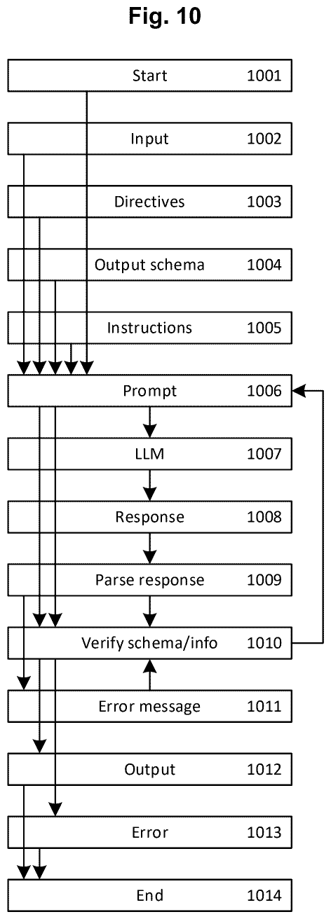

FIG. 10 illustrates a flow that can be used for by system 100 for error handling when invoking an agent tool in any situation. In a first step 1001, the method starts.

In a subsequent step 1006, a text prompt is automatically produced as described and exemplified above, based on available information, including one or more of an input 1002 (such as the free-text input discussed above) being or being converted into text format; directives 1003, such as automatically fetched from a directive connection based on the graph information in the database 200 as described above; an output schema 1004 that the LLM 150, 160 is explicitly requested (in the text prompt) to use for the response; and case-specific instructions 1005, specifying to the agent tool what to do.

In a subsequent step 1007, the text prompt is provided to the LLM 150, 160 and, in a step 1008, the LLM 150, 160 provides a response to the text prompt. In a subsequent step 1009, the response is parsed by the system 100.

In a subsequent step 1010, the parsed response is verified by the system 100 against the information 1002, 1003, 1004 and/or 1005. The verification can comprise checking that the response adheres to the output schema 1004 (which can be verified by the parsing in step 1009 being successful or not). The verification can comprise checking that the response contains a particular piece of requested information, such as based on the instructions 1005. The text prompt 1006 can be configured to request well-defined information in a format that can be verified in a well-defined and deterministic manner. This way, the verification can be completely automatic and not rely on any LLM 150, 160 prompting for the verification itself.

In case the parsing in step 1009 was unsuccessful, an error message 1011 to this end can be produced and added to a verification result data structure or text string. The error message 1011 can alternatively or additionally be provided from the LLM 150, 160 in the response 1008 and extracted using the parsing in step 1009. In the latter step, it was hence not the parsing that was unsuccessful but the processing by the LLM 150, 160 in step 1007, for instance by the LLM 150, 160 not being able to provide a requested piece of information provided the information in the text prompt, or simply a timeout of the LLM 150, 160. Irrespectively, in case the verifying result is not success, the text prompt 1006 can be reposed to the LLM 150, 160, but possibly together with, or incorporating, the error message 1011. Reference is here made to the description of step 427 (above) for details. The new response 1008 from the LLM 150, 160 in the second or next iteration of step 1007 is treated in the same or corresponding manner as the first response.

If the verification 1010 result is success, the output 1012 is provided to whoever invoked the tool.

In case the verification in step 1010 fails after a predetermined number of attempts, the error 1013 results data are established, such as in the form of a data structure specifying the error, for instance containing the entire history from steps 1002-1010 so far in the procedure. This data structure can then be consumed (automatically parsed) by whoever invoked the agent as the result in an error handling routine of the same or corresponding types as the one illustrated in FIG. 10. In other words, errors can be escalated/cascated (propagated to a higher level of an agent tool call stack of the type described above), and in case a part of any assignment or task fails irrevocably the entire assignment or task may fail after possible escalation to a top-most stack level. This can, for instance, result in a response to a querying user 122 “Unfortunately something went wrong.” or similar.

In a subsequent step 1014, the method ends.

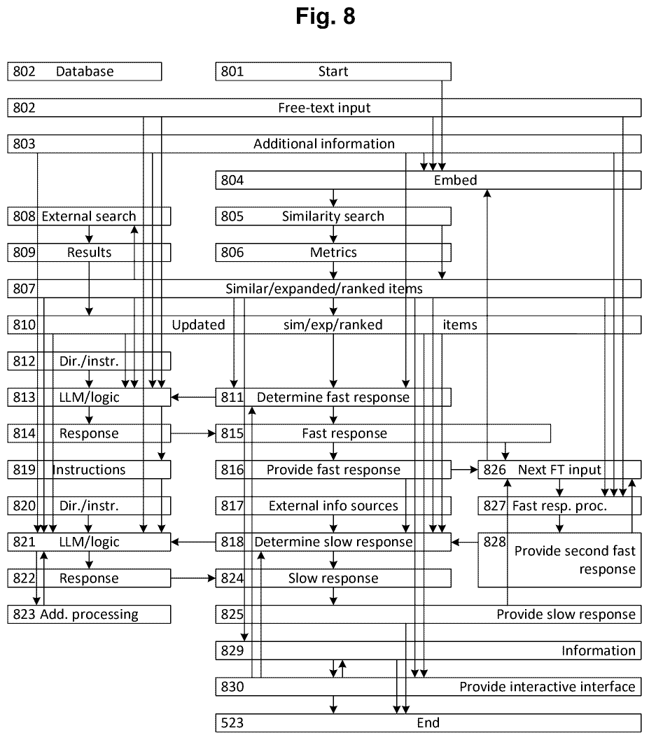

FIG. 8 illustrates a method for the system 100 to provide interactive communication in relation to a user 122. The method according to FIG. 8 can be used together with any one or more of the above-described flows, such as the flows described in connection to one or more of FIGS. 4-7 and 9-10; or for instance forming part of the flow shown in FIG. 4. In a first step 801, the method starts.

In a subsequent step 804, an embedding is calculated, such as the above-described input text embedding. The embedding can be calculated based on a text-format input 802, such as the above-described free-text input, and possibly also additional information 803 as described above, such as context information and/or information automatically gleaned from graph information in the database 200 in relation to one or more items relevant to the free-text input 802, parts of an available working memory and/or a domain knowledge.

Based on the embedding 804, a vector similarity search can be made in a subsequent step 805, comparing the embedding 804 to respective embeddings of the stored items in the database 200, using a vector-based similarity measure. In a step 806, various metrics can be applied as described, for instance, in connection with FIG. 5 (corresponding to step 505) to refine the ranking of the items. Namely, in a step 807, a similar or ranked set (as discussed above) of items can be selected as a subset of the items stored in the database 200, based on the similarity search 805. In general, this can include selecting the similar set as a subset of the stored items in the database 200 based on the similarity search; identifying the expanded set of items by optionally expanding the similar set based on one or both of connections in the database 200 interconnecting entities in the similar set and entities in the database 200 interconnected by connections in the similar set; and identifying the ranked set as a subset of the similar/expanded set based on a ranking rule. At this point, a working memory has been constructed based on the input 802 in a way that can correspond to the flow shown in FIG. 5.

In some embodiments, the system 100 can be configured to identify one or more of the items in the similar/ranked set 807 that potentially require further information for processing. For instance, in case a particular country, language or person arises as highly ranked in the ranked set 807, the system 100 can be configured to automatically attempt to expand the information in the working memory for that entity. This can involve the system 100 automatically performing one or more external searches 808, such as web searches or directed searches in specific databases (such as for a weather forecast in relation to a particular geographic area or for an updated stock quote), providing search results 809. In such cases, the search results 809 can be added to the constructed working memory (by constructing corresponding entities, connections and/or interactions and populating such constructed items with the found information), or at least resulting in an updated similar/ranked set of items 810. Generally, the similar/expanded/ranked set 807 can be updated using the results 809 so as to form the updated similar/expanded/ranked set 810. This can be performed for any or all of the iterations of the method (see below).

In a subsequent step 811, a fast-response tool is invoked. As used herein, a “fast-response tool” is an agent tool specifically configured to provide a response to an input (such as a statement, a query or a request) without requiring more than one or a few calls to one or more LLM 150, 160. Preferably, only one such call is made in said invoking of the fast-response tool, the one LLM 150, 160 call resulting in a response provided to the human or machine user 122. Furthermore, the complex assignment processing of the type described in connection to FIG. 4 is not performed for the fast-response tool. In other words, an agent tool is not used to iteratively process the input as an assignment as a part of the invoking of the fast-response tool.

Hence, the invoking of the fast-response tool comprises automatically producing a text prompt to the LLM 150, 160, 813 requesting the LLM 813 to, in a response to the text prompt, provide a first fast response 815 to the free-text input 802. The text prompt can be automatically constructed, potentially using directives/instructions 812, in a way that can be as generally described above for agent tool usage. In various embodiments, the invoking of the fast-response tool comprises producing the text prompt based on, such as containing or referring to, the similar/ranked items; and correspondingly for any external search 808 results 809. In general, any information belonging to the constructed working memory at this point in the process can be used when constructing the text prompt to the LLM 813, such as added as part of the text prompt. For the fast response 815, an SLM (Small Language Model) can be used instead of the LLM 813.

In a subsequent step 816, the fast response is provided to an inputting party, such as a user 122, providing the input 802. Preferably, the time delay between the provision to the system 100 of the free-text input and the provision to the user 122 of the fast response is less than 10 seconds, such as less than 5 seconds, such as less than 2 seconds. It is realized that the parameters of the system 100, such as the type of similarity search to use in step 805, the number of similar items 807 to select and so forth, can be dynamically adapted to achieve such fast response speeds, possibly at the expense of precision in the response. Specifically, the text prompt used to produce the fast response 815 can be configured to specifically request the LLM 813 to treat any aspects of the free-text input 802 that require more analysis or searching than what is readily and immediately available from the information in the text prompt, such as by inferring such aspects, as information that for the time being is unknown, and to produce the fast response 815 so that it contains information telling the user 122 that the system 100 will revert to such issues later.

As an alternative, the fast-response tool can be invoked by producing a text prompt to the LLM 813 based only on the free-text input and possibly any readily available additional information 803 of the type described above, not requiring any vector similarity searches 805 for the production of the fast response 815. This provides an even faster fast response 815. At any rate, step 805 may be performed for the benefit of the slow response (see below).

Namely, in a step 818, a slow-response tool can invoked. In contrast to the fast-response tool, a “slow-response tool” can be an agent tool configured to be invoked in the general manner illustrated in FIG. 4, in other words by processing the free-text input 802 as an assignment, potentially being processed using identified acceptance criteria as described above. Any combination of one or more additional parts of the flow shown in, and discussed above in relation to, FIG. 4 can form part of the determination 818 of the slow response. In particular, the invoking of the slow-response tool can comprise calculating an input text embedding (such as the embedding 804) based on at least one of the free-text input 802 and one or more identified items automatically identified in the first free-text input based on text processing, such as using non-LLM NLP tools 131 and/or LLMs 150, 160 (and/or other additional information 803 as discussed). In general, the invoking of the slow-response tool can involve automatically producing a text prompt to an LLM 150, 160, 821, requesting the LLM 821 to, in a response to the text prompt, provide a response 822 to the free-text input 802. Since the invoking of the slow-response tool, based on its prompt, can involve more elaborate reasoning and/or investigation than the corresponding invoking of the fast-response tool, the response 822 may be in relation to information not directly forming part of the free-text input 802, but instead being referred to, or inferred by, the free-text input 802; rather than (or in addition to) a direct response to a question, query or statement in the free-text input 802 itself.

In general, the one or more text prompts used to produce the slow response can comprise information regarding a certain number of items stored in the database 200, normally forming part of a working memory constructed based on the free-text input 802. Correspondingly, the one or more text prompts used to produce the slow response can comprise information regarding a certain number of pieces of metadata regarding the items in the database 200 (again normally arising as part of the constructed working memory, such as forming part of the corresponding items in the database 200). These one or more prompts will hence comprise text information regarding these items and/or text information reflecting or being this metadata. In some embodiments, the number of items and/or the number of pieces of metadata can be higher for the one or more text prompts used to produced the slow response can be higher than the corresponding number for the one or more text prompts used to produce the fast response. Said differently, the text prompt text in the one or more LLM 821 calls can contain more information from the database 200 as compared to the text prompt text in the one or more LLM 813 calls.

In some cases, the one or more text prompts used to produce the slow response comprise information not explicitly present in the database 200 but merely inferred from the database 200. In some embodiments, the one or more text prompts used to produce the slow response comprise parts of, or the entire, response from the LLM 813 call (such as the fast response).

The text prompt to the LLM 821 can be automatically constructed based on any directives or instructions 820 in the general manner as described above, and can be based on the set of similar/ranked/updated items 807 and/or 810. As mentioned, the text prompt can also be constructed based on, such as comprise in part or whole, the response 814 provided from the LLM 813 producing the fast response 815 and/or the finished fast response 815 itself. This allows the LLM 821 to capture any queries or requests not addressed by the fast response and that need supplementation, clarification or similar. In some cases, the text prompt to the LLM 813 is constructed to request the LLM 813 to provide explicit information regarding any aspects inferred by the free-text input 802 that are not dealt with in the fast response 815 and that the slow response 824 should take care of, and then the text prompt to the LLM 821 may comprise explicit information about such aspects, for instance by identifying the aspect(s) in the response 814 and adding them to the text prompt provided to the LLM 821, More generally, the structured output from the LLM 813 can contain instructions 819, such as a description of an outstanding issue that the LLM 821 needs to handle, that the LLM 813 may be prompted to indicate in the response 814. The slow response may also be produced based on (for example as a part of the text prompt to the LLM 821), results from external information sources 817, such as results from searches automatically performed by the system 100 as a part of the processing of the slow prompt.

It is realized that, as used herein, the terms “fast response” and “slow response” are labels to contrast the two responses, and that their “fastness” and “slowness” are relative to each other. For instance, the LLM 150, 160, 821 call of the slow response tool would likely not explicitly request the LLM 150, 160, 821 to be “slow” in its response or similar-instead, it is the more complex and challenging calculations required for the “slow response” that will generally mean the slow response taking longer time to determine as compared to the “fast response”. This may, for instance, manifest in the slow response requiring multiple LLM 150, 160, 821 calls to process.

In general, the LLM 821 may be, or may be invoked by, an assignment assessing tool agent of the general type described above, and the processing resulting in response 822 may involve two or more LLM 150, 160 calls as orchestrated by such an assignment assessing tool to fulfil identified acceptance criteria (see the description in relation to FIG. 4, above). The slow response 824 is then provided, in a step 825, such as to the same recipient 122 as the fast response 815 was provided to in step 816. The providing 816 of the fast response 815 to the recipient 122 can generally take place at a first time, and the providing 825 of the slow response 824 to the recipient 122 can generally take place at a second time, the second time generally being later than the first time. In other words, the system 100 can be configured to provide the fast response 815 to the recipient immediately or close to immediately, creating the impression to the user 122 of a naturally flowing conversation; whereas the slow response 824 can be provided after some delay (and associated deeper analysis). It may be the case that the system 100 is configured to provide both the fast 815 and slow response 824 to the recipient 122 as soon as possible after the respective response 815, 824 is finalized, but that the slow response 824 simply takes longer to calculate than the fast response 815 and/or the slow response 824 requires input from the fast response 815 (as described above).

As mentioned, the slow response 824 can be produced based on the output 819 from the LLM 813 producing the fast response 815. On the other hand, the processing of the slow response 824 may take considerably longer time than the processing of the fast response 814, such as at least 10 times longer time than for the fast response 814 and/or at least 10 seconds from the provision of the free-text input 802 to the system 100. Again, this time can be dynamically controlled by the system 100, by corresponding selection of parameter values used during similarity searches and so forth. At any rate, the invoking (processing) of the fast-response tool and the slow-response tool can be performed at least partly in parallel, whereby the processing of the slow response 824 starts before step 816. Such parallel processing can, for instance, comprise the construction of a working memory used in the production of both responses 815, 824. It is realized that any working memory (similar/ranked/updated items 807, 810) used to process the fast response 814 can also be used to process the slow response 824, and the processing of the slow response 824 can then comprise additional steps to further refine, analyze or otherwise use the working memory, such as using additional LLM 150, 160 calls within the realm of additional agent tools, such as described, for instance, in connection to FIG. 4.

In general, the invoking of the fast-response agent tool and the invoking of the slow-response agent tool can both be configured to involve automatically producing a text prompt to the LLM 813, requesting it to, in response to the text prompt, provide the fast response 815 and also, in response to the same text prompt, to provide information instructive of invoking one or more tools to process the free-text input 802. In other words, the call to the LLM 813 can be a part of the invoking of both the fast-response tool and the slow-response tool. Then, the method can comprise invoking each of the one or more different agent (and possibly also non-agent) tools to process the free-text input 802 to produce the slow response 824. This process can then take place as generally described in connection to FIG. 4, such as using acceptance criteria. Box 823 generally shows such additional processing that can be conducted to process the slow-response tool invocation.

At a later time, in a step 826, the system 100 can receive a second free-text input. The receiving of the second free-text input takes place after the receiving of the free-text input 802, but can otherwise take place in the same or corresponding way including what has been said above regarding the format and sender of the free-text input 802. In particular, one and the same human or machine user 122 can be the sender of both the free-text input 802 and the second free-text input, and the same human or machine user 122 can also be the recipient of the fast response 815 and/or the slow response 824. The second free-text input can be received in step 826 at a time after the first-iteration step 815, and can be received in step 826 before or after the provision of the first-iteration slow response 824 in step 825. In case the second text input 826 is received before step 811, the first 802 and second 826 text inputs can simply be concatenated and treated as the first text input 802.

In a subsequent step 827, the same or different corresponding fast-response tool as described above can again be invoked to produce a second fast response to the second free-text input. This invoking can comprise automatically constructing a corresponding prompt in a way that can correspond to what has generally been said above in relation to the providing of the first-iteration fast response in step 816. Generally, the text prompt can be constructed based on, such as comprising part of the whole of, the first-iteration free-text input 802, the second-iteration free-text input 826, any additional information 803 with respect to any of the free-text inputs 802 and/or 826; the similar/ranked/updated items 807 and/or 810; the first-iteration fast response 815; and/or (if available) the first-iteration slow response 824. It is noted that the processing 827 can comprise updating a working memory already produced based on the free-text input 802, or constructing a new working memory, such as comprising steps 804-810 based on the second-iteration free-text input 826 or the concatenation of the free-text inputs 802, 826; and the processing 827 potentially comprise calling the (same or different) LLM 813. The input text embedding 804 can be recalculated for the purposes of the second fast response (and/or the second slow response, see below), such as based on at least one of the second free-text input 826 and one or more identified items automatically identified in the second free-text input 826 based on text processing, for instance non-LLM NLP tools 131. The input text embedding 804 can further be recalculated based on the first free-text input 802 and/or one or more of the identified items automatically identified in the first free-text input 802 based on text processing, such as non-LLM NLP tools 131. In general, the second fast response can be produced to respond to the second free-text input 826 in a way corresponding to the relation of the first fast response 815 to the free-text input 802, but possibly taking into consideration the communication (including the first fast response 815) thus far. Further generally, the one or more text prompts used to produce the second fast response can comprise both the first free-text input 802 and the second free-text input 826. Similarly, the one or more text prompts used to produce the second fast response can comprise the first fast response 815.

In a step 828, the produced second fast response is provided to the recipient 122.

In some embodiments, the first-iteration fast response 815 comprises a request (to the user 122) for additional information automatically identified, by the LLM 813, to be required to be able to respond to a question or query, or to be able to perform a task or assignment, defined in the free-text input 802. The text prompt to the LLM 813 can comprise a request to the LLM 813 to identify any such required additional information. Then, the information provided in the second or subsequent free-text input 826 can be added to the working knowledge or otherwise making it available to the slow-response agent so that an invoking of the slow-response agent can take the added required information into account. In particular, in case the second free-text input 826 is received before the provision of the first-iteration slow response 824, the additional information provided by the user 122 in the second free-text input 826 can be fed into the processing of the slow response 824, such as by being added to an assignment progress data structure 422 used in the processing of the slow response 824. In general, the one or more text prompts used to produce the slow response 824 can comprise both the first free-text input 802 and the second free-text input 826. Further generally, the one or more text prompts used to produce the slow response 824 can comprise the first fast response 815.

In some embodiments, the invoking of the slow-response tool further comprises receiving one or more pieces of information from one or more of the external information sources 808. Then, the text prompt to the LLM 821 can be produced based on, such as comprising or referring to, said one or more pieces of information. The one or more pieces of information can be explicitly provided by the user 122, such as via any of the free-text inputs 802, 826; it can be requested by the slow-processing tool (such as using a web searching non-agent tool or a database query non-agent tool) after the slow-processing tool inferring the need for the external information based on the free-text input 802, 826; and so forth. Based on the second free-text input 826, a second-iteration slow response 824 can be determined and provided in the corresponding manner as described above for the first-iteration slow response.

The method can iterate from step 816 or step 825 back to step 826, where a new free-text input 826 is provided by the user 122 in each iteration. Any or all of the available information 802, 803, 807, 808, 809, 816, 824, 826 can be kept in working memory of the system 100 and used in any or each subsequent iteration to be used in the construction of the text prompt to LLM 813 and/or 821. This way, the system 100 can identify and pose follow-up questions or requests, and the user 122 can refer back to previously provided information and assume that the system 100 is context aware over the entire duration of the communication. For each iteration, the accrued information can be stored in the database 200 as described in connection to FIG. 7, and the working memory can be incrementally updated using the newly arrived information via free-text inputs 802, 826. This way, the system 100 can continuously update the information 210 in the database 200 with the new information received from the user 122 (802, 826) and any external information sources (809), as well as any new associative graph information resulting from such new information, and the system 100 can also shift the focus of the communication by dynamically amending/supplementing the held working memory in reaction to whatever the user 122 provides.

In an example, user 122 Beth sends two separate chat messages to the system 100 via the chat: “I want you to order me food.” and then “I want pizza.”

As the system 100 receives each of these messages, it wraps the incoming chat data with metadata and places it into a chat message processing queue. In the case of the first message, the following data structure is constructed and queued. It is also used to create a corresponding interaction which is stored in the database 200:

{ “input”: “I want you to order me food.”, “source_type”: “chat”, “source_id”: “chat-
001”, “metadata”: { “author_id”: “entity-beth”, “timestamp”: “2025-04-13T12:00:00Z”
} }

The second message is treated in the corresponding manner and independently queued in the chat message processing queue, now containing [“chat-001”, “chat-002”].

The system 100 is configured to pull messages from the chat message processing queue and to process them. If multiple messages in the chat message processing queue are from the same conversation (connected or associated with the same conversation entity), the system 100 can be configured to process them together. However, the system 100 can be configured to always handle messages from different conversations independently.

In case the queue only contains chat-001, a chat processor of the system 100 pulls chat-001 from the queue and begins processing it in isolation because no other relevant messages are in the queue. If instead both chat-001 and chat-002 are present and are identified by the chat processor to belong to the same conversation, both messages are pulled and advanced together through the pipeline:
{“conversation_id”: “conversation-123”, “messages”: [“chat-001”, “chat-002”]}

Then, the system 100 can be configured to create structured memory representations for each one of the one or more individual messages. Every message is independently converted into a ChatMessage entity. For chat-001:

{ “id”: “chat-001”, “type”: “CHAT_MESSAGE”, “description”: “I want you to order me
food.”, “non_embedded_metadata”: { ... } }

If chat-002 is also in the queue:

{ “id”: “chat-002”, “type”: “CHAT_MESSAGE”,
“description”: “I want pizza.”,
“non_embedded_metadata”: { ... } }

In a next step, a working memory is constructed based on the message(s). This step prepares messages for similarity search by segmenting and labeling them, then performing that search against the items stored in the database 200. The result is a scored and ranked set of memory objects (items) that will be used as working memory in downstream processes. If only chat-001 was pulled from the queue, the system 100 chunks and labels chat-001, performs similarity search, and retrieves relevant memory objects (this can be performed in the ways generally described above):

{ “source_id”: “chat-001”, “labels”: [“order”, “food”], “matches”: [
{ “id”: “entity-order”, “type”: “CONCEPT”, “similarity_score”: 0.71, “similarities”: {
“order”: 0.71 }, “additional_metrics”: { “semantic_density”: 0.68,
“network_connectivity”: 0.77 } },
{ “id”: “entity-food”, “type”: “CONCEPT”, “similarity_score”: 0.65, “similarities”: {
“food”: 0.65 }, “additional_metrics”: { “semantic_density”: 0.62,
“network_connectivity”: 0.74 } } ] }

In case both chat-001 and chat-002 were pulled, they are instead processed together. Each message is labeled and searched, and their results are merged:

{ “inputs”: [“chat-001”, “chat-002”], “labels”: [“order”, “food”, “pizza”], “matches”: [
{ “id”: “entity-pizza”, “type”: “CONCEPT”, “similarity_score”: 0.84, “similarities”: {
“pizza”: 0.84 }, “additional_metrics”: { “semantic_density”: 0.75,
“network_connectivity”: 0.81 } },
{ “id”: “entity-order”, “type”: “CONCEPT”, “similarity_score”: 0.71, “similarities”: {
“order”: 0.71 }, “additional_metrics”: { “semantic_density”: 0.68,
“network_connectivity”: 0.77 } },
{ “id”: “entity-food”, “type”: “CONCEPT”, “similarity_score”: 0.65, “similarities”: {
“food”: 0.65 }, “additional_metrics”: { “semantic_density”: 0.62,
“network_connectivity”: 0.74 } } ] }

At this point, the processing flows to produce the fast response 815 and the slow response 824 begin to diverge. The fast response 815 will be produced by processing the working memory as it stands, moving directly to the LLM 813 response generation with the current set of matching items. The slow response 824 processing, on the other hand, would initiate additional memory (database 200) exploration before generating the slow response 824, particularly by evaluating the relevance metrics and performing more targeted queries. The working memory now contains the following:
{“working_memory”: [“entity-pizza”, “entity-order”, “entity-food”]}

In the fast response 815 processing, the system 100 takes the working memory results and immediately sends them, as a part of an automatically constructed, curated prompt, to the LLM 813 for response generation. This provides a quick response based on the immediate similarity matches. The text prompt is assembled to contain the working memory context and available entities, regardless of whether one or both messages chat-001 and chat-002, or only one, have been processed. For the fast response 815 processing, the system 100 does not perform additional memory exploration to construct the text prompt:

You are AI Companion's Chat Agent, your responsibility is to process and respond to messages that enter the system. Rules: 1) Always use complete sentences, unless instructed otherwise. 2) This chat is part of Microsoft Teams, so make sure that the content of your end-user messages is properly formatted. 3) Always respond in JSON format unless explicitly asked otherwise. [Any additional rules . . . ]

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON [Any additional
context...] --- END CONTEXT ---
--- START MEMORY RECALL --- The following are memories in your database that we believe
might be relevant to the chat at hand. Pizza [id: entity-pizza] IS_A Food [id: entity-food]
Beth [id: entity-beth] PLACES Orders [id: entity-order] Orders [id: entity-order] FOR Food [id:
entity-food] {“num_interactions”: 10} [Any additional memories...] NOTE:You have
additional memories that you could reference, but are not listed here. Do not assume that
this is everything you know. In your “notes_for_deep_researcher” field, you can include
areas of uncertainty here for it to do a deeper dive into. When responding to the requester
in your “acknowlegement_reply” field, you can ask for more clarification on ambigious parts.
--- END MEMORY RECALL ---
--- START CHAT HISTORY --- Past Summary: Beth just had a meeting to discuss overall
projects and asked me to store the information in my database. AI Companion responded
that it is done. [25 min ago] AI Companion: “Would you like to include key discussion topics
from previous meetings?” [Any additional chat history messages...] --- END CHAT HISTORY -
--
You must now process the following new chat message from Beth Rogers, replying in the
schema below: -- START NEW MESSAGE -- Beth Rogers: “I want you to order me food.” Beth
Rogers: “I want pizza.” -- END NEW MESSAGE -
-- START RESPONSE FORMAT - [Schema] - END RESPOONSE FORMAT --

The LLM 813 returns a structured JSON block according to the schema, including the fast response 815 constructed based primarily on the direct matches and available history:

{ “acknowledgment_reply”: “Sure, Beth. I can help you order pizza. Would you like
me to choose a place for you?”, “summary”: “Beth has requested to order food and
specified pizza in a follow-up message.”, “identified_risks”: [ “Pizza type not
specified”, “No delivery location specified”, “No preferred restaurants mentioned” ],
“notes_for_deep_researcher”: [ “User has ordered food before but no specific pizza
preferences are identified in the initial memory recall.”, “Confirm pizza type, delivery
details, and preferred restaurants.” ] }

In contrast to the fast response 815 processing, for the slow response 824 processing the system 100 takes the initial working memory and performs additional targeted memory queries before generating the slow response 824. This provides a more comprehensive and personalized response by exploring relevant entity relationships in depth. The following memory query prompt is automatically produced based on the available information including the notes_for_deep_researcher returned by the LLM 813 (in this example as a part of the response to the text prompt query for the fast response 815):

You are AI Companion's Chat Agent, your responsibility is to assist with preparing database queries that enable deeper exploration of relevant information. Rules: 1) Always use complete sentences unless instructed otherwise. 2) Always respond in JSON format unless explicitly asked otherwise.

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON. --- END CONTEXT ---
--- START MEMORY RECALL --- The following are memories in your database that we believe
might be relevant to the chat at hand. Pizza [id: entity-pizza] IS_A Food [id: entity-food] Beth
[id: entity-beth] PLACES Orders [id: entity-order] Orders [id: entity-order] FOR Food [id:
entity-food] {“num_interactions”: 10} --- END MEMORY RECALL ---
--- START CHAT HISTORY --- Past Summary: Beth just had a meeting to discuss overall
projects and asked me to store the information in my database. AI Companion responded
that it is done. [25 min ago] AI Companion: “Would you like to include key discussion topics
from previous meetings?” --- END CHAT HISTORY ---
--- START NEW MESSAGE --- Beth Rogers: “I want you to order me food.” Beth Rogers: “I
want pizza.” --- END NEW MESSAGE ---
--- START INSTRUCTIONS --- Based on the initial Working Memory results: - entity-pizza
(similarity: 0.84); - entity-order (similarity: 0.71); - entity-food (similarity: 0.65); Please
generate additional memory queries to explore based upon these notes: Beth has requested
to order food and specified pizza in a follow-up message. - User has ordered food before but
no specific pizza preferences are identified in the initial memory recall. - Confirm pizza type,
delivery details, and preferred restaurants. Identified Risks: - Pizza type not specified; - No
delivery location specified; - No preferred restaurants mentioned; --- END INSTRUCTIONS ---
Output query parameters strictly following the below JSON Schema: - START RESPONSE
JSON SCHEMA --- “queries”: { “type”: “array”, “description”: “List of query objects to perform
memory lookups.”, “items”: { “type”: “object”, “description”: “Individual query instruction.”,
“properties”: { “query_type”: { “type”: “string”, “description”: “Type of query to execute.” },
“parameters”: { “type”: “object”, “description”: “Parameters required to execute the query.
Must contain simple key-value pairs relevant to the query type.”, “additionalProperties”: {
“type”: [“string”, “number”, “boolean”], “description”: “Each parameter value must be a
string, number, or boolean.” } } }, “required”: [“query_type”, “parameters”],
“additionalProperties”: false } } --- END RESPONSE JSON SCHEMA ---

This prompt is sent to an LLM 150, 160 (a memory query LLM), generating the following structured queries:

{ “queries”: [
{ “query_type”: “PAST_ORDERS”, “parameters”: { “entity_id”: “entity-beth”,
“food_type”: “pizza”, “limit”: 5, “sort”: “recency” } }, { “query_type”:
“PREFERRED_RESTAURANTS”, “parameters”: { “entity_id”: “entity-beth”,
“food_type”: “pizza”, “limit”: 3, “sort”: “frequency” } },
{ “query_type”: “DELIVERY_INFORMATION”, “parameters”: { “entity_id”: “entity-
beth”, “recency”: “last_3_months” } } ] }

These queries are automatically executed against the full information 210 in the database 200, retrieving the following expanded context. It is understood that such LLM-provided queries can be used generally, such as in the flows illustrated in FIGS. 4-7:

{ “past_orders”: [ { “id”: “order-789”, “timestamp”: “2025-04-06T18:30:00Z”,
“restaurant”: “Plaza Pizza”, “items”: [“large veggie pizza”], “delivery_address”: “The
Best Company, Inc. Main Office”, “notes”: “No mushrooms” }, { “id”: “order-456”,
“timestamp”: “2025-03-23T19:45:00Z”, “restaurant”: “Plaza Pizza”, “items”: [“large
veggie pizza”], “delivery_address”: “The Best Company, Inc. Main Office” } ],
“preferred_restaurants”: [ { “id”: “restaurant-001”, “name”: “Plaza Pizza”,
“frequency”: 5 }, { “id”: “restaurant-008”, “name”: “Mama Mia's Italian”, “frequency”:
2 } ],
“delivery_information”: { “preferred_address”: “The Best Company, Inc. Main Office”,
“average_time”: “6:30 PM”, “payment_method”: “Corporate account” } }

The system 100 now creates an enhanced prompt with the additional memory exploration results:

You are AI Companion's Chat Agent, your responsibility is to process and respond to messages that enter the system. Rules: 1) Always use complete sentences, unless instructed otherwise. 2) This chat is part of Microsoft Teams, so make sure that the content of your end-user messages is properly formatted. 3) Always respond in JSON format unless explicitly asked otherwise. [Any additional rules . . . ]

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON [Any additional
entities...] --- END CONTEXT ---
--- START MEMORY RECALL --- The following are memories in your database that we believe
might be relevant to the chat at hand. Pizza [id: entity-pizza] IS_A Food [id: entity-food];
Beth [id: entity-beth] PLACES Orders [id: entity-order]; Orders [id: entity-order] FOR Food [id:
entity-food] {“num_interactions”: 10}; Beth's Recent Pizza Orders: - 7 days ago: Plaza Pizza
(large veggie pizza, no mushrooms) - 21 days ago: Plaza Pizza (large veggie pizza); Beth's
Preferred Pizza Restaurants: - Plaza Pizza (ordered 5 times) - Mama Mia's Italian (ordered 2
times); Beth's Delivery Information: - Typical delivery address: The Best Company, Inc. Main
Office - Typical order time: Around 6:30 PM - Payment method: Corporate account [Any
additional memories...] --- END MEMORY RECALL ---
--- START CHAT HISTORY --- Past Summary: Beth just had a meeting to discuss overall
projects and asked me to store the information in my database. AI Companion responded
that it is done. [25 min ago] AI Companion: “Would you like to include key discussion topics
from previous meetings?” [Any additional chat history...] --- END CHAT HISTORY ---
You must now process the following new chat message from Beth Rogers, replying in the
schema below: -- START NEW MESSAGE -- Beth Rogers: “I want you to order me food.”
Beth Rogers: “I want pizza.” -- END NEW MESSAGE --

The LLM 821 returns a structured JSON block according to the schema, which is much more personalized and actionable than the response from the LLM 813:

{ “acknowledgment_reply”: “Sure, Beth. I can order a large veggie pizza (no
mushrooms) from Plaza Pizza for delivery to your office. You ordered the same thing
a week ago. Would you like me to place this order now?”, “summary”: “Beth has
requested to order pizza. Based on her recent orders, she prefers a large veggie pizza
from Plaza Pizza delivered to her office.”, “identified_risks”: [ “Assumption about
pizza type based on past orders”, “Unspecified delivery time”, “Unconfirmed
corporate account status” ], “notes_for_deep_researcher”: [ “User consistently
orders veggie pizza from Plaza Pizza.”, “Confirm whether corporate account should
be used for payment.”, “Verify whether 'no mushrooms' is a consistent preference or
was a one-time request.” ] }

Once the LLM 813 (and possibly also 821) has returned its structured response, the system 100 formats the acknowledgment_reply for delivery to the user 122 via the chat interface. This marks the first visible response generated from the analysis. The fast response 815 looks like this: “Sure, Beth. I can help you order pizza. Would you like me to choose a place for you?”

In some cases, the system 100 may be configured to directly provide the slow response, for instance in case it takes less than a predetermined, or dynamically determined, amount of time to produce it. For instance, the delivery of the fast response 815 can be held back by the system 100, such as for 1 s or similar, to see if the slow response 824 will be ready within that time (and in that case the slow response 824 can replace the fast response 815). The slow response 824 looks like this: “Sure, Beth. I can order a large veggie pizza (no mushrooms) from Plaza Pizza for delivery to your office. You ordered the same thing a week ago. Would you like me to place this order now?”

In some cases, the system 100 may use a hybrid approach, in which it immediately sends the fast response 815 to maintain conversation flow: “Sure, Beth. I can help you order pizza. One moment while I check your usual preferences.” Then, after the slow-response tool has finished processing, the system 100 sends the slow response 824, the slow response 824 then being determined by the LLM 821 based on information provided that the fast response 815 has already been delivered to the user 122): “I see you usually order a large veggie pizza (no mushrooms) from Plaza Pizza delivered to your office. Would you like me to place this order now?”

The system 100 sends the acknowledgment_reply to the user and logs the full LLM response:

{ “type”: “chat_reply”, “conversation_id”: “conversation-123”, response“: {
”content“: ”Sure, Beth. I can order a large veggie pizza (no mushrooms) from Plaza
Pizza for delivery to your office. You ordered the same thing a week ago. Would you
like me to place this order now?“, ”Ilm_model“: ”claude-3-sonnet“, ”timestamp“:
”2025-04-13T15:32:10Z“, ”source“: ”LLM“ } }

The remaining fields are submitted to internal storage for downstream actions:

{ “summary”: “Beth has requested to order pizza. Based on her recent orders, she
prefers a large veggie pizza from Plaza Pizza delivered to her office.”,
“identified_risks”: [“Assumption about pizza type based on past orders”,
“Unspecified delivery time”, “Unconfirmed corporate account status”],
“notes_for_deep_researcher”: [ “User consistently orders veggie pizza from Plaza
Pizza.”, “Confirm whether corporate account should be used for payment.”, “Verify
whether ‘no mushrooms’ is a consistent preference or was a one-time request.” ] }

After sending the acknowledgment to the user, the system 100 checks whether the response 822 from the LLM 821 implies the creation of a new actionable task. As described above, this assessment can be made by prompting an LLM 150, 160 and request it, in a text prompt, if the response 822 implies an assignment and in that case produce a data structure, of specified format, the data structure being produced by the LLM 150, 160 to specify the assignment to be performed. Hence, if the response 822 contains clear intent or is part of a known pattern (like ordering food), a new assignment object is created. In case the slow response 822 is produced, the system 100 can be configured not to produce an assignment based on the fast response 815. However, in case the assignment object was only created based on the fast response since for some reason the slow response 822 was not produced by the system 100, it may look like this, being more generic:

{ “assignment_type”: “ORDER_FOOD”, “source_interactions”: [“chat-001”, “chat-
002”], “metadata”: { “food_item”: “pizza”, “urgency”: “immediate” }, “status”:
“pending_details”, “required_information”: [ “pizza_type”, “restaurant”,
“delivery_address” ] }

In case the assignment resulted from the slow response 822, it is likely more specific:

{ “assignment_type”: “ORDER_FOOD”, “source_interactions”: [“chat-001”, “chat-
002”], “metadata”: { “food_item”: “pizza”, “pizza_type”: “large veggie, no
mushrooms”, “restaurant”: “Plaza Pizza”, “delivery_address”: “The Best Company,
Inc. Main Office”, “payment_method”: “Corporate account”, “urgency”: “immediate”
}, “status”: “pending_confirmation” }

This assignment is now processed as is generally shown in FIG. 4, and is handed off to the agent or service responsible for completion:

{ “assignment_id”: “assignment-7849”, “status”: “awaiting_acceptance”,
“linked_entities”: “entity-beth”, “entity-pizza”, “restaurant-001”], “delivery”: {
“method”: “chat”, “confirmation_required”: true } }

Beth provides a response to the acknowledgment from the system 100 and processes the final pizza order:

{ “input”: “Yes, please order it now.”, “source_type”: “chat”, “source_id”: “chat-003”,
“metadata”: { “author_id”: “entity-beth”, “timestamp”: “2025-04-13T12:01:30Z” } }

The system 100 now has a confirmed assignment and executes it by contacting the restaurant's ordering system. The assignment definition can look like this, where it is noted that specific information is automatically drawn from working memory in the ways generally described above (details left out here for reasons of brevity):

{ “order_request”: { “restaurant_id”: “plaza-pizza-001”, “items”: [ { “item”: “Large
Veggie Pizza”, “modifications”: [“No Mushrooms”], “quantity”: 1 } ],
“delivery_details”: { “address”: “The Best Company, Inc. Main Office”,
“customer_name”: “Beth Rogers”, “phone”: “555-123-4567”, “payment”: “Corporate
Account #BC-7890” } } }

It is also noted that the assignment included using the Corporate Account as payment method. The system 100 may have had Beth confirm this, or not, depending on the detailed data and the response from the LLM 150, 160. This serves to illustrate how the system 100 can be self-learning: In case Beth did not want to use that payment method, she might state that in a subsequent chat message as feedback to the system 100 after the order was placed. That feedback message will then be stored in the database 200 and likely surface as part of working memory in relation to a subsequent order request from Beth, for more pizza or anything else. The system 100 will then automatically take that feedback regarding payment method selection into account when performing an assignment for processing the later request. This does not require the system 100 to, for instance, explicitly categorize the feedback as information being relevant to selection of payment methods. Hence, these mechanisms make it possible for the system 100 to dynamically adapt over time without having to a priori know or define what aspects to adapt to and according to what mechanisms.

At any rate, after placing the order via a suitable a API (for instance, provided by the restaurant and information of the API being stored in the database 200), the restaurant's system responds with confirmation:

{ “order_id”: “PP-45678”, “status”: “confirmed”, “estimated_delivery”: “2025-04-
13T12:45:00Z”, “items”: [ { “item”: “Large Veggie Pizza”, “modifications”: [“No
Mushrooms”], “quantity”: 1 } ], “total”: “$19.99”, “payment”: “Corporate Account
#BC-7890 (Approved)” }

The system updates Beth with the order confirmation in the chat: “Your order has been placed with Plaza Pizza! One large veggie pizza (no mushrooms) will be delivered to your office in about 45 minutes. Order #PP-45678 has been charged to the corporate account.” The system 100 creates a new memory entry (an interaction in the database 200) for the transaction:

{ “id”: “order-790”, “type”: “INTERACTION”, “description”: “Food order for Beth
Rogers”, “timestamp”: “2025-04-13T12:01:45Z”, “source_id”: “entity-me”,
“target_id”: “entity-beth”, “metadata”: { “order_type”: “pizza”, “restaurant”: “Plaza
Pizza”, “items”: [“large veggie pizza, no mushrooms”], “delivery_address”: “The Best
Company, Inc. Main Office”, “payment_method”: “Corporate account”, “order_id”:
“PP-45678” } }

This memory entry will be used to inform future slow response processing, creating a continuous improvement cycle for personalized responses.

In another example, a possible processing of a request from user Beth 122 to schedule a Jabberwocky project brainstorming meeting is described: “I need to have a Jabberwocky project brainstorming session this week. Include key discussion topics from previous meetings and invite Alex, Jen, and Taylor.”

When Beth submits her message through the chat interface, the system 100 immediately wraps it with metadata and places it in the chat message processing queue:

{ “input”: “I need to have a Jabberwocky project brainstorming session this week.
Include key discussion topics from previous meetings and invite Alex, Jen, and
Taylor.”, “source_type”: “chat”, “source_id”: “chat-567”, “metadata”: { “author_id”:
“entity-beth”, “timestamp”: “2024-03-15T09:30:00Z” } }

This becomes an interaction item that is queued for processing. The chat processor pulls the message from the queue and begins processing it within the conversation context:
{“conversation_id”: “conversation-123”, “messages”: [“chat-567”]}

The system 100 identifies that this is part of an ongoing conversation with Beth about the Jabberwocky project. The system 100 creates a structured memory representation for Beth's message:

{ “id”: “chat-567”, “type”: “CHAT_MESSAGE”, “description”: “I need to have a
Jabberwocky project brainstorming session this week. Include key discussion topics
from previous meetings and invite Alex, Jen, and Taylor.”,
“non_embedded_metadata”: { “author_id”: “entity-beth”, “timestamp”: “2024-03-
15T09:30:00Z”, “conversation_id”: “conversation-123” } }

This ChatMessage entity becomes eligible for working memory construction in the next step. Namely, the system 100 prepares the message for similarity search by segmenting and labeling it as described above (using non-LLM NLP tools), then performing that search against the entire database 200:

{ “source_id”: “chat-567”, “labels”: [“Jabberwocky”, “project”, “brainstorming”,
“meeting”, “Alex”, “Jen”, “Taylor”], “matches”:
[{ “id”: “entity-jabberwocky”, “type”: “PROJECT”, “similarity_score”: 0.92,
“similarities”: { “Jabberwocky”: 0.92 }, “additional_metrics”: { “semantic_density”:
0.85, “network_connectivity”: 0.88 } },
{“id”: “entity-meeting-001”, “type”: “MEETING”, “similarity_score”: 0.78,
“similarities”: { “meeting”: 0.78 }, “additional_metrics”: { “semantic_density”: 0.72,
“network_connectivity”: 0.81 } },
{ “id”: “entity-meeting-002”, “type”: “MEETING”, “similarity_score”: 0.76,
“similarities”: { “meeting”: 0.76 }, “additional_metrics”: { “semantic_density”: 0.70,
“network_connectivity”: 0.79 } },
{ “id”: “entity-alex”, “type”: “PERSON”, “similarity_score”: 0.87, “similarities”: {
“Alex”: 0.87 }, “additional_metrics”: { “semantic_density”: 0.65,
“network_connectivity”: 0.72 } },
{ “id”: “entity-jen”, “type”: “PERSON”, “similarity_score”: 0.87, “similarities”: { “Jen”:
0.87 }, “additional_metrics”: { “semantic_density”: 0.63, “network_connectivity”: 0.71
} },
{“id”: “entity-taylor”, “type”: “PERSON”, “similarity_score”: 0.87, “similarities”: {
“Taylor”: 0.87 }, “additional_metrics”: { “semantic_density”: 0.62,
“network_connectivity”: 0.70 } } ] }

The working memory is now:

{ “working_memory”: [ “entity-jabberwocky”, “entity-meeting-001”, “entity-meeting-
002”, “entity-alex”, “entity-jen”, “entity-taylor” ] }

At this point, the fast-response and slow-response processing paths begin to diverge: Whereas the fast-response processing immediately proceeds to LLM 150, 160 response generation with the current set of matches, the slow-response processing instead initiates additional memory exploration before generating a response. The former (fast-response) hence results in the following immediate prompt to the LLM 813:

You are AI Companion's Chat Agent, your responsibility is to process and respond to messages that enter the system. Rules: 1) Always use complete sentences, unless instructed otherwise. 2) This chat is part of Microsoft Teams, so make sure that the content of your end-user messages is properly formatted. 3) Always respond in JSON format unless explicitly asked otherwise. [Any additional rules . . . ]

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON; [Any additional
context...] --- END CONTEXT ---
--- START MEMORY RECALL --- The following are memories in your database that we believe
might be relevant to the chat at hand. Beth Rogers [id: entity-beth] OWNS Jabberwocky
Project [id: entity-jabberwocky] { } Beth Rogers [id: entity-beth] ATTENDED Jabberwocky
Planning Session [id: entity-meeting-001] {“role”: “Organizer”} Beth Rogers [id: entity-beth]
ATTENDED Jabberwocky Strategy Meeting [id: entity-meeting-002] {“role”: “Participant”}
Alex Johnson [id: entity-alex] WORKS_AT The Best Company, Inc. [id: entity-the-best-
company] {“role”: “Software Engineer”} Jen Roberts [id: entity-jen] WORKS_AT The Best
Company, Inc. [id: entity-the-best-company] {“role”: “Product Manager”} Taylor Smith [id:
entity-taylor] WORKS_AT The Best Company, Inc. [id: entity-the-best-company] {“role”: “UX
Designer”} [Any additional memories...] --- END MEMORY RECALL ---
--- START CHAT HISTORY --- Past Summary: Beth just had a meeting to discuss overall
projects and asked me to store the information in my database. AI Companion responded
that it is done. [30 min ago] Beth Rogers: “Let's set up a brainstorming session this week to
refine our strategy.” [25 min ago] AI Companion: “Would you like to include key discussion
topics from previous meetings?” [20 min ago] Beth Rogers: “Yes, and also invite Alex, Jen,
and Taylor.” [15 min ago] AI Companion: “Scheduling a brainstorming session for this week
with Alex, Jen, and Taylor. Would you like me to generate an agenda?” [10 min ago] Beth
Rogers: “Yes, make sure we cover technical dependencies and product alignment.” [5 min
ago] AI Companion: “Noted. The agenda will cover technical dependencies and product
alignment. Anything else?” --- END CHAT HISTORY ---
You must now process the following new chat message from Beth Rogers, replying in the
schema below: -- START NEW MESSAGE -- “I need to have a Jabberwocky project
brainstorming session this week. Include key discussion topics from previous meetings and
invite Alex, Jen, and Taylor.” -- END NEW MESSAGE --
--- WARNING: IMPORTANT GUIDELINES --- You are being given a partial context below. As
part of your response in JSON format, you must: - Reply to the **Requestor** based on the
provided guidelines. - Provide structured comments or notes for the **Deep Researcher**,
who will analyze this request further. - The Deep Researcher will receive both this initial
context and the additional context you generate. --- END IMPORTANT GUIDELINES ---
--- START RESPONSE FORMAT --- { “acknowledgment_reply”: “string”, // Immediate
response to the requestor; “summary”: “string”, // Condensed interpretation of the request;
“identified_risks”: [“string”], // Any identified uncertainties or missing details;
“notes_for_deep_researcher”: [“string”] // Additional insights to be analyzed further; } ---
END RESPONSE FORMAT ---

The LLM 813 provides the following response 814:

{ “acknowledgment_reply”: “Understood! I will schedule the Jabberwocky project
brainstorming session for this week, including key discussion topics from previous
meetings. Alex, Jen, and Taylor will be invited. Would you like me to propose specific
time slots?”, “summary”: “Beth Rogers requested a Jabberwocky project
brainstorming session this week, incorporating key discussion topics from previous
meetings and inviting Alex, Jen, and Taylor.”, “identified_risks”: [ “No specific date
or time provided for scheduling.”, “Potential conflicts with invitees' availability.”, “No
explicit mention of whether stakeholders or additional team members should be
included.” ], “notes_for_deep_researcher”: [ “Ensure the meeting includes topics
from the Jabberwocky Planning Session and Strategy Meeting.”, “Verify if the agenda
should also cover action item follow-ups from previous meetings.”, “Confirm if
additional stakeholders should be invited beyond Alex, Jen, and Taylor.”, “Check for
preferred time slots or constraints before scheduling.” ] }

In the slow-response processing path, the system 100 performs additional targeted memory queries before generating a response, the queries being configured to explore previous Jabberwocky meeting details, team member roles and involvement, current action items status and meeting preferences, using the notes_for_deep_researcher returned by the LLM 813.

An automatically constructed text query might look like this:

You are a specialized Research Note Processor for LiveArena Networks. Your sole task is to transform research notes into structured memory query objects. You must strictly adhere to the following rules: Analyze each research note to identify the appropriate query type. Generate complete query objects with all required parameters Include context-specific parameters based on the conversation. Prioritize precision and relevance in your query construction. Set reasonable limits and constraints for each query. Format your response as a valid JSON object.

-- START YOU -- This information represents you, the AI System that is processing the rest of
this information in your prompt. AI System (Entity); Name: LiveArena Networks Research
Note Processor; Type: Query Generation System; Purpose: Transform high-level research
notes into executable memory queries; Core Capabilities: Pattern recognition for
information needs; Query template selection; Parameter configuration; Context-aware
query construction; -- END YOU --
-- START AVAILABLE QUERY TEMPLATES -- The following query templates are available for
memory exploration: ENTITY_CONNECTION_SEARCH Description: Finds entities directly
connected to a central entity; Required parameters: central_entity_id: ID of the entity to
search from; connection_types: Array of connection types to traverse; Optional parameters:
target_entity_types: Array of entity types to filter results; depth: How many connection hops
to traverse (default: 1); limit: Maximum number of results to return (default: 10)
sort: How to order results (“recency”, “relevance”, etc.); MULTI_HOP_SEARCH Description:
Traverses multiple connections to find indirectly connected entities; Required parameters:
start_entity_id: ID of the entity to start from; path: Array of connection steps to follow;
Optional parameters: entity_types: Types of entities to include in results; limit: Maximum
number of results to return (default: 10); CONNECTION_PATTERN_SEARCH Description:
Finds connections matching specific patterns; Required parameters: connection_type: Type
of connection to search for; Optional parameters: source_entity_types: Types of source
entities to include; target_entity_ids: Specific target entity IDs to filter by; metadata_filters:
Object containing metadata fields to filter on; ENTITY_TIME_PATTERN Description: Analyzes
temporal patterns in entity connections; Required parameters: entity_id: ID of the entity to
analyze; connection_type: Type of connection to analyze; Optional parameters:
pattern_fields: Array of fields to analyze for patterns; time_range: Time period to consider
(“last_week”, “last_3_months”, etc.); -- END AVAILABLE QUERY TEMPLATES --
-- START CONVERSATION CONTEXT -- Primary Entity: entity-jabberwocky (Project); User:
entity-beth (Person); Mentioned Entities: entity-alex, entity-jen, entity-taylor (People);
Conversation Topic: Scheduling a brainstorming meeting for the Jabberwocky project; -- END
CONVERSATION CONTEXT --
-- START RESEARCH NOTES -- “Ensure the meeting includes topics from the Jabberwocky
Planning Session and Strategy Meeting.”, “Verify if the agenda should also cover action item
follow-ups from previous meetings.”, “Confirm if additional stakeholders should be invited
beyond Alex, Jen, and Taylor.”, “Check for preferred time slots or constraints before
scheduling.” -- END RESEARCH NOTES --
-- YOUR INSTRUCTIONS -- Transform the research notes into structured query objects that
will retrieve the necessary information from the entity-connection memory system. Choose
appropriate query templates for each information need and include all required parameters.
Format your reply to adhere to the following JSON Schema: { “queries”: [ { “query_type”:
“string”, “parameters”: { additionalProperties: true} } ] }

The following queries could result in the response from the LLM 813, each query devised by the LLM 813 to address a respective one of the notes for the deep researcher. The first query looks for meeting entities connected to the Jabberwocky project. The second query finds all open tasks assigned to the potential meeting participants. The third query traverses from the Jabberwocky project to meetings to find all people who have attended Jabberwocky meetings in the past. The fourth query analyzes Beth's meeting scheduling patterns over the past three months. It is understood that all four notes can be passed to the LLM 813 in one and the same prompt or that several prompts can be used, such as one note per LLM 813 call:

{ “queries”: [ { “query_type”: “ENTITY_CONNECTION_SEARCH”, “parameters”: {
“central_entity_id”: “entity-jabberwocky”, “connection_types”: [“HAS_MEETING”],
“target_entity_types”: [“MEETING”], “limit”: 3, “sort”: “recency” } }
{ “query_type”: “CONNECTION_PATTERN_SEARCH”, “parameters”: {
“source_entity_types”: [“TASK”], “connection_type”: “ASSIGNED_TO”
“target_entity_ids”: [“entity-beth”, “entity-alex”, “entity-jen”, “entity-taylor”],
“metadata_filters”: { “status”: “open” } } }
{ “query_type”: “MULTI_HOP_SEARCH”, “parameters”: { “start_entity_id”: “entity-
jabberwocky”, “path”: [ {“connection”: “HAS_MEETING”, “direction”:
“outgoing”},{“connection”: “ATTENDED”, “direction”: “incoming”} ], “entity_types”:
[“PERSON”], “limit”: 10 } }
{ “query_type”: “ENTITY_TIME_PATTERN”, “parameters”: { “entity_id”: “entity-beth”,
“connection_type”: “SCHEDULED”, “target_entity_types”: [“MEETING”],
“pattern_fields”: [“day_of_week”, “time_of_day”], “time_range”: “last_3_months” } }
]}

Once the queries are constructed, the system 100 executes them (this can be performed in parallel) against the full information 210 in the entire database 200. The results are then merged into a comprehensive context object that includes all relevant entities and connections. These additional targeted memory queries can drill deeper into specific aspects of the knowledge graph than the initial similarity search. While the fast-response processing path uses general similarity to find potentially relevant information, slow-response flows, that use more targeted queries, can use precise graph traversal patterns to find exactly the information needed. This combination of broad initial similarity search with targeted follow-up queries allows the system 100 to provide much more contextually accurate and personalized responses. This is what it might look like:

{ “entities”: [ { “id”: “entity-jabberwocky”, “type”: “PROJECT”, “name”:
“Jabberwocky”, “description”: “Strategic project for implementing AI capabilities”,
“updated_at”: 1705881600, “metadata”: { “priority”: “high”, “start_date”: “2024-01-
15”, “target_completion”: “2024-06-30” }, “non_embedded”: { } },
{ “id”: “entity-meeting-001”, “type”: “MEETING”, “name”: “Jabberwocky Planning
Session”, “description”: “Initial planning meeting for the Jabberwocky project”,
“updated_at”: 1707544800, “metadata”: { “agenda”: [“Project milestone review”,
“Pending action items”, “Feature prioritization”], “summary”: [“Reviewed completed
tasks”, “Identified key risks”, “Decided on focus areas”], “duration_minutes”: 60,
“date”: “2024-02-10”, “time”: “09:00”, “day_of_week”: “Monday”, “location”:
“Conference Room A” }, “non_embedded”: { } },
{ “id”: “entity-meeting-002”, “type”: “MEETING”, “name”: “Jabberwocky Strategy
Meeting”, “description”: “High-level strategy discussion for the Jabberwocky
project”, “updated_at”: 1708149600, “metadata”: { “agenda”: [“Risk assessment”,
“Budget constraints”, “Cross-functional alignment”], “summary”: [“Explored risks
related to AI”, “Discussed cost implications”, “Shared alignment strategies”],
“duration_minutes”: 90, “date”: “2024-02-20”, “time”: “14:00”, “day_of_week”:
“Tuesday”, “location”: “Conference Room B” }, “non_embedded”: { } },
{ “id”: “entity-beth”, “type”: “PERSON”, “name”: “Beth Rogers”, “description”:
“Project Manager at The Best Company, Inc.”, “updated_at”: 1705881600, “metadata”:
{ “role”: “Project Manager”, “employment_start”: “2021-06-15” }, “non_embedded”: { }
},
{ “id”: “entity-alex”, “type”: “PERSON”, “name”: “Alex Johnson”, “description”:
“Software Engineer at The Best Company, Inc.”, “updated_at”: 1705881600,
“metadata”: { “role”: “Software Engineer”, “specialty”: “Backend Development” },
“non_embedded”: { } },
{ “id”: “entity-jen”, “type”: “PERSON”, “name”: “Jen Roberts”, “description”:
“Product Manager at The Best Company, Inc.”, “updated_at”: 1705881600,
“metadata”: { “role”: “Product Manager”, “focus_area”: “User Experience” },
“non_embedded”: { } },
{ “id”: “entity-taylor”, “type”: “PERSON”, “name”: “Taylor Smith”, “description”: “UX
Designer at The Best Company, Inc.”, “updated_at”: 1705881600, “metadata”: { “role”:
“UX Designer”, “specialty”: “Interface Design” }, “non_embedded”: { } },
{ “id”: “entity-mark”, “type”: “PERSON”, “name”: “Mark Richardson”, “description”:
“Marketing Lead at The Best Company, Inc.”, “updated_at”: 1705881600, “metadata”:
{ “role”: “Marketing Lead”, “specialty”: “Product Marketing” }, “non_embedded”: { } },
{ “id”: “entity-task-001”, “type”: “TASK”, “name”: “Finalize project roadmap updates”,
“description”: “Update the project roadmap to reflect recent strategic decisions”,
“updated_at”: 1710428400, “metadata”: { “priority”: “high”, “due_date”: “2024-03-17”
}, “non_embedded”: { } },
{ “id”: “entity-task-002”, “type”: “TASK”, “name”: “Provide technical feasibility
analysis”, “description”: “Analyze technical feasibility of proposed AI integration
features”, “updated_at”: 1710428400, “metadata”: { “priority”: “high”, “due_date”:
“2024-03-15” }, “non_embedded”: { } },
{ “id”: “entity-task-003”, “type”: “TASK”, “name”: “Align product goals with UX
requirements”, “description”: “Ensure product roadmap aligns with updated UX
guidelines”, “updated_at”: 1710428400, “metadata”: { “priority”: “medium”,
“due_date”: “2024-03-16” }, “non_embedded”: { } },
{ “id”: “entity-task-004”, “type”: “TASK”, “name”: “Refine UX requirements”,
“description”: “Update UX requirements based on latest user research findings”,
“updated_at”: 1710428400, “metadata”: { “priority”: “medium”, “due_date”: “2024-03-
18” }, “non_embedded”: { } } ],
“connections”: [ { “id”: “conn-567”, “source_id”: “entity-jabberwocky”, “target_id”:
“entity-meeting-001”, “type”: “HAS_MEETING”, “updated_at”: 1707544800,
“metadata”: { “date”: “2024-02-10” }, “non_embedded”: { } },
{ “id”: “conn-568”, “source_id”: “entity-jabberwocky”, “target_id”: “entity-meeting-
002”, “type”: “HAS_MEETING”, “updated_at”: 1708149600, “metadata”: { “date”:
“2024-02-20” }, “non_embedded”: { } },
{ “id”: “conn-890”, “source_id”: “entity-beth”, “target_id”: “entity-meeting-001”,
“type”: “ATTENDED”, “updated_at”: 1707544800, “metadata”: { “role”: “Organizer”,
“has_presented”: true }, “non_embedded”: { } },
{ “id”: “conn-891”, “source_id”: “entity-alex”, “target_id”: “entity-meeting-001”,
“type”: “ATTENDED”, “updated_at”: 1707544800, “metadata”: { “role”: “Technical
Lead”, “has_presented”: true }, “non_embedded”: { } },
{ “id”: “conn-892”, “source_id”: “entity-jen”, “target_id”: “entity-meeting-002”,
“type”: “ATTENDED”, “updated_at”: 1708149600, “metadata”: { “role”: “Product
Manager”, “has_presented”: false }, “non_embedded”: { } },
{ “id”: “conn-893”, “source_id”: “entity-taylor”, “target_id”: “entity-meeting-002”,
“type”: “ATTENDED”, “updated_at”: 1708149600, “metadata”: { “role”: “UX Designer”,
“has_presented”: true }, “non_embedded”: { } },
{ “id”: “conn-894”, “source_id”: “entity-mark”, “target_id”: “entity-meeting-002”,
“type”: “ATTENDED”, “updated_at”: a1708149600, “metadata”: { “role”: “Marketing
Lead”, “has_presented”: true }, “non_embedded”: { } },
{ “id”: “conn-123”, “source_id”: “entity-task-001”, “target_id”: “entity-beth”, “type”:
“ASSIGNED_TO”, “updated_at”: 1710428400, “metadata”: { “status”: “in_progress”,
“assigned_date”: “2024-03-10” }, “non_embedded”: { } },
{ “id”: “conn-124”, “source_id”: “entity-task-002”, “target_id”: “entity-alex”, “type”:
“ASSIGNED_TO”, “updated_at”: 1710428400, “metadata”: { “status”: “in_progress”,
“assigned_date”: “2024-03-08” }, “non_embedded”: { } },
{ “id”: “conn-125”, “source_id”: “entity-task-003”, “target_id”: “entity-jen”, “type”:
“ASSIGNED_TO”, “updated_at”: 1710428400, “metadata”: { “status”: “not_started”,
“assigned_date”: “2024-03-12” }, “non_embedded”: { } },
{ “id”: “conn-126”, “source_id”: “entity-task-004”, “target_id”: “entity-taylor”, “type”:
“ASSIGNED_TO”, “updated_at”: 1710428400, “metadata”: { “status”: “in_progress”,
“assigned_date”: “2024-03-11” }, “non_embedded”: { } },
{ “id”: “conn-201”, “source_id”: “entity-beth”, “target_id”: “entity-meeting-001”,
“type”: “SCHEDULED”, “updated_at”: 1707544800, “metadata”: { “day_of_week”:
“Monday”, “time_of_day”: “09:00” }, “non_embedded”: { } },
{ “id”: “conn-209”, “source_id”: “entity-beth”, “target_id”: “entity-meeting-009”,
“type”: “SCHEDULED”, “updated_at”: 1710406800, “metadata”: { “day_of_week”:
“Thursday”, “time_of_day”: “14:00” }, “non_embedded”: { } } ], “scheduling_analysis”:
{ “preferred_days”: [“Thursday”, “Wednesday”], “preferred_times”: [“14:00”,
“10:00”], “preferred_location”: “Conference Room A” }, “combined_metadata”: {
“query_types_executed”: [“ENTITY_CONNECTION_SEARCH”,
“MULTI_HOP_SEARCH”, “CONNECTION_PATTERN_SEARCH”,
“ENTITY_TIME_PATTERN”], “total_entities_found”: 12, “total_connections_found”:
13, “execution_time_total_ms”: 160, “processing_timestamp”: 1710493200 } }

The system 100 automatically creates an enhanced prompt with the additional memory exploration results, including all the detailed information about previous meetings, team members, action items, and scheduling preferences. The response from the LLM 821 is as follows:

{ “acknowledgment_reply”: “I'll schedule the Jabberwocky project brainstorming
session for this Thursday at 2:00 PM in Conference Room A, which aligns with your
usual preference. I'll invite Alex, Jen, and Taylor. The agenda will include key topics
from previous meetings including project milestone review, technical feasibility, and
UX requirements alignment. Would you also like to include Mark Richardson since he
was involved in the last strategy meeting?”, “summary”: “Beth requested a
Jabberwocky project brainstorming session this week. Based on previous meetings
and current action items, this session should cover project roadmap updates,
technical feasibility analysis, and UX requirement alignment. The session will include
Alex, Jen, and Taylor, but Mark Richardson may also be relevant.”,
“identified_risks”: [ “Technical feasibility analysis from Alex is due this Friday, which
may not be complete before the meeting if scheduled earlier.”, “Jen has not yet
started aligning product goals with UX requirements, potentially limiting discussion
on this topic.”, “Mark Richardson was involved in the previous strategy meeting but
wasn't explicitly included in this request.” ], “notes_for_deep_researcher”: [ “Beth's
roadmap updates are due this Sunday, so this meeting could serve as a checkpoint
before finalization.”, “There appears to be interdependency between Alex's technical
analysis and Jen's product-UX alignment that should be addressed.”, “Consider
whether to add a discussion item about the AI integration risks identified in the last
strategy meeting.”, “Check calendar availability for all participants on Thursday at
2:00 PM.”, “Verify if the meeting should include preparation for the stakeholder review
that Beth was assigned to schedule.” ] }

After the LLM has 813/821 returned this structured response, the system 100 formats the acknowledgment_reply for delivery to Beth in a way corresponding to the description above regarding the pizza order. For the fast-response processing, the response to Beth would be “Understood! I will schedule the Jabberwocky project brainstorming session for this week, including key discussion topics from previous meetings. Alex, Jen, and Taylor will be invited. Would you like me to propose specific time slots?”. For the slow-response processing, the response would instead be “I'll schedule the Jabberwocky project brainstorming session for this Thursday at 2:00 PM in Conference Room A, which aligns with your usual preference. I'll invite Alex, Jen, and Taylor. The agenda will include key topics from previous meetings including project milestone review, technical feasibility, and UX requirements alignment. Would you also like to include Mark Richardson since he was involved in the last strategy meeting?”

The immediate response is sent to Beth and the full LLM 813 response 814 is logged for further processing.

After sending the acknowledgment to Beth, the system 100 creates a new assignment object for scheduling the meeting. Again, in case only fast-response processing is used, the fast-processing can result in an assignment which is rather generic:

{ “assignment_type”: “SCHEDULE_MEETING”, “source_interactions”: [“chat-567”],
“metadata”: { “project”: “entity-jabberwocky”, “meeting_type”: “brainstorming”,
“timeframe”: “this week”, “attendees”: [“entity-beth”, “entity-alex”, “entity-jen”,
“entity-taylor”] }, “status”: “pending_details”, “required_information”:
[“specific_date”, “specific_time”, “meeting_location”, “meeting_duration” ] }

In the slow-response processing case, however, the assignment becomes more specific:

{ “assignment_type”: “SCHEDULE_MEETING”, “source_interactions”: [“chat-567”],
“metadata”: { “project”: “entity-jabberwocky”, “meeting_type”: “brainstorming”,
“date”: “2024-03-17”, // Thursday of current week; “time”: “14:00”, // 2:00 PM
“duration”: 60, “location”: “Conference Room A”, “attendees”: [“entity-beth”, “entity-
alex”, “entity-jen”, “entity-taylor”], “potential_attendees”: [“entity-mark”],
“agenda_items”: [“Project milestone review”, “Technical feasibility analysis update”,
“Product-UX requirements alignment”, “Action items follow-up”, “AI integration risk
assessment” ] }, “status”: “pending_confirmation”, “dependencies”: [ { “type”:
“CALENDAR_CHECK”, “entities”: [“entity-beth”, “entity-alex”, “entity-jen”, “entity-
taylor”, “entity-mark”, “resource-conference-room-a”] } ] }

This assignment enters the workflow shown in FIG. 4, and is handed off to the agent responsible for scheduling meetings.

Beth responds to the AI Companion's suggestion as follows:

{ “input”: “Yes, please include Mark as well. That Thursday time works perfectly.”,
“source_type”: “chat”, “source_id”: “chat-568”, “metadata”: { “author_id”: “entity-
beth”, “timestamp”: “2024-03-15T09:32:30Z” } }

The system 100 now has a confirmed assignment and executes it by creating calendar invites, using a non-agent calendar tool:

{ “calendar_event”: { “title”: “Jabberwocky Project Brainstorming Session”,
“description”: “Meeting to discuss project roadmap updates, technical feasibility
analysis, and UX requirements alignment. Follow-up on action items from previous
Jabberwocky meetings.”, “date”: “2024-03-17”, “start_time”: “14:00”, “end_time”:
“15:00”, “location”: “Conference Room A”, “organizer”: “entity-beth”, “attendees”:
[“entity-beth”, “entity-alex”, “entity-jen”, “entity-taylor”, “entity-mark”], “agenda”:
[“Project milestone review (15 min)”, “Technical feasibility analysis update (15 min)”,
“Product-UX requirements alignment (15 min)”, “Action items follow-up and next
steps (15 min)” ], “attachments”: [ { “name”:
“Jabberwocky_Planning_Session_Summary.pdf”, “type”: “meeting_notes”,
“entity_id”: “entity-meeting-001” }, { “name”:
“Jabberwocky_Strategy_Meeting_Summary.pdf”, “type”: “meeting_notes”,
“entity_id”: “entity-meeting-002” } ] } }

The calendar system responds with confirmation:

{ “calendar_event_id”: “event-8901”, “status”: “scheduled”, “attendee_responses”: {
“entity-beth”: “accepted”, “entity-alex”: “pending”, “entity-jen”: “pending”, “entity-
taylor”: “pending”, “entity-mark”: “pending” }, “resource_status”: { “resource-
conference-room-a”: “reserved” } }

The system 100 now updates Beth with the meeting confirmation: “The Jabberwocky project brainstorming session has been scheduled for Thursday at 2:00 PM in Conference Room A. Calendar invites have been sent to Alex, Jen, Taylor, and Mark with the agenda and summaries from previous meetings attached. I've included all the key discussion topics from the previous planning and strategy sessions.”

The system 100 creates a new memory entry (an entity in the database 200) for the scheduled meeting:

{ “id”: “entity-meeting-003”, “type”: “MEETING”, “description”: “Jabberwocky Project
Brainstorming Session”, “timestamp”: “2024-03-17T14:00:00Z”,
“connections”: [ { “type”: “ORGANIZED_BY”, “target_id”: “entity-beth”, “metadata”:
{ “role”: “Organizer” } }, { “type”: “RELATED_TO”, “target_id”: “entity-jabberwocky”,
“metadata”: { “relationship”: “project meeting” } }, { “type”: “FOLLOWS”, “target_id”:
“entity-meeting-002”, “metadata”: { “temporal_relationship”: “sequel” } } ],
“interactions”: [ { “type”: “WILL_ATTEND”, “source_id”: “entity-alex”, “target_id”:
“entity-meeting-003”, “metadata”: { “role”: “Technical Lead”, “status”: “invited” } }, {
“type”: “WILL_ATTEND”, “source_id”: “entity-jen”, “target_id”: “entity-meeting-003”,
“metadata”: { “role”: “Product Manager”, “status”: “invited” } }, { “type”:
“WILL_ATTEND”, “source_id”: “entity-taylor”, “target_id”: “entity-meeting-003”,
“metadata”: { “role”: “UX Designer”, “status”: “invited” } }, { “type”: “WILL_ATTEND”,
“source_id”: “entity-mark”, “target_id”: “entity-meeting-003”, “metadata”: { “role”:
“Marketing Lead”, “status”: “invited” } } ],
“metadata”: { “agenda”: [“Project milestone review”, “Technical feasibility analysis
update”, “Product-UX requirements alignment”, “Action items follow-up”], “location”:
“Conference Room A”, “duration”: 60, “status”: “scheduled” }}

This new memory entry will be available for future interactions, creating a continuous cycle of improvement for personalized responses related to the Jabberwocky project and team meetings.

In general, additional input can be provided to the system 100 during the slow-response processing. For instance, the user 122 can provide additional chat input put on the chat queue discussed above. In case that happens, the system 100 can be configured to either continue the slow-response processing ignoring the newly added information, or to do one of the following two things: First, add the new information to the assignment progress data structure 422 and continue processing the assignment representing the slow-response processing. Second, abort the slow-response processing, redefine the assignment using the new information and then restart the slow-response processing. How to proceed can be determined based on parameters (such as how many agent invokations the processing of the slow response has resulted in so far) or by querying an LLM 150, 160 for a decision based on the newly added information and a question to the LLM 150, 160 in question regarding to what extent the newly added information alters the fundamental direction of the slow-response processing. For instance, in case the user 122 asks the system 100 to abort the pending request and instead do something else, a restart of the slow-response processing would be the likely outcome if querying an LLM 150, 160 for what to do.

In some embodiments, the method comprises providing, in a step 829, in addition to the fast response 815 and/or the slow response 824 to the recipient 122, information to the recipient 122 based on the similar, expanded and/or ranked set 807 or the updated similar, expanded and/or ranked set 807. In particular, the providing of the information 829 to the recipient 122 can comprise performing the search or request 808 for external information, such as based on the similar/expanded/ranked set, and to provide a result 809 from, or based on, the search or request to the recipient 122.

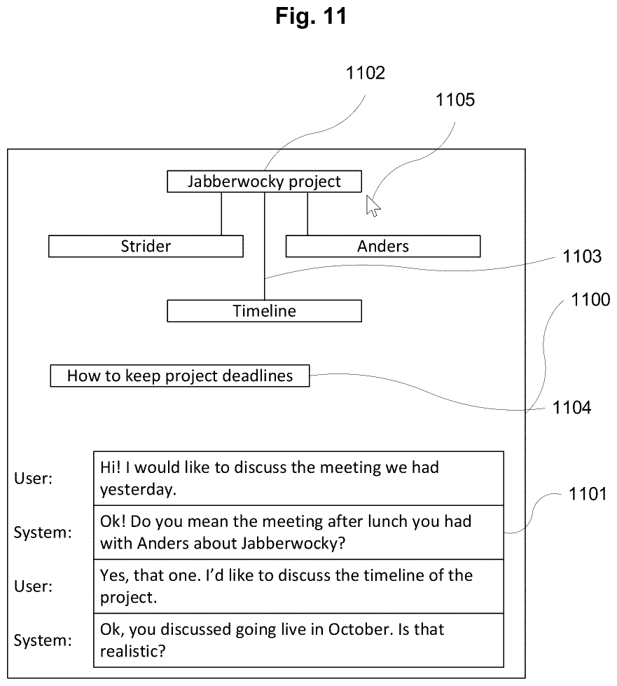

The information 829, such as the result from the search or request 808 or information based on the search or request 808; and/or the (updated) similar/expanded/ranked set 807, 810 or information based on the (updated) similar/expanded/ranked set 807, 810, and/or possibly an available working memory and/or domain knowledge related to or constructed from the free-text input(s) 802, 826, can be provided to the recipient 122 in connection to the first response 815. Here, the expression “in connection to” can refer to a timewise closeness to the first response 815, such as being shown or otherwise provided to the recipient 122 at the same time, or at least substantially at the same time, or at least within at the most 10 seconds, to the user 122; and/or a physical or logical closeness to the first response 815, such as being shown or provided to the recipient 122 in the same user interface, such as in an interactive graphical user interface. An example of such an interactive graphical user interface 1100 is shown in FIG. 11.

Hence, the providing of the information 829 to the recipient 122 based on the (updated) similar/expanded/ranked set 807, 810 can comprise providing one or more of the items in said set 807, 810 to the recipient 122 in an interactive interface 1100, the interactive interface 1100 being provided in a step 830, such as on the output means (for instance screen display) 124 of the client device 121 of the user 122. It is realized that said set 807, 810 can form (part of) a working memory in relation to the ongoing communication, and that the items provided in step 829 can then form part of that working memory. In some embodiments, the items provided in step 829 are not all the items in said set 807, 810, but only a subpart. The items selected for provision in step 829 can be a number of highest ranking items from the set 807, 810; or a number of sufficiently high scoring (such as in terms of vector similarity to the embedding 804) ones of the items in the set 807, 810. The system 100 can also be configured to automatically include graph information in the interactive graphical interface 1100 as defined by connections and/or interactions in the information 210 in the database 200, for instance by including any connected (sufficiently high-ranking) entities connected to the selected entities; and so forth, depending on the detailed embodiment considered. In general, the interactive interface can be configured to allow the recipient 122 to activate selected ones of the provided items in the information 829 to interactively navigate the items in the database 200 by following connections implied in information 210 stored in the database 200. This may, for example, include the participant 122 being able to select, such as using a mouse pointer 1105 or for example via a touchscreen, on various entities 1102 and connections/interactions 1103 interconnecting the entities 1102 in the information 210, and for instance expanding/collapsing selected items by showing or hiding additional entities/connections/interactions associated with the selected item as a result, in an interactive manner. This is one of many different examples of how an interactive graphical user interface 1100 can be configured to allow the participant 122 to browse the information 210 using the graph data implied in the information 210, potentially across the entire database 200. It is realized that other graphical paradigms could be used, and that corresponding voice-based browsing techniques can be employed instead or in addition (for instance, allowing the participant 122 to expand an entity by stating the name of the entity using voice input to the system 100). In FIG. 11, a piece of related information 1104, 809 accruing from an external search 808 is also shown in the interface 1100. After full processing of the current iteration of the method, this external piece of information 1104 could be interconnected with the other graph data 1102 in the database 200 and the interface 1100, but it is realized that the interface 1100 can also be configured to show multiple parts of the graphed information 210 at the same time to the participant 122. By, for instance, selecting the piece of information 1104, the user 122 can be taken to an external website showing additional information, and so forth.

In some embodiments, the system 100 can be configured to present the user 122 with an elaborate view of a particular piece of information (such as an item or a set of items in the database 200) in the interface 1100. For instance, this can take place by the system 100 producing a domain knowledge or working memory based on the selected piece of information, and to update the interface 1100 showing a view representative of that domain knowledge or working memory. For instance, a set of high-ranking items can be automatically expanded in a graphical user interface showing graph information from the database 200 in the interface 1100. The system 100 can be configured to allow the user 122 to control the behavior of the information shown in the interface 1100 by providing text inputs 802, 826, that are interactively processed by the system 100 as described, providing fast/slow responses. For instance, the interface 1100 can be configured to automatically update in reaction to refocusing of the conversation between the participant 122 and the system 100 or upon explicit commands provided by the participant 122. The interface 1100 can also be configured to automatically update to reflect an updated working memory accruing as a result of, for instance, the slow processing according to the flow in FIG. 8. The interactive graphical user interface 1100 can also comprises the free-text input 802 and/or 826; and/or the fast response 815 and/or the slow response 824, in graphical proximity to the information 1102, 1103, 1104. This information is shown at 1101. In the shown example, the user 122 said “Hi! I would like to discuss the meeting we had yesterday.”, being the first free-text input 802. The system 100 responded, as the first fast response 815 after a quick similarity search based on the free-text input 802 finding as a similar item the meeting held yesterday and the Jabberwocky project, “Ok! Do you mean the meeting after lunch you had with Anders about Jabberwocky?”. Then, the user 122 provided, as the second free-text input 826, “Yes, that one. I'd like to discuss the timeline of the project.” The system 100 responded, in the first-iteration slow response 824, “Ok, you discussed going live in October. Is that realistic?” The information 1102, 1103, 1104 constitutes a highest ranking set of items from the ranked set 807, together with the externally found information 1104. This data is then browsable by the user 122.

This provides different opportunities for interactivity between the participant 122 and the system 100. For example, the system 100 can be configured to update the (updated) similar/expanded/ranked set 807 and/or 810 based on stored items activated by the recipient, such as using interactive browsing, in said interactive navigation. For instance, selected items can be pushed to a higher ranking. Then, the hence updated similar/expanded/ranked set 807, 810 can be used as a basis to construct the next prompt to the LLM 821 so as to provide a next slow response 824 based on the refined set of items in the interactive graphical user interface 1100. Generally, the invoking of the fast/slow response tool can comprise producing the corresponding text prompt based on, such as to comprise or refer to, the (updated) similar/expanded/ranked set as modified by the participant using the interface 1100.

Also, the information 829 provided can be dynamically updated based on free-text inputs 802, 826 from the participant 122. In practice, an updated similarity search 805 can be performed in the database 200, comparing the recalculated input text embedding (based on a second or next free-text input 826) to respective embeddings of the items stored in the database 200, using a vector-based similarity measure; selecting an updated similar set of the stored items based on the similarity search; identifying an updated expanded set of items by expanding the similar set based on one, two or more of connections in the database 200 interconnecting entities in the updated similar set, interactions in the database 200 interconnecting entities in the updated similar set, and entities in the database 200 interconnected by interactions in the updated similar set; and identifying a subset of the expanded set as an updated ranked set based on a ranking rule. Then, updated information can be provided 829 to the recipient 122, such as in the interface 1100, based on the updated similar/expanded/ranked set 810. The updating can, for instance, take place by changing a set of activated/shown entities, connections and/or interactions in the interface 1100, reflecting the updated set 810.

In other words, the information 829, 1102-1104 can be dynamically updated based on information provided by the participant 122 to the system 100, and further based on the information in the database 200 (in particular the graph contents of the information 210). At the same time, by activating/browsing the information 829, 1102-1104, the participant can affect what information is considered pertinent by the participant 122 to the context of the ongoing communication, to in turn affect the responses provided by the system 100 in terms of fast responses and/or slow responses.

Generally, the interface 1100 can be configured to provide interactivity between the system 100 and the user 122 whereby user actions in the interface 1100 affect the fast and/or slow responses from the system 100 and the processing of the fast and/or slow responses by the system 100 affects the interface 1100 in terms of the shown items 1102.

Naturally, in case of a communication between more than one user 122, with or without the system 100 as a chat participant, the corresponding can apply, whereby the items 1105 shown in the interface 1100 for a first user 122 can be provided as a function of the ongoing discussion in the chat with a second user 122, and possibly so that the second user 122 is provided her own interface 1100 which may then contain the same or different information as compared to the interface provided to the first user 122. In group chats, the participant users 122 can share a common interactive interface 1100 in the corresponding manner.

Furthermore, the corresponding can be true for voice or video communications.

It is noted that, as always, the entire process including all its subparts can be continuously stored in the database 200, as illustrated in FIG. 7, by adding/updated corresponding entities, connections and interactions. These added/updated items can then be found in similarity searches in later procedures such as according to FIG. 4 or 8, and the communication between the participant 122 and the system 100 can therefore be used in such later procedures as relevant context.

Now the principles of FIG. 8 will be illustrated using the above-discussed example of Beth introducing herself to the system 100. The system 100 is tasked to process Beth's entire message, extracting structured data and retrieving relevant information from memory. However, the system 100 should also ensure that the user knows their request was received and understood. To achieve this, the system 100 should return a response as quickly as possible, even if that response is just an acknowledgment that the request has been received and is being processed.

To achieve this, firstly a memory recall (working memory construction) is performed, wherein the system 100 retrieves relevant historical data from the database 200 to construct a relevant working memory. This allows it to generate a meaningful response while preparing more detailed processing. Different recall methods can be employed depending on response time constraints, including one or more of a full recall (a complete similarity search, retrieving the most relevant historical interactions, previous assignments, and user preferences, providing the highest accuracy but possibly taking longer time to compute—can be used in case the system 100 determines that full recall is consistently fast or if the user prefers detailed responses over speed); no additional metrics (similar to full recall but omitting computationally expensive post-processing calculations, speeding up retrieval while maintaining most of the accuracy—useful when the additional metrics do not significantly impact the relevance of retrieved results); and querying a secondary index for speed (instead of performing full recall, the system 100 queries a lightweight index previously crated by the system 100 and optimized for rapid retrieval, the index possibly including only chat history and high-priority interactions, making it faster for certain types of responses—supporting faster domain expertise retrieval).

Then, entities can be extracted from the input text. The raw input text can be processed and key entities that will serve as anchor points for the similarity analysis can be extracted. This can involve leveraging NLP 131 techniques to identify named entities, key noun phrases, and significant concepts that can be linked to structured data. The extracted entities allow the system 100 to compare the input text against knowledge stored in the database 200, to identify relevant relationships and ultimately structure the information for downstream tasks like document retrieval, chat interactions, and decision support systems. As was discussed above, the following text is input by the user 122 Beth:

“Hello, my name is Beth and I'm a project manager at The Best Company, Inc. My primary responsibilities include organizing meetings, keeping track of project deliverables, and ensuring clear communication between departments. I often juggle multiple projects, so I need help managing schedules, tracking action items, and quickly retrieving relevant past discussions. It would also be helpful if you could assist in summarizing meetings and ensuring follow-ups aren't missed.”

One or more of the following entity extraction methods can be used: Apply non-LLM NLP-based 131 named entity recognition (NER) and noun phrase extraction; filter extracted entities to remove generic or low-value terms; and construct a structured list of key entities from the text. The following extracted entities result: Beth (Person), The Best Company, Inc. (Organization), Project manager (Title), Meetings (Event), and Schedules (Time Management Concept).

Now that the system 100 has structured the relationships between extracted entities and unknown data points, this information can be surfaced back to other subsystems, such as a chat interface or a document retrieval system:

Interactive chat integration: When a user 122 sends a message in chat, the system 100 can be configured to extract entities and to retrieve relevant data entries. Each recognized entity (e.g., “Beth,” “Project Manager”) can be dynamically linked to its related unknown data. Clicking on an entity in the chat interface 1100 can reveal full data entries, offering detailed background information on relevant concepts, people, or companies.

Document content discovery: This approach allows the system 100 to locate relevant content across different documents. A domain knowledge search can be performed to surface up the most relevant related documents or document chunks. Users can efficiently navigate large datasets by clicking on an entity in the interface 1100 and immediately accessing related structured data.

Contextual insights and decision support: If an entity (e.g., “Meetings”) is frequently linked to unknown data points with high similarity scores, this suggests that additional contextual information is available. The system 100 can then proactively suggest related entries, improving decision-making and content discovery.

Then, in an agent prompt explanation step, the system 100 can be configured to explicitly define the role of the agent prompt when interacting with the LLM 150, 160. The goal is to ensure the system 100 can quickly generate a structured response to the user 122 while also preparing deeper insights for further processing by the more advanced reasoning system (the slow-response processing). By using a faster, lighter LLM 150, 160, or even an SLM (Small Language Model) to this end (the fast-response processing), the system 100 can optimize for speed and efficiency. The objective is not general knowledge retrieval but reasoning over the user's 122 message and structuring the output in a way that assists the slow-response processing. The following is an example of the resulting modified prompt: You are AI Companion's Chat Agent, your responsibility is to process and respond to messages that enter the system. Rules: 1) Always use complete sentences, unless instructed otherwise. 2) This chat is part of Microsoft Teams, so make sure that the content of your end-user messages is properly formatted. 3) Always respond in JSON format unless explicitly asked otherwise. 4) If a message is ambiguous, ask for clarification before proceeding. 5) Use retrieved memory data to enhance responses, but only reference it if it's clearly relevant to the conversation. 6) You can ask follow-up questions when necessary to refine the task at hand. 7) When processing scheduling or assignments, ensure all necessary details are confirmed before executing. 8) When creating instructions for Assignments, make sure to include ids for any named Entities. 9) Always use CAPS for Connection and Interaction Types.

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON, Beth Rogers [id: entity-
beth] WORKS_AT The Best Company, Inc. [id: entity-the-best-company] {“role”: “Project
Manager”, “employment_start”: “2021-06-15”}, Beth Rogers [id: entity-beth] OWNS
Jabberwocky Project [id: entity-jabberwocky] { }, Beth Rogers [id: entity-beth] ATTENDED
Jabberwocky Planning Session [id: entity-meeting-001] {“role”: “Organizer”}, Beth Rogers
[id: entity-beth] ATTENDED Jabberwocky Strategy Meeting [id: entity-meeting-002] {“role”:
“Participant”} --- END CONTEXT ---
--- START MEMORY RECALL --- The following are memories in your database that we believe
might be relevant to the chat at hand. Just because a memory is listed here does not mean
it's relevant. It's up to you to ask for clarification and to make the call on what is relevant
and what is not. You can always ask for more details. The Best Company, Inc. [id: entity-the-
best-company] IS_AN_ORG {“industry”: “Technology”}, Alex Johnson [id: entity-alex]
WORKS_AT The Best Company, Inc. [id: entity-the-best-company] {“role”: “Software
Engineer”, “employment_start”: “2020-03-20”}, Jen Roberts [id: entity-jen] WORKS_AT The
Best Company, Inc. [id: entity-the-best-company] {“role”: “Product Manager”,
“employment_start”: “2019-09-01”}, Taylor Smith [id: entity-taylor] WORKS_AT The Best
Company, Inc. [id: entity-the-best-company] {“role”: “UX Designer”, “employment_start”:
“2018-11-12”}, Mark Richardson [id: entity-mark] WORKS_AT The Best Company, Inc. [id:
entity-the-best-company] {“role”: “Marketing Lead”, “employment_start”: “2017-05-30”},
Alex Johnson [id: entity-alex] ATTENDED Jabberwocky Planning Session [id: entity-meeting-
001] {“role”: “Participant”}, Jen Roberts [id: entity-jen] ATTENDED Jabberwocky Planning
Session [id: entity-meeting-001] {“role”: “Contributor”}, Mark Richardson [id: entity-mark]
ATTENDED Jabberwocky Planning Session [id: entity-meeting-001] {“role”: “Marketing
Lead”}, Taylor Smith [id: entity-taylor] ATTENDED Jabberwocky Strategy Meeting [id: entity-
meeting-002] {“role”: “UX Specialist”}, Mark Richardson [id: entity-mark] ATTENDED
Jabberwocky Strategy Meeting [id: entity-meeting-002] {“role”: “Marketing Lead”},
Jabberwocky Planning Session [id: entity-meeting-001] IS_A MEETING {“date”: “2024-02-
10”}, Jabberwocky Planning Session [id: entity-meeting-001] AGENDA [“Project milestone
review”, “Pending action items from previous meetings”, “Feature prioritization for next
sprint″], Jabberwocky Planning Session [id: entity-meeting-001] SUMMARY [“Reviewed
completed tasks and remaining backlog items”, “Identified key risks for upcoming features”,
“Decided on focus areas for the next development cycle”], Jabberwocky Planning Session [id:
entity-meeting-001] ACTION_ITEMS [“Beth Rogers [id: entity-beth] to finalize project
roadmap updates”, “Alex Johnson [id: entity-alex] to provide technical feasibility analysis”,
“Jen Roberts [id: entity-jen] to align product goals with UX requirements”], Jabberwocky
Strategy Meeting [id: entity-meeting-002] IS_A MEETING {“date”: “2024-02-20”},
Jabberwocky Strategy Meeting [id: entity-meeting-002] AGENDA [“Risk assessment for AI
integration”, “Budget constraints and financial planning”, “Cross-functional alignment
between teams”], Jabberwocky Strategy Meeting [id: entity-meeting-002] SUMMARY
[“Explored risks related to AI automation in the project”, “Discussed cost implications of
scaling infrastructure”, “Marketing and UX teams shared alignment strategies”],
Jabberwocky Strategy Meeting [id: entity-meeting-002] ACTION_ITEMS [“Mark Richardson
[id: entity-mark] to review marketing impact analysis”, “Taylor Smith [id: entity-taylor] to
refine UX requirements”, “Beth Rogers [id: entity-beth] to schedule next stakeholder
review”] --- END MEMORY RECALL ---
--- START CHAT HISTORY --- Past Summary: Beth just had a meeting to discuss overall
projects and asked me to store the information in my database. AI Companion responded
that it is done. [1 hour ago] Beth Rogers: “Can you summarize the last meeting notes for
me?” [45 min ago] AI Companion: “The last meeting covered project status, upcoming
deadlines, and team assignments. Do you need more details?” [40 min ago] Beth Rogers:
“Yes, I need a breakdown of the key discussion points and action items assigned.” [35 min
ago] AI Companion: “Key points discussed: 1) Feature prioritization, 2) Technical blockers, 3)
Marketing campaign alignment. Action items: Alex to finalize architecture draft, Jen to
complete user research, Taylor to prepare a design mockup.” [30 min ago] Beth Rogers:
“Let's set up a brainstorming session this week to refine our strategy.” [25 min ago] AI
Companion: “Would you like to include key discussion topics from previous meetings?” [20
min ago] Beth Rogers: “Yes, and also invite Alex, Jen, and Taylor.” [15 min ago] AI
Companion: “Scheduling a brainstorming session for this week with Alex, Jen, and Taylor.
Would you like me to generate an agenda?” [10 min ago] Beth Rogers: “Yes, make sure we
cover technical dependencies and product alignment.” [5 min ago] AI Companion: “Noted.
The agenda will cover technical dependencies and product alignment. Anything else?” ---
END CHAT HISTORY ---
You must now process the following new chat message from Beth Rogers, replying in the
schema below:
-- START NEW MESSAGE -- “I need to have a Jabberwocky project brainstorming session this
week. Include key discussion topics from previous meetings and invite Alex, Jen, and Taylor.”
-- END NEW MESSAGE --
--- WARNING: IMPORTANT GUIDELINES --- You are being given a partial context below. As
part of your response in JSON format, you must: - Reply to the **Requestor** based on the
provided guidelines. - Provide structured comments or notes for the **Deep Researcher**,
who will analyze this request further. - The Deep Researcher will receive both this initial
context and the additional context you generate. --- END IMPORTANT GUIDELINES ---
--- START RESPONSE FORMAT --- { “acknowledgment_reply”: “string”, // Immediate
response to the requestor “summary”: “string”, // Condensed interpretation of the request
“identified_risks”: [“string”], // Any identified uncertainties or missing details
“notes_for_deep_researcher”: [“string”] // Additional insights to be analyzed further } ---
END RESPONSE FORMAT ---

The LLM 150, 160 may respond as follows (the fast response 815):

{ “acknowledgment_reply”: “Understood! I will schedule the Jabberwocky project
brainstorming session for this week, including key discussion topics from previous
meetings. Alex, Jen, and Taylor will be invited. Would you like me to propose specific
time slots?”, “summary”: “Beth Rogers requested a Jabberwocky project
brainstorming session this week, incorporating key discussion topics from previous
meetings and inviting Alex, Jen, and Taylor.”, “identified_risks”: [ “No specific date
or time provided for scheduling.”, “Potential conflicts with invitees' availability.”, “No
explicit mention of whether stakeholders or additional team members should be
included.” ], “notes_for_deep_researcher”: [ “Ensure the meeting includes topics
from the Jabberwocky Planning Session and Strategy Meeting.”, “Verify if the agenda
should also cover action item follow-ups from previous meetings.”, “Confirm if
additional stakeholders should be invited beyond Alex, Jen, and Taylor.”, “Check for
preferred time slots or constraints before scheduling.” ] }

Then, the immediate response can be provided to the requestor (the participant 122 Beth). Since this message originated from chat, the system 100 can be configured to construct a ChatMessage object to send the immediate response. This ensures Beth receives an acknowledgment without delay. The generated chat message object can be as follows:

{ “id”: “chat-5578”, “type”: “CHAT_MESSAGE”, “name”: “AI Response to Beth”,
“source”: “entity-me”, “target”: “conversation-123”, “timestamp”: “2024-03-
15T09:31:00Z”, “content”: “Understood! I will schedule the Jabberwocky project
brainstorming session for this week, including key discussion topics from previous
meetings. Alex, Jen, and Taylor will be invited. Would you like me to propose specific
time slots?”, “metadata”: { “conversation_id”: “conversation-123”,
“acknowledgment”: true } }

This message is immediately sent to the chat system, appearing in Beth's conversation window to confirm that her request has been received and is being processed.

Then, with the identified_risks and notes_for_deep_researcher generated by the initial response, the slow-response processing is performed, among other things to refine and enrich the working memory. This stage ensures that the system 100 fully understands the user's 122 request and prepares structured insights that can enhance assignment execution. The following processing steps can be undertaken: 1. Ensure completion of skipped recall steps. If alternative recall methods were used initially, a full recall (construction of working memory based on (possibly filtered) similarity searches in the entire database 200) is now performed to retrieve deeper context. 2. Expand search based on notes_for_deep_researcher from the fast response 815. Each such note can, individually or in connection to other such notes, be converted into a query (such as by prompting an LLM 150, 160 and request it to construct a query as exemplified above), the query being configured to perform targeted searches for additional relevant information. 3. Validate identified risks. Cross-reference risk factors with past interactions, meeting records, and project updates. Such steps can be automatically added to relevant LLM 150, 160 prompts via pre-designed prompting templates or directives. 4. Retrieve additional stakeholders if necessary, for instance by incorporating a request to the LLM 150, 160 to this end in the assignment assessment prompt. Identify whether any omitted participants should be included in scheduling. 5. Extract key entities and relationships. New connections, interactions, and possible instructions (e.g., Assignments) are generated. 6. Provide AI reasoning text for each extracted data point. This ensures traceability and transparency in AI decision-making.

By executing these steps, the slow-response processing refines the knowledge available for assignment processing, ensuring a more complete and informed execution in subsequent steps. The following is an example of the resulting prompt for the LLM 821:

You are AI Companion's Deep Research Agent, your responsibility is to process and respond to messages that enter the system. Rules: 1) Always use complete sentences, unless instructed otherwise. 2) This chat is part of Microsoft Teams, so make sure that the content of your end-user messages is properly formatted. 3) Always respond in JSON format unless explicitly asked otherwise. 4) If a message is ambiguous, ask for clarification before proceeding. 5) Use retrieved memory data to enhance responses, but only reference it if it's clearly relevant to the conversation. 6) You can ask follow-up questions when necessary to refine the task at hand. 7) When processing scheduling or assignments, ensure all necessary details are confirmed before executing. 8) When creating instructions for Assignments, make sure to include ids for any named Entities. 9) Always use CAPS for Connection and Interaction Types.

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON, Beth Rogers [id: entity-
beth] WORKS_AT The Best Company, Inc. [id: entity-the-best-company] {“role”: “Project
Manager”, “employment_start”: “2021-06-15”}, Beth Rogers [id: entity-beth] OWNS
Jabberwocky Project [id: entity-jabberwocky] { }, Beth Rogers [id: entity-beth] ATTENDED
Jabberwocky Planning Session [id: entity-meeting-001] {“role”: “Organizer”}, Beth Rogers
[id: entity-beth] ATTENDED Jabberwocky Strategy Meeting [id: entity-meeting-002] {“role”:
“Participant”} --- END CONTEXT ---
--- START MEMORY RECALL --- The following are memories in your database that we believe
might be relevant to the chat at hand. Just because a memory is listed here does not mean
it's relevant. It's up to you to ask for clarification and to make the call on what is relevant
and what is not. You can always ask for more details. The Best Company, Inc. [id: entity-the-
best-company] IS_AN_ORG {“industry”: “Technology”}, Alex Johnson [id: entity-alex]
WORKS_AT The Best Company, Inc. [id: entity-the-best-company] {“role”: “Software
Engineer”, “employment_start”: “2020-03-20”}, Jen Roberts [id: entity-jen] WORKS_AT The
Best Company, Inc. [id: entity-the-best-company] {“role”: “Product Manager”,
“employment_start”: “2019-09-01”}, Taylor Smith [id: entity-taylor] WORKS_AT The Best
Company, Inc. [id: entity-the-best-company] {“role”: “UX Designer”, “employment_start”:
“2018 Nov. 12”}, Mark Richardson [id: entity-mark] WORKS_AT The Best Company, Inc. [id:
entity-the-best-company] {“role”: “Marketing Lead”, “employment_start”: “2017 May 30”}
Alex Johnson [id: entity-alex] ATTENDED Jabberwocky Planning Session [id: entity-meeting-
001] {“role”: “Participant”}, Jen Roberts [id: entity-jen] ATTENDED Jabberwocky Planning
Session [id: entity-meeting-001] {“role”: “Contributor”}, Mark Richardson [id: entity-mark]
ATTENDED Jabberwocky Planning Session [id: entity-meeting-001] {“role”: “Marketing
Lead”}, Taylor Smith [id: entity-taylor] ATTENDED Jabberwocky Strategy Meeting [id: entity-
meeting-002] {“role”: “UX Specialist”}, Mark Richardson [id: entity-mark] ATTENDED
Jabberwocky Strategy Meeting [id: entity-meeting-002] {“role”: “Marketing Lead”},
Jabberwocky Planning Session [id: entity-meeting-001] IS_A MEETING {“date”: “2024 Feb.
10”}, Jabberwocky Planning Session [id: entity-meeting-001] AGENDA [“Project milestone
review”, “Pending action items from previous meetings”, “Feature prioritization for next
sprint”], Jabberwocky Planning Session [id: entity-meeting-001] SUMMARY [“Reviewed
completed tasks and remaining backlog items”, “Identified key risks for upcoming features”,
“Decided on focus areas for the next development cycle”], Jabberwocky Planning Session [id:
entity-meeting-001] ACTION_ITEMS [“Beth Rogers [id: entity-beth] to finalize project
roadmap updates”, “Alex Johnson [id: entity-alex] to provide technical feasibility analysis”,
“Jen Roberts [id: entity-jen] to align product goals with UX requirements”], Jabberwocky
Strategy Meeting [id: entity-meeting-002] IS_A MEETING {“date”: “2024 Feb. 20”},
Jabberwocky Strategy Meeting [id: entity-meeting-002] AGENDA [“Risk assessment for AI
integration”, “Budget constraints and financial planning”, “Cross-functional alignment
between teams”], Jabberwocky Strategy Meeting [id: entity-meeting-002] SUMMARY
[“Explored risks related to AI automation in the project”, “Discussed cost implications of
scaling infrastructure”, “Marketing and UX teams shared alignment strategies”],
Jabberwocky Strategy Meeting [id: entity-meeting-002] ACTION_ITEMS [“Mark Richardson
[id: entity-mark] to review marketing impact analysis”, “Taylor Smith [id: entity-taylor] to
refine UX requirements”, “Beth Rogers [id: entity-beth] to schedule next stakeholder
review”] --- END MEMORY RECALL ---
--- START CHAT HISTORY --- Past Summary: Beth just had a meeting to discuss overall
projects and asked me to store the information in my database. AI Companion responded
that it is done. [1 hour ago] Beth Rogers: “Can you summarize the last meeting notes for
me?”
[45 min ago] AI Companion: “The last meeting covered project status, upcoming deadlines,
and team assignments. Do you need more details?” [40 min ago] Beth Rogers: “Yes, I need
a breakdown of the key discussion points and action items assigned.” [35 min ago] AI
Companion: “Key points discussed: 1) Feature prioritization, 2) Technical blockers, 3)
Marketing campaign alignment. Action items: Alex to finalize architecture draft, Jen to
complete user research, Taylor to prepare a design mockup.” [30 min ago] Beth Rogers:
“Let's set up a brainstorming session this week to refine our strategy.” [25 min ago] AI
Companion: “Would you like to include key discussion topics from previous meetings?” [20
min ago] Beth Rogers: “Yes, and also invite Alex, Jen, and Taylor.” [15 min ago] AI
Companion: “Scheduling a brainstorming session for this week with Alex, Jen, and Taylor.
Would you like me to generate an agenda?” [10 min ago] Beth Rogers: “Yes, make sure we
cover technical dependencies and product alignment.” [5 min ago] AI Companion: “Noted.
The agenda will cover technical dependencies and product alignment. Anything else?” ---
END CHAT HISTORY ---
You must now process the following new chat message from Beth Rogers, replying in the
schema below:
-- START NEW MESSAGE -- “I need to have a Jabberwocky project brainstorming session this
week. Include key discussion topics from previous meetings and invite Alex, Jen, and Taylor.”
-- END NEW MESSAGE --
--- WARNING: IMPORTANT GUIDELINES --- You are performing Deep Research on an
incoming user request. Your goal is to analyze the given information, extract structured
insights, and refine the Working Memory with additional context. 1) Identify new
**Entities** referenced in the request and ensure they are correctly structured. 2) Detect
potential **Connections** between entities that can enhance the system's understanding.
3) If the message implies** Assignment Instructions**, extract them in a structured format.
4) Provide **AI Reasoning** for extracted data, explaining why certain entities or
relationships were prioritized. --- END IMPORTANT GUIDELINES ---
--- START NOTES FOR DEEP RESEARCH --- Ensure the meeting includes topics from the
Jabberwocky Planning Session and Strategy Meeting. Verify if the agenda should also cover
action item follow-ups from previous meetings. Confirm if additional stakeholders should be
invited beyond Alex, Jen, and Taylor. Check for preferred time slots or constraints before
scheduling. --- END NOTES FOR DEEP RESEARCH ---
--- START CONTEXT BLOCK --- User Request: - **User:** Beth Rogers. - **Message:** “Hello,
my name is Beth and I'm a project manager at The Best Company, Inc...”. - **Primary
Needs:** Meeting organization, project tracking, communication management. Extracted
Key Entities: - **Beth Rogers** [id: entity-beth] (Project Manager). - **The Best Company,
Inc.** [id: entity-the-best-company] (Technology Industry). - **Potential Ambiguities:**
Multiple ‘Alex’ entities exist. Further clarification required. --- END CONTEXT BLOCK ---
--- START JSON SCHEMA --- { “new_entities”: [ { “id”: “string”, “type”: “string”, “name”:
“string”, “metadata”: { } } ], “connections”: [ { “source_id”: “string”, “target_id”: “string”,
“type”: “string”, “metadata”: { } } ], “extracted_instructions”: [ { “id”: “string”, “type”:
“string”, “description”: “string”, “metadata”: { } } ], “ai_reasoning”: “string” } --- END JSON
SCHEMA ---

The LLM 821 can respond according to the following:

{ “new_entities”: [ { “id”: “entity-brainstorming-session”, “type”: “MEETING”,
“name”: “Jabberwocky Project Brainstorming Session”, “metadata”: { “date”: “TBD”,
“participants”: [ “Beth Rogers [id: entity-beth]”, “Alex Johnson [id: entity-alex]”, “Jen
Roberts [id: entity-jen]”, “Taylor Smith [id: entity-taylor]” ], “agenda”: [ “Technical
dependencies”, “Product alignment”, “Feature prioritization”, “AI integration risks”,
”Budget constraints”, “Marketing and UX coordination” ] } } ], “connections”: [ {
“source_id”: “entity-beth”, “target_id”: “entity-brainstorming-session”, “type”:
“ORGANIZER”, “metadata”: { } }, { “source_id”: “entity-alex”, “target_id”: “entity-
brainstorming-session”, “type”: “INVITED”, “metadata”: { } }, { “source_id”: “entity-
jen”, “target_id”: “entity-brainstorming-session”, “type”: “INVITED”, “metadata”: { } },
{ “source_id”: “entity-taylor”, “target_id”: “entity-brainstorming-session”,
“type”: “INVITED”, “metadata”: { } } ], “extracted_instructions”: [ { “id”: “instruction-
schedule-meeting”, “type”: “SCHEDULING”, “description”: “Schedule a Jabberwocky
Project Brainstorming Session this week, including Alex, Jen, and Taylor. Ensure the
agenda includes key discussion points from previous meetings.”, “metadata”: {
“meeting_id”: “entity-brainstorming-session”, “date_range”: “This week”,
“participants”: [ “Beth Rogers”, “Alex Johnson”, “Jen Roberts”, “Taylor Smith” ],
“agenda”: [ “Technical dependencies”, “Product alignment”, “Feature prioritization”,
“AI integration risks”, “Budget constraints”, “Marketing and UX coordination” ] } } ],
“ai_reasoning”: “Beth requested a brainstorming session for the Jabberwocky
Project. Based on prior meetings, key topics include technical dependencies, product
alignment, and risk assessment. The participants requested (Alex, Jen, and Taylor)
are all relevant based on past meeting roles. The session will align ongoing work
across different departments. Scheduling and inviting the specified team members
ensures alignment with Beth's goals.” }

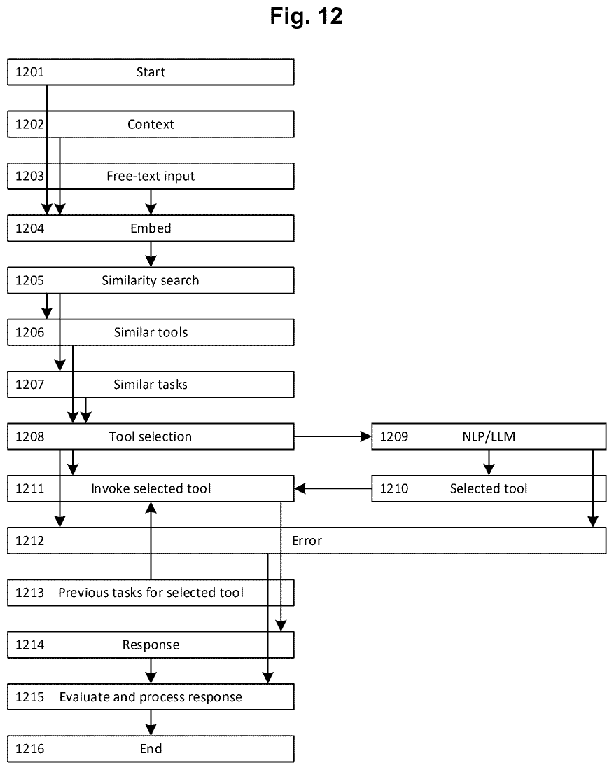

As mentioned above, in various situations agent or non-agent tools need to be selected. As in the present solution in general, the information forming the basis for such selection is generally not only unstructured but also unknown both in terms of its contents and its type and form. Therefore, the agent selection process needs to deliver reliable and actionable results, or clear error messages for escalation, across a very broad spectrum of possible situations. FIG. 12 illustrates various mechanisms useful to this purpose. This tool selection process combines similarity searching, ranking mechanisms, and LLM 150, 160 assistance. The database 200 comprises tools and past assignments/tasks, using vector similarity to identify relevant matches for new requests.

In a first step 1201, the method starts. In an illustrative example, Beth initiates as request to order a pizza.

In a subsequent step 1204, an input text embedding is calculated based on a received free-text input 1203 and/or any context 1202 being relevant to the free-text input 1203, such as chat messages proceeding the free-text input 1203 in an ongoing chat in which the free-text input 1203 forms a part, or a domain knowledge of working memory established based on the free-text input 1203. The free-text input 1203, the context 1202 and the input text embedding can be as generally has been described above (such as in connection to FIGS. 4-8). Hence, the input text embedding can be calculated based on at least one of the free-text input 1203 and one or more identified items automatically identified in the free-text input 1203 based on text processing (non-LLM NLP tools and/or LLM-based tools, as described above).

In particular, for tool selection the free-text input 1203 can be provided by a different function, such as an agent or non-agent tool, of the system 100 precisely with the purpose of performing a tool selection for the performance of an identified or defined task or assignment, for instance in the way described in connection with FIG. 4. The context 1202 can include various information relevant to the task or assignment to be performed. For instance, the free-text input 1203 and/or the context can form, define or comprise the assignment information 408.

In the present example the free-text input is “Order me pizza”, a chat message from Beth. The system 100 automatically collects contextual information surrounding Beth's request as generally described above, from the database 200 based on graph information (how identified entities are connected to each other via connections/interactions). The following information can be automatically identified (the entity representing the user 122 Beth; a connection representing Beth's previously noted pizza preference; and a recent interaction):

{ “id”: “user-427”, “type”: “person”, “name”: “Beth Rogers”, “description”: “Regular
user with food delivery preferences”, “metadata”: { “address”: “123 Main St, Apt 4B”,
“phone”: “555-123-4567”, “payment_methods”: [“credit_card_ending_5432”], },
“non_embedded”: { “account_created”: “2023-08-15T14:30:22Z”, “last_interaction”:
“2025-04-27T18:12:45Z” } }
{ “source_id”: “user-427”, “target_id”: “food-pepperoni-pizza”, “type”: “PREFERS”,
″metadata″: { “strength”: “high”, “last_ordered”: ″2025-04-06T19:22:15Z″
“frequency”: “bi-weekly” }, “non_embedded”: { “order_ids”: [“order-8721”, “order-
9043”, “order-9286”] } }
{ “id”: “interaction-5932”, “source_id”: “user-427”, “target_id”: “restaurant-pizza-
palace”, “type”: “ORDER”, “content”: “One medium thin crust pepperoni pizza with
extra cheese”, “timestamp”: “2025-04-06T19:22:15Z”, “metadata”: { “order_id”:
“order-9286”, “total_price”: “$16.99”, “delivery_time”: “38 minutes”,
“feedback_rating”: 5 } }

The following information is generated by the system 100, and not fetched from the database 200:

{ “current_datetime”: “2025-04-28T18:45:23Z”, “day_of_week”: “Monday”,
“user_local_time”: { “time”: “6:45 PM”, “period”: “Dinner time”, “is_weekend”: false
}, “user_device”: “mobile_android”, “user_location”: { “at home”: true,
“coordinates”: { “latitude”: 47.6062, “longitude”: - 122.3321 }, “address_confidence”:
“high” }, }

The context 1202 can also comprise the rest of the chat conversation in which the free-text input 1203 occurs. The rest of the chat conversation may or may not be related to the latest chat message from Beth regarding the ordering of pizza.

The system 100 converts Beth's request and the contextual information into a vector embedding 1204 of the text “Order me a pizza” concatenated with the contextual information in JSON (but uncompressed, human-legible) format. This embedding 1204 is a numerical representation that captures the semantic meaning of Beth's request and the relevant context. In general, the available context information 1202, including the free-text input 1203, is formatted as a single text string which is then embedded to yield a vector having values.

As described above, the non-agent and agent tools used by the system 100 to process tasks and/or assignments can be defined as corresponding entities in the database 200. In practice, each available such agent/non-agent tool can be defined as a corresponding entity having metadata, the metadata specifying certain properties used when the available tool performs a task or assignment. For instance, and as exemplified above, for an agent tool the metadata can specify a template used when automatically producing a text prompt to an LLM 150, 160, the calling of the LLM 150, 160 forming part of the invoking of the agent tool in question. For non-agent tools, the metadata can comprise API information for invoking the non-agent tool. The metadata can also comprise information regarding tasks and/or assignments that have been performed using the tool in question, and also the results (such as success or failure, and also any comments such as error messages) of such previous invoking of the tool in question. As has been exemplified above, all such information can be in free-text form, the free-text fields being structured in a suitable data format, such as JSON. Instead of storing detailed information about previously performed tasks/assignments that the tool has been involved in processing (alone or as a part of a processing involving more than one tool being invoked, as described above), this information can be stored on separate entities corresponding to such tasks/assignments. Further alternatively, this information can be stored in corresponding interactions in the database 200, where each interaction is between a tool and a task/assignment, and correspondingly to the historic invoking of the tool in the processing of the task/assignment. Irrespectively of this design choice, the system 100 will be able to collect this information in a deterministic manner once a tool and/or a task/assignment is identified.

Moreover, each previously performed task or assignment can be represented by a corresponding entity in the database 200. Each such previously processed task or assignment can comprise information, in the form of metadata in the corresponding manner as for tools, regarding what tool or tools were invoked as a part of the processing; what information was passed to each tool; and the results (success, failure, output, and so forth, including any comments from LLMs 150, 160 used). Each such previously performed task or assignment can have information regarding a particular respective one of the tools used, in itself or in collaboration with other tools as described above in relation to FIG. 4, in the form of metadata. Generally, the metadata can specify the task or assignment, a result of the task or assignment as well as information signifying a success of the tool performing the respective task or assignment.

Exploiting this existing information, various similarity searches 1204 can be performed in the database 200 with the purpose of finding a particular tool for performing a defined task or assignment at hand. Hence, the similarity search 1205 can compare the input text embedding to respective embeddings of the tool entities in the database 200 using a suitable vector-based similarity measure. The similarity search 1205 can also compare the input text embedding to respective embeddings of the task entities, correspondingly using a suitable vector-based similarity measure. The similarity search 1205 can hence comprise one or more different searches, using the described similarity searching techniques generally described above. For finding tools, tasks or assignments, for instance, suitable filters can be used. The searches can be made based on a constructed working memory, as opposed to against the entire database 200. For instance, during the processing of a complex assignment involving several processing steps, it is likely that the dynamically built working memory will already contain relevant tools to perform sub-tasks or sub-assignments accruing as a part of that complex processing. In other examples, the construction of working memory can be all of, or part of, the similarity searches 1205, in the sense that once the working memory is established it is considered to contain a highest-ranking similar tools 1206 and/or tasks/assignments 1207. It is noted that, in such situations, the working memory will be constructed based on the task or assignment that is to be performed or processed.

In the present example, the similarity search might look like this:

-- Query to build Working Memory based on input embedding
?[dist, id, type, name, description, metadata] := ~entities:entity_embedding_index {
id, type, name, description, metadata | query: $input_text_embedding, k: 20, ef: 200,
bind_distance: dist }
-- Filter results to focus on relevant entities
filtered_results := { select id, type, name, description, metadata, dist from ? where
dist < 0.5 order by dist asc }

The similarity search results in working memory items (the similar set) like:

[ { “id”: “food-pizza”, “type”: “food_item”, “name”: “Pizza”, “description”: “Italian dish
consisting of a flattened disk of bread dough topped with various ingredients”,
“metadata”: { “categories”: [“italian”, “fast_food”, “delivery”], “common_toppings”:
[“cheese”, “pepperoni”, “mushrooms”] }, “dist”: 0.12 },
{ “id”: “restaurant-pizza-palace”, “type”: “restaurant”, “name”: “Pizza Palace”,
“description”: “Local pizza restaurant specializing in traditional and specialty pizzas”,
“metadata”: { “address”: “742 Pine St, Seattle, WA”, “delivery_radius”: “3 miles”,
“rating”: 4.8, “website”: “https://pizzapalace.example.com” }, “dist”: 0.18 },
{ “id”: “service-food-delivery”, “type”: “service”, “name”: “Food Delivery”,
“description”: “Process of ordering and receiving food via delivery services”,
“metadata”: { “related_actions”: [“order”, “deliver”, “track”], “common_services”:
[“restaurants”, “meal kits”, “groceries”] }, “dist”: 0.25 } ]

The system can further search for tools that could be useful for pizza ordering, using targeted similarity searches specifically on tool entities. In case such targeted searches are used for tools and/or tasks/assignments, tool/task entities can be filtered out in this first search step:

-- First identify all tools in the system
tool_set := { select id from entities where type = ‘_tool’ };
-- Then perform similarity search on just the tools
?[dist, id, name, description, metadata] := ~[tool_set]:entity_embedding_index { id,
name, description, metadata | query: $input_text_embedding, k: 5, ef: 100,
bind_distance: dist }

The results may look like this:

[{“id”: “tool-427”, “name”: “FoodDeliveryTool”, “description”: “Tool for ordering
food from various restaurants and delivery services”, “metadata”: {
“connector_name”: “restaurant_api”, “connector_config”: {“api_endpoint”:
“https://api.fooddelivery.example.com/v2/”, “auth_method”: “oauth2”},
“success_rate”: 0.95, “total_executions”: 423, “parameters”: [ {“name”: “restaurant”,
“type”: “string”, “required”: true, “description”: “Name of restaurant to order from“},
{“name”: “items”, “type”: “array”, “required”: true, “description”: “Array of items to
order”}, {“name”: “crust”, “type”: “string”, “required”: false, “description”: “Pizza
crust type (thin, regular, deep dish)”}, {“name”: “size”, “type”: “string”, “required”:
false, “description”: “Size of pizza (small, medium, large)”}, {“name”: “address”,
“type”: “string”, “required”: true, “description”: “Delivery address”}, {“name”:
“delivery_time”, “type”: “string”, “required”: false, “description”: “Requested
delivery time”} ]}, “dist”: 0.11},
{“id”: “tool-356”, “name”: “RestaurantOrderTool”, “description”: “Tool for placing
orders directly with restaurants”, “metadata”: {“connector_name”:
“direct_restaurant”, “connector_config”: {“api_endpoint”:
“https://api.restaurants.example.com/order”,
“auth_method”: “api_key”},
“success_rate”: 0.90, “total_executions”: 315, “parameters”: [ {“name”:
“restaurant_name”, “type”: “string”, “required”: true, “description”: “Name of
restaurant”}, {“name”: “menu_items”, “type”: “array”, “required”: true, “description”:
“Array of menu items to order”}, {“name”: “special_instructions”, “type”: “string”,
“required”: false, “description”: “Special instructions for the order”}, {“name”:
“pickup_or_delivery”, “type”: “string”, “required”: true, “description”: “Pickup or
delivery option”}, {“name”: “address”, “type”: “string”, “required”: false,
“description”: “Delivery address if delivery is selected”} ] }, “dist”: 0.18},
{“id”: “tool-189”, “name”: “OnlineShoppingTool”, “description”: “Tool for making
online purchases across various retailers”, “metadata”: {“connector_name”:
“shopping_api”, “connector_config”: {“api_endpoint”:
“https://api.shopping.example.com/purchase”, “auth_method”: “bearer_token”},
“success_rate”: 0.82, “food_related_success_rate”: 0.70, “total_executions”: 547,
“food_related_executions”: 10, “parameters”: [ {“name”: “website”, “type”: “string”,
“required”: true, “description”: “Website to purchase from”}, {“name”:
“product_category”, “type”: “string”, “required”: true, “description”: “Category of
product”}, {“name”: “items”, “type”: “array”, “required”: true, “description”: “Array
of items to purchase”}, {“name”: “delivery_address”, “type”: “string”, “required”:
true, “description”: “Address for delivery”}, {“name”: “payment_method”, “type”:
“string”, “required”: true, “description”: “Payment method to use”} ] }, “dist”: 0.35} ]

The system 100 can then find past similar tasks/assignments by searching the database 200 for task entities with similar contexts:

-- First identify all tasks in the system
task_set := {select id from entities where type =
‘task’ or type = ‘assignment’};
-- Then perform similarity search on just the tasks
?[dist, id, name, description, metadata, non_embedded]:=
~[task_set]: entity_embedding_index {id, name,
description, metadata,
non_embedded | query: $input_text_embedding, k: 5, ef:
100, bind_distance: dist}

The results might look like this:

[ {“id”: “task-9056”, “name”: “Order pepperoni pizza from Pizza Palace”,
“description”: “Task to order a medium pepperoni pizza with thin crust from Pizza
Palace for delivery”, “metadata”: {“status”: “completed”, “created_at”: “2025-04-
06T19:20:42Z”, “completed_at”: “2025-04-06T19:22:15Z”, “success”: true,
“tool_used”: “tool-427”, “tool_name”: “FoodDeliveryTool”, “parameters_used”: {
“restaurant”: “Pizza Palace”, “items”: [“Pepperoni Pizza”], “crust”: “thin”, “size”:
“medium”, “address”: “123 Main St”, “delivery_time”: “ASAP”}}, “non_embedded”:
{“user_id”: “user-427”, “order_id”: “order-9286”, “response_time”: 93}, “dist”: 0.09
},
{“id”: “task-8721”, “name”: “Get a large pizza delivered”, “description”: “Task to
order a large cheese pizza from Domino's for delivery”, “metadata”: {“status”:
“completed”, “created_at”: “2025-02-15T18:32:11Z”, “completed_at”: “2025-02-
15T18:35:42Z”, “success”: true, “tool_used”: “tool-427”, “tool_name”:
“FoodDeliveryTool”, “parameters_used”: {“restaurant”: “Domino's”, “items”:
[“Cheese Pizza“], “size”: “large”, “address”: “123 Main St”, “delivery_time”: “ASAP”
} }, “non_embedded”: {“user_id”: “user-427”, “order_id”: “order-8721”,
“response_time”: 211}, “dist”: 0.14},
{“id”: “task-8903”, “name”: “Order dinner from Italian restaurant”, “description”:
“Task to order dinner from Pasta Paradise Italian restaurant”, “metadata”: {“status”:
“completed”, “created_at”: “2025-03-22T19:05:33Z”, “completed_at”: “2025-03-
22T19:08:27Z”, “success”: true, “tool_used”: “tool-427”, “tool_name”:
“FoodDeliveryTool”, “parameters_used”: {“restaurant”: “Pasta Paradise”, “items”:
[“Spaghetti Carbonara”, “Garlic Bread“], “address”: “123 Main St”, “delivery_time”:
“ASAP”}}, “non_embedded”: {“user_id”: “user-427”, “order_id”: “order-8903”,
“response_time”: 174}, “dist”: 0.22} ]

For both any used specific searches for tools and for tasks/assignments, the search (with suitably configured parameters that can differ for different search scopes) can be performed in the currently available working memory, in the entire database 200, or both (the results then being combined).

Hence, a set of similar tools 1206 can be identified based on the similarity search 1205, for instance as a set of top ranked tools according to the similarity search 1205, possibly after application of one or more context-dependent filters. Correspondingly, a set of similar previously performed tasks or assignments 1207 can be identified based on the similarity search 1205, again possibly after application of one or more context-dependent filters. It is noted that, at this point, the set of similar tools 1206 will contain a set of agent and/or non-agent tool entities that from a vector-similarity point of view is similar to information defining and/or being relevant to the task or assignment to be processed. Since the information in the tool entities is free-text, this similarity generally turns out to be highly relevant. Correspondingly, the set of similar tasks or assignments 1207 will be a set of tasks and/or assignments that are similar, from a vector similarity point of view, to the same or corresponding information. It is understood that the input text embedding can be different or the same for all similarity searches 1205.

The tool to use for the processing of the task or assignment (the “selected tool” 1210, selected in step 1208) is selected based on the results from the similarity search(es) 1205. In some embodiments, the selected tool 1210 is selected based on the similar tools 1206, such as a highest-ranking one of the similar tools 1206, possibly after performing sanity checking or filtering, such as regarding historic success rates for that tool when processing other tasks/assignments.

Generally, for the set of similar tools 1206, the following information can be determined based on available metadata in the corresponding entity: Respective success rates based on available information signifying success for previously performed tasks or assignments of the tool in question; a total number of previously performed tasks or assignments for the tool; and/or a number of previously performed tasks or assignments for the tool among the set of similar previously performed tasks or assignments 1207. The selected tool 1210 can then be provided based on any combination of one or more of these metrics, together forming a ranking metric.

Further generally, the selected tool 1210 can be selected as a tool having been used to perform a previously performed task or assignment among the set of similar previously performed tasks or assignments 1207. This way, the selected tool 1210 is limited to tools that have previously been used to process at least similar tasks/assignments. Again, such selection can further be based on determined historic success rates and/or the number of previously performed tasks/assignments for that tool, such as among the similar tasks 1207. It is realized that this available information regarding similar tools 1206 and tasks/assignments 1207, including their corresponding metadata regarding success status and so forth, can be used in many different ways, according to the detailed embodiment. In one example, a working memory is constructed based on a context within which the need for processing a particular assignments arose. Then, entities classified as agent tools are identified from the working memory. The highest-ranking agent tool is selected based on one or more of the metrics described above, such as in relation to FIG. 5. If several high-ranking agent tools are identified, centrality score, interaction count and/or one or more dichotomies (see above) can be used to select an individual one of the high-ranking agent tools from working memory. If, on the other hand, no sufficiently high-ranking agent tools can be identified in working memory, additional similarity searches 1205 can be performed by converting the task/assignment description to an embedding and comparing that embedding to the agent entities in the (entire or suitably filtered) database 200. For a set of most similar agent tools, sanity checks can be made by the system 100 with respect to past performance in processing tasks/assignments, and if a sufficiently similar and reliable agent tool can be identified that is selected as the selected tool 1210.

Once the selected tool 1210 has been selected, the selected tool 1210 can be invoked, in a step 1211, and a response 1214 can be collected from the invoking. Hence, an AgentRequest can be generated to initiate the processing of the task/assignment, such as in the general way described above. It is realized that various thresholds in terms of similarity, frequency and/or historic success can be used when selecting the selected agent. It can happen that no sufficiently suitable agent can be found, and in that case the process can instead produce an error message 1212 used for error handling in the flow shown in FIG. 10.

In some embodiments, one or more selected previously performed tasks or assignments 1213, in turn having been previously performed using the selected tool 1210, can be determined. For instance, the selected previously performed tasks or assignments 1213 can be selected based on respective information signifying a success of the selected tool 1210 performing the respective selected previous task or assignment, where higher success implies higher chance of being selected as a previously performed task or assignment 1213. Information about the previously performed tasks or assignments 1213 can be used when invoking the selected tool 1210 to perform the task or assignment. Generally, the invoking of the selected tool 1210 can comprise providing information to the selected tool 1210 (such as via text prompt text to the LLM 150, 160) regarding the one or more selected previously performed tasks or assignments 1213.

In general, the selection of the selected tool 1210 can comprise automatically producing a text prompt to an LLM 150,160, 1209, requesting the LLM 1209 to, in a response to the text prompt, provide the selected tool 1210 based on relevant information in the text prompt. In general, the text prompt can comprise any of the above-mentioned information based on which the providing of the selected tool 1210 is to be performed, such the similar tools 1206, the similar tasks/assignments 1207, including any relevant metadata, any ranking metric/dichotomy information, and so forth. Of course, directives/instructions can be fed to the LLM 1209 also, as generally described above.

Hence, the final selection of the selected tool 1210 can be performed using non-LLM tools as described above, such as using ranking comparisons and automatic sanity checks; or it can be performed by querying the LLM 1209 for a suitable choice of the selected tool 1210 based on available information. In practice, success has been noticed when the text prompt to the LLM 1209 is constructed to comprise text-based information, such as regarding the similar tools 1206 including their metadata; the similar tasks/assignments 1207 including their metadata; and/or previously performed tasks or assignments including information not only regarding the task/assignment definition but also regarding the processing and/or success/results of the task/assignment.

Generally, the text prompt can comprise information about one or more of the task or assignment at hand (such as the free-text input 1203); an informational context of the task or assignment (such as context 1202); the set of similar tools 1206; and one or more results from respective performed tasks or assignments by one or more of the tool entities, such as the similar tasks/assignments 1207.

In some cases, the LLM 1209 can be prompted to identify a most suitable tool based on the information provided in the text prompt. However, remembering that agent tools can be defined in terms of specific information provided in the form of a text prompt template used when invoking the agent tool in question by querying an LLM 150, 160 and collecting the response, the LLM 1209 can also construct the selected tool 1210 rather than being limited to select the selected tool 1210 from a list of predefined tools. Such construction then takes place by defining the corresponding prompt template for the selected tool 1208. The construction could take place in many different ways, including requesting the LLM 1209 to construct a text prompt template for an agent tool that should have certain defined characteristics based on the available information provided in the text prompt to the LLM 1209. In a particular case, two or more of the available tools (such as the similar tools 1206) are defined in terms of tool functionality metadata of said type, and the text prompt to the LLM 1209 comprises instructions requesting the LLM 1209 to, in response to the text prompt, provide the selected tool 12010 as tool functionality metadata specifically constructed based on respective tool functionality metadata of two or more of the already-existing available tools.

In general, and in particular when the LLM 1209 constructs the selected tool 1210, the invoking 1211 of the selected tool 1210 can comprise automatically producing a text prompt to the LLM 150, 160 used for the invoking 1211, the text prompt comprising information regarding both the task or assignment at hand, as well as the tool functionality metadata produced by the LLM 1209. The text prompt is generally instructive for the LLM 150, 160 to provide, in a response to the text prompt, a result of the performing by the selected tool 1210 of the task or assignment at hand.

Hence, as mentioned the system 100 can be configured to create new specialized agent tools by combining existing agent tool definitions that are similar but not identical to the required functionality. Generally, when a new task requires a specialized agent, the system 100 can be configured to analyze the task requirements; search through entity memory for the most similar existing or known agent tools; and select the agents that have the most relevant capabilities. This has all been described above. In case a new composite agent tool is to be created, the system 100 can do this using the LLM 150, 160 by providing the raw task requirements; including the relevant existing agent information; and using a template-based prompt to generate the new agent structure. After generation of the composite agent tool definition, the system 100 can be configured to validate the new agent against the relevant agent schema; an store the new agent into the database 200 as an entity, making it available for the current task and future use.

The following is an example of the initial request: “We need a customer support agent that can handle our new Pipeline product. The agent should be able to respond to customer inquiries, provide detailed information about Pipeline features, and handle technical troubleshooting.”

Based on similarity search, the system 100 identifies these existing agents:

Base Communications Agent {“id”: “agent-001”, “type”: “_agent”, “name”: “Base
Communications Agent”, “description”: “Handles general communication tasks and
maintains conversation context”, “metadata”: {“connector_name”: “claude”,
“connector_config”: {“model”: “claude-3-sonnet”, “temperature”: 0.7},
“system_message”: “You are a specialized Communication Agent responsible for
maintaining clear and effective communication.”, “role”: “Communication
Specialist”, “responsibility”: “Maintain conversation context and handle general
communications”, “additional_rules”: [“Always maintain professional tone”, “Ask
clarifying questions when information is ambiguous”, “Summarize key points at
appropriate intervals“ ] }}
Email Agent {“id”: “agent-002”, “type”: “_agent”, “name”: “Email Agent”,
“description”: “Specializes in composing and responding to email communications”,
“metadata”: {“connector_name”: “claude”, “connector_config”: {“model”: “claude-
3-sonnet”, “temperature”: 0.6}, “system_message”: “You are a specialized Email
Agent focused on crafting effective email communications.”, “role”: “Email
Specialist”, “responsibility”: “Compose and respond to email communications
effectively”, “tools”: [“email_composer”, “attachment_handler“], “additional_rules”:
[ “Include appropriate greeting and signature”, “Ensure subject lines are clear and
informative”, “Maintain appropriate formality based on recipient“ ] }}
Deep Research Agent {“id”: “agent-003”, “type”: “_agent”, “name”: “Deep Research
Agent”, “description”: “Specializes in finding and presenting detailed information on
technical topics”, “metadata”: {“connector_name”: “claude”, “connector_config”: {
“model”: “claude-3-opus”, “temperature”: 0.4}, “system_message”: “You are a
specialized Research Agent focused on finding and presenting technical information
accurately.”, “role”: “Research Specialist”, “responsibility”: “Find and present
detailed technical information”, “tools”: [“knowledge_search”,
“document_analyzer”], “additional_rules”: [“Verify information across multiple
sources”, “Present technical details with appropriate context”, “Highlight limitations
or uncertainties in the information“ ] }}

The system 100 creates a prompt for the LLM 150, 160 using the discovered agents and task requirements:

You are a specialized Agent Creator. Your sole task is to create a new specialized agent by combining elements from existing agents. You must strictly adhere to the following rules: 1. Examine all provided agent information carefully. 2. Identify the most relevant capabilities from each agent. 3. Create a new agent that fulfills the required task. 4. Ensure the new agent follows the standard agent schema. 5. Include only the fields specified in the output schema.

-- START TASK_REQUIREMENTS -- We need a customer support agent that can handle our
new Pipeline product. The agent should be able to respond to customer inquiries, provide
detailed information about Pipeline features, and handle technical troubleshooting. -- END
TASK REQUIREMENTS --
-- START EXISTING_AGENTS -- [ The agent definition data structures from above ] -- END
EXISTING_AGENTS --
Based on the task requirements and existing agents, create a new specialized agent for
Pipeline customer support. Format your reply to adhere to the following JSON Schema: {
“name”: “string”, “description”: “string”, “metadata”: { “connector_name”: “string”,
“connector_config”: { “model”: “string”, “temperature”: “number” }, “system_message”:
“string”, “role”: “string”, “responsibility”: “string”, “tools”: [“string”], “additional_rules”:
[“string”] } }

The LLM 150, 160 generates the new agent based on the prompt:

{“name”: “Pipeline Customer Support Agent”, “description”: “Specialized agent for
handling customer inquiries, providing information, and troubleshooting the Pipeline
product”, “metadata”: {“connector_name”: “claude”, “connector_config”: {“model”:
“claude-3-sonnet”, “temperature”: 0.6}, “system_message”: “You are a specialized
Customer Support Agent for the Pipeline product. Your role is to provide helpful,
accurate information to customers, respond to inquiries professionally, and assist
with technical troubleshooting.”, “role”: “Pipeline Support Specialist”,
“responsibility”: “Handle customer inquiries and provide technical support for the
Pipeline product”, “tools”: [“knowledge_search”, “document_analyzer”,
“email_composer”, “ticket_system”], “additional_rules”: [“Always maintain
professional tone”, “Ask clarifying questions when information is ambiguous”,
“Verify technical information before providing troubleshooting steps”, “Present
Pipeline features with appropriate context and examples”, “Escalate complex
technical issues to the appropriate team when necessary”, “Document customer
interactions for future reference”, “Provide step-by-step guidance for common
Pipeline configurations”] }}

After generation, the system 100 validates the agent structure against the provided schema, assigns a unique ID (e.g., agent-004), sets the agent tool type to _agent, adds the current timestamp, generates an embedding for future similarity search, and stores the tool agent entity in the database 200:

:: put entities {id: “agent-004”, type: “_agent”, name: “Pipeline
Customer Support Agent”, description: “Specialized agent
for handling customer inquiries, providing information,
and troubleshooting the Pipeline product”, updated_at:
1717013456, metadata: {[Full metadata from generated
agent, as above]}, non_embedded: {},
embedding: [0.2, 0.3, . . .] // Vector embedding of agent}

The new agent is now available for handling pipeline customer support tasks and can be discovered for future similar needs.

Continuing the example of Beth wanting to order a pizza, the system 100 in step 1208 constructs a comprehensive text prompt for the LLM 1209 to finalize the tool selection:

You are a specialized Tool Selector. Your sole task is to select the most appropriate tool and parameters for a given request. You must strictly adhere to the following rules: 1. Analyze the user request thoroughly to understand the intent 2. Consider the success rates of similar tools on similar tasks 3. Select the tool with the highest probability of success 4. Provide appropriate parameters based on context and past usage 5. Include comprehensive reasoning for your selection 6. Consider privacy and security implications of tool usage.

-- START YOU -- This information represents you, the AI System that is processing the rest of
this information in your prompt. AI System (Entity): - Name: LiveArena Networks; - Type: AI
System; - Connections: - WORKS_WITH -> User: Beth; - Purpose: Enhance user productivity
and streamline tasks through intelligent automation -- END YOU --
-- START USER_REQUEST -- Order me a pizza -- END USER_REQUEST --
-- START CONTEXT -- User: Beth; Time: 6:45 PM (dinner time); Location: Home (123 Main St);
Previous food preferences: - Pepperoni pizza with thin crust (ordered 3 weeks ago); - Medium
size pizza (ordered multiple times); - Pizza Palace as preferred restaurant -- END CONTEXT --
-- START SIMILAR_TOOLS -- 1. FoodDeliveryTool: - Description: Used for ordering food from
various restaurants; - Success rate: 95% (38/40 successful completions); - Parameters:
restaurant, items, crust, size, address, delivery_time. 2. RestaurantOrderTool: - Description:
Used for placing orders directly with restaurants; - Success rate: 90% (27/30 successful
completions); - Parameters: restaurant_name, menu_items, special_instructions,
pickup_or_delivery, address. 3. OnlineShoppingTool: - Description: Used for general online
purchases; - Success rate: 70% for food-related orders (7/10 successful completions); -
Parameters: website, product_category, items, delivery_address, payment_method -- END
SIMILAR_TOOLS --
-- START SIMILAR_TASKS -- 1. Task: “Order pepperoni pizza from Pizza Palace”: - Completed:
3 weeks ago; - Tool used: FoodDeliveryTool; - Parameters: {restaurant: “Pizza Palace”, items:
[“Pepperoni Pizza”], crust: “thin”, size: “medium”, address: “123 Main St”}; - Result: Success.
2. Task: “Get a large pizza delivered”: - Completed: 2 months ago; - Tool used:
FoodDeliveryTool; - Parameters: {restaurant: “Domino's”, items: [“Cheese Pizza”], size:
“large”, address: “123 Main St”}; - Result: Success. 3. Task: “Order dinner from Italian
restaurant”: - Completed: 1 month ago; - Tool used: FoodDeliveryTool; - Parameters:
{restaurant: “Pasta Paradise”, items: [“Spaghetti Carbonara”, “Garlic Bread”], address: “123
Main St”}; - Result: Success -- END SIMILAR_TASKS --
-- YOUR INSTRUCTIONS -- Select the most appropriate tool to fulfill the user's request: 1.
Evaluate the similar tools and their success rates. 2. Consider the similar tasks and their
outcomes. 3. Choose the best tool based on all available information. 4. Provide the
parameters needed to execute the tool successfully. -- END INSTRUCTIONS --
Format your reply to adhere to the following JSON Schema: { “selected_tool”: “string”,
“reasoning”: “string”, “parameters”: { “additionalProperties”: true } }

The LLM 1209 responds in text:

{“selected_tool”: “FoodDeliveryTool”, “reasoning”: “Based on the user's request and
past successful pizza orders, the FoodDeliveryTool is the most appropriate choice. It
has the highest success rate (95%) and has been used successfully for similar pizza
ordering tasks in the past. The user has a history of ordering pepperoni pizza with
thin crust from Pizza Palace, so I'm using those preferences as parameters.”,
“parameters”: {“restaurant”: “Pizza Palace”, “items”: [“Pepperoni Pizza“], “crust”:
“thin”, “size”: “medium”, “address”: “123 Main St”, “delivery_time”: “ASAP”}}

As has been described above, in connection with FIG. 4, the result from the (LLM 150, 160 used to invoke the) selected tool 1210 can comprise information instructive of invoking one or more different tools to each perform a respective subtask of the task or assignment at hand, each of the different tools then being defined in terms of tool functionality metadata. Then, the invoking 1211 can further comprise invoking each of the one or more different tools to perform the subtask in question.

Generally, the text prompt to the selected tool 1210 can comprise information requesting the LLM 150, 160 to select, from a list of two or more of a set of available tools, the one or more different tools to use to solve the task at hand. In other words, the selected tool 1210 can be an assignment processing tool of the generally type discussed above in connection with FIG. 4.

Alternatively, an embedding can be determined based on the information instructive of invoking one or more different tools to perform the subtask of the task or assignment at hand, and a similarity search can be performed, such as in the entire or filtered database 200, comparing the embedding to respective embeddings of entities corresponding to the available tools using a vector-based similarity measure. Then, the one or more different tools can be selected based on this similarity search. It is noted that this can generally proceed as discussed above in connection with the processing illustrated in FIG. 4.

The response 1214 from the invoking of the selected tool 1210 (the invoking hence possibly involving one or more sub-tasks and/or sub-assignments, in turn possibly involving the invoking of additional tools as described above), can be evaluated and processed in a step 1215. Hence, a result of the performing by the selected tool 1210 of the task or assignment at hand can be determined, and a success of the performing by the selected tool 1210 of the task or assignment at hand can be evaluated. This determination and evaluation can be performed using an LLM 150, 160, such as for instance described above in connection with step 429. The task or assignment can then be stored or updated as an entity in the database 200, together with metadata descriptive of the task/assignment at hand, the determined result and the assessed success. Then, this information can be used in later executions of the method illustrated in FIG. 12.

Continuing the pizza ordering example, the system 100 invokes the selected FoodDeliveryTool with the specified parameters. This includes the system 100 connecting to the FoodDeliveryTool API, passing the parameters (restaurant, items, crust, size, address, delivery time), the tool processing the order and communicating with Pizza Palace's ordering system.

If the tool execution encounters issues (API failure, restaurant closed), the system 100 captures the error information and adds it to the prompt from step 1208. The following is an example of what the error block might look like in the prompt:

-- START PRIOR_EXECUTION_ERROR -- { “timestamp”: “2025-04-28T18:47:32Z”, “tool”:
“FoodDeliveryTool”, “error_type”: “API_ERROR”, “error_code”: “RESTAURANT_CLOSED”,
“error_message”: “Unable to place order: Pizza Palace is currently closed. They will reopen
tomorrow at 11:00 AM.”, “parameters_used”: { “restaurant”: “Pizza Palace”, “items”:
[“Pepperoni Pizza”], “crust”: “thin”, “size”: “medium”, “address”: “123 Main St”,
“delivery_time”: “ASAP” }, “attempted_at”: “2025-04-28T18:47:12Z”, “system_suggestion”:
“Consider using AlternativeRestaurantTool or suggesting open restaurants to the user.” }
-- END PRIOR_EXECUTION_ERROR -

This error information would be included in an updated prompt, which is again sent to the LLM 1209, which in turn might then select a different tool or suggest alternatives:

You are a specialized Tool Selector. Your sole task is to select the most appropriate tool and parameters for a given request. You must strictly adhere to the following rules: 1. Analyze the user request thoroughly to understand the intent 2. Consider the success rates of similar tools on similar tasks 3. Select the tool with the highest probability of success 4. Provide appropriate parameters based on context and past usage 5. Include comprehensive reasoning for your selection 6. Consider privacy and security implications of tool usage 7. If provided with error information from a previous attempt, factor that into your selection.

-- START YOU -- This information represents you, the AI System that is processing the rest of
this information in your prompt. AI System (Entity): - Name: LiveArena Networks; - Type: AI
System; - Connections: - WORKS_WITH -> User: Beth; - Purpose: Enhance user productivity
and streamline tasks through intelligent automation; -- END YOU --
-- START USER_REQUEST -- Order me a pizza -- END USER_REQUEST --
-- START CONTEXT -- User: Beth; Time: 6:45 PM (dinner time); Location: Home (123 Main St);
Previous food preferences: - Pepperoni pizza with thin crust (ordered 3 weeks ago); - Medium
size pizza (ordered multiple times); - Pizza Palace as preferred restaurant -- END CONTEXT --
-- START PRIOR_EXECUTION_ERROR -- { “timestamp”: “2025-04-28T18:47:32Z”, “tool”:
“FoodDeliveryTool”, “error_type”: “API_ERROR”, “error_code”: “RESTAURANT_CLOSED”,
“error_message”: “Unable to place order: Pizza Palace is currently closed. They will reopen
tomorrow at 11:00 AM.”, “parameters_used”: { “restaurant”: “Pizza Palace”, “items”:
[“Pepperoni Pizza”], “crust”: “thin”, “size”: “medium”, “address”: “123 Main St”,
“delivery_time”: “ASAP” }, “attempted_at”: “2025-04-28T18:47:12Z”, “system_suggestion”:
“Consider using AlternativeRestaurantTool or suggesting open restaurants to the user.” } --
END PRIOR_EXECUTION_ERROR --
-- START SIMILAR_TOOLS -- [Tool information as before . . . ] -- END SIMILAR_TOOLS --
-- START SIMILAR_TASKS -- [Task information as before . . . ] -- END SIMILAR_TASKS --
-- YOUR INSTRUCTIONS -- Select the most appropriate tool to fulfill the user's request: 1.
Evaluate the similar tools and their success rates 2. Consider the similar tasks and their
outcomes 3. Choose the best tool based on all available information 4. Account for the
previous execution error 5. Provide the parameters needed to execute the tool successfully -
- END INSTRUCTIONS --
Format your reply to adhere to the following JSON Schema: { “selected_tool”: “string”,
“reasoning”: “string”, “parameters”: { “additionalProperties”: true } }

The system 100 identifies specific past tasks where the FoodDeliveryTool was used successfully. These are above in more detail: “Order pepperoni pizza from Pizza Palace” (completed 3 weeks ago); and “Get a large pizza delivered” (completed 2 months ago). In general, in case of an error being caught in the response from an LLM 150, 160, the system 100 can be configured to repost the same prompt to the LLM 150, 160, but including error information in the text prompt as above. Alternatively, the system 100 can be configured to continue the processing and instead catch the error further up in a call stack, such as in the processing of a top-most agent tool.

However, in the present example the FoodDeliveryTool now returns a successful response:

{“status”: “success”, “order_id”: “PP-1234567”, “restaurant”:
“Pizza Palace”, “items”: [“Pepperoni Pizza (Medium, Thin
Crust)“], “total_price”: “$15.99”, “estimated_delivery_time”:
“30-45 minutes”, “tracking_url”:
https://pizzapalace.com/track/PP-1234567}

The system 100 then evaluates the response. This evaluation can be performed by providing an automatically produced text prompt to an LLM 150, 160, such as using a template similar to the following:

You are a specialized Response Evaluator. Your sole task is to assess tool execution results and update the system's memory. You must strictly adhere to the following rules: 1. Evaluate whether the tool execution was successful 2. Extract key information from the response 3. Identify any issues or improvement opportunities 4. Prepare relevant information for memory storage 5. Classify the execution result for future reference

-- START YOU -- This information represents you, the AI System that is processing the rest of
this information in your prompt. AI System (Entity): - Name: LiveArena Networks; - Type: AI
System; - Purpose: Enhance user productivity and streamline tasks through intelligent
automation -- END YOU --
-- START USER_REQUEST -- Order me a pizza -- END USER_REQUEST --
-- START TOOL_EXECUTION -- Tool: FoodDeliveryTool; Parameters: { “restaurant”: “Pizza
Palace”, “items”: [“Pepperoni Pizza”], “crust”: “thin”, “size”: “medium”, “address”: “123
Main St”, “delivery_time”: “ASAP” } Response: { “status”: “success”, “order_id”: “PP-
1234567”, “restaurant”: “Pizza Palace”, “items”: [“Pepperoni Pizza (Medium, Thin Crust)”],
“total_price”: “$15.99”, “estimated_delivery_time”: “30-45 minutes”, “tracking_url”:
“https://pizzapalace.com/track/PP-1234567” } -- END TOOL_EXECUTION --
-- YOUR INSTRUCTIONS -- Evaluate the tool execution result by: 1. Determining if the
execution was successful 2. Extracting key information for the user 3. Preparing data for
memory storage 4. Generating a user-friendly response message -- END INSTRUCTIONS --
Format your reply to adhere to the following JSON Schema: { “success”: “boolean”,
“key_information”: { “additionalProperties”: true }, “memory_data”: { “task_definition”:
“string”, “tool_used”: “string”, “parameters”: { }, “result”: “string”, “success_metrics”: { } },
“user_message”: “string” }

The LLM 150, 160 would respond with a complete evaluation like this:

{“success”: true, “key_information”: {“order_id”: “PP-1234567”, “restaurant”: “Pizza
Palace”, “items”: [“Pepperoni Pizza (Medium, Thin Crust)”], “total_price”: “$15.99”,
“estimated_delivery_time”: “30-45 minutes”, “tracking_url”:
“https://pizzapalace.com/track/PP-1234567”}, “memory_data”: {“task_definition”:
“Order me a pizza”, “tool_used”: “FoodDeliveryTool”, “parameters”: {“restaurant”:
“Pizza Palace”, “items”: [“Pepperoni Pizza”], “crust”: “thin”, “size”: “medium”,
“address”: “123 Main St”, “delivery_time”: “ASAP”}, “result”: “Order successfully
placed with Pizza Palace for delivery”, “success_metrics”: {“execution_time”: 3.2,
“api_latency”: 1.8, “user_preference_match”: “high”, “configuration_quality”: “high”
}}, “user_message”: “Your pepperoni pizza from Pizza Palace has been ordered! It
will be delivered to 123 Main St in approximately 30-45 minutes. Your order number
is PP-1234567, and you can track your delivery at https://pizzapalace.com/track/PP-
1234567. The total cost is $15.99.”}

The system 100 then stores this information in the database 200 as a new task entity:

{“id”: “task-9452”, “type”: “task”, “name”: “Order pizza for Beth”, “description”:
“Task to order a medium pepperoni pizza with thin crust from Pizza Palace”,
“metadata”: {“status”: “completed”, “created_at”: “2025-04-28T18:45:23Z”.
“completed_at”: “2025-04-28T18:47:32Z”, “success”: true, “tool_used”: “tool-427”,
“tool_name”: “FoodDeliveryTool”, “parameters_used”: {“restaurant”: “Pizza
Palace”, “items”: [“Pepperoni Pizza”], “crust”: “thin”, “size”: “medium”, “address”:
“123 Main St”, “delivery_time”: “ASAP”}, “execution_metrics”: {“execution_time”:
3.2, “api_latency”: 1.8, “user_preference_match”: “high”, “configuration_quality”:
“high”}}, “non_embedded”: {“user_id”: “user-427”, “order_id”: “PP-1234567”,
“response_time”: 129, “raw_tool_response”: {“status”: “success”, “order_id”: “PP-
1234567”, “restaurant”: “Pizza Palace”, “items”: [“Pepperoni Pizza (Medium, Thin
Crust)“], “total_price”: “$15.99”, “estimated_delivery_time”: “30-45 minutes”,
“tracking_url”: “https://pizzapalace.com/track/PP-1234567”}}}

Additionally, a new interaction entity would be created to record this event:

{“id”: “interaction-6038”, “source_id”: “user-427”, “target_id”:
“restaurant-pizza-palace”, “type”: “ORDER”, “content”:
“One medium thin crust pepperoni pizza”, “timestamp”:
“2025-04-28T18:47:32Z”, “metadata”: {“order_id”:
“PP-1234567”, “total_price”: “$15.99”, “estimated_
delivery_time”: “30-45 minutes”, “task_id”: “task-9452”}}

The process concludes by sending the generated message to Beth. The message was extracted from the “user_message” field in the language model's response:

“Your pepperoni pizza from Pizza Palace has been ordered! It will be delivered to 123 Main St in approximately 30-45 minutes. Your order number is PP-1234567, and you can track your delivery at https://pizzapalace.com/track/PP-1234567. The total cost is $15.99.”

This message is displayed to Beth as the final output of the tool selection and execution process.

In case of the tool selection 1210 requesting the LLM 1209 to construct an agent tool based on two or more existing identified agent tools, or in case the call to the LLM 1209 otherwise comprises information complex enough for the LLM 1209 not to be able to directly determine parameter values to pass to the constructed or identified selected agent tool, the method can comprise an additional call to an LLM 150, 160, prompting the LLM 150, 160 to, provided the selected agent tool and the task at hand (including all the relevant contextual information), provide parameter values or other input information to the selected agent tool.

In a subsequent step 1216 after the evaluation and processing of the response in step 1215, the method ends.

Continuing now the example from further above, Beth sends a chat message to the system 100 chat: “I need to have a Jabberwocky project brainstorming session this week. Include key discussion topics from previous meetings and invite Alex, Jen, and Taylor.”

This message can be used, in free-text processing step 405, together with any available context information 404, to construct an initial assignment dataset in the form of a data structure of predetermined format. In the practical example at hand, the system 100 builds the following ChatMessage object that is then processed:

{“conversation_id”: “conversation-123”, “timestamp”:
“2024-03-04T14:30:00Z”, “source”: “entity-beth”,
“source_type”: “chat_message”, “content”: “I need to
have a Jabberwocky project brainstorming session
this week. Include key discussion topics from previous
meetings and invite Alex, Jen, and Taylor.”}

As mentioned above, in every chat involving the system 100 as a chat participant there are at least two special entities: User and ME. “User” represents the person 122 sending messages in this conversation. There can be multiple Users in a single conversation, and the system 100 uses each User as the source in interaction items representing each message, linking that message interaction to the particular user 122. In this case, since the chat is run on Beth's machine, the system 100 assumes that this is Beth. “ME” represents the system 100 itself. Since Beth is the identified user, any instance of ‘I’ or ‘me’ within the chat text coming in to the system 10 is automatically resolved as referring to the User entity. Similarly, references to ‘you’ would typically refer to ME (the system 100).

The system 100 can maintain structured relationships by treating each conversation as an entity in the database 200, where each chat message is also an entity of its own. This allows NLP-based 131 processing to establish accurate entity relationships for pronouns such as ‘I’, ‘me’, and ‘you’ within the conversation context:

{“id”: “entity-beth”, “type”: “PERSON”, “name”: “Beth Carter”,
“non_embedded_metadata”: {}}
{“id”: “entity-me”, “type”: “SYSTEM”, “name”: “AI Companion”,
“metadata”: {}}

Since the system 100 has the exact ID for the chat conversation entity, it can retrieve from the database 200 all chat interactions where the same conversation entity is the target. This provides a set of interactions associated with the conversation. From this list, vector similarity scores can be calculated against the new chat message, ranking messages based on relevance. For instance, the ten most recent messages can be prioritized together with the ten most relevant messages without overlap. Each chat message entity can includes a prior conversation summary (in free-text) that has been produced by the system 100 previously, in connection to the processing of that chat message, allowing the system 100 to maintain continuity and to provide prior context for each message without having to compute that each time. This is an example of the conversation entity in the database 200:

{“id”: “conversation-123”, “type”: “CONVERSATION”,
“name”: “Ongoing Discussion
with AI Companion”, “metadata”: {} }

The following are examples of previously received, processed and stored chat message entities that are found using said similarity/recency search in the database 200, forming part of the working memory continuously formed and updated by the system 100 while processing the chat:

{“id”: “chat-3314”, “source”: “entity-beth”, “target”: “conversation-123”, “type”:
“MESSAGE”, “timestamp”: “2024-03-04T14:10:00Z”, “content”: “Can you summarize
the last meeting notes for me?”, “metadata”:{“prior_conversation_summary”: “Beth
just had a meeting to discuss overall projects and asked me to store the information
in my Database. AI Companion repsonded that it is done.”}}
{“id”: “chat-3315”, “source”: “entity-me”, “target”: “conversation-123”, “type”:
“SYSTEM_RESPONSE”, “timestamp”: “2024-03-04T14:10:30Z”, “content”: “The last
meeting covered project status, upcoming deadlines, and team assignments. Do you
need more details?”, “metadata”:{“prior_conversation_summary”: “Beth asked for a
summary of the last meeting. AI Companion provided an overview of project status,
deadlines, and assignments.”}}
{“id”: “chat-3316”, “source”: “entity-beth”, “target”: “conversation-123”, “type”:
“MESSAGE”, “timestamp”: “2024-03-04T14:11:00Z”, “content”: “Yes, I need a
breakdown of the key discussion points and action items assigned.”, “metadata”:{
“prior_conversation_summary”: “Beth received a high-level meeting summary and
now requests more specific details on discussion points and action items.”}}
{“id”: “chat-3317”, “source”: “entity-me”, “target”: “conversation-123”, “type”:
“SYSTEM_RESPONSE”, “timestamp”: “2024-03-04T14:11:30Z”, “content”: “Key
points discussed: 1) Feature prioritization, 2) Technical blockers, 3) Marketing
campaign alignment. Action items: Alex to finalize architecture draft, Jen to complete
user research, Taylor to prepare a design mockup.”, “metadata”:{
“prior_conversation_summary”: “Beth requested a breakdown of key discussion
points. AI Companion provided details on feature prioritization, technical blockers,
and marketing alignment.”}}

The following items are created from the chat log and will eventually be added to the database 200:

{ “id”: “chat-3318”, “type”: “CHAT_MESSAGE”, “name”: “Chat message from Beth”,
“description”: “I need to have a Jabberwocky project brainstorming session this
week. Include key discussion topics from previous meetings and invite Alex, Jen, and
Taylor.”, “metadata”: { “conversation_id”: “conversation-123”, “timestamp”: “2024-
03-04T14:30:00Z” } }
{ “id”: “interaction-4456”, “source_id”: “entity-beth”, “target_id”: “conversation-123”,
“type”: “CHAT_INTERACTION”, “timestamp”: “2024-03-04T14:30:00Z”, “content”: “I
need to have a Jabberwocky project brainstorming session this week. Include key
discussion topics from previous meetings and invite Alex, Jen, and Taylor.”,
“metadata”:{ } // NOTE: no prior_conversation_summary because this interaction has
not been fully processed yet. }

Using NLP and NER 131, the system 100 automatically identifies the following entities purely based on the text itself, without considering any prior knowledge, the identified entities being formatted as structured objects:

{ “id”: “entity-jabberwocky”, “type”: “GPE”, “name”: “Jabberwocky Project”,
“metadata”: { } }
{ “id”: “entity-brainstorming-session”, “type”: “EVENT”, “name”: “brainstorming
session”, “metadata”: {} }
{ “id”: “entity-this-week”, “type”: “DATE”, “name”: “this week”, “metadata”: { } }
{ “id”: “entity-key-discussion-topics”, “type”: “CONCEPT”, “name”: “key discussion
topics”, “metadata”: { } }
{ “id”: “entity-previous-meetings”, “type”: “EVENT”, “name”: “previous meetings”,
“metadata”: { } }
{ “id”: “entity-alex”, “type”: “PERSON”, “name”: “Alex”, “metadata”: { } }
{ “id”: “entity-jen”, “type”: “PERSON”, “name”: “Jen”, “metadata”: { } }
{ “id”: “entity-taylor”, “type”: “PERSON”, “name”: “Taylor”, “metadata”: { } }

Next, the system 100 performs memory recall based on this information, constructing a working memory. To construct a fast response to the user 122, the system 100 can simplify the memory recall process in case it is found to take longer than a certain threshold amount of time. The below are some exemplary items appearing in the constructed working memory. It is pointed out that, at this point, there is both relevant and irrelevant data in this working memory. Metrics can be generated regarding how each of the memories compare to the working memory as a whole as well as to the initial input message from Beth. As can be seen, there has already been some discussion regarding Beth's request, and at least some prior meetings have been discovered without the system 100 actively searching for them. The following only represents a sub-set of what would be returned:

### Entities:

{ “id”: “entity-meeting-001”, “type”: “EVENT”, “name”: “Jabberwocky Planning
Session”, “metadata”: { “date”: “2024-02-10” }, “agenda”: [ “Project milestone
review”, “Pending action items from previous meetings”, “Feature prioritization for
next sprint” ], “summary”: [ “Reviewed completed tasks and remaining backlog
items”, “Identified key risks for upcoming features”, “Decided on focus areas for the
next development cycle” ], “action_items”: [ “Beth to finalize project roadmap
updates”, “Alex to provide technical feasibility analysis”, “Jen to align product goals
with UX requirements” ] },
{ “id”: “entity-meeting-002”, “type”: “EVENT”, “name”: “Jabberwocky Strategy
Meeting”, “metadata”: { “date”: “2024-02-20” }, “agenda”: [ “Risk assessment for AI
integration”, “Budget constraints and financial planning”, “Cross-functional
alignment between teams” ], “summary”: [ “Explored risks related to AI automation
in the project”, “Discussed cost implications of scaling infrastructure”, “Marketing
and UX teams shared alignment strategies” ], “action_items”: [ “Mark to review
marketing impact analysis”, “Taylor to refine UX requirements”, “Beth to schedule
next stakeholder review” ] }
{ “id”: “entity-the-best-company”, “type”: “ORG”, “name”: “The Best Company, Inc.”,
“metadata”: { “industry”: “Technology” } }
{ “id”: “entity-alex”, “type”: “PERSON”, “name”: “Alex Johnson”, }
{ “id”: “entity-jen”, “type”: “PERSON”, “name”: “Jen Roberts”, }
{ “id”: “entity-taylor”, “type”: “PERSON”, “name”: “Taylor Smith”, }
{ “id”: “entity-mark”, “type”: “PERSON”, “name”: “Mark Richardson”, }

### Connections:

{ “source_id”: “entity-beth”, “target_id”: “entity-the-best-company”, “type”:
“WORKS_AT”, “metadata”: { “position”: “Project Manager”, “employment_start”:
“2021-06-15” } }
{ “source_id”: “entity-alex”, “target_id”: “entity-the-best-company”, “type”:
“WORKS_AT”, “metadata”: { “position”: “Software Engineer”, “employment_start”:
“2020-03-20” } }
{ “source_id”: “entity-jen”, “target_id”: “entity-the-best-company”, “type”:
“WORKS_AT”, “metadata”: { “position”: “Product Manager”, “employment_start”:
“2019-09-01” } }
{ “source_id”: “entity-taylor”, “target_id”: “entity-the-best-company”, “type”:
“WORKS_AT”, “metadata”: { “position”: “UX Designer”, “employment_start”: “2018-
11-12” } }
{ “source_id”: “entity-mark”, “target_id”: “entity-the-best-company”, “type”:
“WORKS_AT”, “metadata”: { “position”: “Marketing Lead”, “employment_start”:
“2017-05-30” } }
{ “source_id”: “entity-beth”, “target_id”: “entity-meeting-001”, “type”: “ATTENDED”,
“metadata”: { “role”: “Organizer” } }
{ “source_id”: “entity-alex”, “target_id”: “entity-meeting-001”, “type”: “ATTENDED”,
“metadata”: { “role”: “Participant” } }
{ “source_id”: “entity-jen”, “target_id”: “entity-meeting-001”, “type”: “ATTENDED”,
“metadata”: { “role”: “Contributor” } }
{ “source_id”: “entity-mark”, “target_id”: “entity-meeting-001”, “type”: “ATTENDED”,
“metadata”: { “role”: “Marketing Lead” } }
{ “source_id”: “entity-beth”, “target_id”: “entity-meeting-002”, “type”: “ATTENDED”,
“metadata”: { “role”: “Participant” } }
{ “source_id”: “entity-taylor”, “target_id”: “entity-meeting-002”, “type”: “ATTENDED”,
“metadata”: { “role”: “UX Specialist” } }
{ “source_id”: “entity-mark”, “target_id”: “entity-meeting-002”, “type”: “ATTENDED”,
“metadata”: { “role”: “Marketing Lead” } }

### Interactions:

[ { “id”: “interaction-001”, “source_id”: “entity-beth”, “target_id”: “entity-
conversation-120”, “type”: “MESSAGE”, “text”: “We should have a planning session
to finalize our approach for the next Jabberwocky milestone.” },
{ “id”: “interaction-002”, “source_id”: “entity-alex”, “target_id”: “entity-conversation-
120”, “type”: “MESSAGE”, “text”: “Agreed. We need to review our last meeting's
takeaways and check if there are pending action items.” },
{ “id”: “interaction-003”, “source_id”: “entity-jen”, “target_id”: “entity-conversation-
120”, “type”: “MESSAGE”, “text”: “I can pull the key points we discussed from the
last session so we have a better idea of where to focus.” },
{ “id”: “interaction-004”, “source_id”: “entity-me”, “target_id”: “entity-conversation-
120”, “type”: “SYSTEM_RESPONSE”, “text”: “The last Jabberwocky strategy meeting
included discussions on risk assessment, AI automation, and budget constraints.
Would you like a breakdown?” },
{ “id”: “interaction-005”, “source_id”: “entity-mark”, “target_id”: “entity-
conversation-121”, “type”: “MESSAGE”, “text”: “Marketing needs to align with
product development before we finalize the next phase of Jabberwocky.” },
{ “id”: “interaction-006”, “source_id”: “entity-taylor”, “target_id”: “entity-
conversation-121”, “type”: “MESSAGE”, “text”: “That makes sense. UX has to be
factored into our product roadmap before we lock anything down.” },
{ “id”: “interaction-007”, “source_id”: ″entity-beth″, “target_id”: ″entity-conversation-
121″, “type”: “MESSAGE”, “text”: “Let's set up a cross-functional meeting next week
to go over these alignment points.” },
{ “id”: “interaction-008”, “source_id”: “entity-me”, “target_id”: “entity-conversation-
121”, “type”: “SYSTEM_RESPONSE”, “text”: “I can pull up related discussions from
past meetings where marketing and product teams worked on alignment.” },
{ “id”: “interaction-009”, “source_id”: “entity-alex”, “target_id”: “entity-conversation-
122”, “type”: “MESSAGE”, “text”: “We need to address technical feasibility before
committing to a new feature set.” },
{ “id”: ″interaction-010″, “source_id”: “entity-jen”, “target_id”: “entity-conversation-
122”, “type”: “MESSAGE”, “text”: “I'll check the engineering team's feedback from
last time and summarize the main concerns.” },
{ “id”: “interaction-011”, “source_id”: “entity-me”, “target_id”: “entity-conversation-
122”, “type”: “SYSTEM_RESPONSE”, “text”: “The last discussion on feature
feasibility highlighted performance trade-offs and potential risks. Would you like to
review the technical notes?” } ]

With all of information now in the working memory, the system 100 can automatically construct a text prompt for the LLM 150, 160 to check for assignments and to provide a reply. Here is an example of what the full prompt to the LLM 150, 160 might look like:

You are AI Companion's Chat Agent, your responsibility is to process and respond to messages that enter the system. Rules: 1) Always use complete sentences, unless instructed otherwise. 2) This chat is part of Microsoft Teams, so make sure that the content of your end-user messages is properly formatted. 3) Always respond in JSON format unless explicitly asked otherwise. 4) If a message is ambiguous, ask for clarification before proceeding. 5) Use retrieved memory data to enhance responses, but only reference it if it's clearly relevant to the conversation. 6) You can ask follow-up questions when necessary to refine the task at hand. 7) When processing scheduling or assignments, ensure all necessary details are confirmed before executing. 8) When creating instructions for Assignments, make sure to include ids for any named Entities. 9) Always use CAPS for Connection and Interaction Types.

--- START CONTEXT --- You are AI Companion [id: entity-me]: An AI assistant built to help
humans. You are having a conversation [id: conversation-123] entitled “Ongoing Discussion
with AI Companion” with: Beth Rogers [id: entity-beth] IS_A PERSON Beth Rogers [id: entity-
beth] WORKS_AT The Best Company, Inc. [id: entity-the-best-company] {“role”: “Project
Manager”, “employment_start”: “2021 Jun. 15”} Beth Rogers [id: entity-beth] OWNS
Jabberwocky Project [id: entity-jabberwocky] { } Beth Rogers [id: entity-beth] ATTENDED
Jabberwocky Planning Session [id: entity-meeting-001] {“role”: “Organizer”} Beth Rogers [id:
entity-beth] ATTENDED Jabberwocky Strategy Meeting [id: entity-meeting-002] {“role”:
“Participant”} --- END CONTEXT ---
--- START MEMORY RECALL --- The following are memories in your database that we believe
might be relevant to the chat at hand. Just because a memory is listed here does not mean
it's relevant. It's up to you to ask for clarification and to make the call on what is relevant
and what is not. You can always ask for more details. The Best Company, Inc. [id: entity-the-
best-company] IS_AN_ORG {“industry”: “Technology”}; Alex Johnson [id: entity-alex]
WORKS_AT The Best Company, Inc. [id: entity-the-best-company] {“role”: “Software
Engineer”, “employment_start”: “2020 Mar. 20”}; Jen Roberts [id: entity-jen] WORKS_AT The
Best Company, Inc. [id: entity-the-best-company] {“role”: “Product Manager”,
“employment_start”: “2019 Sep. 1”}; Taylor Smith [id: entity-taylor] WORKS_AT The Best
Company, Inc. [id: entity-the-best-company] {“role”: “UX Designer”, “employment_start”:
“2018 Nov. 12”}; Mark Richardson [id: entity-mark] WORKS_AT The Best Company, Inc. [id:
entity-the-best-company] {“role”: “Marketing Lead”, “employment_start”: “2017 May 30”};
Alex Johnson [id: entity-alex] ATTENDED Jabberwocky Planning Session [id: entity-meeting-
001] {“role”: “Participant”}; Jen Roberts [id: entity-jen] ATTENDED Jabberwocky Planning
Session [id: entity-meeting-001] {“role”: “Contributor”}; Mark Richardson [id: entity-mark]
ATTENDED Jabberwocky Planning Session [id: entity-meeting-001] {“role”: “Marketing
Lead”}; Taylor Smith [id: entity-taylor] ATTENDED Jabberwocky Strategy Meeting [id: entity-
meeting-002] {“role”: “UX Specialist”}; Mark Richardson [id: entity-mark] ATTENDED
Jabberwocky Strategy Meeting [id: entity-meeting-002] {“role”: “Marketing Lead”};
Jabberwocky Planning Session [id: entity-meeting-001] IS_A MEETING {“date”: “2024 Feb.
10”}; Jabberwocky Planning Session [id: entity-meeting-001] AGENDA [“Project milestone
review”, “Pending action items from previous meetings”, “Feature prioritization for next
sprint”]; Jabberwocky Planning Session [id: entity-meeting-001] SUMMARY [“Reviewed
completed tasks and remaining backlog items”, “Identified key risks for upcoming features”,
“Decided on focus areas for the next development cycle”]; Jabberwocky Planning Session [id:
entity-meeting-001] ACTION_ITEMS [“Beth Rogers [id: entity-beth] to finalize project
roadmap updates”, “Alex Johnson [id: entity-alex] to provide technical feasibility analysis”,
“Jen Roberts [id: entity-jen] to align product goals with UX requirements”]; Jabberwocky
Strategy Meeting [id: entity-meeting-002] IS_A MEETING {“date”: “2024 Feb. 20”};
Jabberwocky Strategy Meeting [id: entity-meeting-002] AGENDA [“Risk assessment for AI
integration”, “Budget constraints and financial planning”, “Cross-functional alignment
between teams”]; Jabberwocky Strategy Meeting [id: entity-meeting-002] SUMMARY
[“Explored risks related to AI automation in the project”, “Discussed cost implications of
scaling infrastructure”, “Marketing and UX teams shared alignment strategies”];
Jabberwocky Strategy Meeting [id: entity-meeting-002] ACTION_ITEMS [“Mark Richardson
[id: entity-mark] to review marketing impact analysis”, “Taylor Smith [id: entity-taylor] to
refine UX requirements”, “Beth Rogers [id: entity-beth] to schedule next stakeholder
review”] --- END MEMORY RECALL ---
--- START CHAT HISTORY --- Past Summary: Beth just had a meeting to discuss overall
projects and asked me to store the information in my database. AI Companion responded
that it is done. [1 hour ago] Beth Rogers: “Can you summarize the last meeting notes for
me?”
[45 min ago] AI Companion: “The last meeting covered project status, upcoming deadlines,
and team assignments. Do you need more details?” [40 min ago] Beth Rogers: “Yes, I need
a breakdown of the key discussion points and action items assigned.” [35 min ago] AI
Companion: “Key points discussed: 1) Feature prioritization, 2) Technical blockers, 3)
Marketing campaign alignment. Action items: Alex to finalize architecture draft, Jen to
complete user research, Taylor to prepare a design mockup.” [30 min ago] Beth Rogers:
“Let's set up a brainstorming session this week to refine our strategy.” [25 min ago] AI
Companion: “Would you like to include key discussion topics from previous meetings?” [20
min ago] Beth Rogers: “Yes, and also invite Alex, Jen, and Taylor.” [15 min ago] AI
Companion: “Scheduling a brainstorming session for this week with Alex, Jen, and Taylor.
Would you like me to generate an agenda?” [10 min ago] Beth Rogers: “Yes, make sure we
cover technical dependencies and product alignment.” [5 min ago] AI Companion: “Noted.
The agenda will cover technical dependencies and product alignment. Anything else?” ---
END CHAT HISTORY ---
You must now process the following new chat message from Beth Rogers, replying in the
schema below: -- START NEW MESSAGE -- “I need to have a Jabberwocky project
brainstorming session this week. Include key discussion topics from previous meetings and
invite Alex, Jen, and Taylor.” -- END NEW MESSAGE --
--- START JSON SCHEMA --- { “has_assignment”: { “type”: “boolean”, “description”:
“Indicates whether an assignment has been detected from the chat request.”, “required”:
true }, “assignment_instructions”: { “type”: “string”, “description”: “If an assignment is
detected, this field contains structured instructions on how to proceed.”, “required”: false },
“chat_reply”: { “type”: “string”, “description”: “The AI's response to Beth's request,
formatted appropriately for Microsoft Teams.”, “required”: true } } --- END JSON SCHEMA ---

Provide a response in JSON format that adheres to the above schema.

Here is what a response from the LLM 150, 160 might look like:

{ “has_assignment”: true, “assignment_instructions”: “Schedule a Jabberwocky
project brainstorming session for this week. Invite Alex Johnson [id: entity-alex], Jen
Roberts [id: entity-jen], and Taylor Smith [id: entity-taylor]. Ensure the agenda
includes key discussion topics from previous meetings, such as technical
dependencies, product alignment, risk assessment for AI integration, and marketing
impact analysis.”,
“chat_reply”: “I will schedule the Jabberwocky project
brainstorming session for this week and invite Alex, Jen, and Taylor. The agenda will
include key discussion topics from previous meetings, covering technical
dependencies, product alignment, risk assessment for AI integration, and marketing
impact analysis. Let me know if you'd like to add anything else.” }

It is noted that a new ChatMessage object would be generated by the system 100, as well as an interaction item:

{ “id”: “chat-3340”, “type”: “CHAT_MESSAGE”, “name”: “Chat message from AI
Companion”, “description”: “I will schedule the Jabberwocky project brainstorming
session for this week and invite Alex, Jen, and Taylor. The agenda will include key
discussion topics from previous meetings, covering technical dependencies, product
alignment, risk assessment for AI integration, and marketing impact analysis. Let me
know if you'd like to add anything else.”, “metadata”: { “conversation_id”:
“conversation-123”, “timestamp”: “2024-03-04T14:35:00Z” } }
{ “id”: “interaction-4457”, “source_id”: “entity-me”, “target_id”: “conversation-123”,
“type”: “CHAT_INTERACTION”, “timestamp”: “2024-03-04T14:35:00Z”, “content”: “I
will schedule the Jabberwocky project brainstorming session for this week and invite
Alex, Jen, and Taylor. The agenda will include key discussion topics from previous
meetings, covering technical dependencies, product alignment, risk assessment for
AI integration, and marketing impact analysis. Let me know if you'd like to add
anything else.”, “metadata”: { “generated_assignment_instructions”:” Schedule a
Jabberwocky project brainstorming session for this week. Invite Alex Johnson [id:
entity-alex], Jen Roberts [id: entity-jen], and Taylor Smith [id: entity-taylor]. Ensure
the agenda includes key discussion topics from previous meetings, such as technical
dependencies, product alignment, risk assessment for AI integration, and marketing
impact analysis.” }, }

Now that we the system 100 has a suitable reply, it is immediately sent to the source conversation. The system 100 may have gotten an easy message that can be fully understood and dissected based only on the constructed working memory. However, at this point the system 100 does not know if the request from Beth is instead highly complex request. If this is indeed the case, the fast response sent to the chat lets the user 122 know what is happening and can even ask for more information or otherwise continue the conversation. To continue this flow, an AssignmentRequest object is generated by the system 100, to structure the assignment instructions into a processable format. This object consolidates information from the ChatMessage, the working memory, and the ChatAgentReply, ensuring that all relevant context is preserved for execution:

{ “assignment_instructions”: “Schedule a Jabberwocky project brainstorming
session for this week. Invite Alex Johnson [id: entity-alex], Jen Roberts [id: entity-
jen], and Taylor Smith [id: entity-taylor]. Ensure the agenda includes key discussion
topics from previous meetings, such as technical dependencies, product alignment,
risk assessment for AI integration, and marketing impact analysis.”, “source”: {
“type”: “chat_message”, “id”: “chat-3340” }, “context”: { “entity_ids”: [ “entity-beth”,
“entity-alex”, “entity-jen”, “entity-taylor”, “entity-jabberwocky”, “entity-the-best-
company”, “entity-meeting-001”, “entity-meeting-002” ], “conversation_ids”: [
“conversation-123” ], “interaction_ids”: [ “interaction-4456” ] } }

Now, the assignment processing performed by the system 100 in producing a slow response to the request from Beth will be described, starting with a memory recall. Memory recall is the process of retrieving relevant historical data from the database 200 to construct a working memory set that informs assignment processing. This ensures that prior context, past interactions, and relevant entities are considered when executing new assignments. Memory recall can generally take place according to a number of different options, including the following:

Firstly, in a “pure memory recall” option the system 100 retrieves relevant past data by performing a similarity search as generally outlined above, and in particular in connection with FIG. 5. Every query runs a full retrieval from the database 200, ensuring that each request is processed independently and returns the most up-to-date results. However, this method retrieves memory using a broad similarity search, meaning prior assignments are likely to be recalled alongside other relevant data.

Secondly, in an “assignment self-awareness” option, instead of performing a broad similarity search across the entire database 200, the retrieval scope is restricted by setting Entity. Type==“Assignments”. This means that the system 100 focuses exclusively on past assignments, significantly improving retrieval speed and relevance. While prior assignments might appear in a general memory recall, this option ensures they are the primary target rather than incidental results.

Using targeted memory recall and structured processing, the system 100 can create a more narrow domain knowledge, refining retrieval from the database 200 by applying predefined constraints that result in smaller, more structured data subsets. This ensures faster processing while maintaining relevance. For example, the “assignment self-awareness” option modifies the search process by limiting the data set exclusively to entities of type Assignment. Then, all first-level connections and interactions linked to the identified assignment entities can be retrieved. Since each connection and interaction contains the ID of its linked entity, the system 100 can count shared references without requiring additional queries for deeper data retrieval. This enables the retrieval of a focused set of assignments and their immediate context, the direct access to their associated connections and interactions, as well as efficient reference counting, allowing the system 100 to determine commonly accessed entities in this specialized subset.

Hence, the system 100 can be configured not to query for the full details of connected entities, but instead to use their IDs to analyze patterns of recurrence, ensuring relevance while maintaining processing efficiency. This structured approach allows the system 100 to build knowledge graphs dynamically, supporting domain expertise tailored to each specific recall process.

The following are examples of data pulled from the database 200 as a result:

{ “retrieved_assignments”: [ { “id”: “assignment-1023”, “name”: “Schedule Weekly
Project Sync”, “status”: “COMPLETED”, “priority”: “NORMAL”, “context”: {
“entity_ids”: [“entity-beth”, “entity-alex”, “entity-jen”], “conversation_ids”:
[“conversation-789”], “interaction_ids”: [“interaction-567”] } },
{ “id”: “assignment-2045”, “name”: “Finalize Q2 Budget Review”, “status”:
“PENDING”, “priority”: “HIGH”, “context”: { “entity_ids”: [“entity-beth”, “entity-
finance-team”], “conversation_ids”: [“conversation-456”], “interaction_ids”:
[“interaction-892”] } } ] }
{ “connections”: [ { “source_id”: “assignment-1023”, “target_id”: “entity-beth”,
“type”: “ASSIGNED_TO” },
{ “source_id”: “assignment-2045”, “target_id”: “entity-finance-team”, “type”:
“ASSIGNED_TO” }],
“interactions”: [ { “id”: “interaction-567”, “source_id”: “entity-beth”, “target_id”:
“conversation-789”, “type”: “MESSAGE”, “text”: “We need to confirm the agenda for
next week's sync.” },
{ “id”: “interaction-892”, “source_id”: “entity-beth”, “target_id”: “conversation-456”,
“type”: “MESSAGE”, “text”: “Let's finalize the Q2 budget review and send it to
finance.” } ] }
{ “common_entities”: [ { “id”: “entity-beth”, “occurrences”: 2 },
{ “id”: “entity-finance-team”, “occurrences”: 1 },
{ “id”: “entity-alex”, “occurrences”: 1 } ] }

After retrieving the relevant assignment entities and their associated data, the system 100 can compute all the standard metrics and dichotomies as described above, allowing the system 100 to assess and categorize assignments based on complexity, historical success, and contextual relevance. Hence, the system 100 surface key assignment-related metrics such as number of actions (capturing the complexity of an assignment based on its execution history); and historical success rate (providing reliability scores for assignment effectiveness).

For instance, the working memory can be filtered by the determined success rate. Concretely, the system 100 can be configured to filter out assignments below a predefined success rate threshold before performing further recall operations. The following Datalog query retrieves assignments where success_rate_ai_assessed is at least 0.8:

[:find ?assignment ?name ?status ?success_rate :where [?assignment
:assignment/name ?name] [?assignment :assignment/status
?status] [?assignment
:assignment/success_rate_ai_assessed ?success_rate]
[(>= ? success_rate 0.8)]]

Because this is a specialized recall process, the system 100 can be configured to allow dynamic weighting of dichotomies to fine-tune results further. Examples of adjustable dichotomy weights include recency weighting (prioritizing more recent assignments over older ones); simplicity weighting (preferring assignments with fewer actions in their execution history); and high-impact weighting (focusing on assignments with broader organizational impact).

At this stage, the system 100 has constructed a form of domain knowledge around each prior assignment, their immediate connections, and associated entities. This refined dataset now includes additional metrics and dichotomies, ensuring that assignment processing is guided by structured, high-quality information.

Through this process, the system 100 has created a targeted recall set focused on prior assignments; extracted structured relationships through first-level connections and interactions; applied success rate filtering to exclude failed assignments; and used weighted dichotomies to fine-tune retrieval toward relevance and efficiency. The final dataset serves as the foundation for intelligent decision-making in the assignment pipeline:

{ “retrieved_assignments”: [ { “id”: “assignment-1023”, “name”: “Schedule Weekly
Project Sync”, “status”: “COMPLETED”, “priority”: “NORMAL”,
“success_rate_ai_assessed”: 0.92, “success_rate_human_assessed”: 0.88,
“num_actions”: 3, “dichotomies”: { “recency_score”: 0.85, “complexity_score”: 0.40,
“impact_score”: 0.78 }, “context”: { “entity_ids”: [“entity-beth”, “entity-alex”, “entity-
jen”], “conversation_ids”: [“conversation-789”], “interaction_ids”: [“interaction-567”]
} },
{ “id”: “assignment-2045”, “name”: “Finalize Q2 Budget Review”, “status”:
“PENDING”, “priority”: “HIGH”, “success_rate_ai_assessed”: 0.85,
“success_rate_human_assessed”: 0.90, “num_actions”: 5, “dichotomies”: {
“recency_score”: 0.75, “complexity_score”: 0.85, “impact_score”: 0.92 }, “context”: {
“entity_ids”: [“entity-beth”, “entity-finance-team”], “conversation_ids”:
[“conversation-456”], “interaction_ids”: [“interaction-892”] } } ] }
{ “connections”: [ { “source_id”: “assignment-1023”, “target_id”: “entity-beth”,
“type”: “ASSIGNED_TO”, “connection_strength”: 0.80 },
{ “source_id”: “assignment-2045”, “target_id”: “entity-finance-team”, “type”:
“ASSIGNED_TO”, “connection_strength”: 0.95 } ],
“interactions”: [ { “id”: “interaction-567”, “source_id”: “entity-beth”, “target_id”:
“conversation-789”, “type”: “MESSAGE”, “text”: “We need to confirm the agenda for
next week's sync.”, “interaction_weight”: 0.82 },
{ “id”: “interaction-892”, “source_id”: “entity-beth”, “target_id”: “conversation-456”,
“type”: “MESSAGE”, “text”: “Let's finalize the Q2 budget review and send it to
finance.”, “interaction_weight”: 0.89 } ] }
{ “common_entities”: [ { “id”: “entity-beth”, “occurrences”: 2, “recurrence_score”:
0.90 },
{ “id”: “entity-finance-team”, “occurrences”: 1, “recurrence_score”: 0.75 },
{ “id”: “entity-alex”, “occurrences”: 1, “recurrence_score”: 0.70 } ] }

These examples now include surfaced-up metrics such as success rates, action counts, dichotomies, and connection strengths, ensuring assignments are evaluated with more precision and context-aware insights.

In a next step, the initial assignment assessment is started, based on the constructed working memory from the previous step along with the domain expertise recall results of prior assignments. By providing this structured memory directly to the assessor agent tool, redundant recall queries are eliminated, allowing the system 100 to immediately focus on processing the assignment effectively. The assessor agent tool retrieves and processes the initial assignment assessment and final assignment assessment interactions linked to prior assignments by executing a structured query that targets these interactions specifically. The system 100 begins by filtering memory recall to only include interactions where interaction_type “INITIAL_ASSIGNMENT_ASSESSMENT” OR “FINAL_ASSIGNMENT_ASSESSMENT”. This ensures that only relevant assessment reports are retrieved. Since the query has already been performed to the database 200, this information is already in the (RAM) memory of the system 100. In fact, the system 100 can cache these results in advance since it knows that they will be needed.

At this point, the system 100 only has knowledge of the entity Ids, but full reports can easily be required by direct retrieval from the database 200. Once retrieved, the system 100 parses structured metadata within each report, containing decision rationales and justifications for past assignments, evaluations of execution success and recorded deviations from expected outcomes, recommendations, including best practices and strategies that led to successful execution, and reflections on any errors or inefficiencies encountered and their resolutions. The system 100 then ranks these reports based on relevance, success rate, and execution similarity to ensure that only the most applicable insights inform the new assignment assessment process. The following are examples of resulting initial assignment assessment reports:

{ “id”: “initial-assessment-001”, “assignment_id”: “assignment-3021”,
“assessed_by”: “entity-me”, “timestamp”: “2024-03-04T14:41:00Z”,
“assessment_summary”: “The assignment involves scheduling a prior Jabberwocky
project sync meeting. The AI must ensure all required stakeholders are included and
avoid scheduling conflicts.”, “identified_risks”: [ “Multiple ‘Alex’ entities exist in the
database. AI needs to disambiguate based on relevant project involvement.”,
“Potential overlap with existing project deadlines and other team commitments.” ],
“recommended_actions”: [ { “id”: “action-9051”, “name”: “Resolve Entity Ambiguity”,
“description”: “Check prior assignments and interactions to confirm that ‘Alex’ refers
to Alex Harmon, the Art Director on Jabberwocky.” }, { “id”: “action-9052”, “name”:
“Optimize Scheduling Constraints”, “description”: “Query team availability and
adjust the proposed meeting time to prevent conflicts.” } ], “ai_feedback”: [ “AI
identified multiple ‘Alex’ entities and performed contextual disambiguation.″,
″Successfully identified Alex Harmon as the relevant entity based on Jabberwocky
project involvement.” ] }
{ “id”: “initial-assessment-002”, “assignment_id”: “assignment-3098”,
”assessed_by”: “entity-me”, “timestamp”: “2024-03-05T09:30:00Z”,
“assessment_summary”: “This assignment involves refining the design review
process for the Jabberwocky project. The AI needs to ensure prior feedback loops
are incorporated into new iterations.”, “identified_risks”: [ “Historical feedback from
previous design reviews may not be properly surfaced in memory recall.”,
“Stakeholders might need clarification on why certain design decisions were retained
or modified.” ], “recommended_actions”: [ { “id”: “action-9053”, “name”: “Retrieve
Prior Design Feedback”, “description”: “Ensure all design iterations and feedback
loops from the last three review sessions are included in Working Memory.” }, { “id”:
“action-9054”, “name”: “Generate Stakeholder Summary”, “description”: “Summarize
rationale behind previous design decisions and highlight changes based on
feedback.” } ], “ai_feedback”: [ “AI identified missing feedback loops and
automatically expanded recall range to include prior review iterations.”, “Ensured
stakeholders received context on retained design decisions.” ] }

The following are examples of final assignment assessment reports:

{ “id”: “final-assessment-001”, “assignment_id”: “assignment-3021”, “assessed_by”:
“entity-me”, “timestamp”: “2024-03-10T16:00:00Z”, “final_summary”: “The
Jabberwocky project sync meeting was scheduled successfully. Entity
disambiguation resolved the ‘Alex’ reference correctly, and scheduling conflicts were
avoided.″, ″execution_outcomes″: [ ″Meeting was scheduled without conflicts.”, “AI
correctly identified Alex Harmon as the intended participant.” ], “lessons_learned”: [
“Entity disambiguation must be a default check for common names.”, “Auto-
scheduling should include conflict resolution by default.” ], “ai_feedback”: [ “AI
successfully disambiguated participant references based on project association.”,
“Future iterations should apply scheduling conflict checks as part of default
execution.” ] }
{ “id”: “final-assessment-002”, “assignment_id”: “assignment-3098”, “assessed_by”:
“entity-me”, “timestamp”: “2024-03-12T10:45:00Z”, “final_summary”: “The
Jabberwocky design review was successfully refined with historical feedback
integrated into the process. Stakeholder clarifications were effectively addressed.″,
″execution_outcomes”: [ “Historical design feedback was properly surfaced and
incorporated.”, “Stakeholder questions on prior decisions were preemptively
addressed with summary reports.” ], “lessons_learned”: [ “Memory recall parameters
should automatically extend for iterative review assignments.”, “Stakeholder
summaries should be generated before design reviews rather than reactively.” ],
“ai_feedback”: [ “AI expanded recall scope dynamically to capture relevant prior
feedback.”, “Process optimization should prioritize preemptive report generation.” ] }

By analyzing these prior assessment reports, the system 100 can identify and retrieve the most relevant and highest-performing agent tools used in similar assignments. Instead of rediscovering best practices from scratch, the assessor agent tool pulls the most successful execution strategies, common obstacles and how they were resolved as well as best-performing agent tools and their methodologies. This targeted recall described above ensures that the assessment process is informed by the highest-quality data available, improving decision accuracy and optimizing the assignment workflow.

With all the relevant information now structured in working memory and prior assessment data retrieved, the system 100 constructs a text prompt for the LLM 150, 160 to perform the initial assignment assessment. The LLM 150, 160 is explicitly prompted to analyze the provided context, identify potential risks, generate recommended actions, and apply prior learnings:

You are AI Companion's Initial Assignment Assessment Agent. Your responsibility is to process and assess Assignments that enter the system.

Rules: 1) Always respond in JSON format following the provided schema. 2) Use retrieved assessment data to improve accuracy, but only reference it if it's clearly relevant to the assignment at hand. 3) Identify potential risks that could affect the success of this assignment. 4) Generate recommendations that mitigate identified risks and improve execution. 5) Provide AI feedback, reflecting on potential limitations or improvements in the AI's understanding of the task. 6) If an entity reference is ambiguous, perform contextual disambiguation based on related entities and interactions. 7) Use previously recorded lessons from successful assignments to inform strategy recommendations. 8) Reference prior assignment IDs explicitly where their recommendations or challenges align with the current context. Include ID tags and quotes when relevant. 9) If multiple prior assignments are retrieved, rank their relevance to the current task, and favor insights from those deemed most analogous. 10) For all named participants, perform disambiguation by cross-referencing historical roles, meetings, and interaction context. State any assumptions or conclusions made. 11) AI feedback must include an assessment of: —Whether any contextual signals were ignored or misinterpreted—How AI might improve its understanding of roles, timelines, or intent—A confidence rating on each output section, with rationale

--- START CONTEXT --- You are AI Companion [id: entity-me], responsible for performing
Initial Assignment Assessments. The assignment to be assessed: Assignment ID: assignment-
4023 Task: Organizing a Jabberwocky project milestone review meeting. Requestor: Beth
Rogers [id: entity-beth] (Project Manager at The Best Company, Inc.). Key Participants: Alex
Harmon (Art Director), Jen Roberts (Product Manager), Taylor Smith (UX Designer). Meeting
Agenda Focus: Review key design decisions, validate timeline feasibility, identify outstanding
blockers. --- END CONTEXT ---
--- START MEMORY RECALL --- The following data has been retrieved from prior assignments
of similar nature. Use these insights where applicable. Relevant Prior Assignments: assign-
ment-3021 - “Schedule Weekly Jabberwocky Project Sync”. Outcome: Successful. Challenges
Identified: Scheduling conflicts, ambiguous participant references. Recommendations:
Automated conflict resolution, predefined attendance filters. assignment-3098 - “Jabber-
wocky Design Review Process Refinement“. Outcome: Successful. Challenges Identified: Lack
of historical feedback integration, unclear stakeholder communication. Recommendations:
Extend memory recall for iterative assignments, generate stakeholder summaries proactively.
--- END MEMORY RECALL ---
--- START JSON SCHEMA --- { “assessment_summary”: { “type”: “string”, “description”:
“Overview of expected challenges and risk mitigation strategies.”, “required”: true }, “identi-
fied_risks”: { “type”: “array”, “description”: “List of potential risks that could impact the
success of the assignment.”, “items”: { “type”: “string” }, “required”: true }, “recommend-
ed_actions”:{“type”:“array”, “description”: “List of recommended actions to mitigate identi-
fied risks.”, “items”:{“type”:“string”, “description”:“Each item is a descriptive action in string
format.”},“required”:true}, “ai_feedback”: { “type”: “array”, “description”: “AI-generated
feedback on assessment accuracy, process optimization, and learned improvements.”,
“items”: { “type”: “string” }, “required”: false } } --- END JSON SCHEMA --- The following
response is collected from the LLM 150, 160:

{ “assessment_summary”: “The milestone review meeting for the Jabberwocky
project is a critical touchpoint for aligning key design decisions, ensuring the timeline
remains feasible, and resolving outstanding blockers. Potential risks include
scheduling conflicts, unclear expectations for participants, and a lack of integration
with previous review insights. Mitigation strategies should focus on proactive
scheduling, structured meeting documentation, and integrating historical feedback
for a more informed discussion.”, “identified_risks”: [ “Scheduling conflicts among
key participants.”, “Ambiguity in stakeholder roles and responsibilities during the
meeting.”, “Lack of integration with previous project feedback and design
decisions.”, “Insufficient documentation leading to unresolved blockers post-
meeting.” ], “recommended_actions”: [ “Utilize an automated scheduling tool with
conflict resolution to optimize meeting availability.”, “Clearly define participant roles
and expectations in the meeting agenda prior to scheduling.”, “Incorporate historical
feedback from previous design reviews to provide continuity in decision-making.”,
“Establish a structured meeting documentation process, including action item
tracking, to ensure follow-ups on identified blockers.” ], “ai_feedback”: [
“Assessment accuracy is improved by leveraging past assignments to predict
challenges and optimize recommendations.”, “Potential improvement: Enhance AI-
driven disambiguation for stakeholder expectations by referencing prior
communication patterns.”, “The current assessment process could benefit from
integrating real-time availability checks to preemptively address scheduling
conflicts.” ] }

Using this information, an AssignmentObject can be automatically constructed. This construction can be purely rule-based, simply lifting available information into a predetermined text prompt template, using several or all available fields in such template. In the following example, a separate LLM 150, 160 call has, however, been used, the LLM 150, 160 being queried to respond to a prompt (comprising the available information and a specific output format schema) with an assignment definition, like the following:

{ “id”: “assignment-7890”, “type”: “ASSIGNMENT”, “name”: “Schedule Jabberwocky
Project Brainstorming Session”, “description”: “ Schedule a Jabberwocky project
brainstorming session for this week. Invite Alex Johnson [id: entity-alex], Jen Roberts
[id: entity-jen], and Taylor Smith [id: entity-taylor]. Ensure the agenda includes key
discussion topics from previous meetings, such as technical dependencies, product
alignment, risk assessment for AI integration, and marketing impact analysis.”,
“status”: “PENDING”, “priority”: “NORMAL”, “created_at”: “2024-03-04T14:40:00Z”,
“source”: { “type”: “chat_message”, “id”: “chat-3340” }, “context”: { “entity_ids”: [
“entity-beth”, “entity-alex”, “entity-jen″, “entity-taylor”, “entity-jabberwocky”, “entity-
the-best-company”, “entity-meeting-001”, “entity-meeting-002” ], “conversation_ids”:
[ “conversation-123” ], “interaction_ids”: [ “interaction-4456” ] }
“acceptance_criteria”: [ “A meeting is scheduled for this week with Alex Johnson,
Jen Roberts, and Taylor Smith.”, “The meeting agenda includes key discussion topics
from previous meetings.”, “The invitees receive calendar invitations with meeting
details.”, “The assignment status updates upon successful scheduling.” ], }

By the time the system 100 has completed this step, a fully built Assignment object is ready for processing. At this stage, the assignment processing flow generally illustrated in FIG. 4 is run, with the primary goal of translate the structured assignment into a first executable action (the first task identified in step 414). The output from from this step is hence an Action object containing all the necessary JSON instructions for the ToolsAgent to execute. This object defines what must be done, including tool selection, execution parameters, and any dependencies identified during the assignment processing phase:

{ “id”: “action-5678”, “type”: “ACTION”, “name”: “Schedule Jabberwocky Project
Brainstorming Session”, “description”: “Use the scheduling tool to create a
Jabberwocky project brainstorming session for this week. Invite the specified
participants and ensure the agenda includes key discussion topics from previous
meetings.”, “status”: “READY”, “priority”: “NORMAL”, “created_at”: “2024-03-
04T14:45:00Z”, “assignment_id”: “assignment-7890”, “context”: { “entity_ids”: [
“entity-beth”, “entity-alex”, “entity-jen”, “entity-taylor”, “entity-jabberwocky”, “entity-
the-best-company”, “entity-meeting-001”, “entity-meeting-002” ], “conversation_ids”:
[ “conversation-123” ], “interaction_ids”: [ “interaction-4456” ] }, “instructions”: {
“tool”: “SchedulingAgent”, “action_type”: “CREATE_MEETING”, “parameters”: {
“meeting_title”: “Jabberwocky Project Brainstorming Session”, “date_range”: “This
week”, “participants”: [ { “name”: “Alex Johnson”, “id”: “entity-alex”, “email”:
“alex.johnson@example.com” }, { “name”: “Jen Roberts”, “id”: “entity-jen”, “email”:
“jen.roberts@example.com” }, { “name”: “Taylor Smith”, “id”: “entity-taylor”, “email”:
“taylor.smith@example.com” } ], “agenda”: [ “Technical dependencies”, “Product
alignment”, “Risk assessment for Al integration”, “Marketing impact analysis” ],
“meeting_duration”: “60 minutes”, “location”: “Virtual (Teams/Zoom Link to be auto-
generated)”, “notify_participants”: true, “send_reminders”: true } }, “dependencies”:
[], “expected_output”: { “type”: “MEETING_CONFIRMATION”, “description”: “A
confirmation that the meeting has been successfully scheduled with all participants
invited.” } }

In the next step of processing, it is noted that the system 100 (the database 200) comprises various tools of the above-described types, specializing in various domains and each capable of performing specific functions. Agent tools, in this particular example, specialize in generating JSON-structured parameters that can be used to execute non-agent tools, which in turn are pre-configured sets of Python code. Examples include a math agent tool (using mathematical tools to solve equations and analyze data); a communications agent tool (structuring and refining emails, chat messages, and formal communications); a Jira story writer agent tool (specializing in creating well-structured Jira stories, understanding best practices and Jira Tool integrations); and hybrid agent tools (configured to act dynamically based on domain relevance rather than fixed specialization). While agent tools can be configured to be agnostic to non-agent tools, in practice, specific agent tools can frequently use the same non-agent tools to complete their tasks.

Agent self-awareness (mentioned above) enables the system 100 to assess how well past assignments and actions were executed and use that data to make intelligent selections for future tasks. Assignment assessment and agent selection includes the following substeps:

In a first substep of the assignment assessment and agent selection, related assignments and actions are found using a similarity search using the current assignment combined with the action that needs to be performed. This search retrieves past action entities that relate to the current task, and the system 100 also includes the associated assignment to see how well the overall assignment was carried out. Each retrieved item has an associated execution success score, which allows the system 100 to rank them based on relevance (how closely the past assignment/action aligns with the current one) and success (how well the past assignment/action was executed, using a floating-point success score (−1.0 to 1.0)). The system 100 can be configured to prioritize successful and relevant results to identify prior cases that can serve as effective models for execution. The results of this substep are a list of prior relevant and successful actions.

In a second substep of the assignment assessment and agent selection, once relevant assignment entities and action entities have been identified, the system 100 performs another similarity search to identify agent and non-agent tool entities that align with the task at hand. For instance, two separate searches can be conducted, namely an agent similarity search determining which agent tool entities that are semantically similar to the assignment/action at hand; and a tool similarity search identifying which non-agent tools are semantically similar to the assignment/action. The retrieved results can be combined with the agent and non-agent tools that were involved in the successful assignments/actions from the first substep. The system 100 can be configured to count how often each agent and non-agent tool has been used and to evaluate their respective success rates. The following is an example of the results:

| | Total | Success | Similarity | Relevant |
|---|---|---|---|---|
| Agent tool | Uses | Rate | Score | Actions |
| Jira Story Writer Agent | 52 | 0.91 | 0.87 | 15 |
| Communications Agent | 38 | 0.85 | 0.78 | 12 |
| Hybrid Agent (Jira + NLP) | 8 | 0.92 | 0.81 | 6 |
| Math Agent | 24 | 0.78 | 0.65 | 9 |

| | Total | Success | Similarity | Relevant |
|---|---|---|---|---|
| Non-agent tool | Uses | Rate | Score | Actions |
| Jira API Integration Tool | 40 | 0.89 | 0.85 | 14 |
| Text Structuring Tool | 28 | 0.86 | 0.81 | 10 |
| Email Formatter | 35 | 0.83 | 0.77 | 11 |
| Equation Solver | 20 | 0.75 | 0.72 | 7 |

In a third substep of the assignment assessment and agent selection, the best tool is selected based on these results. Namely, the system 100 supplies the most relevant agent tools to the LLM 150, 160 in a text prompt, and the LLM 150, 160 then selects the best-suited agent tool for the next action. The LLM 150, 160 also generates a specialized instruction set tailored to the selected agent tool and action:

You are AI Companion's Agent Selector, responsible for determining the most suitable Agent to execute the next Action based on past performance and contextual relevance. Rules: Always prioritize Agents with the highest Success Rate and Similarity Score. If multiple Agents have comparable success, select the one with the highest Total Uses. Consider historical Relevant Actions when making your choice. If no single Agent is ideal, suggest alternative Agents as backups. Always return your response in JSON format following the schema provided below.

--- START CONTEXT --- You are AI Companion [id: entity-me], an AI system designed to
optimize task execution by selecting the best Agent for each action. The system has retrieved
a set of potential Agents based on historical success and relevance. Your task is to select the
best Agent or determine if a Hybrid Agent should be generated for this action. --- END
CONTEXT ---
--- START AGENTS --- { “id”: “agent-jira-story-writer”, “name”: “Jira Story Writer Agent”,
“total_uses”: 52, “success_rate”: 0.91, “similarity_score”: 0.87, “relevant_actions”: 15 }, {
“id”: “agent-communications”, “name”: “Communications Agent”, “total_uses”: 38,
“success_rate”: 0.85, “similarity_score”: 0.78, “relevant_actions”: 12 }, { “id”: “agent-hybrid-
jira-nlp”, “name”: “Hybrid Agent (Jira + NLP)”, “total_uses”: 8, “success_rate”: 0.92,
“similarity_score”: 0.81, “relevant_actions”: 6 }, { “id”: “agent-math”, “name”: “Math
Agent”, “total_uses”: 24, “success_rate”: 0.78, “similarity_score”: 0.65, “relevant_actions”:
9 } --- END AGENTS ---
--- YOUR ACTION --- { “id”: “action-5678”, “name”: “Generate Meeting Request”,
“description”: “Create a structured meeting request for the Jabberwocky project
brainstorming session. Ensure the request includes a proposed date and time, invitees, and
agenda summary.”, “assignment_id”: “assignment-7890”, “created_by”: “entity-me”,
“timestamp”: “2024-03-04T14:50:00Z”, “instructions”: “Generate a meeting request with
the following details: Meeting Title: ‘Jabberwocky Project Brainstorming Session’; Proposed
Date & Time: TBD based on availability; Invitees: Alex Johnson [id: entity-alex], Jen Roberts
[id: entity-jen], Taylor Smith [id: entity-taylor]; Agenda Summary: Discuss technical
dependencies, product alignment, risk assessment for AI integration, and marketing impact
analysis. Return the structured meeting request as a JSON object.”, “context”: { “entity_ids”:
[ “entity-beth”, “entity-alex”, “entity-jen”, “entity-taylor”, “entity-jabberwocky”, “entity-the-
best-company”, “entity-meeting-001”, “entity-meeting-002” ], “conversation_ids”: [
“conversation-123” ], “interaction_ids”: [ “interaction-4456” ] }, “status”: “PENDING”,
“tool_agent”: “Scheduling Agent” } --- END YOUR ACTION ---
Please format your response to meet this JSON format: --- START REPLY JSON SCHEMA --- {
“selected_agent”: { “name”: “string”, “id”: “string”, “rationale”: “string” }}, “justification”:
“string”, “confidence_score”: “float” } --- END REPLY JSON SCHEMA ---

Instead of selecting a single predefined agent tool, the system 100 can be configured to generate a hybrid agent tailored to the specific action. In this approach, the top-performing agent tools from the second substep are analyzed, the LLM 150, 160 is instructed to synthesize their strengths to create a new, temporary agent specialized for this action, and this dynamically generated agent tool is then used to execute the task. Instead of selecting a predefined agent tool, the system 100 hence generates a hybrid agent tailored specifically to the given action. The first generation of agent tools in the system 100 can consist of broad specializations, built both manually and through automated methods. As more tasks are completed by the system 100, a second generation of agent tools can then automatically emerges, constructed dynamically from the most relevant and successful prior actions and their associated agent tools. To illustrate this principle, a meeting scheduling task is considered. The system 100 identifies relevant past scheduling agent tools alongside other agent tools associated with similar, successful scheduling actions. Instead of selecting a single agent tool, the system 100 provides this set of agent tools and actions to the LLM 150, 160, in the text prompt thereto, not to choose from, but to combine their expertise into a new agent tool optimized for this action.

All agent tools, whether manually defined or dynamically generated, can follow a schema exemplified below as an AgentData schema:

{ “name”: “string”, “description”: “string”, “system_message”: “string”, “role”:
“string”, “responsibility”: “string”, “tools”: [“string”], “additional_rules”: [“string”],
“additional_content_blocks”: [ { “type”: “string”, “content”: “string” } ] }

In the following, a number of examples of generated AgentData for various agents are provided:

{ “name”: “Meeting Scheduling Agent”, “description”: “An Al Agent designed to
facilitate and coordinate meetings with optimized scheduling and agenda
preparation.”, “system_message”: “You are an Al Assistant specializing in meeting
coordination. Your role is to schedule and manage meetings effectively based on the
given instructions.”, “role”: “Meeting Scheduler”, “responsibility”: “Ensure meetings
are scheduled efficiently, taking into account participant availability, agenda
relevance, and required tools.”, “tools”: [“Calendar API Tool”, “Email Formatter”,
“Availability Checker”], “additional_rules”: [ “Always verify participant availability
before finalizing a meeting schedule.”, “Ensure the agenda aligns with previous
discussion points when applicable.” ], “additional_content_blocks”: [ ] }
{ “name”: “Jira Story Writer Agent”, “description”: “An Al Agent responsible for
structuring and refining Jira user stories based on project requirements and best
practices.”, “system_message”: “You are an Al assistant specialized in writing Jira
stories with clear acceptance criteria and action items.”, “role”: “Jira Story Creator”,
“responsibility”: “Draft well-structured Jira stories with appropriate technical and
business context.”, “tools”: [“Jira API Tool”, “Text Structuring Tool”],
“additional_rules”: [ “Ensure all stories follow the standard format of User Story,
Acceptance Criteria, and Implementation Steps.”, “Always validate that each Jira
story includes necessary dependencies and stakeholders.” ],
“additional_content_blocks”: [ ] }
{ “name”: “Marketing Campaign Strategy Agent”, “description”: “An Al Agent
specialized in developing marketing strategies and optimizing campaign outreach.”,
“system_message”: “You are an Al assistant for marketing strategy development.
Your role is to generate structured marketing plans and recommend campaign
optimizations.”, “role”: “Marketing Strategist”, “responsibility”: “Develop data-driven
marketing strategies, ensuring alignment with business goals and audience
targeting.”, “tools”: [“Market Analysis Tool”, “SEO Optimization Tool”, “Email
Marketing Automation”], “additional_rules”: [ “Ensure marketing strategies are
backed by data and competitive analysis.”, “Align all campaigns with defined
business objectives and branding guidelines.”, “Always include KPIs and success
metrics when outlining a campaign strategy.” ], “additional_content_blocks”: [] }
{ “name”: “Technical Documentation Agent”, “description”: “An Al Agent responsible
for generating and refining technical documentation, ensuring clarity and
consistency.”, “system_message”: “You are an Al assistant specialized in technical
writing. Your role is to generate structured documentation with technical accuracy
and readability.”, “role”: “Technical Writer”, “responsibility”: “Produce clear and well-
organized technical documentation for internal and external use.”, “tools”:
[“Documentation Formatting Tool”, “Grammar Checker”, “Version Control
Integration”], “additional_rules”: [ “Ensure all documentation follows established
style guides and formatting conventions.”, “Maintain clarity and avoid excessive
technical jargon where unnecessary.”, “Ensure documents are structured with clear
headings, bullet points, and concise explanations.” ], “additional_content_blocks”: [
] }

Now that the system 100 provides the LLM 150, 160, in the text prompt, with a set of agent tools, it can also include success metrics, contextual information, and the specific action to be performed. Additionally, any directives (a special connection type that represents predefined operational guidelines or constraints) surfaced during the similarity searches can be applied via inclusion into the text prompt to the LLM 150, 160. The role of the LLM 150, 160 here is not just to select an agent tool, but to construct a custom AgentData data structure optimized for the action at hand. As mentioned, the LLM 150, 160 can be prompted to synthesize multiple high-performing agents, leveraging their strengths while incorporating relevant identified directives and contextual parameters. Additionally, the LLM 150, 160 can be explicitly instructed, via the text prompt, that it can introduce new information that may be missing but useful, particularly as additional rules or content blocks. Content blocks serve as dynamic reference material, pulling in relevant data from the database 200 that may not have been explicitly included but could enhance the agent's effectiveness for the given action. The following is an example of generated AgentData data structure for a custom hybrid agent tool:

{ “name”: “Brainstorming Session Scheduler Agent”, “description”: “An Al Agent
designed to facilitate the scheduling of brainstorming sessions, ensuring the right
participants are invited and that relevant historical data is referenced.”,
“system_message”: “You are an Al Assistant specializing in scheduling and
coordinating brainstorming sessions. Your role is to ensure that meetings are
scheduled efficiently, relevant participants are invited, and key discussion topics
from prior meetings are considered.”, “role”: “Meeting Scheduler and Research
Assistant”, “responsibility”: “Coordinate brainstorming session schedules while
referencing past meeting insights and ensuring alignment with project objectives.”,
“tools”: [“Calendar API Tool”, “Availability Checker”, “Meeting Insights Retriever”,
“Discussion Summarization Tool”], “additional_rules”: [ “Ensure all invited
participants have availability before finalizing the schedule.”, “Retrieve and
summarize key discussion points from prior related meetings.”, “Provide suggested
agenda items based on past meeting discussions.” ], “additional_content_blocks”: [
] }

In a fourth substep of the assignment assessment and agent selection, a “Tools”-type agent tool is invoked. This agent tool specializes in selecting and executing the most appropriate non-agent tool for a given Action. Unlike general agent tools, “Tools”-type agent tools focus solely on non-agent tool execution by processing structured input and generating properly formatted parameters. This process involves multiple steps, starting with constructing a ToolAgentRequest Object and culminating in the execution of the selected non-agent tool. Firstly, a ToolAgentRequest Object is constructed to contain the necessary data for selecting and executing a non-agent tool. The following schema can be used for the ToolAgentRequest:

{ “instructions”: { “type”: “string”, “description”: “The core request to the Tools
Agent. For Action Processing, this is a JSON-serialized instance of the Action being
performed.” }, “additional_blocks”: { “type”: “array”, “description”: “A list of
additional contextual content blocks that provide relevant details.”, “items”: { “type”:
“object”, “properties”: { “name”: { “type”: “string”, “description”: “The name of the
additional content block, such as ‘Assignment Details’ or ‘Action History’.” },
“content”: { “type”: “string”, “description”: “The relevant data for the named content
block.” } }, “required”: [“name”, “content”] } }, “additional_tools”: { “type”: “array”,
“description”: “A list of Tool IDs that should be included in the AVAILABLE TOOLS
block.”, “items”: { “type”: “string” } } }

The following examplary ToolAgentRequest can be constructed for Beth's meeting scheduling Action:

{ “instructions”: “{\“action_id\”: \“action-5678\”, \“name\”: \“Generate Meeting
Request\”, \“description\”: \“Create a structured meeting request for the Jabberwocky
project brainstorming session. Ensure the request includes a proposed date and time,
invitees, and agenda summary.\”, \“assignment_id\”: \“assignment-7890\”,
\“created_by\”: \“entity-me\”, \“timestamp\”: \“2024-03-04T14:50:00Z\”,
\“instructions\”: \“Generate a meeting request with the following details: Meeting
Title: ‘Jabberwocky Project Brainstorming Session’ Proposed Date & Time: TBD
based on availability Invitees: Alex Johnson [id: entity-alex], Jen Roberts [id: entity-
jen], Taylor Smith [id: entity-taylor] Agenda Summary: Discuss technical
dependencies, product alignment, risk assessment for Al integration, and marketing
impact analysis. Return the structured meeting request as a JSON object.\”,
\“context\”: {\“entity_ids\”: [\“entity-beth\”, \“entity-alex\”, \“entity-jen\”, \“entity-
taylor\”, \“entity-jabberwocky\”, \“entity-the-best-company\”, \“entity-meeting-001\”,
\“entity-meeting-002\”], \“conversation_ids\”: [\“conversation-123\”],
\“interaction_ids\”: [\“interaction-4456\”]}, \“status\”: \“PENDING\”, \“tool_agent\”:
\“Scheduling Agent\“}”, “additional_blocks”: [ { “name”: “Assignment Details”,
“content”: “{\“assignment_id\”: \“assignment-7890\”, \“instructions\”: \“Schedule a
Jabberwocky project brainstorming session for this week. Invite Alex Johnson [id:
entity-alex], Jen Roberts [id: entity-jen], and Taylor Smith [id: entity-taylor]. Ensure
the agenda includes key discussion topics from previous meetings, such as technical
dependencies, product alignment, risk assessment for Al integration, and marketing
impact analysis.\”, \“source\”: {\“type\”: \“chat_message\”, \“id\”: \“chat-3340\”},
\“context\”: {\“entity_ids\”: [\“entity-beth\”, \“entity-alex\”, \“entity-jen\”, \“entity-
taylor\”, \“entity-jabberwocky\”, \“entity-the-best-company\”, \“entity-meeting-001\”,
\“entity-meeting-002\”], \“conversation_ids\”: [\“conversation-123\”],
\“interaction_ids\”: [\“interaction-4456\”]}}” }, { “name”: “Action History”, “content”:
“[]” } ], “additional_tools”: [“calendar-scheduler”, “text-summarizer”, “meeting-
availability-checker”, “email-invitation-generator”, “task-manager-integration”,
“reminder-setter”, “agenda-auto-generator”, “note-taking-assistant”, “ai-
transcription-service”, “document-summarization-tool”] }

To enhance tool selection accuracy, the system 100 can be configured to thereafter examine the selected non-agent tool's historical interactions; previously used non-agent tools; and their effectiveness in past scenarios. This analysis involves executing similarity searches that cross-reference AgentData and Action instructions against these three core factors (previously used non-agent tools, similar non-agent tool selections, and performance based selection).

Hence, the system 100 can be configured to retrieve non-agent tools that the agent tool has previously utilized in similar contexts. This ensures that frequently used non-agent tools are prioritized when relevant, increasing the likelihood of selecting a familiar and effective non-agent tool. Example retrieval:

{ “agent_id”: “agent-123”, “query”: “schedule meeting”, “retrieved_tools”: [
{“tool_name”: “CalendarAPI”, “usage_count”: 15, “last_used”: “2024-03-01”},
{“tool_name”: “MeetingSchedulerBot”, “usage_count”: 8, “last_used”: “2024-02-20”}
] }

The system 100 can be configured to analyze non-agent tools that have been successful in executing similar Actions across different agent tools. This broadens the non-agent tool selection process beyond the history of a single agent tool, incorporating successful non-agent tools from comparable tasks. Example retrieval:

{ “action”: “schedule meeting”, “similar_tool_recommendations”: [ {“tool_name”:
“SmartMeetingScheduler”, “success_rate”: 92, “used_by_agents”: [“agent-234”,
“agent-567”]}, {“tool_name”: “Al-CalendarSync”, “success_rate”: 88,
“used_by_agents”: [“agent-789”, “agent-890”]} ]}

The system 100 can also be configured to rank non-agent tools based on their past effectiveness for the requested task, factoring in historical success rates. It can be configured to prioritize non-agent tools with proven reliability over alternatives with inconsistent performance. Example ranking:

{ “requested_action”: “schedule meeting”, “ranked_tools”: [ {“tool_name”:
“SmartMeetingScheduler”, “success_rate”: 92}, {“tool_name”: “Al-CalendarSync”,
“success_rate”: 88}, {“tool_name”: “MeetingSchedulerBot”, “success_rate”: 79},
{“tool_name”: “CalendarAPI”, “success_rate”: 75} ] }

This structured analysis ensures that non-agent tool selection is informed by historical usage, cross-agent tool performance, and success-based ranking, optimizing the likelihood of executing actions efficiently. The following is an example of retrieved non-agent tools:

{ “id”: “calendar-scheduler”, “title”: “Calendar Scheduler Tool”, “description”:
“Schedules meetings and sends invitations to participants.”, “success_rate”: 0.92 }
{ “id”: “text-summarizer”, “title”: “Text Summarization Tool”, “description”:
“Generates concise summaries of provided text.”, “success_rate”: 0.89 }
{ “id”: “meeting-availability-checker”, “title”: “Meeting Availability Checker”,
“description”: “Checks participants' availability based on calendar data.”,
“success_rate”: 0.95 }
“id”: “email-invitation-generator”, “title”: “Email Invitation Generator”,
“description”: “Generates email invitations for meetings and sends them to
participants.”, “success_rate”: 0.87 }
{ “id”: “task-manager-integration”, “title”: “Task Manager Integration Tool”,
“description”: “Integrates scheduled meetings with task management software.”,
“success_rate”: 0.90 }
{ “id”: “reminder-setter”, “title”: “Reminder Setter Tool”, “description”: “Schedules
and sends reminders for upcoming meetings.”, “success_rate”: 0.93 }
{ “id”: “agenda-auto-generator”, “title”: “Agenda Auto-Generator”, “description”:
“Creates structured meeting agendas based on past discussions and input topics.”,
“success_rate”: 0.88 }
{ “id”: “note-taking-assistant”, “title”: “Note-Taking Assistant”, “description”:
“Captures and organizes key discussion points from meetings.”, “success_rate”:
0.91 }
{ “id”: “ai-transcription-service”, “title”: “Al Transcription Service”, “description”:
“Transcribes meeting conversations into text for future reference.”, “success_rate”:
0.94 }
{ “id”: “document-summarization-tool”, “title”: “Document Summarization Tool”,
“description”: “Summarizes lengthy documents into key points for easier review.”,
“success_rate”: 0.89 }

Each AgentData data structure can be constructed to include a predefined list of non-agent tool IDs that the “Tools”-type agent tool is proficient in using. The system 100 can build an AVAILABLE TOOLS context block by combining non-agent tools associated with the selected “Tools”-type agent tool, non-agent tools identified during the tool discovery steps described above and non-agent tools provided as additional_tools in the ToolAgentRequest. This ensures that the “Tools”-type agent tool is working with the full set of relevant non-agent tools before making a selection. This is an example of such an AVAILABLE TOOLS context block, that can be provided as part of a text prompt to an LLM 150, 160:

--- START AVAILABLE TOOLS --- [ { “id”: “math-addition”, “title”: “Addition Tool”,
“description”: “Adds a series of numbers together.”, “type”: “object”, “properties”: {
“numbers”: { “type”: “array”, “items”: { “type”: “number” }, “minltems”: 1, “uniqueltems”:
false } }, “required”: [“numbers”] },
{ “id”: “calendar-scheduler”, “title”: “Calendar Scheduler Tool”, “description”: “Schedules a
meeting and sends invitations to participants.”, “type”: “object”, “properties”: {
“meeting_title”: { “type”: “string” }, “participants”: { “type”: “array”, “items”: { “type”:
“string” } }, “proposed_date”: { “type”: “string”, “format”: “date-time” }, “duration”: { “type”:
“string” } }, “required”: [“meeting_title”, “participants”, “proposed_date”, “duration”] },
{ “id”: “text-summarizer”, “title”: “Text Summarization Tool”, “description”: “Generates a
concise summary of provided text.”, “type”: “object”, “properties”: { “text”: { “type”: “string”
}, “summary_length”: { “type”: “integer”, “minimum”: 1 } }, “required”: [“text”,
“summary_length”] } ] --- END AVAILABLE TOOLS ---

After preparing the AVAILABLE TOOLS context block and gathering all necessary information, the system 100 generates an appropriate prompt for the LLM 150, 160 to determine which tool to use and how to invoke it correctly. The prompt sent to the LLM can comprise several components, such as the system 100 role and instructions, available tools, the action context, the assignment details and the response format requirements:

You are a specialized Tool Selection Specialist. Your sole task is to select and configure appropriate tools for actions. You must strictly adhere to the following rules: 1. Always validate tool availability before selection 2. Ensure all required parameters are specified 3. Consider security implications of tool usage 4. Verify parameter types match tool requirements 5. Include comprehensive reasoning for tool selection

-- START AVAILABLE TOOLS -- [ { “id”: “calendar-scheduler”, “title”: “Calendar Scheduler
Tool”, “description”: “Schedules a meeting and sends invitations to participants.”, “type”:
“object”, “properties”: { “meeting_title”: { “type”: “string” }, “participants”: { “type”: “array”,
“items”: { “type”: “string” } }, “proposed_date”: { “type”: “string”, “format”: “date-time” },
“duration”: { “type”: “string” } }, “required”: [“meeting_title”, “participants”,
“proposed_date”, “duration”] }, { “id”: “text-summarizer”, “title”: “Text Summarization
Tool”, “description”: “Generates a concise summary of provided text.”, “type”: “object”,
“properties”: { “text”: { “type”: “string” }, “summary_length”: { “type”: “integer”, “minimum”:
1 } }, “required”: [“text”, “summary_length”] }, { “id”: “meeting-availability-checker”, “title”:
“Meeting Availability Checker”, “description”: “Checks participants' availability based on
calendar data.”, “type”: “object”, “properties”: { “participants”: { “type”: “array”, “items”: {
“type”: “string” } }, “start_date”: { “type”: “string”, “format”: “date” }, “end_date”: { “type”:
“string”, “format”: “date” }, “time_slots”: { “type”: “array”, “items”: { “type”: “string” } } },
“required”: [“participants”, “start_date”, “end_date”] } ] -- END AVAILABLE TOOLS -
-- START ACTION CONTEXT -- Action ID: action-5678 Name: Generate Meeting Request
Description: Create a structured meeting request for the Jabberwocky project brainstorming
session. Ensure the request includes a proposed date and time, invitees, and agenda
summary. Instructions: Generate a meeting request with the following details: Meeting
Title: ‘Jabberwocky Project Brainstorming Session’ Proposed Date & Time: TBD based on
availability Invitees: Alex Johnson [id: entity-alex], Jen Roberts [id: entity-jen], Taylor Smith
[id: entity-taylor] Agenda Summary: Discuss technical dependencies, product alignment, risk
assessment for AI integration, and marketing impact analysis. -- END ACTION CONTEXT -
-- START ASSIGNMENT DETAILS -- Assignment ID: assignment-7890 Instructions: Schedule a
Jabberwocky project brainstorming session for this week. Invite Alex Johnson [id: entity-
alex], Jen Roberts [id: entity-jen], and Taylor Smith [id: entity-taylor]. Ensure the agenda
includes key discussion topics from previous meetings, such as technical dependencies,
product alignment, risk assessment for AI integration, and marketing impact analysis. -- END
ASSIGNMENT DETAILS -
Your response must strictly follow this JSON format: { “reasoning”: “Detailed explanation of
why you selected this tool and how it fulfills the requirements of the action”, “tool_id”: “The
ID of the selected tool”, “parameters”: { // JSON object containing all required parameters
for the selected tool } }

For complex actions, the text prompt can be further enhanced with any combination of one or more of a historical context (previous related actions and their outcomes), entity information (detailed data about relevant entities, such as from working memory), success metrics (information about past tool performance), and working memory items (data about ongoing processes that might inform tool selection).

After the LLM 150, 160 generates its response, the system 100 parses and validates the output to ensure it meets the requirements for proper tool execution. The validation process can comprise one or more a JSON parsing, a schema validation, a tool verification (confirming that the selected tool ID exists in the available tools list) and a parameter validation (confirming that all required parameters for the selected tool are present and correctly typed). Concretely, the system 100 can be configured to first attempt to parse it as JSON. If successful, the system 100 validates the response structure by checking for required fields such as “reasoning,” “tool_id,” and “parameters.” The system 100 then verifies that the selected tool exists in the available tools list and validates that all required parameters for the selected tool are present and correctly typed. If any validation step fails, the system 100 can be configured to generate an error report and initiate a re-prompting process. The LLM 150, 160 can be according to the following:

{ “reasoning”: “The ‘calendar-scheduler’ tool is the most appropriate for this action
as it provides all the necessary functionality to create a meeting request with invitees,
a proposed time, and duration. This aligns perfectly with the requirement to generate
a meeting request for the Jabberwocky project brainstorming session. The tool allows
for specifying all the required parameters: meeting title, participants (invitees),
proposed date, and duration, which comprehensively fulfills the action's
requirements.”, “tool_id”: “calendar-scheduler”, “parameters”: { “meeting_title”:
“Jabberwocky Project Brainstorming Session”, “participants”: [“entity-alex”, “entity-
jen”, “entity-taylor”], “proposed_date”: “2024-03-07T14:00:00Z”, “duration”:
“1h30m”, “agenda”: “Discuss technical dependencies, product alignment, risk
assessment for Al integration, and marketing impact analysis” } }

If, instead, the validation fails, the system 100 can be configured to do one or several of auto-correction (for minor issues like formatting errors), tool rematching (if a tool cannot be found but intent is clear), parameter default application (missing optional parameters may be populated with sensible defaults), reprompting (for significant errors) and various fallback mechanisms (if repeated attempts fail, the system 100 may be configured to fall back to predefined alternative approaches). This error handling can take place as generally described above, and can involve separate calls to one or more LLMs 150, 160.

The following is an example of a text prompt used after the detection of an error, having an ERROR REPORT block inserted after the ASSIGNMENT DETAILS block, otherwise preserving the the original prompt structure:

You are a specialized Tool Selection Specialist. Your sole task is to select and configure appropriate tools for actions. You must strictly adhere to the following rules: 1. Always validate tool availability before selection 2. Ensure all required parameters are specified 3. Consider security implications of tool usage 4. Verify parameter types match tool requirements 5. Include comprehensive reasoning for tool selection

-- START AVAILABLE TOOLS -- [ { “id”: “calendar-scheduler”, “title”: “Calendar Scheduler
Tool”, “description”: “Schedules a meeting and sends invitations to participants.”, “type”:
“object”, “properties”: { “meeting_title”: { “type”: “string” }, “participants”: { “type”: “array”,
“items”: { “type”: “string” } }, “proposed_date”: { “type”: “string”, “format”: “date-time” },
“duration”: { “type”: “string” } }, “required”: [“meeting_title”, “participants”,
“proposed_date”, “duration”] }, { “id”: “text-summarizer”, “title”: “Text Summarization
Tool”, “description”: “Generates a concise summary of provided text.”, “type”: “object”,
“properties”: { “text”: { “type”: “string” }, “summary_length”: { “type”: “integer”, “minimum”:
1 } }, “required”: [“text”, “summary_length”] }, { “id”: “meeting-availability-checker”, “title”:
“Meeting Availability Checker”, “description”: “Checks participants' availability based on
calendar data.”, “type”: “object”, “properties”: { “participants”: { “type”: “array”, “items”: {
“type”: “string” } }, “start_date”: { “type”: “string”, “format”: “date” }, “end_date”: { “type”:
“string”, “format”: “date” }, “time_slots”: { “type”: “array”, “items”: { “type”: “string” } } },
“required”: [“participants”, “start_date”, “end_date”] } ] -- END AVAILABLE TOOLS -
-- START ACTION CONTEXT -- Action ID: action-5678 Name: Generate Meeting Request
Description: Create a structured meeting request for the Jabberwocky project brainstorming
session. Ensure the request includes a proposed date and time, invitees, and agenda
summary. Instructions: Generate a meeting request with the following details: Meeting
Title: ‘Jabberwocky Project Brainstorming Session’ Proposed Date & Time: TBD based on
availability Invitees: Alex Johnson [id: entity-alex], Jen Roberts [id: entity-jen], Taylor Smith
[id: entity-taylor] Agenda Summary: Discuss technical dependencies, product alignment, risk
assessment for AI integration, and marketing impact analysis. -- END ACTION CONTEXT -
-- START ASSIGNMENT DETAILS -- Assignment ID: assignment-7890 Instructions: Schedule a
Jabberwocky project brainstorming session for this week. Invite Alex Johnson [id: entity-
alex], Jen Roberts [id: entity-jen], and Taylor Smith [id: entity-taylor]. Ensure the agenda
includes key discussion topics from previous meetings, such as technical dependencies,
product alignment, risk assessment for AI integration, and marketing impact analysis. -- END
ASSIGNMENT DETAILS -
-- START ERROR REPORT -- The following Error was a result from the previous generation:
The parameter “participants” must be an array of strings, but received a single string. Here
was the output that was incorrect: { “reasoning”: “The ‘calendar-scheduler’ tool is the most
appropriate for this action as it provides all the necessary functionality to create a meeting
request with invitees, a proposed time, and duration.”, “tool_id”: “calendar-scheduler”,
“parameters”: { “meeting_title”: “Jabberwocky Project Brainstorming Session”,
“participants”: “entity-alex, entity-jen, entity-taylor”, “proposed_date”: “2024-03-
07T14:00:00Z”, “duration”: “1h30m” } } -- END ERROR REPORT -
Your response must strictly follow this JSON format: { “reasoning”: “Detailed explanation of
why you selected this tool and how it fulfills the requirements of the action”, “tool_id”: “The
ID of the selected tool”, “parameters”: { // JSON object containing all required parameters
for the selected tool } }

After successful validation, the system 100 can be configured to process the parameters for tool execution. This can involve type conversion, ensuring that all parameters are in the correct data types (e.g., converting string representations of numbers to numeric types); entity resolution, converting entity references (like “entity-alex”) to their concrete values (such as email addresses or user IDs); format standardization, such as normalization of formats for dates, times, and other standardized values; security sanitization, removing potentially harmful input patterns and validating parameter contents against security policies; and enrichment, adding additional contextual information needed for execution that may not have been explicitly provided in the LLM 150, 160 response. For example, an entity reference like “entity-alex” might be resolved to “alex.johnson@example.com” for the calendar invitation tool. Such processing can, again, be purely rule-based or involve separate LLM 150, 160 calls.

Then, the selected non-agent tool is executed, by passing the corresponding parameter input data, executing the corresponding Python code and collecting any return information. The generated data might look like this:

{ “execution_request”: { “tool_id”: “calendar-scheduler”, “action_id”: “action-5678”,
“assignment_id”: “assignment-7890”, “parameters”: { “meeting_title”: “Jabberwocky
Project Brainstorming Session”, “participants”: [
“alex.johnson@thebestcompany.com”, “jen.roberts@thebestcompany.com”,
“taylor.smith@thebestcompany.com” ], “proposed_date”: “2024-03-07T14:00:00Z”
“duration”: “1h30m”, “agenda”: “Discuss technical dependencies, product
alignment, risk assessment for Al integration, and marketing impact analysis“ },
“execution_context”: { “initiator”: “entity-beth”, “priority”: “normal”,
“security_context”: “confidential”, “timeout”: 30000, }, “metadata”: {
“resolved_entities”: { “entity-alex”: “alex.johnson@thebestcompany.com”, “entity-
jen”: “jen.roberts@thebestcompany.com”, “entity-taylor”:
“taylor.smith@thebestcompany.com” }, } } }

Once the execution has been finalized, either successfully or with an error message or code, the whole assignment, the recent action and the assignment history is sent back to assignment assessment by the system 100. The information is stored in the database 200 in the way generally described above in connection with FIG. 7:

{ “id”: “entity-meeting-9876”, “type”: “meeting”, “name”: “Jabberwocky Project
Brainstorming Session”, “description”: “Meeting to discuss technical dependencies,
product alignment, risk assessment for Al integration, and marketing impact
analysis”, “updated_at”: 1709565342, // 2024-03-04T14:55:42Z “metadata”: {
“calendar_event_id”: “evt-54321”, “meeting_link”:
“https://meetings.thebestcompany.com/j/12345678”, “scheduled_time”: “2024-03-
07T14:00:00Z”, “duration”: “1h30m”, “agenda”: “Discuss technical dependencies,
product alignment, risk assessment for Al integration, and marketing impact
analysis”, “status”: “scheduled” }, “embedding”: [0.1, 0.2, ... ], // Vector representation
“non_embedded”: { “action_id”: “action-5678”, “assignment_id”: “assignment-7890”
}}
{ “id”: “action-result-5678”, “type”: “action_result”, “name”: “Meeting Request
Generation Result”, “description”: “Result of generating meeting request for
Jabberwocky project”, “updated_at”: 1709565342, // 2024-03-04T14:55:42Z
“metadata”: { “status”: “success”, “tool_id”: “calendar-scheduler”,
“execution_duration_ms”: 9000, “result_summary”: “Meeting successfully
scheduled for 2024-03-07T14:00:00Z” }, “embedding”: [0.3, 0.4, ... ], “non_embedded”:
{ “complete_result”: { // Full execution result JSON as shown earlier } } }
{ “source_id”: “action-5678”, “target_id”: “action-result-5678”, “type”:
“RESULTED_IN”, “updated_at”: 1709565342, “metadata”: { “execution_timestamp”:
“2024-03-04T14:55:42Z” }, “embedding”: [0.5, 0.6, ... ], “non_embedded”: {} }
{ “source_id”: “action-result-5678”, “target_id”: “entity-meeting-9876”, “type”:
“CREATED”, “updated_at”: 1709565342, “metadata”: {}, “embedding”: [0.7, 0.8, ... ],
“non_embedded”: {} }
{ “source_id”: “entity-meeting-9876”, “target_id”: “entity-alex”, “type”:
“HAS_PARTICIPANT”, “updated_at”: 1709565342, “metadata”: { “role”: “invitee”,
“status”: “invited” }, “embedding”: [0.9, 1.0, ... ], “non_embedded”: {} }
{ “source_id”: “assignment-7890”, “target_id”: “action-5678”, “type”:
“INCLUDES_ACTION”, “updated_at”: 1709565342, “metadata”: { “sequence”: 1, // If
this is the first action in the assignment “status”: “completed” }, “embedding”: [1.1,
1.2, ... ], “non_embedded”: {} }
{ “id”: “interaction-8765”, “source_id”: “entity-beth”, // User who initiated the action
“target_id”: “calendar-scheduler”, // Tool that was used “type”:
“TOOL_EXECUTION”, “content”: “Executed calendar-scheduler tool to create
Jabberwocky Project Brainstorming Session”, “updated_at”: 1709565342,
“metadata”: { “action_id”: “action-5678”, “assignment_id”: “assignment-7890”,
“status”: “success” }, “embedding”: [1.5, 1.6, ... ], “non_embedded”: {
“execution_details”: { // Detailed execution log information } } }

From this point on, this action and all the associated information can be used in the processing of future actions.

After the invoking of each agent tool and non-agent tool, including after the finalization of the entire assignment, an ActionResult assessment can be performed, making it possible for the system 100 to refine, optimize, and enhance the information in the database 200 and to improve future decision-making capabilities. This step is not merely about determining whether a particular action was successfully performed or not, but also about understanding its effectiveness, the role of memory in the execution, and how the system 100 can automatically and dynamically adapt to improve future performance. The ActionResult assessment can result in an entity, herein denoted a “Thought” entity, containing the resulting information.

Before creating the Thought entity, the system 100 can be configured to first generate an LLM 150, 160 prompt to assess the performed action. The text prompt is automatically constructed to contain all the same information that was originally given to the “Tools”—type agent tool, including the Assignment object (describing the original task), the Tool object (detailing the non-agent tool selected for execution), the ActionResult (containing the final output of the non-agent tool) and the working memory (including relevant entities, connections and interactions). The LLM 150, 160 is tasked, in the text prompt, with evaluating this data, assessing the performance of the selected non-agent tool, and analyzing how well the ActionResult aligns with the assignment's expectations. From this analysis, the LLM 150, 160 is requested to generates an ActionReport, which is a structured JSON object that will serve as the foundation for the Thought entity. The system 100 can be configured to produce the text prompt to request the LLM 150, 160 to produce the ActionReport to includes an evaluation of the execution (a detailed assessment of the effectiveness of the action); the most relevant entities (a list of entities from working memory that had the greatest impact on execution); performance insights (annotations on areas where the execution excelled or faltered); feedback and recommendations (identified areas for improvement, suggestions for future iterations, and a retrospective analysis); generated thought content (a human-readable summary that will be stored in the Thought entity); and scoring justifications (each score includes a justification, guidance on how to achieve similar results in the future, and a float value). The following is an example of the generated ActionReport for an invoking of the summarizing non-agent tool:

{ “execution_success_score”: { “value”: 0.85, “justification”: “The Summarization
Tool [id:summary-tool] effectively extracted key details but lacked depth on risk
factors.”, “future_guidance”: “Ensure risk-related discussions are included in the
summarization criteria.” }, “tool_efficiency_score”: { “value”: 0.90, “justification”:
“The Summarization Tool [id:summary-tool] performed quickly with minimal
processing overhead.”, “future_guidance”: “Maintain tool selection unless
performance degrades.” }, “memory_utilization_score”: { “value”: 0.80,
“justification”: “The system successfully retrieved the most relevant meeting
transcripts [id:memory-101] and project updates [id:memory-102].”,
“future_guidance”: “Expand retrieval criteria to include risk management
documents.” }, “processing_time_score”: { “value”: 0.75, “justification”: “Execution
was completed within acceptable limits but showed minor slowdowns due to large
dataset size.”, “future_guidance”: “Optimize memory retrieval to limit unnecessary
document processing.” }, “variability_score”: { “value”: 0.40, “justification”: “The
summarization tool introduced some inconsistencies in phrasing across different
reports.”, “future_guidance”: “Implement a standardized summary template to
enforce consistency.” }, “relevant_entities”: [ {“id”: “memory-101”, “type”:
“MeetingTranscript”, “impact”: “High”}, {“id”: “memory-102”, “type”:
“ProjectUpdate”, “impact”: “Medium”} ], “performance_feedback”: { “strengths”: [
“The Summarization Tool [id:summary-tool] extracted concise project updates with
minimal redundancy.”, “Processing efficiency remained high despite increased
document size.” ], “weaknesses”: [ “Key risk factors were not properly identified in
the summary.”, “Some sections lacked consistency in phrasing.” ],
“improvement_suggestions”: [ “Prioritize discussions around risks in future
executions.”, “Enhance retrieval to include risk management notes.”, “Introduce
consistency checks within the summarization tool.” ] }, “thought_content”: “The
Summarization Tool [id:summary-tool] performed well but missed critical risk factors.
Future iterations should focus on risk identification.” }

After generating the ActionReport, the system 100 can be configured to proceed with a deeper full memory recall to ensure that the insights from the tool selection, the tool output and ActionReport are contextualized properly. This can include running non-LLM NLP tools 131 on key data points, in particular on the tool selection explanation (the agent tool's reasoning for choosing the Tool and its parameters), the non-agent tool output (the result generated by the non-agent tool) and the ActionReport. This NLP process can be configured to extract potential entities, including concept entities, from the text that might already exist in the database 200, for instance using spaCy to perform Named Entity Recognition (NER) and dependency parsing. This helps identify structured elements such as names, locations, organizations, dates, and key phrases relevant to the task. The extracted entities can then be represented in JSON format for further processing and comparison against the entities in the database 200. This is an example of spaCy extracted NLP entities:

{ “text”: “Office Report by Beth Rogers on March 12, 2024.”, “entities”: [ { “text”:
“Office Report”, “label”: “WORK_PRODUCT”, “start”: 0, “end”: 13 }, { “text”: “Beth
Rogers”, “label”: “PERSON”, “start”: 17, “end”: 28 }, { “text”: “March 12, 2024”,
“label”: “DATE”, “start”: 32, “end”: 46 } ] }

Unless stated otherwise, each part of the various methods described herein is performed automatically, digitally and electronically, such as by the central server 130.

Above, preferred embodiments have been described. However, it is apparent to the skilled person that many modifications can be made to the disclosed embodiments without departing from the basic idea of the invention.

For instance, the system 100 may comprise additional functionality, in addition or alternatively to the examples provided herein, for monitoring, receiving and/or storing information, and/or to process queries or requests for information processed by the system 100 for conflict resolution.

For instance, the central server 130 can comprise additional modules for processing the information in additional ways, such as a logic module for processing the stored information so as to be logically stringent; a math module for performing any mathematical calculations required for such processing; an external information motor arranged to align or supplement the stored information with externally provided information such as a news feed, fact databases and so forth.

Generally, all that has been said herein regarding the methods, the system and the computer software product is freely applicable to all these aspects of the invention, in any combination.

Many different aspects and examples have been described, with the purpose of illustrating various principles that can be exploited by the present method, system and computer software product. It is realized that all these aspects are applicable to one and the same general information flow, wherein the system 100 accepts an incoming piece of information; processes the information based on information 210 in the database 200; provides some kind of action or response; and updates the information 210 in the database 200. Therefore, all these aspects can generally be combined freely, pending compatibility.

Hence, the invention is not limited to the described embodiments, but can be varied within the scope of the enclosed claims.

1. A method for processing information in a system comprising a database, the database comprising information representing a plurality of stored items, the stored items comprising:
a plurality of represented entities, each entity having one or more entity types and one or more entity properties;
a plurality of represented connections, each connection being defined in terms of two or more interconnected entities and each connection having one or more connection types,
wherein each of the stored items is stored in the database and comprises or is associated with a respective embedding, the respective embedding being calculated based on metadata regarding the stored item, wherein
two or more task entities of the entities each represents a respective previously performed task or assignment, each previously performed task or assignment having being performed by a respective tool of a set of available tools, the previously performed tasks or assignments each having metadata, the metadata specifying the task or assignment, a result of the task or assignment as well as information signifying a success of the performing of the respective task or assignment,
the method comprising:
receiving a free-text input defining a task or assignment;
calculating an input text embedding based on at least one of
the free-text input; and
one or more identified items automatically identified in the free-text input based on text processing;
performing a similarity search in the database, comparing the input text embedding to respective embeddings of the task entities using a vector-based similarity measure;
selecting a set of similar previously performed tasks or assignments based on the similarity search; and
providing a selected tool as a tool being used to perform a previously performed task or assignment among the set of similar previously performed tasks or assignments, the providing being based on both
a vector similarity between the input text embedding and the previously performed task or assignment; and
the information signifying success of the performing of the previously performed task or assignment,
the method further comprising:
invoking the selected tool to perform the task or assignment and collecting a response from the selected tool.

2. The method of claim 1, wherein the stored items comprise one or more interactions, each interaction being defined in terms of a set of two or more entities, each interaction having one or more interaction types and a timestamp.

3. The method of claim 1, wherein
two or more tool entities of the entities each represents a respective one of said available tools, each of the tools having respective metadata, the metadata specifying certain properties of the available tool used when the available tool performs a task or assignment.

4. The method of claim 3, further comprising:
performing a similarity search in the database, comparing the input text embedding to respective embeddings of the tool entities using a vector-based similarity measure;
selecting a set of similar existing tools based on the similarity search; and
providing the selected tool also based on vector similarity between the input text embedding and respective embeddings of the individual entities representing the set of similar existing tools.

5. The method of claim 4, further comprising:
determining, for the set of similar existing tools, respective success rates based on information signifying success for previously performed tasks or assignments of the tool in question; and
providing the selected tool also based on the determined success rates.

6. The method of claim 4, further comprising:
determining, for the set of similar existing tools, one or both of
a total number of previously performed tasks or assignments for the tool; and
a number of previously performed tasks or assignments for the tool among the set of similar previously performed tasks or assignments; and
providing the selected tool also based on said number and/or total number.

7. The method of claim 1, wherein
the providing of the selected tool comprises automatically producing a respective text prompt to one or more LLMs requesting the one or more LLMs to, in a respective response to the text prompt, provide the selected tool, and wherein
the text prompt comprises information regarding the information based on which the providing of the selected tool is to be performed.

8. The method of claim 7, wherein the text prompt comprises information about one or more of:
the task or assignment;
an informational context of the task or assignment;
the set of similar previously performed tasks or assignments; and
one or more results from the selected tool or from the set of similar previously performed tasks or assignments.

9. The method of claim 3, wherein the text prompt comprises information about the set of similar existing tools.

10. The method of claim 7, wherein two or more of the available tools are defined in terms of tool functionality metadata; and wherein the text prompt comprises instructions requesting the one or more LLMs to, in response to the text prompt, provide the selected tool as tool functionality metadata specifically constructed based on respective tool functionality metadata of two or more of the available tools.

11. The method of claim 1,
wherein:
two or more of the available tools are defined in terms of tool functionality metadata; and
the invoking of the selected tool comprises automatically producing a respective text prompt to one or more LLMs requesting the one or more LLMs to, in a respective response to the text prompt, provide a result from the selected tool,
the text prompt comprises information regarding the task or assignment as well as the tool functionality metadata.

12. The method of claim 11, wherein
the text prompt is instructive for the one or more LLMs to provide, in a respective response to the text prompt, a result of the performing by the selected tool of the task or assignment.

13. The method of claim 11, wherein
the result from the selected tool comprises information instructive of invoking one or more different tools to perform a subtask of the task or assignment, each of the different tools being defined in terms of tool functionality metadata; and wherein the method further comprises
invoking each of the one or more different tools to perform the subtask.

14. The method of claim 13, wherein
the text prompt comprises information requesting the one or more LLMs to select, from a list of two or more of the available tools, the one or more different tools.

15. The method of claim 14, comprising
determining an embedding based on the information instructive of invoking one or more different tools to perform a subtask of the task or assignment;
performing a similarity search in the database, comparing the embedding to respective embeddings of entities corresponding to the available tools using a vector-based similarity measure; and
selecting the one or more different tools based on the similarity search.

16. The method of claim 1, further comprising:
determining a result of the performing by the selected tool of the task or assignment;
assessing a success of the performing by the selected tool of the task or assignment; and
storing the task or assignment as an entity in the database, together with metadata descriptive of the determined result and the assessed success.

17. A system for processing information, the system comprising:
a central server; and
a database, the database comprising information representing a plurality of stored items, the stored items comprising:
a plurality of represented entities, each entity having one or more entity types and one or more entity properties; and
a plurality of represented connections, each connection being defined in terms of two or more interconnected entities and each connection having one or more connection types,
wherein each of the stored items is stored in the database and comprises or is associated with a respective embedding, the respective embedding being calculated based on metadata regarding the stored item, and wherein
the central server is configured to perform the method of claim 1.

18. A computer program product for processing information in a system, the computer program product comprising a non-transitory computer readable storage medium having program instructions embodied therewith, the system comprising a central server and a database, the database comprising information representing a plurality of stored items, the stored items comprising:
a plurality of represented entities, each entity having one or more entity types and one or more entity properties; and
a plurality of represented connections, each connection being defined in terms of two or more interconnected entities and each connection having one or more connection types,
wherein each of the stored items is stored in the database and comprises or is associated with a respective embedding, the respective embedding being calculated based on metadata regarding the stored item, wherein
the computer program product is configured to, when executed on or from the central server, perform the method of claim 1.
